(19) United States
(12) Patent Application Publication
(10) Pub. No.: US 2003/0055776 A1
(43) Pub. Date: Mar. 20, 2003

(54) Method and apparatus for bundling transmission rights and energy for trading

(76) Inventor: Ralph Samuelson, Mountain View, CA (US)

Correspondence Address: GLENN PATENT GROUP, 3475 EDISON WAY, SUITE L, MENLO PARK, CA, 94025, US

(21) Appl. No.: 10/146,511

(22) Filed: May 14, 2002

Related U.S. Application Data
(63) Continuation-in-part of application No. 09/932,694, filed on Aug. 16, 2001.
(60) Provisional application No. 60/291,218, filed on May 15, 2001.

(51) Int. Cl. G06F 17/60

(52) U.S. Cl. 705/37

(57) ABSTRACT

A method and apparatus for bundling transmission rights and energy for trading allows participants to enter bids for complete energy and transmission rights bundles that they wish to buy and offers for the complete bundles that they wish to sell through a user interface. An optimization system is provided that continuously searches for ways to disassemble the bundles that participants wish to sell into their component elements (transmission rights and energy) and reassembles them into bundles that participants wish to buy. Any time that a set of bundles that participants wish to sell can be reassembled into a set of bundles that other customers wish to buy, and the aggregate bids for the new bundles exceeds the aggregate offers for the old bundles, the optimization system contracts orders for the bundles and performs the disassembly and reassembly. The invention provides a participant with a ex ante quote for any point-to-point transmission right at any time. An optimization system calculates this quote based on the standing bids and offers for other point-to-point transmission rights currently posted in the system by other participants or market makers. A participant that finds the quote attractive places an order at any time and is assured that the order will contract at the quoted price.

### CROSS REFERENCE TO RELATED APPLICATIONS

This application is a continuation-in-part of U.S. patent application Ser. No. 09/932,694, filed on Aug. 16, 2001 and claims benefit of U.S. Provisional Patent Application Ser. No. 60/291,218, filed on May 15, 2001.

### BACKGROUND OF THE INVENTION

1. TECHNICAL FIELD

This invention relates to using a transaction system for trading, operational scheduling, and settling transactions involving ephemeral, fungible commodities with regards to electrical power as applied to grids of one or more AC power networks.

2. DESCRIPTION OF THE PRIOR ART

The United States and, in particular, the state of California find themselves in a state of crisis regarding the availability and cost of electrical power. Many experts are investigating this crisis, including the inventors. Several primary problems contribute to that crisis.

1. The electrical power grid has seen almost no new electrical power generation capacity added in years.

2. Tools to optimally manage electrical consumption are antiquated and insensitive to changing consumption and cost patterns in real time, often amounting to no more than simple manual switches. While turning off unused equipment such as electric lights has been useful, it does not help the facility managers who must make decisions based upon plans encompassing the facility needs, such as producing products to sell and providing hot water and comfortable room temperatures in hotels.

3. The system of transmitting electrical power, particularly AC electrical power has significant congestion paths, known herein as flow gates. There has been little economic incentive to increase the transmission capacity through the flow gates, in part because there is no coherent policy provided fair and predictable economic return to the required capital investments.

4. Deregulation in the California energy industry brought many things with it, including a restriction to only short-term energy contracts. As the older, long term contracts ended, this left the bulk of the state's energy costs vulnerable to daily market fluctuations and led to the prices on the spot market dominating the cost of energy not only in California, but throughout the United States.

Regarding adding electrical power generation capacity. Many large facilities are unwelcome in the neighborhoods where they may be built, due to pollution and a lack of esthetic appeal. Up until recently, this was cited as the primary reason for little new power capacity.

One promising alternative is power generation associated with an existing facility. Many facilities can produce large quantities of burnable fuel, which could be used to generate electricity. Such facilities include, but are not limited to, municipal waste treatment plants, commercial livestock farms raising hogs and/or chickens, feed lots, saw mills, as well as farms raising vegetable matter, such as corn and sorghum. It is in the public interest that such facilities produce electrical power. Additionally, other facilities, including breweries, refineries and chemical plants, can produce electricity from steam, heated fluids or other gases, and/or heat already required by the facility.

These new facilities face must figure out how to manage such an endeavor without incurring a large management overhead. Today's power management procedures and technology is based upon large facilities, often generating hundreds of megawatts. Such facilities often require three shifts of operations staff, each of which may number a dozen or more people. These facilities also require energy traders, scheduling experts and an accounting staff to finalize and oversee the settlements phase. This management process is too expensive for a facility that sells power on the order of a megawatt. What is needed is a tool supporting all these management functions at a fraction of the overhead of contemporary methods.

Existing management systems for large generation facilities face a problem in reliably communicating between all these different necessary management functions. Usually the reliability error is in the interfaces between different management subsystems. What is needed is a unified mechanism supporting all the primary management activities discussed above, providing a consistent, easy to use tool for organizing the activities and communicating the results of the various managerial agents of a large generation facility.

As used herein, a fungible commodity refers to a commodity traded strictly in terms of the quantity of that commodity. No single unit of a fungible commodity is distinguishable from another unit of that commodity. A kilowatt-hour of 60 Hz AC power delivered on a power line is not distinguishable from another kilowatt-hour delivered at the same time to the same place on the same line. An ephemeral, fungible commodity is a fungible commodity whose existence is extremely short-lived. Electrical power generation, network bandwidth, seats on an airplane and entry slots onto a freeway during rush hour are all examples of fungible commodities which exist but for a short duration of time. In contradistinction, starting lots in an assembly line produce tangible results, which may differ widely in content, thus showing an example of an ephemeral, non-fungible commodity.

There are some basic physical properties of electrical power distribution which are important to understand. An AC power network is an electrical network connecting AC power generators to AC power loads on power lines controlled so that the network as a whole can be seen to function at an essentially constant frequency and uniform phase across the network. Drifts in phase are compensated by phase shifting devices to enforce the uniform phase property across the AC power network. Drifts in frequency are compensated at the generators. Such frequency variations are typically caused by variances between the loads and generated power. The effect of these compensations is to operationally provide essentially constant frequency and uniform phase throughout the AC power network.

The AC power distribution frequency in the United States, Canada, Mexico and some other countries is 60 Hz and in some other countries is 50 Hz. In certain cases, the power is distributed in a 2-phase transmission scheme. In certain other instances, the power is distributed in a 3-phase transmission scheme.

A grid as used herein refers to an electrical power system which may comprise more than one AC power network as well as DC power lines which may transfer energy between nodes of different AC power networks or between nodes of a single AC power network.

Cities, generators and the like act as the nodes of an AC power network. A specific node may comprise more than one generator or load. A bus connects these local facilities of a node. High voltage AC transmission lines transfer power between the cities and the generators in major load centers of an AC power network.

By way of example, in the United States, there's an AC power network called the Western States Coordinating Council, which covers British Columbia in Canada down to Northern Mexico and over to the Rocky Mountains. There's another AC power network in Texas and there is another AC power network essentially covering the rest of the United States and Canada, with the exception of a portion of Quebec. These three AC power networks are connected together by direct current lines to form the North American grid. They are not connected in AC. They are asynchronous, in that they are not synchronized either in terms of frequency or phase across the United States, Canada and northern Mexico.

Electrical power generation can be readily seen to be ephemeral and fungible. One kilowatt is reasonably treated the same as another, persisting only a relatively short period of time. Electrical power transmission can also be seen as ephemeral and fungible. Electrical power transmission is most commonly performed as AC transmission lines between nodes of an AC power network. DC power lines are used additionally to connect specific nodes of either a single AC power network or nodes of distinct AC power networks.

Electrical power storage is of typically limited time duration. The most commonly used storage system is to pump water uphill to a storage site where it is held until needed. When needed, it is gravity-fed through one or more turbines to generate electricity. Such systems, for economic reasons, are not used to store power for very long, often for no more than a day or two. It is noted that the interface points for power into such systems are ephemeral and fungible.

Power switching between lines involving high power (megawatts and above) is not commonly done. Current examples of AC power switching include switching between amplifiers and antenna feeds in broadcast radio systems, and typically involve no more than a fraction of a megawatt. While there are some high power AC switches, they are large and expensive devices. High power AC switches rarely change state. Note that the power traversing the interfaces of such switches to a power network are ephemeral and fungible.

There are some basic physical properties distinguishing AC power distribution systems from other flow-based systems such as DC power, gas, water and oil transmission systems. AC power networks differ from gas, water, oil and other fluid flow distribution systems in that changes in power generation and loading propagate across such networks at approximately the speed of light. The effect of power generation and power loading effects the whole AC power network in a manner that, for practical purposes, is simultaneous.

Due to the stability of frequency and phase across an AC power network, changes in power have a super positioning effect. This insures that the power being carried on any line in the network is essentially a linear function of the generators and loads on the network. Furthermore, if a path of lines connects two nodes, generating power at the first node carried by the path is offset by power generated at the second node, as related by the above mentioned linear function.

These AC power networks are operated within a safe range, so that the patterns of flows are fairly predictable, given the configuration of the network does not change. The National Electric Reliability Council computes a system of a set of numbers called power transfer distribution factors available on the North American Reliability Council website, www.nerc.com, showing how the power is distributed across these various lines. It is a linear function of the amount injected, which changes sign when the direction of transfer changes from Node1 to Node2 into Node2 to Node1. Such functions are skew symmetric with respect to the nodes.

Consider a DC network: one can directly control the delivery of power from one point to another. This cannot be done on AC power networks. It is a characteristic of AC power networks that all lines are affected in roughly fixed proportions, sometimes referred to as “transfer distribution factors” and by the generating and loading at specific nodes.

By way of example, when AC power is sent from Bonneville Power Authority in the state of Washington to San Francisco, some of it comes down the direct path and some of it comes down through Idaho to Arizona and back up from Southern California to Northern California.

One may be limited in what can be brought from the Bonneville Power Authority to San Francisco because there'sa problem with the flow coming up from Southern California to Northern California. Please note, this particular path, known as Path15, is often the first path to become congested.

These constrained flow elements are called flowgates. A flowgate of a given AC power network refers herein to a collection of at least one line whose total maximum safe carrying capacity acts as a congested element of the network, constraining AC power delivery between two or more nodes of that network.

Historical congestion analysis of specific AC power networks reveals that only a small number of flowgates account for almost all congestion problems. Such flowgates are herein referred to as significant flowgates. Path15 is considered a significant flowgate.

The associated AC power transfer across a given flowgate is additive due to the super positioning effects previously discussed. Thus, in sending 100 megawatts along a path, the transmission may have a 10% impact on the flowgate, putting 10 megawatts on the flowgate. A second generator may have a 5% impact on that flowgate. Generating 100 megawatt at the second generator would add 5 megawatt across the flowgate.

FIG. 1A depicts an exemplary AC power network based upon contemporary AC power technology as found in the prior art. The network contains 12 nodes labeled 10, 20, 30, 40, 50, 60, 70, 80, 90, 100, 110 and 120 respectively.

AC transmission line 12 runs between node 10 and node 20. Line 14 runs between node 10 and node 40. Line 22 runs between node 20 and node 30. Line 36 runs between node 30 and node 40. Line 42 runs between node 40 and node 120. Line 44 runs between node 40 and node 60. Line 46 runs between node 40 and node 50. Line 52 runs between node 50 and node 110. Line 54 runs between node 50 and node 60. Line 56 runs between node 50 and node 70. Line 62 runs between node 60 and node 110. Line 64 runs between node 60 and node 70. Line 82 runs between node 80 and node 90. Line 92 runs between node 90 and node 120. Line 94 runs between node 90 and node 110. Line 96 runs between node 90 and node 100. Line 102 runs between node 100 and node 110. Line 112 runs between node 110 and node 120.

Flowgate A 210 is a constraint on the network. Lines 32, 34 and 42 are constrained by flowgate A 210 by a total maximum safe carrying capacity, in that these lines have transmission capacity limitations which are easily overloaded when this maximum safe carrying capacity is exceeded.

Flowgate B 220 is a constraint on the network. Lines 42 and 44 are constrained by flowgate B 220.

Flowgate C 230 is a constraint on the network. Lines 52 and 62 are constrained by flowgate C 230 to a total maximum safe carrying capacity.

By way of example, a mountain range such as the Cascade mountain range in the state of Washington might have a limited number of passes. The transmission lines through each mountain pass may form a single flowgate. Flowgates A 210, B 220 and C 230 illustrate the overall effect that might result for transmission paths through three mountain passes.

Another problem, as yet addressed, is revenue sharing between multiple vendors supporting energy transmission along a flow path. By way of example, consider one of the few passes through the Cascade mountain range located in the state of Washington. Through each of these narrow corridors runs one or more strips of land populated by power transmission towers and high voltage power lines. The AC power transmitted on these power lines is frequency and phase matched. The collection of these AC power lines may create a single system constraint, a flowgate.

By way of example, suppose there are three transmission lines between two nodes in an AC power network, each individually capable of carrying 100 megawatts. These three transmission paths may collectively form a flowgate, which has a collective transmission limit of 200 megawatts, even though the sum of the three transmission lines is 300 megawatts.

Assume that some group of investors wants to finance a new set of towers supporting one or more transmission lines through this mountain pass. The new transmission facility will in all probability become part of the flowgate of transmission lines through that mountain pass from the moment it becomes operational. The question: How are flowgate transmission revenues to be shared when more than one group has made the capital investment to support such transmission? Note that if investors cannot reasonably predict a fair return on their investment, they will be unlikely to make the investment.

What is needed is a mechanism providing incentives to groups seeking to add transmission capabilities through fair and predictable revenue sharing from flowgate transmission revenues.

FIG. 1B depicts a list of associated AC power functions described by their coefficients for each flowgate of a collection of flowgates for each of the busses of the various nodes of the exemplary AC power network of FIG. 1A as disclosed in the prior art.

Note that these AC power functions are essentially linear and can be described by their coefficients.

Bus 1 locally connects all facilities of Node 10. Bus 2 locally connects all facilities of Node 20. Bus 3 locally connects all facilities of Node 30. Bus 4 locally connects all facilities of Node 40. Bus 5 locally connects all facilities of Node 50. Bus 6 locally connects all facilities of Node 60.

Bus 7 locally connects all facilities of Node 70. Bus 8 locally connects all facilities of Node 80. Bus 9 locally connects all facilities of Node 90. Bus 10 locally connects all facilities of Node 100. Bus 11 locally connects all facilities of Node 110. Bus 12 locally connects all facilities of Node 120.

Note that the facilities at these nodes, connected by the associated buss, often vary greatly in terms of generation capacity as well as loading capacity. By way of example, a city often consumes far more AC power than it generates. Another example, a node for a major hydroelectric dam such as Grand Coulee Dam would tend to generate far more AC power than it consumed.

Note that the associated AC power functions for the various busses are all fractions of 1, since the most power that could be transferred is the amount of power at the generation node. Note further that some of these AC power functions are negative. Bus 11 has strictly zeroes for its power function. It is essentially acting as a reference node for calculating the associated functions. When electricity is generated at Bus 1 and consumed at Bus 11, the values in the first row of FIG. 2 indicate the ratio of power transferred across flowgates A, B, and C. If the power is generated at Bus 11 and consumed at Bus 1, the same values apply but are of reversed sign.

Consider how AC power transfers are managed today in most of North Amerca. Transmission rights are considered and negotiated in terms of point-to-point transfers within the network known as contract paths. Such thinking is contrary to the previously discussed physics of these AC power networks, because changes in power generation or load at any node have an essentially linear effect on all transmission lines in the network, and consequently impact all flowgates within that network to some extent.

The contract path system maintains the fiction that AC power can be directed to follow a path through the network chosen as one might with natural gas. By changing the valves, one can mythically direct AC power a particular way through the AC power network. The contract path system was put in place because it was thought conceptually easier since one only had to make reservations along the single path. The fundamental problem with the contract path approach is that the contract path arrangement for transmission does not accord with the way the power actually flows in an AC power network.

Today's contract path is a first-come, first-served priority scheme. What is bought has very limited resale capability. By way of example, consider three nodes A, B and C forming a triangle in an AC power network. Suppose one bought a power transmission from A to B and bought a transmission from B to C. Using the contract path approach, does not mean one owns the power transmission from A to C, because contract paths are not additive. Owning power transmission from A to B and from B to C would not entitle power transmission from A to C. To transport from A to C, one would have to purchase separately transmission from A to C. This is because there might be some flowgate constraint which would not be met in the two separate paths which would be triggered in the combined path. So in the contract based market, which is the traditional market, once you have purchased the transmission from A to B, it's only value is for moving energy from A to B.

Today, there are several ad hoc approaches to limiting flow on one path because of the impact on another path. These contract path approaches ignore the physics of AC power networks. This leads to situations where even though some other path may actually be the constraint, when a particular path becomes over-constrained, cuts are issued to compensate. The central operator acts, because a flowgate will attempt to exceed its safe carrying capacity, forbidding transmission often across apparently irrelevant paths to compensate. The result is market chaos, since participants do not have reasonable assurance that their deals will actually go to delivery.

Another alternative approach is to take all of these generator costs, and the preferences of the buyers, into a mathematical optimization program, and figure out the optimal flow. This alternative approach has significant disadvantages. In a commercial market, getting people to reveal all their costs is quite difficult. Most people are very reluctant to do that. Further, such costs frequently change. The loads have to reveal their preferences between consuming and non-consuming players, which is a tremendous informational burden. It is extremely unlikely that they could or would do it. Even if they did, all this information is a tremendous burden on the central operator collecting all the information.

Such an alternative approach requires two-way communication among all the players, with all these devices and systems to control, when the people consume power and when they turn on and off these distributed devices. It has proven impossible to provide the requisite level of reliable communication and direct control systems. Besides, people are unwilling to turn over control of their business lives to a central operator.

Another approach in industry is used by a system operator called PJM, for Pennsylvania, New Jersey and Maryland, who have developed a system called Locational Marginal Pricing (LMP). It is a central dispatched methodology. However, a local flow model is buried within it. It supports some centralized management of generators, related equipment and facilities in order to get a consistent solution that is based upon the power distribution matrix. This is a matrix of all power transfer distribution factors between nodes of the AC power network.

This approach suffers from at least the same problems facing any other centralized control scheme. There is a very limited amount of detailed information such a system can acquire, or use, to optimize AC power transfers. The power users are again blind to their options. The players cannot determine what works best for them. The central operator dictates to them. Also, under LMP, prices are not known until after the deal is done (ex post), which may be at the time of delivery or day ahead of delivery. Generation operators do not obtain the information they need to plan their hydroelectric, maintenance, and unit commitment decisions. Nor can price risks be easily hedged.

NERC has developed a methodology addressing flowgates to some extent. This is discussed in a document entitled “Discussion Paper on Aligning Transmission Reservations and Energy Schedules to Actual Flows”, distributed in November, 1998 by the NERC Transaction Reservation and Scheduling Self-Directed Work Team. This team proposed an electrical power industry shift to a system of reserving and scheduling transmission based on actual use of congested flowgates, which they called the FLOWBAT method. Their proposal suffers from a serious omission, it does not address the issue of allocating flowgate capacity when demand exceeds supply. By their silence on this issue, it appears that they would continue the current practice of first-come, first-served allocation. The flaws discussed above for centralized planning continue to be relevant in this approach.

Certain economists have expressed reservations with a flowgate market model utilizing a limited number of flowgates. They believe that leaving any flowgates out of the system, even minor ones, introduces gaming opportunities, which will cause the RTO to incur costs that must be paid by everyone. However, flowgates are numerous, and may arise unpredictably. It may not be feasible to trade every flowgate, as would be required to overcome the potential for gaming.

Supporting a large number of flowgates in a market model leads to several other problems. First, there is the technical problem of providing a user interface that makes it possible for users to cope with the complexity of numerous flowgates.

Second, there is the problem of maintaining liquidity with this many flowgates. Customers want to buy and sell the bundles of flowgates they need to move energy from one point in the network to another. They may not feel comfortable posting bids and offers for individual flowgates without an assurance that they will be able to buy or sell the remaining flowgates they need for their bundle at a reasonable price. If everyone withholds bids and offers from the market until they see bids and offers for all the flowgates they want to buy or sell, the market could significantly lack liquidity.

What is needed is a method of using a market model supporting large numbers of flowgates and providing users with a straightforward method of trading the AC power transfer, while discouraging gaming opportunities.

What is needed is a system supporting trading transmission rights and quantities of fungible ephemeral commodities in the form of complete bundles. These complete bundles would allow purchase of delivered energy with one transaction. The system should permit the bundles to be internally large and complicated, supporting trading in every flowgate right, and potential flowgate right and providing users with straightforward trading mechanisms for AC power transfer. Such trading mechanisms insure compliance with flowgate constraints, and thus the physics of AC power networks, while discouraging gaming opportunities.

LMP accomplishes this, but does so at a cost of forcing participants to trade transmission rights (known as FTRs) at a limited number of discrete times, at prices that are known only ex post. What is needed is an approach combining the flexibility of LMP with the benefits of true continuously traded forward markets.

While certain RTO's like the flowgate concept, they often do not want the responsibility for identifying a small number of commercially significant constraints. They want the market to identify the significant constraints.

O'Neill et al. in A Joint Energy and Transmission Rights Auction, propose to have periodic auctions (they suggest these auctions could be “repeated with any frequency: hourly, monthly, annually, or even the life of the transmission assets”). However it is still an auction. Participants would submit bids or offers with no idea as to what the final price was going to be, or whether their bid was going to be a winner or a loser, until the auction was over. Participants would not be able to see in advance where they could get the best deal for their energy, taking into account the transmission costs.

Recognizing this limitation, O'Neill et al. proposes to expand the auction to be a joint auction of energy and transmission. Participants who simply wanted to get the best deal for their energy could post a bid or offer for energy, and the optimization model would figure out where to get the best deal for it. This sounds like convenience, but it actually removes most of the control over the terms of the deal from the hands of participants, thereby eliminating competition on any attribute other than price (such as terms of payment, duration, consequences of non-delivery, and flexibility to modify or cancel the deal). Furthermore, since the price of the energy would not be known until after the auction, participants would not be able to plan their operations optimally over time (such as when to do maintenance, or when to use limited reservoir capacity at a hydro plant).

The energy auction side of O'Neill et al.'s proposal is identical to LMP, and suffers from the same limitations.

It would be advantageous to provide a method and apparatus for bundling transmission rights and energy for trading that provides a continuous market for trading energy and transmission rights that allows participants to obtain accurate ex ante quotes for energy and transmission rights. It would further be advantageous to provide a method and apparatus for bundling transmission rights and energy for trading that provides automated disassembly and reassembly of energy and transmission rights bundles to efficiently fulfill participant bids.

### SUMMARY OF THE INVENTION

The invention provides a method and apparatus for bundling transmission rights and energy for trading. The system provides a continuous market for trading energy and transmission rights that allows participants to obtain accurate ex ante quotes for energy and transmission rights. In addition, the invention provides automated disassembly and reassembly of energy and transmission rights bundles to efficiently fulfill participant bids.

Participants enter bids for complete energy and transmission rights bundles that they wish to buy and offers for the complete bundles that they wish to sell through a user interface. An optimization system is provided that continuously searches for ways to disassemble the bundles that participants wish to sell into their component elements (transmission rights and energy) and reassembles them into bundles that participants wish to buy. Any time that a set of bundles that participants wish to sell can be reassembled into a set of bundles that other customers wish to buy, and the aggregate bids for the new bundles exceeds the aggregate offers for the old bundles, the optimization system contracts orders for the bundles and performs the disassembly and reassembly.

The invention provides a participant with a ex ante quote for any point-to-point transmission right at any time. An optimization system calculates this quote based on the standing bids and offers for other point-to-point transmission rights currently posted in the system by other participants or market makers. A participant that finds the quote attractive places an order at any time and is assured that the order will contract at the quoted price.

Participants can therefore negotiate energy deals on any terms they wish with each other, using the transmission quotes provided by the optimization system to guide them to the best deal. The invention can also provide a joint market for energy and transmission—it provides ex ante quotes for energy at any location, as well as transmission between locations. The invention allows a true fully competitive energy market.

Other aspects and advantages of the invention will become apparent from the following detailed description in combination with the accompanying drawings, illustrating, by way of example, the principles of the invention.

### BRIEF DESCRIPTION OF THE DRAWINGS

FIG. 1A depicts an exemplary AC power network based upon contemporary AC power technology as found in the prior art;

FIG. 1B depicts a list of associated AC power functions described by their coefficients for each flowgate of a collection of flowgates for each of the busses of the various nodes of the exemplary AC power network of FIG. 1A as disclosed in the prior art;

FIG. 2A depicts various certified clients, 3100, 3120, 3140, and 3160-3180, controlling a means for using 5000 a transaction system 6000;

FIG. 2B depicts a simplified block diagram in which the mean 5000 for using means supporting transaction system 6000 includes a transaction system 3000 comprised of at least one computer communicatively coupled with the certified client(s) and controlled by program system(s) made up of program steps residing in accessibly coupled 3022 memory 3026;

FIG. 2C depicts a refinement of transaction system 3000 as a system diagram in FIG. 2B;

FIG. 2D depicts a refinement of transaction system 3000 as a system diagram in FIG. 2C;

FIG. 2E depicts a grid management system providing functions and services for grid market operations including a collection of client computers 3700, 3720, 3740, 3760 and 3780 respectively coupled through network 3200 to server system 3500 including server computer 3520, and web server computer 3560, as well as server computer 3580 and database engine 3590;

FIG. 2E depicts a collection of client computers 3700, 3720, 3740, 3760 and 3780 respectively coupled through network 3200, as depicted in FIG. 2E, with further refinements showing a program system 4000 supporting communicating with one or more members of the engine system, as well as encryption devices;

FIG. 3A depicts a virtual trading floor 1000, containing validated orders and market intervals with associated market states and further containing a certified client collection of certified clients;

FIG. 3B depicts a market interval containing a product type, location and time interval;

FIG. 3C depicts a refinement of a market interval as depicted in FIG. 3B further containing multiple time intervals;

FIG. 3D depicts a macro market interval 1500 for a fungible, ephemeral commodity from FIG. 3A;

FIG. 4 depicts a detail flowchart of operation 5000 of FIGS. 2A-2E for method of a certified client interactively using a transaction system supporting transactions involving at least one fungible, ephemeral commodity;

FIG. 5A depicts a detail flowchart of operation 5012 of FIG. 4 for the certified client initiating the action in the transaction system;

FIG. 5B depicts a detail flowchart of operation 5212 of FIG. 5A for the certified client responding to the financial commitment presented by the transaction system;

FIG. 6A depicts a validated order 1200 of the validated order collection;

FIG. 6B depicts a refinement of FIG. 6A of a validated order 1200 of the validated order collection;

FIG. 7A depicts a refinement of FIG. 3B of a market interval of an energy product type;

FIG. 7B depicts a refinement of FIG. 3B of a market interval of an AC power transfer product type;

FIG. 7C depicts a refinement of FIG. 7B of a market interval of an AC power transfer product type;

FIG. 7D depicts a refinement of FIGS. 7B and 7C of a market interval of an AC power transfer point-to-point product type;

FIG. 8 depicts a validated order 1200 comprised of at least two validated orders, each with an associated market interval;

FIG. 9A depicts a market interval of a DC power line;

FIG. 9B depicts market interval 1100 of FIG. 3B further containing a window time interval during which the market interval is active only within the window time interval;

FIG. 9C depicts market interval 1100 of FIG. 9B containing a window time interval and multiple time intervals;

FIG. 10 depicts a view of certified client user interface 7000 showing an ordering screen with hourly time interval based market intervals for a specific energy market;

FIG. 11 depicts a view of certified client user interface 7100 showing an ordering screen for daily on-peak time interval based market intervals for a specific energy market;

FIG. 12 depicts a view of certified client user interface 7200 showing an ordering screen for hourly time interval based market intervals for a specific flowgate market;

FIG. 13 depicts a view of certified client user interface 7300 showing an ordering screen for hourly time interval based market intervals with respect to a specific facility (“Hyatt Generation”) including energy transmission costs from multiple displayed markets;

FIG. 14 depicts a view of certified client user interface 7400 showing an ordering screen for hourly time interval based market intervals from a trade book perspective;

FIG. 15 depicts a view of certified client user interface 7500 showing an overview trading position for specific hours of two successive days including the trade book and a limited number of certified clients;

FIG. 16 depicts a detailed view of certified client user interface 7600 showing the trading position for specific hours of two successive days with regards to one certified client based upon FIG. 15;

FIG. 17 depicts a view of certified client user interface 7700 providing an overview of the reports on transactions and/or schedules available for presentation to the user;

FIG. 18 depicts a view of certified client user interface 7800 providing a detailed view of the monthly invoice for the certified client including fees to the transaction engine service provider, who may be a first party, (APX Fees 7802);

FIG. 19 depicts a detail flowchart of operation 5022 of FIG. 4 for managing the user resource;

FIG. 20A depicts a detail flowchart of operation 5022 of FIG. 4 for managing the user resource;

FIG. 20B depicts a detail flowchart of operation 5452 of FIG. 20A for creating the first knowledge interval;

FIG. 21A depicts a detail flowchart of operation 5022 of FIG. 4 for managing the user resource;

FIG. 21B depicts a detail flowchart of operation 5022 of FIG. 4 for managing the user resource;

FIG. 21C depicts a detail flowchart of operation 5192 of FIG. 5A for the certified client initiating the bid;

FIG. 22 depicts a detail flowchart of operation 5592 of FIG. 21A for operating the equipment usage item;

FIG. 23A depicts a detail flowchart of operation 5042 of FIG. 4 for managing the market position portfolio;

FIG. 23B depicts a detail flowchart of operation 5732 of FIG. 23A for presenting the local market position portfolio;

FIG. 24 depicts a detail flowchart of operation 5752 of FIG. 23B for presenting the market position summary;

FIG. 25A depicts a detail flowchart of operation 5000 of FIG. 4 for the method of using the transaction system;

FIG. 25B depicts a detail flowchart of operation 5832 of FIG. 25A for maintaining the market position database;

FIG. 26 depicts a detail flowchart of operation 5852 of FIG. 25B for maintaining the market position;

FIG. 27A depicts a detail flowchart of operation 5042 of FIG. 4 for maintaining the local market position portfolio;

FIG. 27B depicts a detail flowchart of operation 5000 of FIGS. 2A-2E for the method of using the transaction system;

FIG. 28A depicts a detail flowchart of operation 5000 of FIGS. 2A-2E for the method of using the transaction system;

FIG. 28B depicts a detail flowchart of operation 5872 of FIG. 26 for maintaining the current bid list;

FIG. 29 depicts a detail flowchart of operation 5032 of FIG. 4 for managing the bilateral trading portfolio;

FIG. 30A depicts a detail flowchart of operation 5032 of FIG. 4 for managing the bilateral trading portfolio;

FIG. 30B depicts a detail flowchart of operation 5062 of FIG. 4 for managing the credit resource collection, for each of the credit resources of the credit resource collection;

FIG. 31 depicts a detail flowchart of operation 8152 of FIG. 30B for managing the credit resource, for at least one of the credit resources of the credit resource collection;

FIG. 32A depicts a detail flowchart of operation 5022 of FIG. 4 for managing the user resource;

FIG. 32B depicts a detail flowchart of operation 5022 of FIG. 4 for managing the user resource;

FIG. 33A depicts a detail flowchart of operation 5022 of FIG. 4 for managing the user resource;

FIG. 33B depicts a detail flowchart of operation 5022 of FIG. 4 for managing the user resource;

FIG. 34A depicts a detail flowchart of operation 5052 of FIG. 4 for managing said market trade collection;

FIG. 34B depicts a detail flowchart of operation 8412 of FIG. 34A for presenting said market trade, for at least one of said market trades;

FIG. 35 depicts a detailed view of certified client user interface showing a multi-window trading display according to the invention;

FIG. 36 depicts a detailed view of certified client user interface showing a menu bar of a multi-window trading display according to the invention;

FIG. 37 depicts a detailed view of certified client user interface showing an informational area of a multi-window trading display according to the invention;

FIG. 38 depicts a detailed view of certified client user interface showing a window displaying bid/offer details according to the invention;

FIG. 39 depicts a detailed view of certified client user interface showing a previous trade information window according to the invention;

FIG. 40 depicts a detailed view of certified client user interface showing a window displaying orders to be reviewed or submitted according to the invention;

FIG. 41 depicts a detailed view of certified client user interface showing an order entry form according to the invention;

FIG. 42 depicts a detailed view of certified client user interface showing a task list window according to the invention;

FIG. 43 depicts a detailed view of certified client user interface showing an order modification window according to the invention;

FIG. 44 depicts a detailed view of certified client user interface showing a broker version of a market screen according to the invention;

FIG. 45 depicts a detailed view of certified client user interface showing a schedule manager screen according to the invention;

FIG. 46 depicts a detailed view of certified client user interface showing a detailed version of a schedule manager screen according to the invention;

FIG. 47 depicts a detailed view of certified client user interface showing an order summary screen according to the invention;

FIG. 48 depicts a detailed view of certified client user interface showing a delivery report for APX market and OTC transactions according to the invention;

FIG. 49 depicts a detailed view of certified client user interface showing a counterparties information screen according to the invention;

FIG. 50 depicts a detailed view of certified client user interface showing a counterparty selection screen according to the invention; and

FIG. 51 depicts a detailed view of certified client user interface showing a message display window according to the invention.

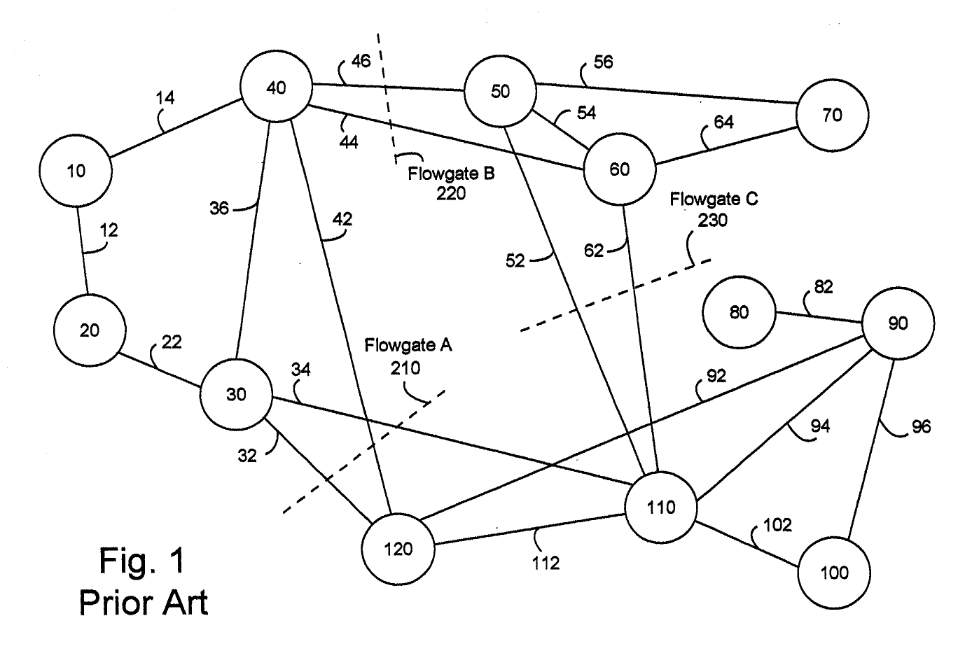

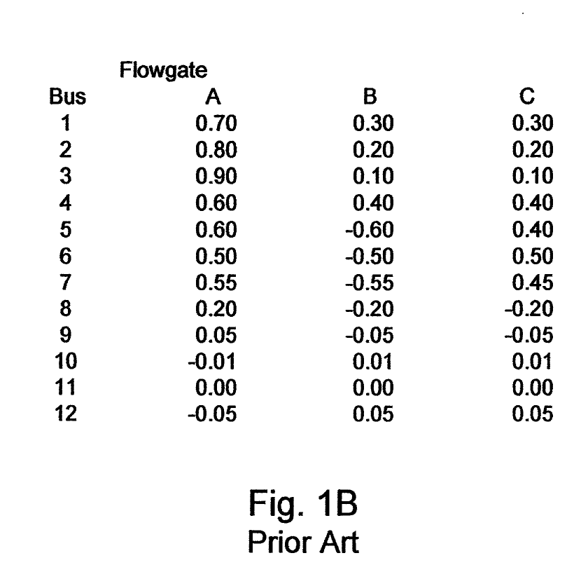

### DETAILED DESCRIPTION OF THE INVENTION

Note that a commitment may be performed without requiring a schedule. For example, a first certified client may buy a certain amount of green tickets, e.g. a form of tradable ecology-based energy credit, from a second certified client. In such situations, there might be no schedule generated for that commitment, but each certified client involved in the commitment would find the commitment referenced in the settlement.

A commitment may be scheduled for performance, but not actually be performed. For example, a network operator may curtail the availability of electrical power to consumers in certain areas to avert a blackout. Those consumers, while having scheduled commitments, did not fully enjoy the performance of the commitments. While the schedule would reflect the commitment, the settlements for those consumers would reference the actual performance of that commitment.

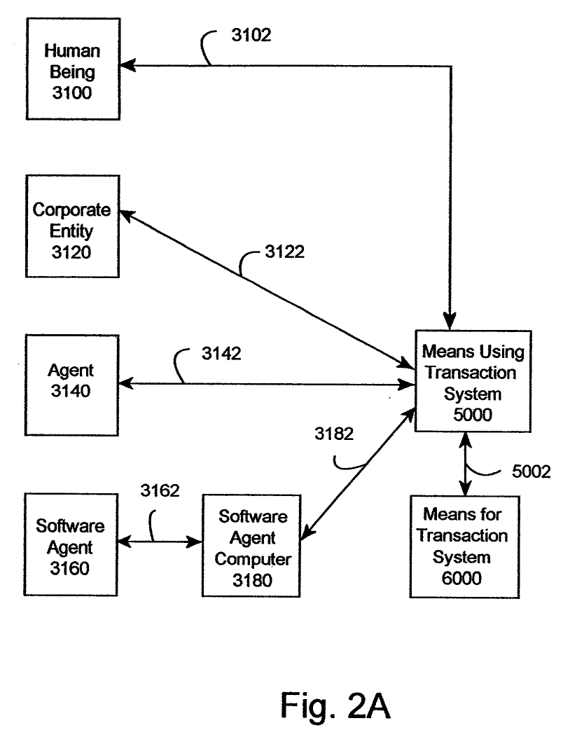

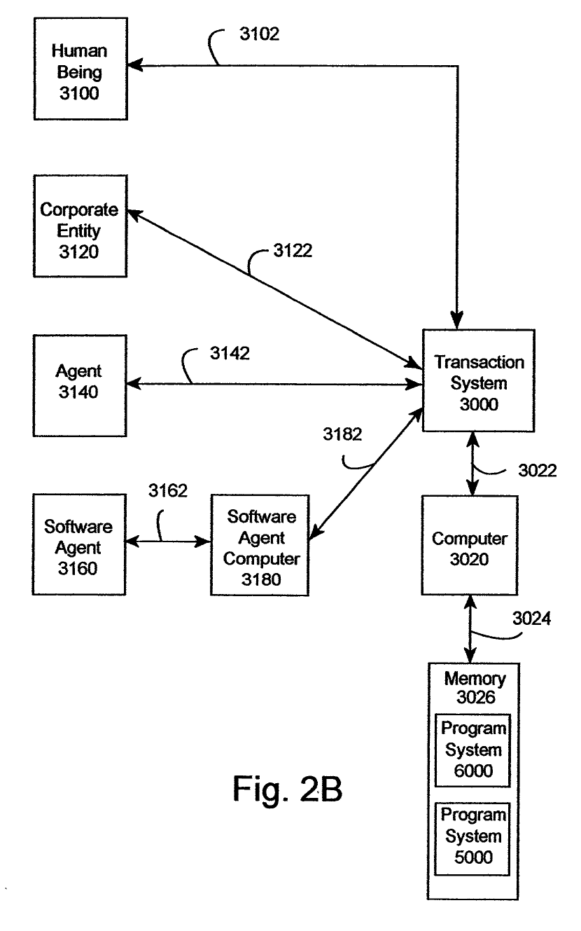

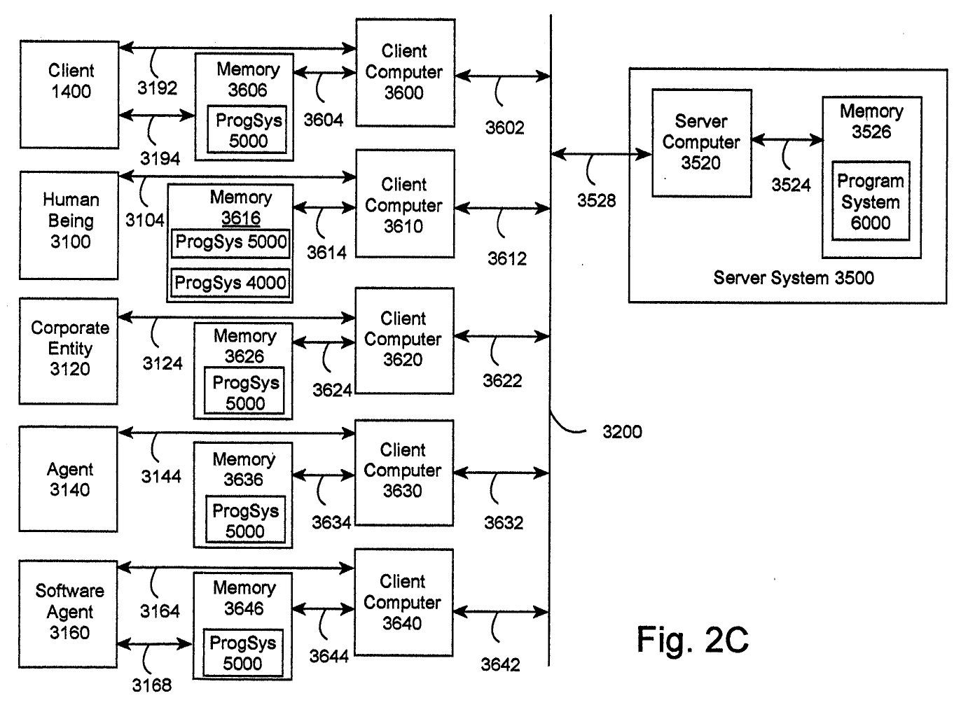

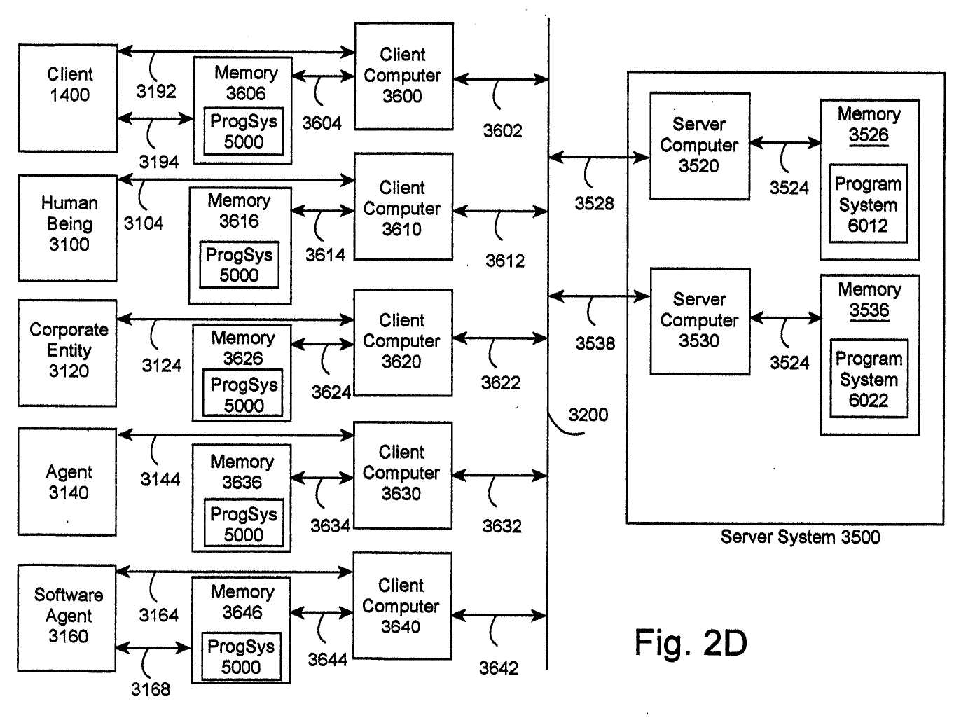

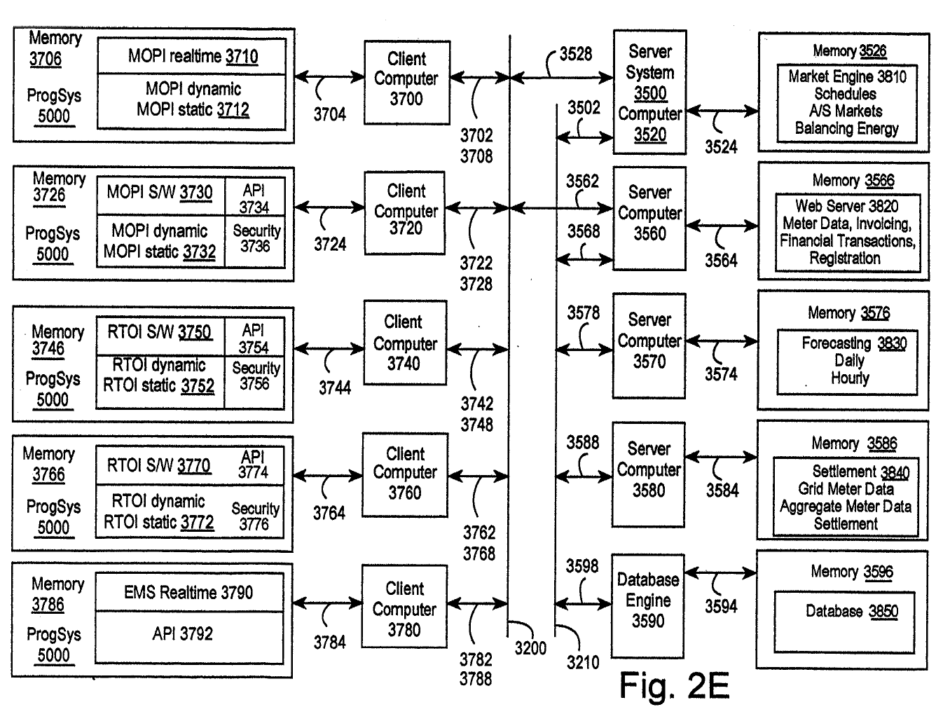

FIG. 2A depicts various certified clients, 3100, 3120, 3140, and 3160-3180, controlling a means for using 5000 a transaction system 6000.

The certified client may control 3102, 3122, 3142 and 3182 the means of use 5000 acoustically and/or tactilely and/or via wireless communications and/or via wireline communications the transaction system 6000.

Means for using 5000 and/or transaction system 6000 may include implementations of the respective operational methods, which do not rely upon instruction pointers and as such may not be considered as computers in a traditional sense.

Note that these entities, the human being 3100, corporate entity 3120, agent 3140 and software agent 3160 may communicate with means 5000 by use of messages as represented by arrows 3102, 3122, 3142, and 3182, respectively. Such messages may use a wireline physical transport layer as represented by one or more of the arrows 3102, 3122, 3142, and 3182. Such messages may use a wireless physical transport layer as represented by one or more of the arrows 3102, 3122, 3142, and 3182. Such messages may use body signals in certain further embodiments of the invention. Such messages may further use hand signals. Such message may also use acoustic signaling of messages. Such messages may also further use verbal messages in a human language.

FIG. 2B depicts a simplified block diagram in which the mean 5000 for using means supporting transaction system 6000 includes a transaction system 3000 comprised of at least one computer communicatively coupled with the certified client(s) and controlled by program system(s) made up of program steps residing in accessibly coupled 3022 memory 3026.

The operational methods 5000 and 6000 are respectively supported by program systems 5000 and 6000 containing program steps residing in memory 3026 accessibly coupled 3022 to at least one computer 3020 in the transaction system.

The transaction system may further comprise a client computer communicatively coupled to a server computer included in a server system. The certified client may operate the client computer to interactively use the transaction system.

The server system may provide a market engine supporting a virtual trading floor involving at least one of the fungible, ephemeral commodities. The server system may further comprise an engine system supporting the virtual trading floor involving the fungible, ephemeral commodities.

Transaction system 3000 is comprised of at least one computer 3020 coupled 3024 to computer readable memory 3026. The communication and interaction between transaction system 3000 and computer 3020 is denoted by arrow 3022. Such communication and interaction 3022 may employ a variety of communications technologies, including a wireless physical transport layer in certain embodiments of the invention. Alternatively, communication and interaction 3022 may employ a wireline physical transport layer.

Note that the invention may include only a market engine of the invention supporting at least any two of the following: a virtual trading floor 6032, bilateral trading 6042 and/or external market trading 6052, as well as maintain the commitment list 6062.

FIG. 2C depicts a refinement of transaction system 3000 as a system diagram in FIG. 2B. This transaction system is comprised of a client computer collection and a server system 3500 coupled to a network 3200.

The client computer collection is comprised of at least one client computer 3600 operated (used) 3192 by certified client 1400. Client computer 3610 may be operated (used) 3104 by a human being as client 3100. Client computer 3620 may be operated (used) 3124 by a corporate entity as client 3120. Client computer 3630 may be operated (used) 3144 by an authorized agent as client 3140. The certified client may be represented by an agent, authorized by the first party, to act on behalf of the first party with respect to contracting.

Server system 3500 includes at least one server computer 3520 coupled to network 3200. Network 3200 further couples 3602, 3612, 3622, 3632 and 3642 to client computers 3600, 3610, 3620, 3630 and 3640, respectively. Network 3200 at least supports communication between client computers and at least one server computer 3520 of server system 3500. As used herein, the term network refers not only to Local Area Networks (LANs), but also to Wide Area Networks (WANs). Network supported communication as used herein includes, but is not limited to, digital communication protocols as well as analog communication protocols. Network supported communication as used herein further includes, but is not limited to, message passing protocols and packet based protocols. Network supported communication as used herein further includes, but is not limited to, communication protocols including TCP/IP. Network supported communication as used herein further includes, but is not limited to, communication protocols supporting the Internet. Network supported communication as used herein further includes, but is not limited to, communication protocols supporting the World Wide Web.

Client computer 3610 with coupled 3614 computer readable memory 3616 may be operated 3104 by a client 1400 further coupled 3194 to computer readable memory 3606. Memory 3616 is shown containing program system 5000 and program system 4000. Program system 4000 implements a method of operating the client computer with respect to the transaction system, including the server and/or server system as illustrated in FIGS. 2C to 2E. Due to space constraints in FIGS. 2C to 2E, program system 4000 is only explicitly shown here. This is not means to limit the scope of the Claims, but is done strictly for the purpose of clarifying the discussion and drawings.

Client computer 3640 with coupled 3644 computer readable memory 3646 may be operated 3164 by a software agent as client 3160. The coupling 3194 may provide various personal optimizations and shortcuts, including, but not limited to, macro style functions and standard contract forms employed by the client 1400.

Server system 3500 may include at least one server computer 3520 coupled 3524 to computer readable memory 3526.

FIG. 2D depicts a refinement of transaction system 3000 as a system diagram in FIG. 2C. This transaction system is comprised of a client computer collection and a server system 3500 coupled to a network 3200.

Server system 3500 may include at least one server computer 3520 coupled 3524 to computer readable memory 3526.

Note that server computer coupled computer readable memory may contain a read-write accessible memory. Note that the read-write accessible memory may contain at least one mass storage unit. In certain a mass storage unit may include a disk drive. A mass storage unit may be accessed using a file management system. A mass storage unit may be accessed as a database.

The invention also comprises a method of operating a client computer with a client computer message address interfaced with a reliable distributed system composed of a server system containing server computers with associated messaging addresses. The method includes a login procedure, a message composition procedure for an outgoing message to the reliable distributed system, and a message analysis procedure for an incoming message from the reliable distributed system.

The login procedure may maintain a list of messaging addresses of the collection of computers of the distributed system, a first login message and a login protocol and performs the following:

a. A first server computer of the server system is selected, and a first login message is sent to the associated address of the first server computer.

b. If there is a first acknowledgment message received from the first server computer message address then the login procedure proceeds to perform the login protocol.

c. Whenever the login protocol fails with the first server computer or

whenever there is no acknowledgment message received from the first server computer within a predetermined amount of time or

whenever there remain server computers in the server system for which login has not been attempted,

a new first server computer is selected from the remaining server computers of the server system and these steps are repeated.

d. Whenever the login protocol succeeds with the first server computer, the first server computer is designated the connection computer.

The message composition procedure for an outgoing message to the distributed system may comprise performing the following: Maintaining a list of message formats. Determining the selection of a first message format. Using the first message format to create an outbound message. Sending the outbound message to the connection computer.

The message analysis procedure for an incoming message from the distributed system may comprise performing the following: Receiving the message from the connection computer. Validating the received message creates a valid received message.

An object class structure may be used to support message passing, each message comprising a message type and at least one message field. Each message-passing object comprises handling an unknown message type and handling for an unknown message field.

Handling an unknown message type for a received message from a first object by a second object may comprise the first object sending the second object a reply message indicating unknown received message type and referencing the received message.

Handling an unknown message field of the received message by the second object may comprise handling the other fields of the received message by the second object.

The invention may operate a reliable distributed system of a collection containing at least one process group running on several computers comprising receiving confirmed messages from certified clients and maintaining a group state. Each process group computer possesses a messaging address. The computers of a process group communicate among themselves with a virtually synchronous messaging system.

Receiving a confirmed message from a certified client may occur at one computer of the first collection of computers running the process group. Upon receipt the receiving computer broadcasts the confirmed message from the certified client to all computers of the first collection of computers.

Maintaining a group state on each computer of the first collection of computers of the process group may comprise the following operations: Each computer processes the confirmed message from the certified client to create a group state candidate. Each computer broadcasts a virtually synchronous group state candidate message to the other computers. Each computer receives the virtually synchronous group state candidate messages of the other computers. Each computer analyzes the received virtually synchronous group state candidate messages and its own virtually synchronous group state candidate to create a new group state.

Reliable distributed computer systems have been developed in the prior art, as in Reliable Distributed Computing With the Isis Toolkit, edited by Birman and Van Renesse, ISBN 0-8186-5342-6, © 1994 Institute for Electrical and Electronic Engineers, Inc. These reliable distributed systems are based around process groups of cooperating concurrent processes redundantly performing the same operations on copies of the same data while being distributed through a multi-computer system.

The prior art (particularly in Chapter 11, “Reliable Communication in the Presence of Failures” pages 176-200, in Reliable Distributed Computing With the Isis Toolkit) discloses basic communication protocols, ABCAST and GBCAST, for broadcasting messages within a process group and for detecting and reacting to network failures. The protocols provide strong guarantees for message delivery causality and message delivery atomicity. Message delivery causality is the guarantee that a message should not be delivered before its predecessor. Message delivery atomicity guarantees that two messages are delivered in the same sequence to all recipients.

The invention may employ a messaging system for message passing concurrent objects, instances of which reside on computers each possessing a controller belonging to a collection of computers comprising ABCAST protocol and GBCAST protocol. The ABCAST protocol is an atomic broadcast protocol used to communicate messages between object instances across the computers of the collection of computers. The GBCAST protocol is a global broadcast protocol to communicate messages between controllers of the computers of the collection of computers.

The invention may employ an object class structure executing in a process group of computers communicating with each other via a messaging protocol supporting at least virtual synchrony. Each instance of each object of the object class structure comprises an object instance clone reading on each of the process group computers.

Each object instance may further send and receive messages from other object instances and each object instance clone communicates with messages to other object instance clones of the same object instance.

However, the ABCAST and GBCAST protocols are not sufficient by themselves to implement a message driven architecture. A message driven architecture requires that objects can not only send message to each other, but also reply to those messages. The R-Object class, as used herein, refers to an object class supporting at least ABCAST, GBCAST and a message driven architecture.

Each object class may further possess a state, which is a member of a collection of states. Each instance of each object class state changes as an atomic event. All activities of each object class occur as atomic events. Atomic events may be triggered by message reception. Each instance of an object receives messages triggering state changes in the same sequence as all other instances of that object. This enforces all R-Object instances changing their state through exactly the same sequence without having to directly communicate that new state among themselves.

A concurrent computing entity may reside on each of the computers of a process group of computers where it owns access to a binary file or memory used for storing the resilient object instance state. It executes updates to the binary file as a transaction. The storage in the binary file is organized into table objects. Each table object consists of a set of records.

In certain embodiments of the invention, all individuals wishing to access the RTO systems must establish a login session with the appropriate system. This applies to RTO participants, RTO staff, as well as other systems that are integrated into the platform. Each login session is established under the protocols of the security integrated into the RTO systems. The location of the session may not be important to the system, allowing the RTO to operate multiple sites. The multiple RTO sites may each operate as a monitor site, a failover site, or to share workload. Login session at multiple sites can be connected to server system 3500 simultaneously, and are synchronized by server system 3500.

Each RTO participant may share the same security information for authorized scheduling entities (ASEs), RTO operators, and transmission operators (TOs). This security information may be maintained through the registration interface, through which all permissions for each participant may be maintained. This information may be used to validate all login sessions.

Access to the server system 3500 and/or server computer 3560 may be obtained by establishing a login session with the appropriate system. This may apply to RTO participants, including ASEs, RTO operators, and TOs, as well as other computer systems, such as EMS/SCADA systems. This ensures that only authorized individuals and systems can access the APX systems.

The security information may be checked each time that an RTO participant or computer system attempts to log into server system 3500 or server computer 3520 or web server 3560. Login information may include a login ID and password. Login information may be passed in an encrypted form. If access is permitted, the login session may then be configured in accordance with the permissions associated with the particular login ID.

This ensures that each RTO participant may access only those systems and data to which the participant is authorized.

Access to each system may also be controlled in terms of modes including at least receiving data, placing bids, and viewing positions. This mechanism restricts each login session to its authorized systems, making available only its authorized information, and does so in only its authorized modes.

Each login session may include a real-time, two-way communication session or a secure web-based connection between the RTO participant software and the servers. Each session may rely on one or more encryption mechanisms to encode the communication. For the real-time connections, this mechanism may include frequent encryption key change, which may further be invisible to the user to ensure privacy of communication between each RTO participant and the systems 3500 and 3560.

The invention may include help desk staff. The help desk staff may not have access to market data, scheduling data, or any participant business data. Further, the help desk staff may be unable observe A/S auction or EIS market activity. The help desk staff may not know who or what was selected or dispatched, or at what price. The help desk staff may in certain embodiments only monitor system conditions, such as the number of sessions logged on, the level of activity in the market (for performance monitoring), and when bidding is opened or closed. The help desk staff may maintain reliable data archives and backups on all servers. The help desk staff may perform these maintenance and archival tasks without regard to content.

In certain embodiments, certified users are primarily approved scheduling entities (ASEs), the control area operators (CAOs), and the RTO operators (regardless of location). These certified users may participate in the RTO at the operational level, using services of the server system 3500 or web server 3560.

The invention may include a method of operating a client computer communicatively coupled to an engine system. The engine system includes at least one of the following: a market engine, a scheduling engine and a settlement engine. The client computer communicating with the engine system supports certified client transactions regarding market intervals. Each market interval contains at least one fungible, ephemeral commodity, a location and a time interval.

An engine group includes at least two engine group computers, each implementing a market engine, a scheduling engine or a settlement engine. Note that two engine group computers may redundantly implement a market engine. Alternatively, two engine group computers may redundantly implement a scheduling engine. Additionally, two engine group computers may redundantly implement a settlement engine. An engine group may include two engine group computers implementing different engines. The engine group provides multiple access mechanisms by which communications between the client computer and the engine system may take place.

Note that the engine system may include one or more engine groups. Note that the engine system may be implemented as an engine group.

The client computer may interact with at least one member of the engine group by establishing the client computer as the certified client through communication with the engine system and participating as the certified client communicating with the engine system.

The engine group advantageously removes the potential for a single point of failure in the communication between the client and the engines implemented by the engine group, increasing the overall communication system reliability.

FIG. 2E depicts a grid management system providing functions and services for grid market operations including a collection of client computers 3700, 3720, 3740, 3760 and 3780 respectively coupled through network 3200 to server system 3500 including server computer 3520, and web server computer 3560, as well as server computer 3580 and database engine 3590.

The discussion of variations regarding the use of client computers is found in FIGS. 2C and 2D. A certified client, possibly a human being, corporate entity, agent, or software agent may each control any of the examples of client computers 3700, 3720, 3740, 3760 and 3780.

As used herein, MOPI refers to Market Operations Participant Interface. MOPI is an interface may that include, but is not limited to, the functions and capabilities of Participants, who are certified clients of the system.

As used herein, RTOI refers to RTO Operator Interface. RTOI is an interface that may include, but is not limited to, the functions and capabilities of Participants, who are certified clients of the system and who interact as RTO Operators within one or more grids.

As used herein, EMS refers to Energy Management System.

EMS and RTOI components may each further perform operations including, but not limited to,

Receiving energy management schedules,

Confirming receipt of energy management schedules,

Receiving requests for energy equipment status,

Providing energy equipment status,

Sending requests for energy equipment status,

Receiving energy equipment status reports,

Receiving metering data about transmission lines,

Receiving frequency data about transmission lines, and

Command override messages putting a specific remote energy site off-limits to automated control and places it under manual control of the operator.

Sending output adjustment commands to remote energy generation sites.

Note that these output adjustment commands have the effect of modifying the transmission line frequencies and the output adjustment commands take into account the effect on transmission line frequencies as well as flowgate constraints in making these commands.

There may be client computers with accessible memory containing MOPI components such as client computers 3700 and 3720 or containing RTOI components such as client computers 3740 and 3760 or containing EMS components such as client computer 3780. There may be no client computers with accessible memory containing MOPI components such as client computers 3700 and 3720. There may be no client computers with accessible memory containing RTOI components such as client computers 3740 and 3760. There may be no client computers with accessible memory containing EMS components such as client computer 3780.

Client computer 3700 accessibly couples 3704 to computer readable memory 3706 as well as communicatively couples 3702 to network 3200. The MOPI realtime component 3710 and MOPI dynamic and static component 3712 may both reside in accessibly coupled memory 3706.

The MOPI realtime component 3710 may include a method of using market engine 3810 with MOPI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The MOPI realtime component 3710 may include the ability to use communication with more than one server computer 3520 within server system 3500 to communicate within a session with the market engine 3810.

The MOPI realtime component 3710 may include the ability to encrypt the communication with server system 3500. Alternatively, the client computer 3700 may include security devices insuring security independently of the method of using the market engine. Additionally both the MOPI realtime component 3710 and the client computer 3700 may act together to provide two layers of security.

Client computer 3720 accessibly couples 3724 to computer readable memory 3726 as well as communicatively couples 3722 to network 3200. The MOPI software component 3730 and MOPI dynamic and static component 3732 may both reside in accessibly coupled memory 3726.

The MOPI realtime component 3730 may include a method of using market engine 3810 with MOPI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The MOPI realtime component 3730 may include the ability to use communication with more than one server computer 3520 within server system 3500 to communicate within a session with the market engine 3810. MOPI realtime component 3730 may further include API 3734, which controls the ability to use communication with more than one server computer 3520 within server system 3500 to communicate within a session with the market engine 3810.

The MOPI realtime component 3730 may include the ability to encrypt the communication with server system 3500. Alternatively, the client computer 3720 may include security devices insuring security independently of the method of using the market engine. Additionally both the MOPI realtime component 3730 and the client computer 3720 may act together to provide two layers of security. MOPI realtime component 3730 may include security module 3736 providing the ability to encrypt the communication with server system 3500.

Client computer 3740 accessibly couples 3744 to computer readable memory 3746 as well as communicatively couples 3742 to network 3200. The RTOI software component 3750 and RTOI dynamic and static component 3752 may both reside in accessibly coupled memory 3746.

The RTOI realtime component 3750 may include a method of using market engine 3810 with RTOI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The RTOI realtime component 3750 may include the ability to use communication with more than one server computer 3520 within server system 3500 to communicate within a session with the market engine 3810. RTOI realtime component 3750 may further include API 3754, which controls the ability to use communication with more than one server computer 3520 within server system 3500 to communicate within a session with the market engine 3810.

The RTOI realtime component 3750 may include the ability to encrypt the communication with server system 3500. Alternatively, the client computer 3740 may include security devices insuring security independently of the method of using the market engine. Additionally both the RTOI realtime component 3750 and the client computer 3740 may act together to provide two layers of security. RTOI realtime component 3750 may include security module 3756 providing the ability to encrypt the communication with server system 3500.

Client computer 3760 accessibly couples 3764 to computer readable memory 3766 as well as communicatively couples 3762 to network 3200. The RTOI software component 3770 and RTOI dynamic and static component 3772 may both reside in accessibly coupled memory 3766.

The RTOI realtime component 3770 may include a method of using market engine 3810 with RTOI dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The RTOI realtime component 3770 may include the ability to use communication with more than one server computer 3520 within server system 3500 to communicate within a session with the market engine 3810. RTOI realtime component 3770 may further include API 3774, which controls the ability to use communication with more than one server computer 3520 within server system 3500 to communicate within a session with the market engine 3810.

The RTOI realtime component 3770 may include the ability to encrypt the communication with server system 3500. Alternatively, the client computer 3760 may include security devices insuring security independently of the method of using the market engine. Additionally both the RTOI realtime component 3770 and the client computer 3760 may act together to provide two layers of security. RTOI realtime component 3770 may include security module 3776 providing the ability to encrypt the communication with server system 3500.

Client computer 3780 accessibly couples 3784 to computer readable memory 3786 as well as communicatively couples 3782 to network 3200. The EMS realtime component 3790 may both reside in accessibly coupled memory 3706.

The EMS realtime component 3790 may include a method of using market engine 3810 with EMS dynamic and static component 3712. The method of using market engine 3810 may include, but is not limited to, participating in sessions with market engine 3810 in which at least one of the following may occur. An order may be sent, which may include one or more ask orders and/or one or more bid orders. A market price may be requested. A market price may be received. A validated commitment may be received. Notification of the opening or closing of a market interval may be received.

The EMS realtime component 3790 may include the ability to use communication with more than one server computer 3520 within server system 3500 to communicate within a session with the market engine 3810. EMS realtime component 3790 may further include API 3794, which controls the ability to use communication with more than one server computer 3520 within server system 3500 to communicate within a session with the market engine 3810.

The EMS realtime component 3790 may include the ability to encrypt the communication with server system 3500. Alternatively, the client computer 3780 may include security devices insuring security independently of the method of using the market engine. Additionally both the EMS realtime component 3790 and the client computer 3780 may act together to provide two layers of security. EMS realtime component 3790 may include security module 3796 providing the ability to encrypt the communication with server system 3500.

Because many components are integrated into the architecture, they are available to all operational functions. The RTOI software component 3750 and RTOI dynamic and static component 3752, for example, may share the common communications and communicate directly with the RTO participants and RTO staff simultaneously. This permits the creation of integrated user interfaces that contain all of the functions of the services delivered via these systems in a single point of contact. The users are not forced to deal with integration issues and disparate mechanisms to communicate with the RTO.

In certain embodiments of the invention, all individuals wishing to access the RTO systems must establish a login session with the appropriate system. This applies to RTO participants, RTO staff, as well as other systems that are integrated to the platform. Each login session is established under the protocols of the security integrated into the RTO systems. The location of the session may not be important to the system, allowing the RTO to operate multiple sites. The multiple RTO sites may each operate as a monitor site, a failover site, or to share workload. Login session at multiple sites can be connected to server system 3500 simultaneously, and are synchronized by server system 3500.

Each RTO participant may share the same security information for authorized scheduling entities (ASEs), RTO operators, and transmission operators (TOs). This security information may be maintained through the registration interface, through which all permissions for each participant may be maintained. This information may be used to validate all login sessions.

Access to the server system 3500 and/or server computer 3560 may be obtained by establishing a login session with the appropriate system. This may apply to RTO participants, including ASEs, RTO operators, and TOs, as well as other computer systems, such as EMS/SCADA systems. This ensures that only authorized individuals and systems can access the APX systems.

The security information may be checked each time that an RTO participant or computer system attempts to log into server system 3500 or server computer 3520 or web server 3560. Login information may include a login ID and password. Login information may be passed in an encrypted form. If access is permitted, the login session may then be configured in accordance with the permissions associated with the particular login ID.

This ensures that each RTO participant may access only those systems and data to which the participant is authorized.

Access to each system may also be controlled in terms of modes including at least receiving data, placing bids, and viewing positions. This mechanism restricts each login session to its authorized systems, makes available only its authorized information, and does so in only its authorized modes.

Each login session may include a real-time, two-way communication session or a secure web-based connection between the RTO participant software and the servers. Each session may rely on one or more encryption mechanisms to encode the communication. For the real-time connections, this mechanism may include frequent encryption key change, which may further be invisible to the user to ensure privacy of communication between each RTO participant and the systems 3500 and 3560.

Certain embodiments may include help desk staff. The help desk staff may not have access to market data, scheduling data, or any participant business data. Further, the help desk staff may be unable observe A/S auction or EIS market activity. The help desk staff may not know who or what was selected or dispatched, or at what price. The help desk staff may in certain embodiments only monitor system conditions, such as the number of sessions logged on, the level of activity in the market (for performance monitoring), and when bidding is opened or closed. The help desk staff may maintain reliable data archives and backups on all servers. The help desk staff may perform these maintenance and archival tasks without regard to content.

In certain embodiments, certified users are primarily approved scheduling entities (ASEs), the control area operators (CAOs), and the RTO operators (regardless of location). These certified users may participate in the RTO at the operational level, using services of the server system 3500 or web server 3560.

The invention also comprises a method of operating a client computer communicatively coupled to an engine system. The engine system includes at least one of the following: a market engine, a scheduling engine and a settlement engine. The client computer communicating with the engine system supports certified client transactions regarding market intervals. Each market interval contains at least one fungible, ephemeral commodity, a location and a time interval.

An engine group includes at least two engine group computers, each implementing a market engine, a scheduling engine or a settlement engine. Note that two engine group computers may redundantly implement a market engine. Alternatively, two engine group computers may redundantly implement a scheduling engine. Additionally, two engine group computers may redundantly implement a settlement engine. An engine group may include two engine group computers implementing different engines. The engine group provides multiple access mechanisms by which communications between the client computer and the engine system may take place.

Note that the engine system may include one or more engine groups. Note that the engine system may be implemented as an engine group.

The client computer may interact with at least one member of the engine group by establishing the client computer as the certified client through communication with the engine system and participating as the certified client communicating with the engine system.

The engine group advantageously removes the potential for a single point of failure in the communication between the client and the engines implemented by the engine group, increasing the overall communication system reliability.

FIG. 2E depicts a collection of client computers 3700, 3720, 3740, 3760 and 3780 respectively coupled through network 3200, as depicted in FIG. 2E, with further refinements showing a program system 4000 supporting communicating with one or more members of the engine system, as well as encryption devices.

Program system 4000 contains program steps residing in the accessibly coupled memory of the client computers, implementing the method of operating the client computers in their communicative interactions with one or more of the engines or the engine group shown in FIG. 2E. Note that any client computer may accessibly coupled to more than one kind of memory. The discussion herein refers to accessibly coupled memory as including any memory, which can even once be accessibly coupled to the client computer.

The MOPI realtime component 3710 may include the program system 4000, or be included within the program system 4000 as the implementation of the method of operating the client computer to communicatively interact with one or more of the engines or the engine group shown in FIG. 2E.

Client computer 3700 may interact with at least one member of the engine group by establishing the client computer as the certified client through communication with the engine system and participating as the certified client communicating with the engine system.

The MOPI realtime component 3730 may include the program system 4000, or be included within the program system 4000 as the implementation of the method of operating the client computer to communicatively interact with one or more of the engines or the engine group shown in FIG. 2E.

API component 3734 may include the program system 4000, or be included within the program system 4000 as the implementation of the method of operating the client computer to communicatively interact with one or more of the engines or the engine group shown in FIG. 2E.

Security module 3736 may be included in program system 4000. Alternatively, security module 3736 may be used through a software interface by program system 4000. Security module 3736 may include a third party vendor supplied software component. Security module 3736 may include an implementation of the Secure Socket Layer protocol.

Client computer 3720 may include security device 3800 insuring security independently of the method of using the market engine or the software controlling client computer 3720. Additionally both the MOPI realtime component 3730 and the client computer 3720 may act together to provide two layers of security. MOPI realtime component 3730 may include security module 3736 providing the ability to encrypt the communication with server system 3500.

Client computer 3720 may be coupled 3802 to encryption device 3800. Client computer 3720 may control the operation of encryption device 3800.

The RTOI software component 3750 may include the program system 4000, or be included within the program system 4000 as the implementation of the method of operating the client computer to communicatively interact with one or more of the engines or the engine group shown in FIG. 2E.

API component 3754 may include the program system 4000, or be included within the program system 4000 as the implementation of the method of operating the client computer to communicatively interact with one or more of the engines or the engine group shown in FIG. 2E.

Security module 3756 may be included in program system 4000. Alternatively, security module 3756 may be used through a software interface by program system 4000. Security module 3756 may include a third party vendor supplied software component. Security module 3756 may include an implementation of the Secure Socket Layer protocol.

Encryption receiver 3810 may receive 3812 messages from one or more of the engine group from network 3200. The results of processing the received message may be conveyed 3814 to client computer 3740.

Encryption transmitter 3820 may receive 3822 messages from client computer 3740 to be encrypted. The encrypted messages may then be sent 3824 from encryption transmitter 3820 to network 3200.

In certain embodiments of the invention, a single security device may incorporate encryption receiver 3810 and encryption transmitter 3740.

Encryption receiver 3810 may receive 3812 messages from and encryption transmitter 3820 may transmit 3824 messages to the same engine of the engine system. Encryption receiver 3810 may receive 3812 messages from and encryption transmitter 3820 may transmit 3824 messages to different engines of the engine system.

The RTOI realtime component 3770 may include the program system 4000, or be included within the program system 4000 as the implementation of the method of operating the client computer to communicatively interact with one or more of the engines or the engine group shown in FIG. 2E.

API component 3774 may include the program system 4000, or be included within the program system 4000 as the implementation of the method of operating the client computer to communicatively interact with one or more of the engines or the engine group shown in FIG. 2E.

Security module 3776 may be included in program system 4000. Alternatively, security module 3776 may be used through a software interface by program system 4000. Security module 3776 may include a third party vendor supplied software component. Security module 3776 may include an implementation of the Secure Socket Layer protocol.

The EMS realtime component 3790 may include the program system 4000, or be included within the program system 4000 as the implementation of the method of operating the client computer to communicatively interact with one or more of the engines or the engine group shown in FIG. 2E.

API component 3792 may include the program system 4000, or be included within the program system 4000 as the implementation of the method of operating the client computer to communicatively interact with one or more of the engines or the engine group shown in FIG. 2E.

Client computer 3700 may include encryption device 3830 insuring security independently of the method of using the market engine. Both the EMS realtime component 3790 and client computer 3700 may act together to provide two layers of security. EMS realtime component 3790 may include security module 3796 providing the ability to encrypt the communication with server system 3500.

Communication 3832 between client computer 3780 and encryption device 3830 may utilize memory access mechanism 3784. The memory access mechanism 3784 may be across a general-purpose bus. Communication 3832 may act as an input-output port scheme on the general-purpose bus.

Communication 3832 may also be implemented by use of a memory-mapping scheme whereby encryption device 3830 is accessed 3784 by special addresses 3832 in the memory domain.

Note that a client computer system may employ more than one security device. Further, a client computer system may employ different security measures in communication with different engines of the engine system.

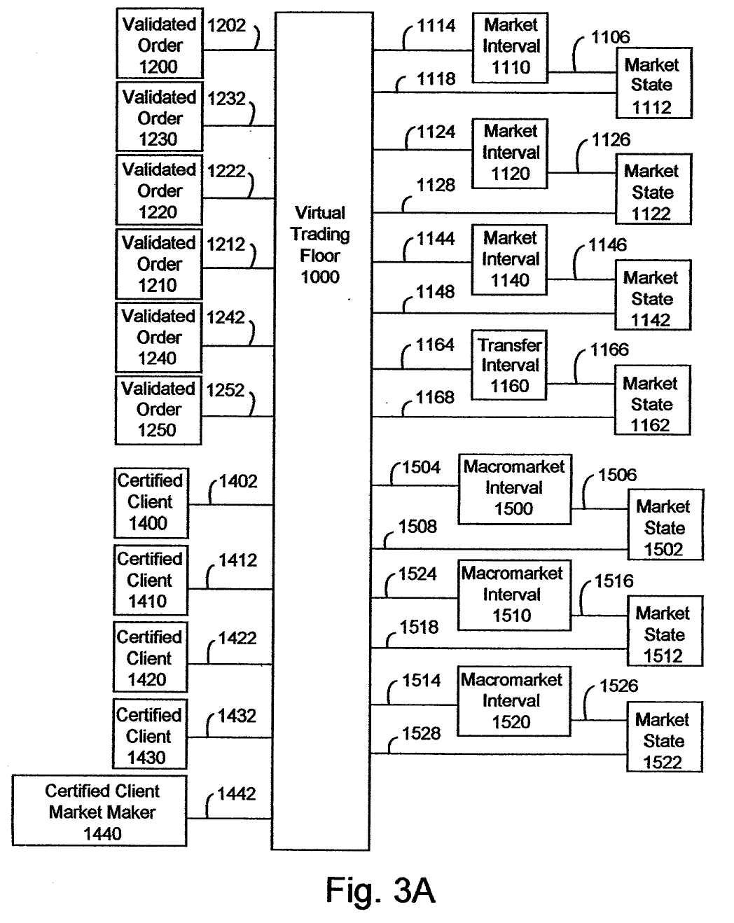

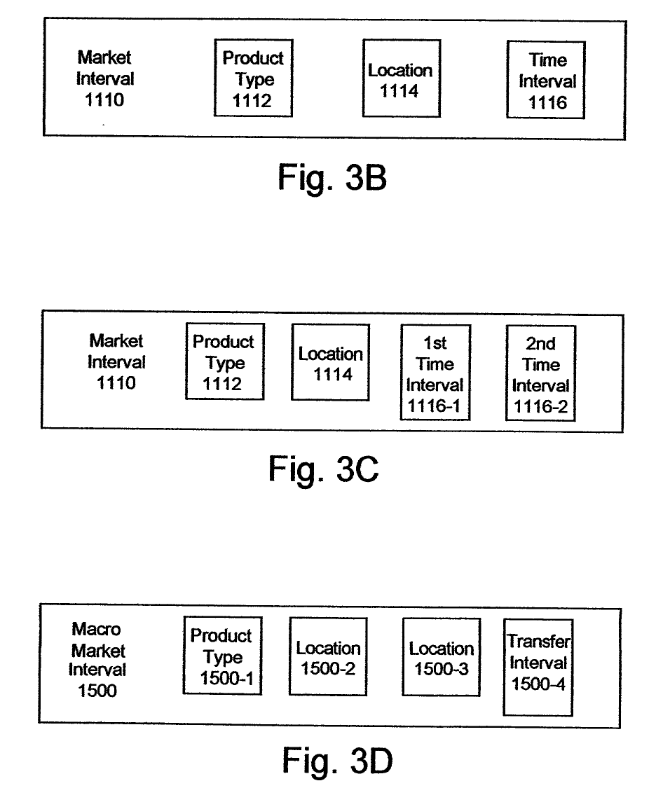

FIG. 3A depicts a virtual trading floor 1000, containing validated orders and market intervals with associated market states and further containing a certified client collection of certified clients.

The virtual trading floor mechanism 1000 comprises a collection of market intervals, each with an associated market state, and validated orders. A market contains a product type and a location. Trading in the market is done in terms of market intervals 1100, 1120, and 1140 as well as specialized market intervals including transfer intervals 1160 and macro market intervals 1200, 1210 and 1220.

Each market interval of a market contains the market product type, market location, plus a calendar scheme with an interval end. The market state of a market interval comprises a market price for the market interval product type at the market interval location during the market interval time interval.

Note that some market intervals such as market interval 1160 are further denoted as transfer intervals, further shown in FIG. 3D. A transfer interval 1160 includes a location further distinguished as having a start location 1163 and a delivery location 1164. For many fungible non-ephemeral commodities, not only is a product type 1161 specified, but also a transfer type 1162 is specified. By way of example, a container of wheat may be transported by truck, train, barge or ship. As with other market intervals, there is a time interval 1165 involved, which designated the expected time of transport.

Macro market intervals 1200, 1210, and 1220 are also shown. These are specialized market intervals which reflect at least one origin market interval and at least one destination market interval. FIG. 3E provides a more detailed discussion of macro markets for fungible non-ephemeral commodities. FIG. 3F provides a more detailed discussion of macro markets for fungible ephemeral commodities.

A validated order may contain an amount of the market interval product type, a price for the market interval product type. The validated order is either a bid validated order or an ask validated order.

FIG. 3A also depicts a certified client collection comprised of certified clients. Certified clients may include, but are not limited to, human beings. Certified clients may further include, but are not limited to, corporate entities. Certified clients may also further include agents authorized by the certified clients to represent them in interactions regarding the virtual trading floor. Certified clients may also further include software agents executing on software agent computers authorized by certified clients to represent them in interactions regarding the virtual trading floor. Note that in certain embodiments of the invention, the market engine manages and/or maintains the certified client collection.

A virtual trading floor may support trading ephemeral, fungible commodities of an electrical power grid containing at least one AC power network. Each AC power network further contains a node collection of at least two nodes. The product type of the market intervals of the market interval collection may be a member of a product type collection comprised of energy and AC power transfer. The location of a market interval having an energy product type may be a first node of the node collection of an AC power network contained in the electrical power grid. The location of a market interval having an AC power transfer product type may be from a first node of a first AC power network contained in the electrical power grid to a second node of the first AC power network.

Some certified clients may be market makers 1440. Market makers are market participants who have taken on the additional role of attempting to arbitrage in transmission.

For fungible ephemeral commodities, market makers 1440 use the transaction system to access point-to-point transmission orders and individual flowgate orders. Market makers 1440 may also have their own inventories of point-to-point transmission rights and flowgate rights, which they may or may not choose to post in the market.

Market makers 1440 may also be described as market providers in certain economic systems, where the term “market maker” has a pre-established and divergent meaning.

Market makers may be allowed to go into a negative position in individual flowgate rights, or even point-to-point rights, assuming they have sufficient credit with the RTO. If the market maker is still in a negative position at the scheduling deadline, he/she will be billed for the missing transmission rights, just as if they had submitted an uncovered schedule. To the participant who bought the transmission right from a market maker with a negative position, the transmission right is the same as any other. This rule provides a “cushion” that insures liquidity in the market. It means that market makers always have a way to quote a price for any transmission the participants may desire to buy or sell. The rule is harmless, in such embodiments, all of these transmission rights affect only the financial settlement.

Allowing market makers to go into negative positions in transmission rights also removes any incentive to hoard transmission rights. Without this rule, hoarding could be attractive in a system with hundreds of flowgates, since one participant could buy up all the rights to some flowgate that is not perceived as scarce for very little money. Without a liquid market in even one flowgate, it might be impossible for market makers to create quotes for many point-to-point rights.

There may be rules prohibiting a single participant from owning more than a certain fraction of a single flowgate. But such rules require policing and can get in the way of some participants with legitimate needs, and might not be effective if several participants act in concert (with or without explicit collusion).

The RTO's role may begin with the initial auctions. The RTO auctions both flowgate rights and point-to-point rights, based on an algorithm that maximizes the value received. This algorithm is similar to the algorithm currently used by PJM to auction FTRs.

Thus, once a new transmission provider is acknowledged by the RTO, it would enter the revenue process at the RTO auction by becoming part of the trading followed by scheduling followed by settlement processes.

Under normal conditions, the RTO stands behind all point-to-point rights and flowgate rights that it auctions. Any participant can obtain reasonable price certainty by buying a point-to-point right. In the event that one of the flowgates has to be de-rated, the RTO may buy back the flowgate rights or optionally redispatch around the problem.

Such bundled point-to-point rights possess at least the following advantages.

Forward price discovery of congestion costs allows planning of unit maintenance, unit commitment, and hydroelectric resources.

Bundled point-to-point rights advantageously minimize market involvement of RTO in the market, including involvement in the selection of commercially significant flowgates.

Easily traded market instruments for hedging congestion costs, providing virtually complete hedging of risk for participants.

Flowgates provide a mechanism for resolving seams issues between control areas.

Bundled point-to-point rights with a flowgate foundation assure least cost redispatch within system constraints.

Bundled point-to-point rights with a flowgate foundation give a complete set of congestion costs between all locations at delivery time.

Bundled point-to-point rights with a flowgate foundation support participants producing and consuming energy with minimal advance scheduling.

Bundled point-to-point rights with a flowgate foundation provide the ability to handle large numbers of constraints.

FIG. 3B depicts a market interval containing a product type, location and time interval. The product types may include ephemeral, fungible commodities. All product types may be ephemeral, fungible commodities.

Location may refer to a single node. A node may be specified geographically. A node may be specified in terms of nodes in a network. The network may contain both a collection of nodes and a collection of lines, each line extends from a first node to a second node. Note that the term line as used herein does not exclusively imply a straight line. A node may be specified in terms of a node of a network contained in a grid of one or more networks, further containing special lines connecting nodes of potentially distinct networks.

Location may additionally refer to a transition or transfer from a first node to a second node.

A market interval has a uniform price for its product type within the time interval. A market interval may also have uniform buy and sell positions, to support uniform movement of the product within the market interval. A single market interval may be seen to act as an independent commodity market of the fungible, ephemeral commodity for its product type.

FIG. 3C depicts a refinement of a market interval as depicted in FIG. 3B further containing multiple time intervals.

In FIG. 3C, two time intervals are depicted by way of example. More than two time intervals may be contained in one market interval. Each of the multiple time intervals may not temporally overlap the other contained time intervals of the market interval.

Note that both market positions and market prices may have similar formats. Both market positions and market prices may include representations as a quantity, which is a scalar value, and a point or set of points over a calendar line known herein as a time interval. Arithmetic functions and operations including, but not limited to, addition, subtraction, negation, multiplication, minimums and maximums are readily extended to apply to these scalar values over calendar time.

As stated elsewhere in this document, the minimal condition placed upon the time intervals of a market interval is that they not overlap. It is often advantageous to place further constraints on market intervals in terms of the orders submitted to a virtual trading floor.

These constraints can be thought of as follows: if order market intervals were the footprints on the calendar line, a strip may be considered the shoe that left those footprints. While there may be an indefinitely large number of orders covering the calendar line, there are usually only a small finite number of shoes, i.e. strips involved with those orders. An order's market interval may be further constrained to only begin at discrete points on the calendar line.

By way of example, consider the following strips:

An hourly strip is a market interval that allows orders to be submitted for market intervals that start on the hour and last for an hour.

A daily strip is a market interval that allows orders to be submitted for market intervals that start on the local time day boundary and end on local time boundaries. As used here, local time means the local time with respect to the location of the market segment. Note that because the strip is specified in terms of the local time, the actual length may vary depending on the current calendar day at that location. For example, during daylight to standard time transition in the United States, the daily strip spans 25 hours instead of the standard 24 hours.

A daily off-peak strip allows orders for market intervals that start at the local time day boundary and continue until 6:00 AM local time and then start again at 10:00 PM and continue until the ending day boundary.

Other examples may include, but are not limited to, five-minute strips, monthly strips and yearly strips. The set of strips a market may support must ensure that orders are submitted for non-partially overlapping intervals. These constraints require that strips either be sub-periods of another strip or compliment the strip. An example of two strips, which cannot co-exist in the same market, are the weekly strip and the monthly strip. This is because not all weeks are sub-periods of any one month.

A lot is the quantity in multiples of which an order must be contracted.

A basic function of a market segment is to match buy and sell orders at a single price. Certain embodiments of the invention will satisfy differing rules established for different markets belonging to different regulatory regions regarding that matching process. By way of example, in a bid-ask market, an incoming buy/sell order is immediately matched with the best buy/sell order standing in the market with the trade price as the limit price of the standing order.

In a call-auction market, buy and sell orders are collected together in a batch and matched sometime after they have been submitted. All orders in the batch are traded at the same price, which is calculated based upon the limit prices of all orders in the batch.

FIG. 3D depicts a macro market interval 1500 for a fungible, ephemeral commodity from FIG. 3A.

The invention also comprises a method of a certified client interactively using a transaction system supporting transactions involving at least one fungible, ephemeral commodity.

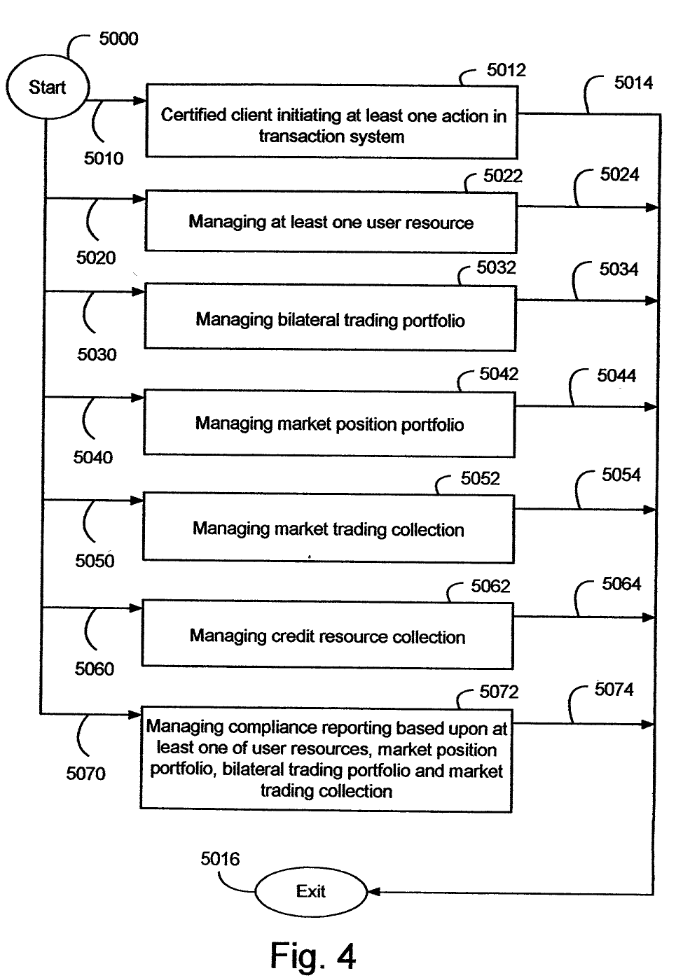

FIG. 4 depicts a detail flowchart of operation 5000 of FIGS. 2A-2E for method of a certified client interactively using a transaction system supporting transactions involving at least one fungible, ephemeral commodity.

Arrow 5010 directs the flow of execution from starting operation 5000 to operation 5012. Operation 5012 performs the certified client initiating at least one action in the transaction system. Arrow 5014 directs execution from operation 5012 to operation 5016. Operation 5016 terminates the operations of this flowchart.

The method is further comprised of at least two of the following operations belonging to the basic usage collection.

Arrow 5020 directs the flow of execution from starting operation 5000 to operation 5022. Operation 5022 performs managing at least one user resource. Arrow 5024 directs execution from operation 5022 to operation 5016. Operation 5016 terminates the operations of this flowchart.

Arrow 5030 directs the flow of execution from starting operation 5000 to operation 5032. Operation 5032 performs managing a bilateral trading portfolio comprising at least one bilateral trade in at least one of the fungible, ephemeral commodities. Arrow 5034 directs execution from operation 5032 to operation 5016. Operation 5016 terminates the operations of this flowchart.

Arrow 5040 directs the flow of execution from starting operation 5000 to operation 5042. Operation 5042 performs managing a market position portfolio comprising at least one market position of at least one of the fungible, ephemeral commodities. Arrow 5044 directs execution from operation 5042 to operation 5016. Operation 5016 terminates the operations of this flowchart.

Arrow 5050 directs the flow of execution from starting operation 5000 to operation 5052. Operation 5052 performs managing a market trading collection comprising at least one market trade in at least one of the fungible, ephemeral commodities. Arrow 5054 directs execution from operation 5052 to operation 5016. Operation 5016 terminates the operations of this flowchart.

Arrow 5060 directs the flow of execution from starting operation 5000 to operation 5062. Operation 5062 performs managing a credit resource collection comprising at least one credit resource. Arrow 5064 directs execution from operation 5062 to operation 5016. Operation 5016 terminates the operations of this flowchart.

Arrow 5070 directs the flow of execution from starting operation 5000 to operation 5072. Operation 5072 performs managing compliance reporting based upon at least one of the collection comprising the user resources, the market position portfolio, the bilateral trading portfolio and the market trading collection. Arrow 5074 directs execution from operation 5072 to operation 5016. Operation 5016 terminates the operations of this flowchart.

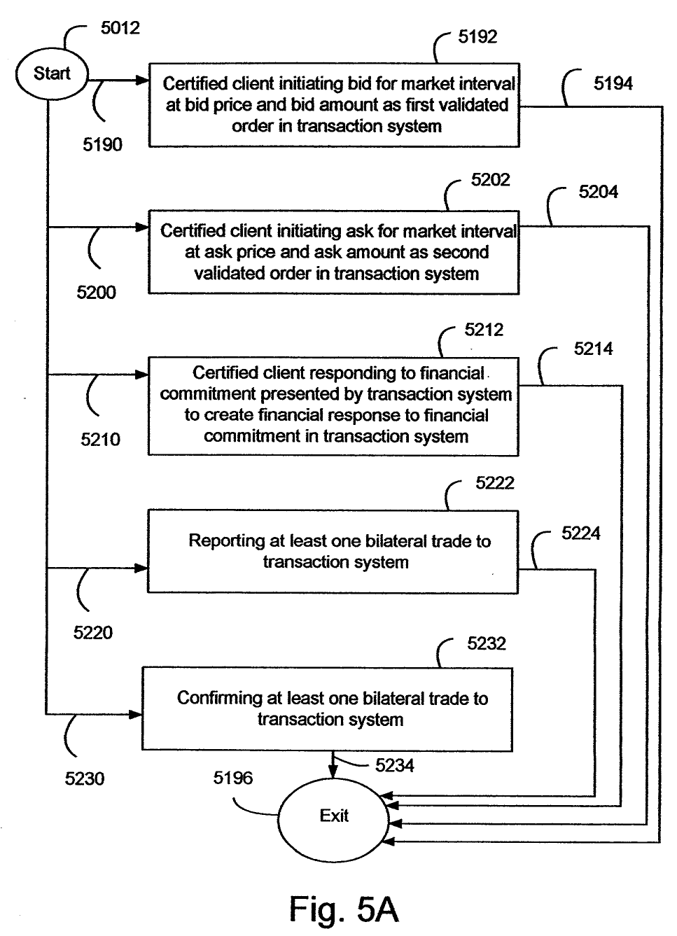

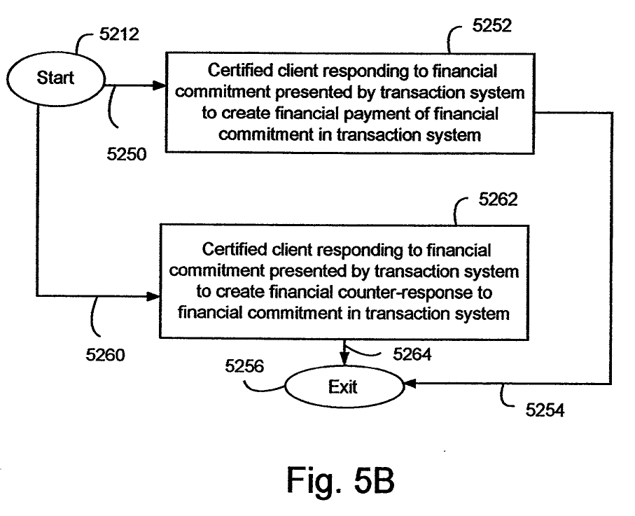

FIG. 5A depicts a detail flowchart of operation 5012 of FIG. 4 for the certified client initiating the action in the transaction system.

Arrow 5190 directs the flow of execution from starting operation 5012 to operation 5192. Operation 5192 performs the certified client initiating a bid for a market interval at a bid price and a bid amount as a first validated order in the transaction system. Arrow 5194 directs execution from operation 5192 to operation 5196. Operation 5196 terminates the operations of this flowchart.

Arrow 5200 directs the flow of execution from starting operation 5012 to operation 5202. Operation 5202 performs the certified client initiating an ask for a market interval at a ask price and a ask amount as a second validated order in the transaction system. Arrow 5204 directs execution from operation 5202 to operation 5196. Operation 5196 terminates the operations of this flowchart.

Arrow 5210 directs the flow of execution from starting operation 5012 to operation 5212. Operation 5212 performs the certified client responding to a financial commitment presented by the transaction system to create a financial response to the financial commitment in the transaction system. Arrow 5214 directs execution from operation 5212 to operation 5196. Operation 5196 terminates the operations of this flowchart.

Arrow 5220 directs the flow of execution from starting operation 5012 to operation 5222. Operation 5222 performs reporting at least one of the bilateral trades to the transaction system. Arrow 5224 directs execution from operation 5222 to operation 5226. Operation 5226 terminates the operations of this flowchart.

Arrow 5230 directs the flow of execution from starting operation 5012 to operation 5232. Operation 5232 performs confirming at least one of the bilateral trades to the transaction system. Arrow 5234 directs execution from operation 5232 to operation 5226. Operation 5226 terminates the operations of this flowchart.

FIG. 5B depicts a detail flowchart of operation 5212 of FIG. 5A for the certified client responding to the financial commitment presented by the transaction system.

Arrow 5250 directs the flow of execution from starting operation 5212 to operation 5252. Operation 5252 performs the certified client responding to the financial commitment presented by the transaction system to create a financial payment of the financial commitment in the transaction system. Arrow 5254 directs execution from operation 5252 to operation 5256. Operation 5256 terminates the operations of this flowchart. Arrow 5260 directs the flow of execution from starting operation 5212 to operation 5262. Operation 5262 performs the certified client responding to the financial commitment presented by the transaction system to create a financial counter-response to the financial commitment in the transaction system. Arrow 5264 directs execution from operation 5262 to operation 5256. Operation 5256 terminates the operations of this flowchart.

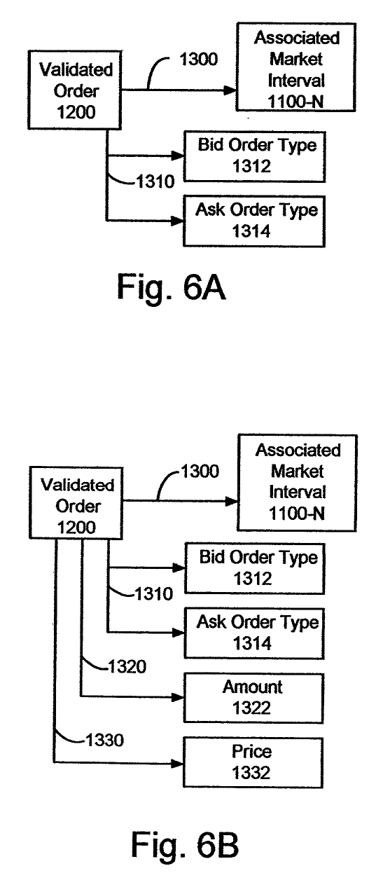

FIG. 6A depicts a validated order 1200 of the validated order collection.

Validated order 1200 has an associated 1300 market interval 1100-N of the market interval collection. The market interval collection is separately maintained in certain embodiments of the invention. Maintaining the validated order collection and market interval collections may be coupled.

Each validated order 1200 further contains a member of the order type collection 1310 which is either a bid order 1312 of the associated 1300 market interval 1100-N or an ask validated order 1314 of the associated 1300 market interval 1100-N.

FIG. 6B depicts a refinement of FIG. 6A of a validated order 1200 of the validated order collection.

As depicted in FIG. 6A, validated order 1200 has an associated 1300 market interval 1100-N of the market interval collection. The market interval collection is separately maintained in certain embodiments of the invention. Maintaining the validated order collection and market interval collections may be coupled.

As depicted in FIG. 6A, each validated order 1200 further contains a member of the order type collection 1310 which is either a bid order 1312 of the associated 1300 market interval 1100-N or an ask validated order 1314 of the associated 1300 market interval 1100-N.

A validated order may contain 1320 an amount 1322 of the product type 1110-N of the associated 1300 market interval 1100-N.

A validated order may contain 1330 a price 1332 of the product type 1110-N of the associated 1300 market interval 1100-N.

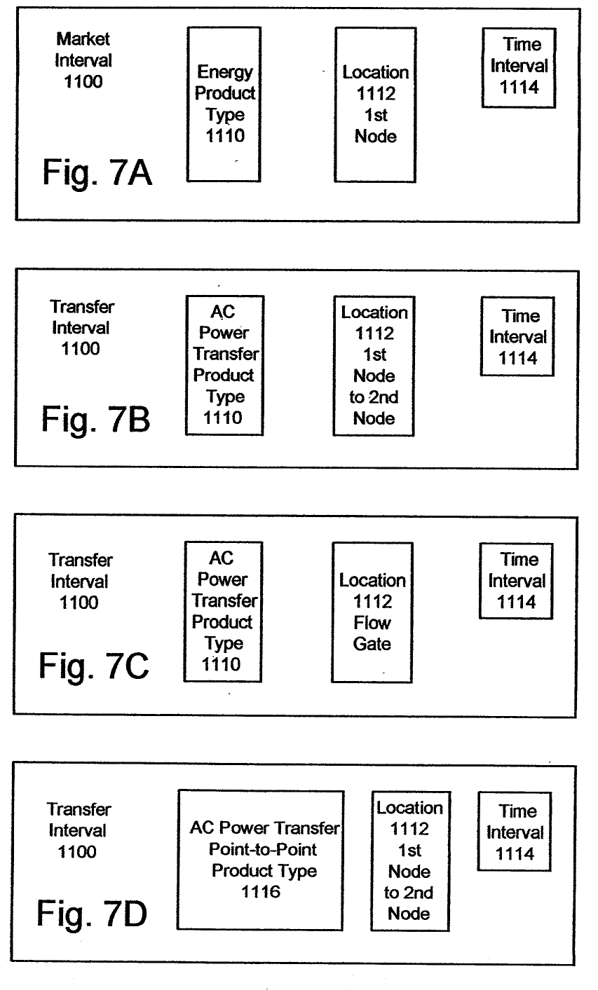

FIG. 7A depicts a refinement of FIG. 3B of a market interval of an energy product type. The product type 1110 of the market interval is further described as an energy product type 1110. The location 1112 is a first node of an AC power network contained in the electrical power grid.

FIG. 7B depicts a refinement of FIG. 3B of a market interval of an AC power transfer product type. The product type 1110 of the market interval is further described as an Energy product type 1110. The location 1112 is from a first node of a first AC power network contained in the electrical power grid to a second node of the first AC power network. Note that this form of location represents a transmission between the first node of the first AC power network and the second node of the first AC power network.

FIG. 7C depicts a refinement of FIG. 7B of a market interval of an AC power transfer product type. The product type 1110 of the market interval is described as an Energy product type 1110. The location 1112 is a flowgate of the flowgate collection of a first AC power network contained in the electrical power grid. Note that flowgates can represent a congestion constraint across more than one transmission line, and may not have a specific first node to second node description.

Such embodiments of the invention of a flowgate market interval are advantageous in providing a market to trade transfer capability between users. Because of the linear nature of AC power transfer throughout an AC power network, these transfer rights can generally be linearly accumulated to insure the contracted transfers are physically feasible in satisfying the overall flowgate constraints of the AC power network.

FIG. 7D depicts a refinement of FIGS. 7B and 7C of a market interval of an AC power transfer point-to-point product type. The product type 1116 of the market interval is a refinement of the AC power product type 1110 as depicted in FIG. 7B. The product type 1116 of the market interval is further described as an Energy product type 1110. The location 1112 is from a first node of a first AC power network contained in the electrical power grid to a second node of the first AC power network.

Note that as in FIG. 7B, this form of location represents a transmission between the first node of the first AC power network and the second node of the first AC power network. However, a market interval for an AC power transfer point-to-point product type further possesses all the ancillary flowgate transmission rights required for the power transmission from the first node to the second node of the AC power network.

Such market intervals support trading in bundles of flowgates rights as point-to-point rights. From a user perspective, point to point rights are what the market participants really want to buy and sell. They are much simpler to deal with and comprehend than flowgate rights.

In terms of maintaining market liquidity, participants should be very comfortable posting bids and offers for point-to-point AC power transfer rights, since they constitute complete products from a participant perspective.

Bids for AC power transfer point-to-point market intervals are comprised of bids for at least one flowgate transmission right sharing the same location. Bids for AC power transfer point-to-point market intervals may further comprise bids for each of the flowgates of the flowgate collection sharing the same location. Bids for AC power transfer point-to-point market intervals may further comprise transmission rights for at least one flowgate with differing location. This advantageously supports creating transmissions canceling adverse effects on one or more flowgates.

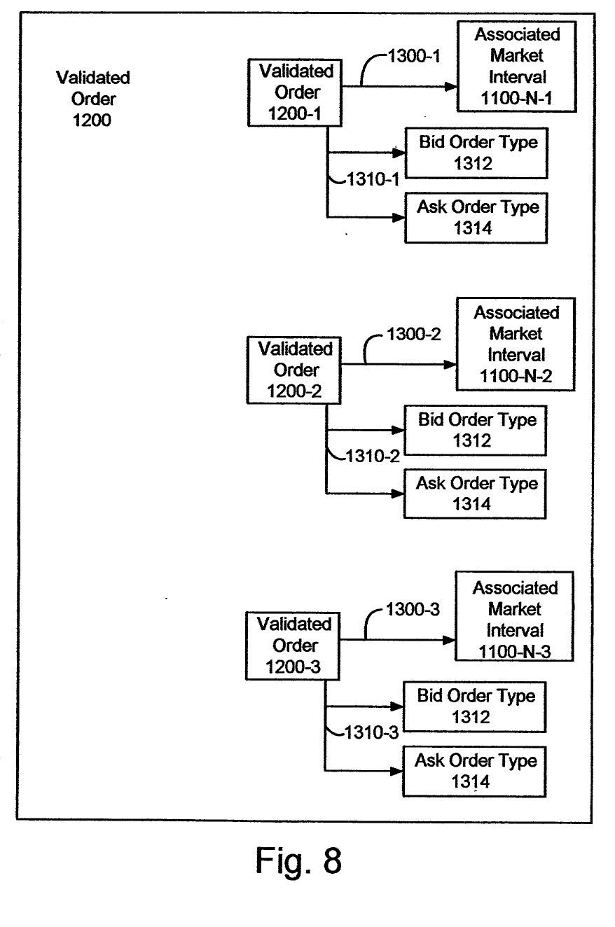

FIG. 8 depicts a validated order 1200 comprised of at least two validated orders, each with an associated market interval.

Validated order 1200-1 has an associated 1300-1 market interval 1100-N-1 of the market interval collection. Validated order 1200-1 further contains a member of the order type collection 1310-1 which is either a bid order 1312 of the associated 1300 market interval 1100-N-1 or an ask validated order 1314 of the associated 1300 market interval 1100-N-1.

Validated order 1200-2 has an associated 1300-2 market interval 1100-N-2 of the market interval collection. Validated order 1200-2 further contains a member of the order type collection 1310-2 which is either a bid order 1312 of the associated 1300 market interval 1100-N-2 or an ask validated order 1314 of the associated 1300 market interval 1100-N-2.

Validated order 1200-3 has an associated 1300-3 market interval 1100-N-3 of the market interval collection. Validated order 1200-3 further contains a member of the order type collection 1310-3 which is either a bid order 1312 of the associated 1300 market interval 1100-N-3 or an ask validated order 1314 of the associated 1300 market interval 1100-N-3.

There may be no specific limit to the number of validated orders comprising a validated order. There may be a limit to the number of validated orders comprising a validated order.

The associated market intervals of multiple validated orders within a validated order may share the same product type. The associated market intervals of multiple validated orders within a validated order may share the same location.

The associated market intervals of multiple validated orders within a validated order may differ in product type. The associated market intervals of multiple validated orders within a validated order may differ in location.

As discussed in the background, the physics of AC power networks indicates each AC power network contained in the electrical power grid further contains a flowgate collection of flowgates. Each flowgate location being either from an associated first node of the AC power network to an associated second node of the AC power network, or in the case of a collection of constrained transmission lines, will be denoted by a flowgate designator. An AC power transfer amount from node1 to node2 produces an amount of AC power transfer across the flowgate as essentially an associated linear, skew-symmetric function of the amount from node1 to node2, for each of the flowgates of the flowgate collection. For each of the flowgates of the flowgate collection, there is at least one market interval in the market interval collection of AC power transfer product type with the flowgate location.

Each validated order of the validated order collection with the AC power transfer product type of the associated market interval may further contain an amount. A validated order of AC power transfer product type from the first node to the second node may be further comprised of a validated order of the flowgate associated market interval. The amount ordered for that flowgate is essentially the associated linear, skew-symmetric function of the amount from the first node to the second node, for each of the flowgates of the flowgate collection.

Note that there may be a price associated with each validated order of the AC power transfers of the flowgates. There may be a price associated with the AC power transfer from the first node to the second node.

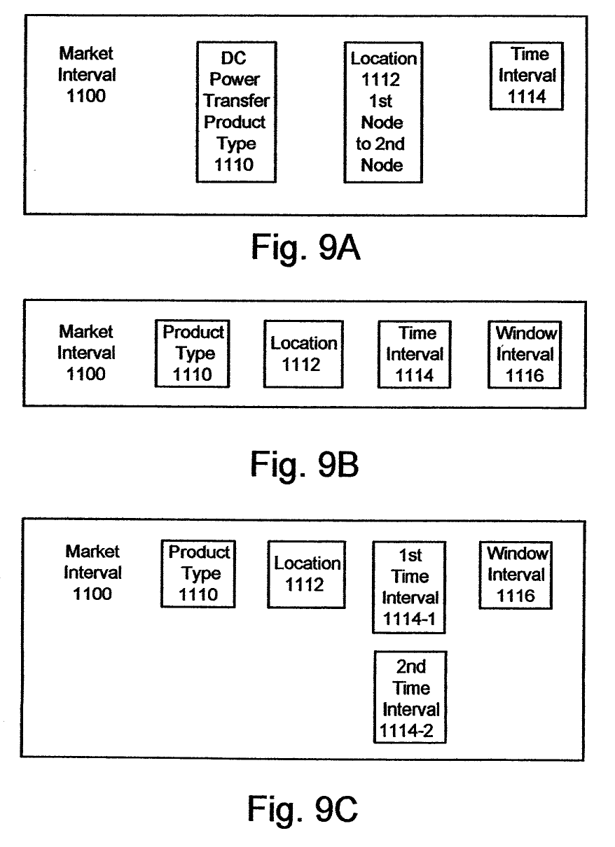

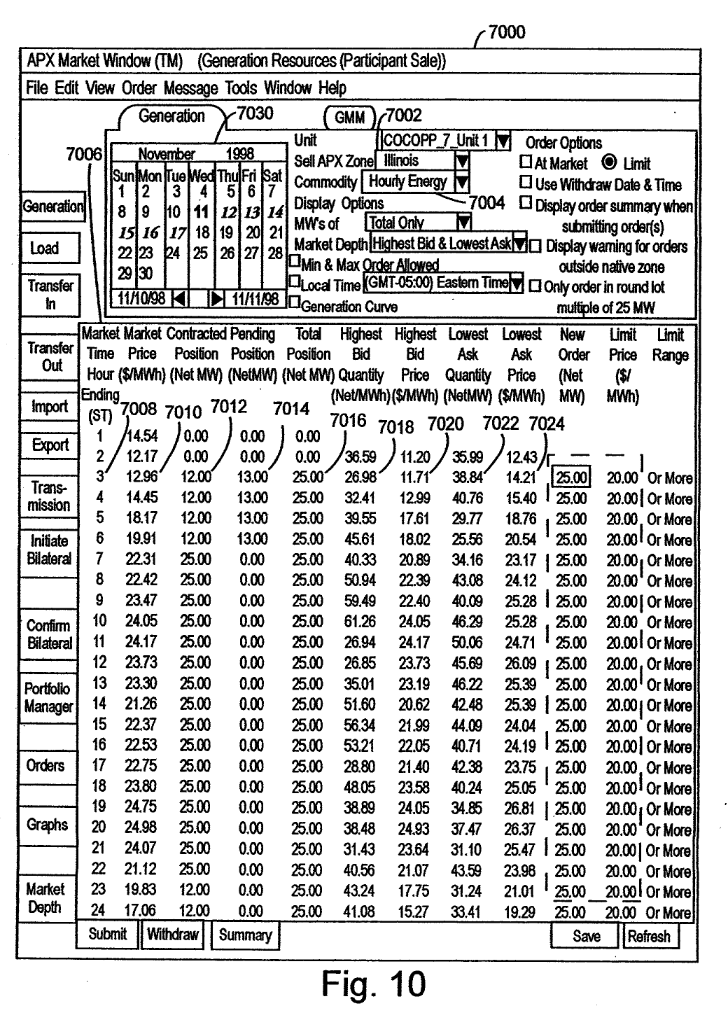

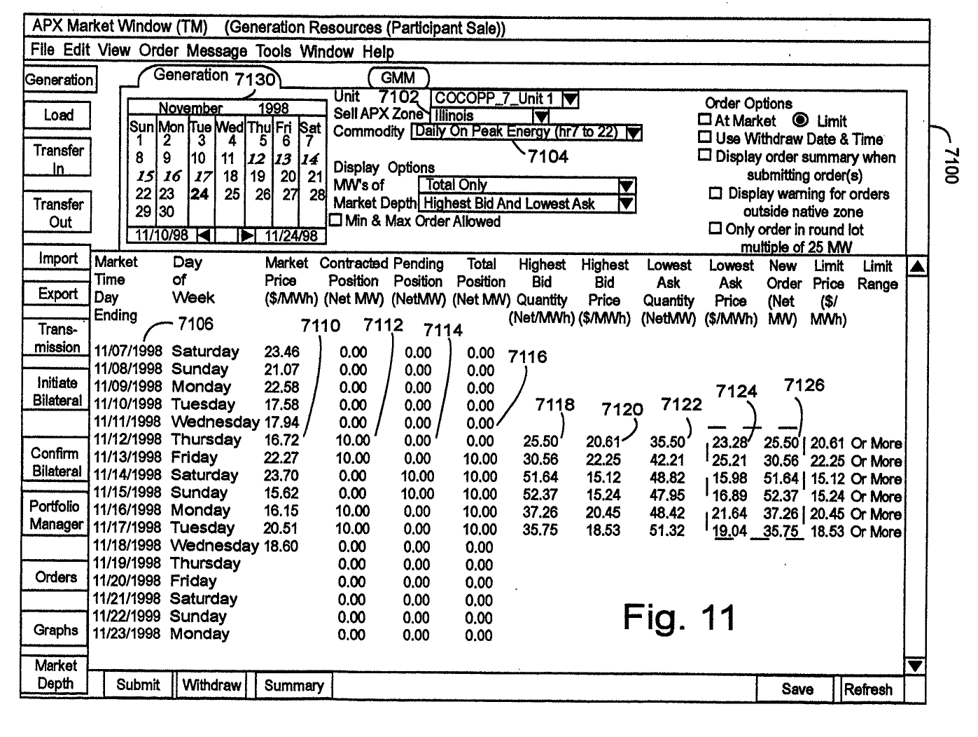

FIG. 9A depicts a market interval of a DC power line. An electrical power grid may further contain a DC power line collection of at least one DC power line at the location of the DC power line from a first node of a first AC power network to a second node of a second AC power network. The product type collection further comprises DC power transfer. For each DC power line of the DC power line collection, there is at least one associated market interval with DC power transfer product type, with the location as the location of the DC power line.

FIG. 9B depicts market interval 1100 of FIG. 3B further containing a window time interval during which the market interval is active only within the window time interval. The window time interval of the market interval entirely occurs before the time interval contained in the market interval for each market interval.

FIG. 9C depicts market interval 1100 of FIG. 9B containing a window time interval and multiple time intervals. Each of the time intervals does not overlap the other time intervals. The window time interval occurs before each of the time intervals.

Note that the invention may comprise managing more than one generator of a fungible, ephemeral commodity. The invention may include managing a first generator of a first fungible, ephemeral commodity and managing a second generator of a second fungible, ephemeral commodity. The invention may also include managing a generator of more than one fungible, ephemeral commodity.

The invention may include managing more than one load consuming a fungible, ephemeral commodity. The invention may include managing a first load consuming a first fungible, ephemeral commodity and managing a second load consuming a second fungible, ephemeral commodity. The invention may also include managing a load consuming more than one fungible, ephemeral commodity.

The invention may include managing more than one import providing a fungible, ephemeral commodity. The invention may include managing a first import providing a first fungible, ephemeral commodity and managing a second import providing a second fungible, ephemeral commodity. The invention may also include managing a import providing more than one fungible, ephemeral commodity.

The invention may include managing more than one export consuming a fungible, ephemeral commodity. The invention may include managing a first export consuming a first fungible, ephemeral commodity and managing a second export consuming a second fungible, ephemeral commodity. The invention may also include managing an export consuming more than one fungible, ephemeral commodity.

As used herein, presenting something to a certified client who is human may include, but is not limited to, visually displaying that something, placing a presentation of that something into a windowing system, which may be directed to display the something by the human and acoustically presenting that something to the certified client.

Presenting something to a certified client operating a computer interacting within the transaction system may further include, but is not limited to, transmitting a presentation of the something to the client computer. The client computer may further receive and process the presentation.

Presenting something to a software agent operating a software agent computer may include, but is not limited to, inserting or adding the processed presentation into a fact database accessible by the software agent.

FIG. 10 depicts a view of certified client user interface 7000 showing an ordering screen with hourly time interval based market intervals for a specific energy market.

Note that in FIGS. 10 to 16, which show various views of certified client user interfaces, managing a market trading position portfolio is illustrated based upon the assumption that the certified client is actively trading.

In circumstances where the certified client is not actively trading, as for instance in situations regarding certified clients such as homes, factories and farms consuming and/or generating power below the minimum lot size, minor variants of FIGS. 10 to 16 would show the market position portfolios.

In general, managing a market trading portfolio is similar to managing a market position portfolio with the added capability

Client display screen 7000 may interactively show the market state of a number of related market intervals. Client display screen 7000 may indicate the market state of market intervals sharing the same product type 7004 and location 7002 and for successive time intervals 7008 for Nov. 11, 1998 as indicated by highlighted lettering in calendar 7030.

The column 7006 labeled “Market Time Hour Ending (ST)” has a succession of rows with entries from 1 to 24, indicating the hourly energy markets 7004 in the Illinois sell zone 7002. Consider the row labeled by the hour 7008 ending at “3”. This row displays the market state of the market interval with energy product type, Illinois sell zone location and hour time interval ending at 3:00 for Nov. 11, 1998. The current market price in dollars per megawatt-hour 7010 is “12.96”. The contracted position in net megawatts 7012 is “12.00”. The pending position in net megawatts 7014 is “13.00”. The total position in net megawatts 7016 is “25.00”, which is the sum of the contract and pending positions for that market interval. The highest bid quantity in net megawatts-hours 7018 is “26.98”. The highest bid price in dollars per megawatt-hour 7020 is “11.71”. The highest ask quantity in net megawatts-hours 7022 is “38.84”. The highest ask price in dollars per megawatt-hour 7024 is “14.21”.

FIG. 11 depicts a view of certified client user interface 7100 showing an ordering screen for daily on-peak time interval based market intervals for a specific energy market.

Client display screen 7100 may interactively show the market state of a number of related market intervals. Client display screen 7100 may indicate the market state of market intervals sharing the same product type 7104 and location 7102 and for successive time intervals 7106 from Nov. 7, 1998 to Nov. 24, 1998 as indicated by highlighted lettering in calendar 7130. Consider the row for Nov. 12, 1998.

The column labeled “Market Time Day Ending” has a succession of rows with entries from Nov. 7, 1998 to Nov. 23, 1998, indicating the daily on peak energy markets 7104 in the Illinois sell zone 7102.

The current market price in dollars per megawatt-hour 7110 is “16.72”. The contracted position in net megawatts 7112 is “10.00”. The pending position in net megawatts 7114 is “0.00”. The total position in net megawatts 7116 is “10.00”, which is the sum of the contract and pending positions for that market interval. The highest bid quantity in net megawatts-hours 7118 is “25.50”. The highest bid price in dollars per megawatt-hour 7120 is “20.61”. The lowest ask quantity in net megawatts-hours 7122 is “35.50”. The lowest ask price in dollars per megawatt-hour 7124 is “23.28”.

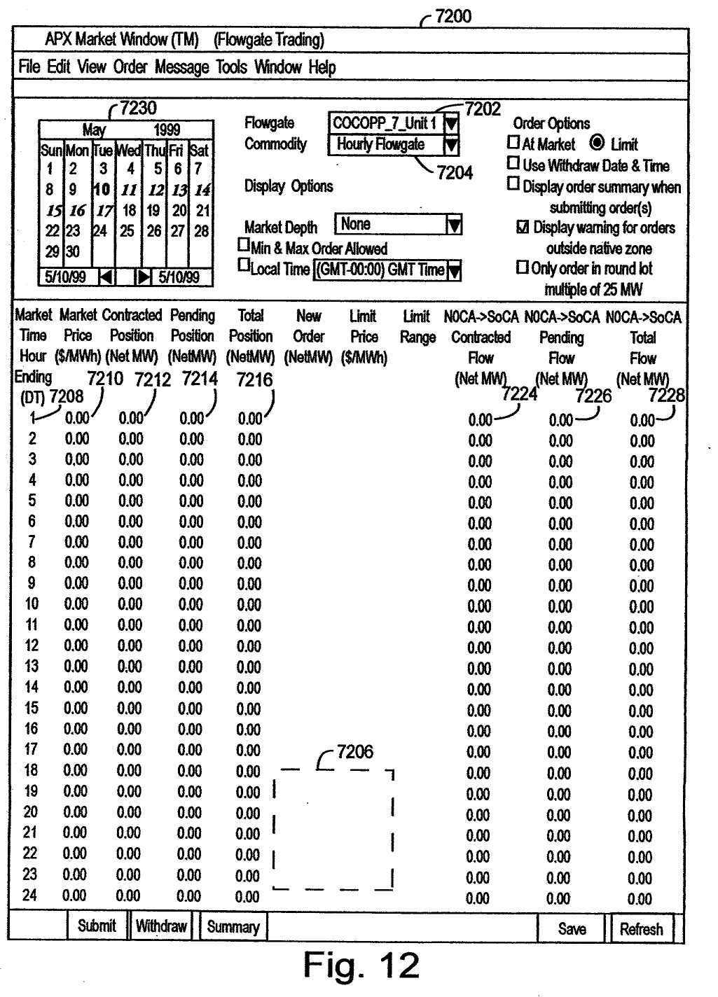

FIG. 12 depicts a view of certified client user interface 7200 showing an ordering screen for hourly time interval based market intervals for a specific flowgate market.

The displayed information 7200 includes a variety of fields, including field 7202, where a specific flowgate or intertie may be selected. Immediately below that field is field 7204 specifying commodity type, in this case, “Hourly Flowgate”. The column indicated by 7210 represents the current market price. The column to its right 7212 indicates the amount of the commodity already awarded. The box 7206 points to two columnar components. The left component represents the bid quantity and the right component represents the bid price per unit quantity on each row. Note that each row represents a distinct market interval, trading independently of the other market intervals.

Client display screen 7200 may show the market state of a number of related market intervals, may indicate the market state of market intervals sharing the same product type 7204 and location 7202 and for successive time intervals for May 10, 1999 as indicated by highlighted lettering in calendar 7230.

The column labeled “Market Time Hour Ending (DT)” 7208 has a succession of rows with entries from 1 to 24, indicating the hourly AC power transfer markets 7204 in the flowgate location “Flowgate_a” 7202. Consider the row labeled by the hour 7208 ending at “1”. This row displays the market state of the market interval with AC power transfer product type, flowgate 7202 location and hour time interval ending at 1:00 for May 10, 1999. The current market price in dollars per megawatt-hour 7210 is “0.00”. The contracted position in net megawatts 7212 is “0.00”. The pending position in net megawatts 7214 is “0.00”. The total position in net megawatts 7216 is “0.00”, which is the sum of the contract and pending positions for that market interval. The contracted flow 7224 is “0.00”. The pending flow 7226 is “0.00”. The total flow 7228 is “0.00”.

The user interface supporting many flowgates may be very similar to FIGS. 10, 11 and 12, with some added features. In the Energy Market screen of FIGS. 10 and 11, there are columns showing the market position in terms of bid and ask summaries.

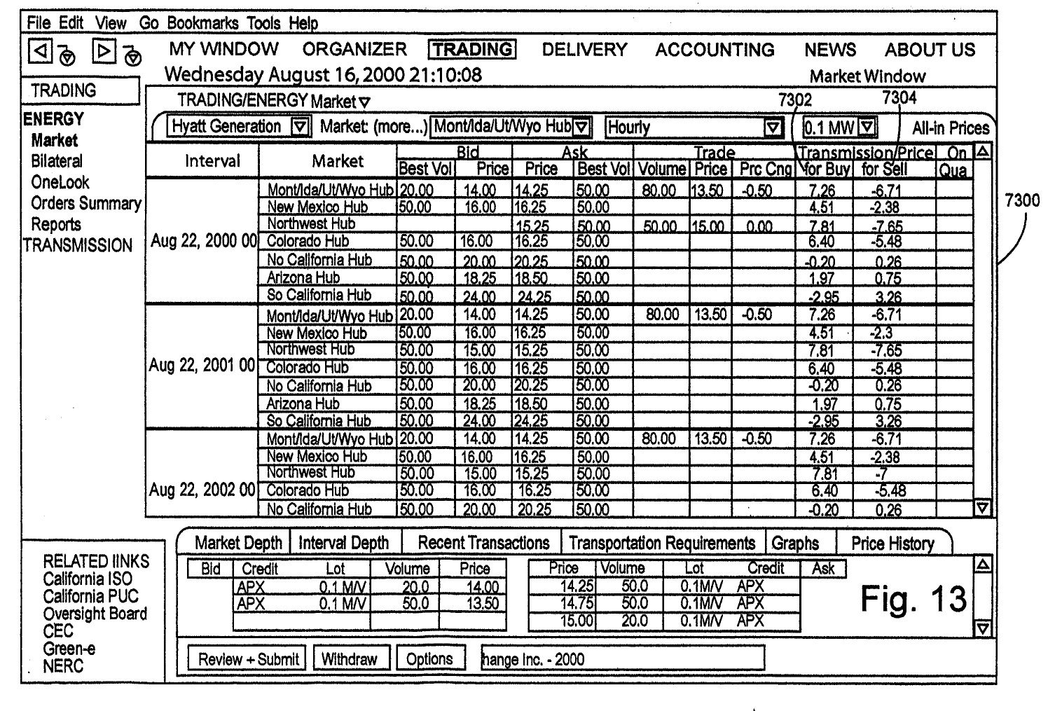

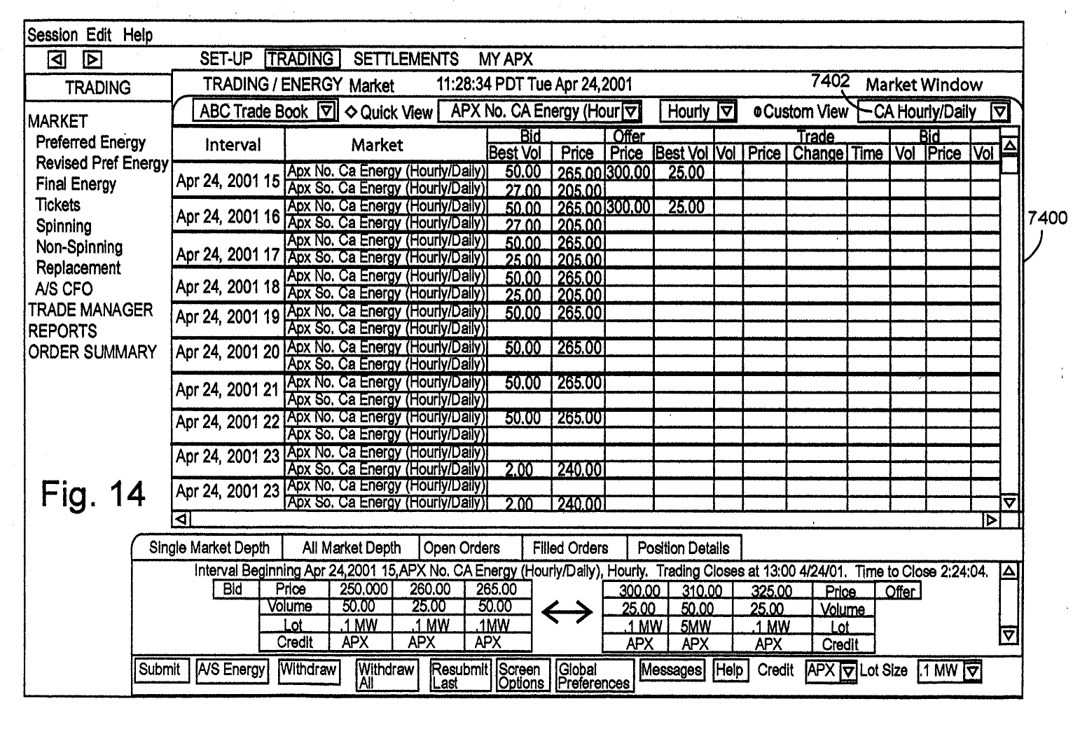

FIG. 13 depicts a view of certified client user interface 7300 showing an ordering screen for hourly time interval based market intervals with respect to a specific facility (“Hyatt Generation”) including energy transmission costs from multiple displayed markets.

The more specific information on energy and transmission prices are available in the tabs at the bottom of the screen. There is an “Interval Depth” tab (which may be called “All Market Depth”) and a “Market Depth” tab (which may be called “Single Market Depth”).

The “Transmission requirements” tab shows the required flowgate transmission rights for a point-to-point transmission from the Hub to the business location.

The column labeled 7302 shows the transmission cost to buy energy at the hub (Market) and transfer it to the business location (Hyatt Generation).

The column labeled 7304 shows the transmission cost to sell energy at the hub (Market) and transfer from the business location (Hyatt Generation). Costs 7302 and/or 7304 may be calculated from current market price of the required flowgate market intervals.

Certain embodiments of the invention include dynamic creation of transmission bids and offers shown in the Energy Market screen. When a participant opens the Energy Market screen for a particular facility, market, strip, and lot size, a signal is sent to the market makers. They may respond with bids and offers tailored for this particular screen. The dynamic capability may be needed because it is not feasible for market makers to continuously post bids and offers between every hub and every facility location.

Certain embodiments include “Transmission from Hub Depth” and “Transmission to Hub Depth” tabs. These tabs may show, in addition to quantity, price, and possibly credit, codes identifying the market maker making the bid or offer. The reason this information is needed is that different market makers may be relying on reconfiguring the same standing bids and offers to create their bids and offers. Hence, if the participant lifts or hits one of these bids or offers, the other market maker will likely withdraw their corresponding bid or offer. When a participant sees similar bids or offers from two different market makers, it is probably only possible to hit or lift one of them. Another way to deal with this problem might be to only display a stack of bids or offers from one market maker at a time—perhaps the one offering the best price.

When the participant enters a buy or sell order in the appropriate columns and presses the “submit” button, the user interface may display the energy order and a listing of all the flowgates and the transmission quantity through the flowgate required to deliver the energy. The user can check off which orders he/she wishes to place. The user may check all items to do a complete “all-in” order.

Alternatively, the invention includes at least one mechanism where most users could avoid any direct dealings in flowgates. The energy order may be displayed, along with a single order to buy (for energy purchases) or sell (for energy sales) transmission in the direction of the energy flow, and another order to sell or buy transmission in the direction against the energy flow. The user may check all three items to do a complete “all-in” order. The user who wished to buy energy and transmission without incurring any obligations would check only the first two lines. Users could do energy only orders by clicking only the first line, or transmission only orders by clicking one or both of the transmission lines.

The advantage of this macromarket trading scheme, is that there is just one transaction including the source generation, transmission rights and destination loading, where applicable, which preferably becomes a single contract. This creates a fundamental simplification in the conceptual effort required to trade energy delivery.

FIG. 14 depicts a view of certified client user interface 7400 showing an ordering screen for hourly time interval based market intervals from a trade book perspective.

Trade books are useful in the preliminary stages of trading energy, when the principal requirement is to create production and load commitments. A trade book has no business location. By way distinction, a facility always has a location.

Many power utility companies, as well as facilities operators employ a trade book approach for initial, relatively time-distant energy trading, and then switch to a facility based energy trading activity as the time approaches when scheduling the energy delivery becomes relevant. Such tasks are often performed by two separate groups of people within such organizations.

Note that the certified client may select various markets and at least the presentation use of the visible columns, which become part of the user view, which can be saved, selected and presented by name, such as “CA Hourly/Daily” in field 7402.

Note that this may effect and/or control the ordering of columns, rows, and/or the sorting of columns and/or rows

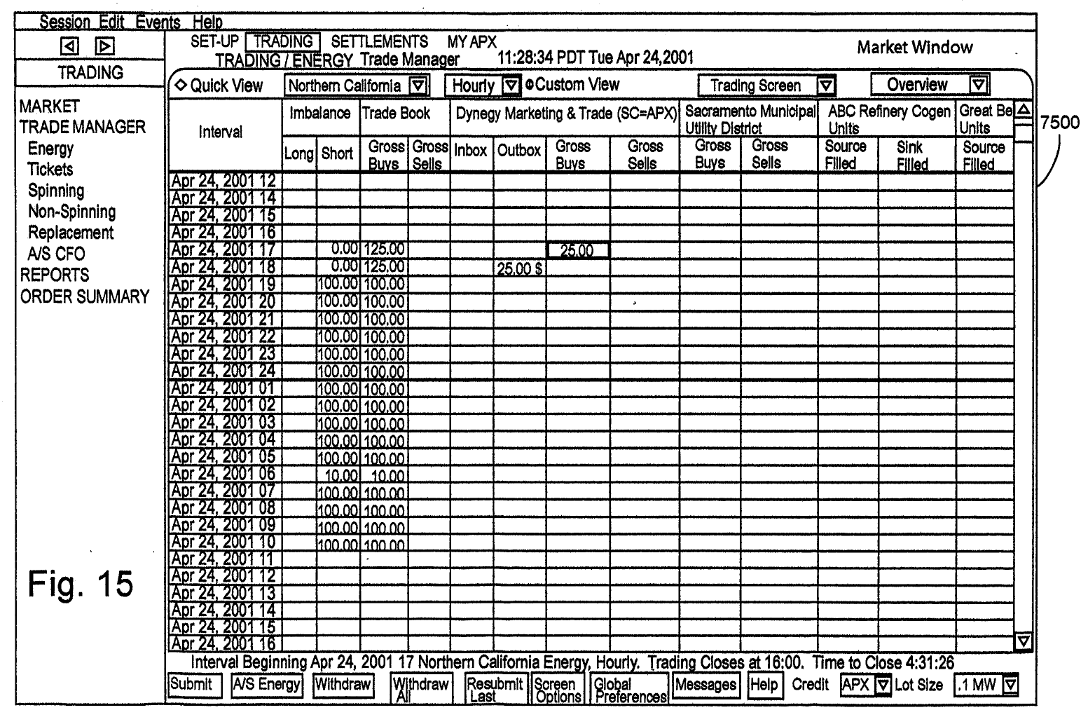

FIG. 15 depicts a view of certified client user interface 7500 showing an overview trading position for specific hours of two successive days including the trade book and a limited number of certified clients.

A certified client may use view 7500 in the scheduling process.

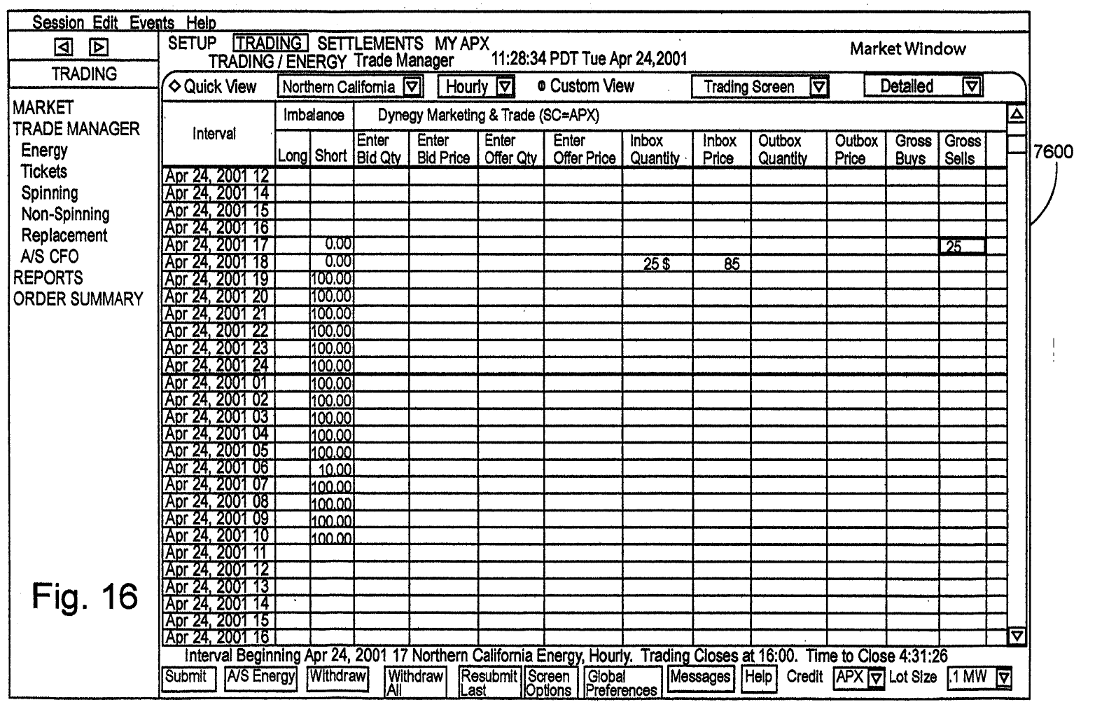

FIG. 16 depicts a detailed view of certified client user interface 7600 showing the trading position for specific hours of two successive days with regards to one certified client based upon FIG. 15.

FIG. 16 is sometimes referred to as a “drill down” from FIG. 15.

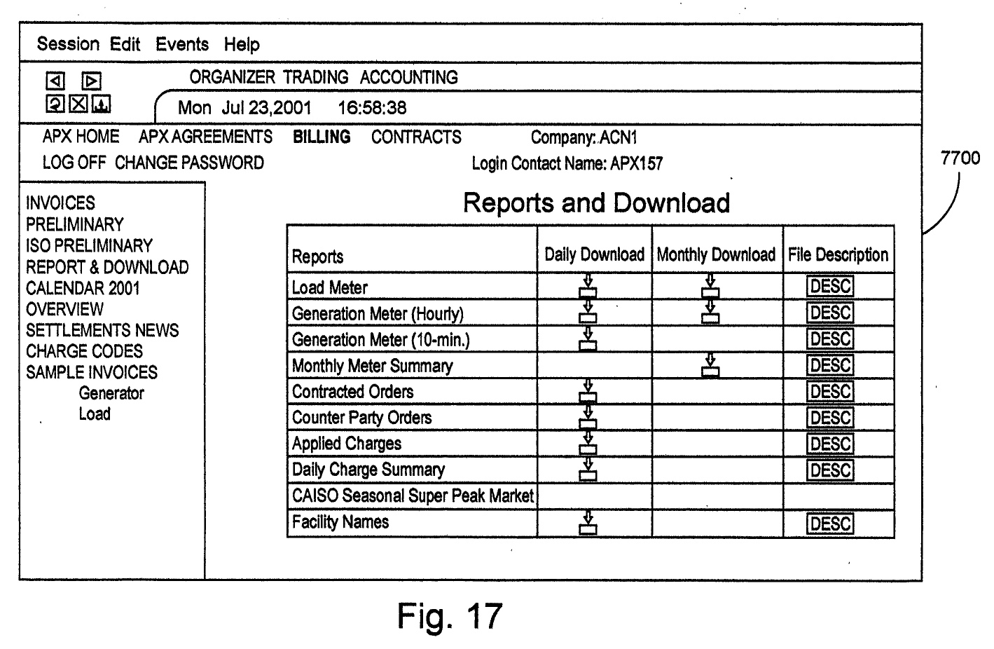

FIG. 17 depicts a view of certified client user interface 7700 providing an overview of the reports on transactions and/or schedules available for presentation to the user.

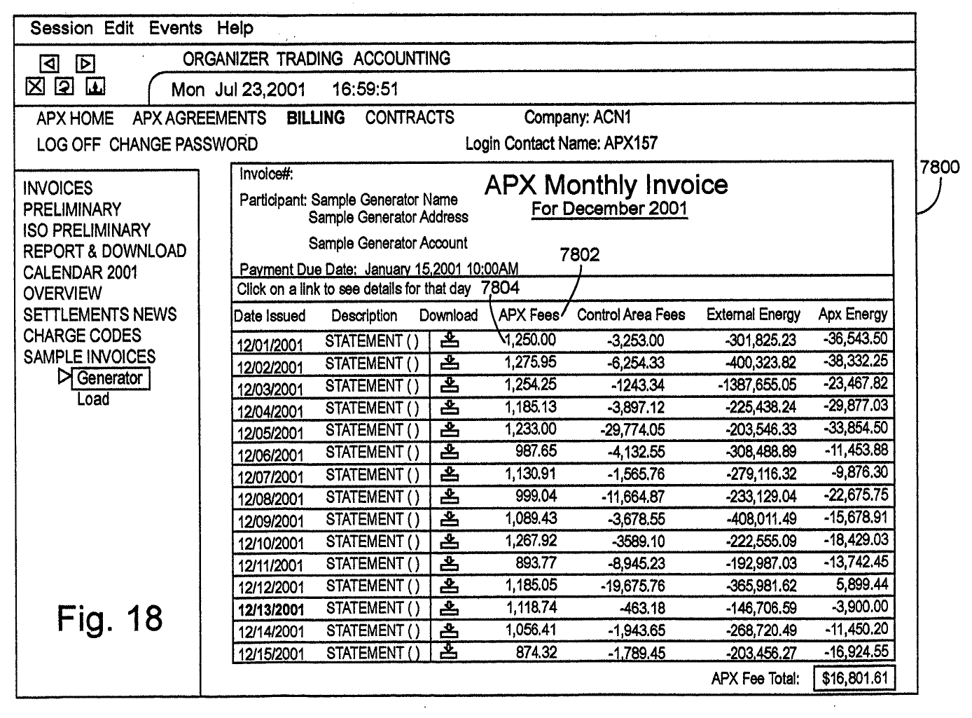

FIG. 18 depicts a view of certified client user interface 7800 providing a detailed view of the monthly invoice for the certified client including fees to the transaction engine service provider, who may be a first party, (APX Fees 7802).

Note individual financial obligations 7804 are shown as owed by the certified client to the first party. Responses to the financial statement include payment of the obligation 7804 to the first party. Such payments are a product of the process of using the transaction system of this invention.

Further note that there are potentially several first parties to whom or from whom moneys may be owed or are owing: A service provider supporting at least some of the operations of FIG. 4 such as APX may be a first party; a regulatory agency may be a first party; A network operator may be a first party; A public utility company; And often at least one other certified client, who performed or received benefit from the performance of a commitment through use of the transaction system, may also be a first party.

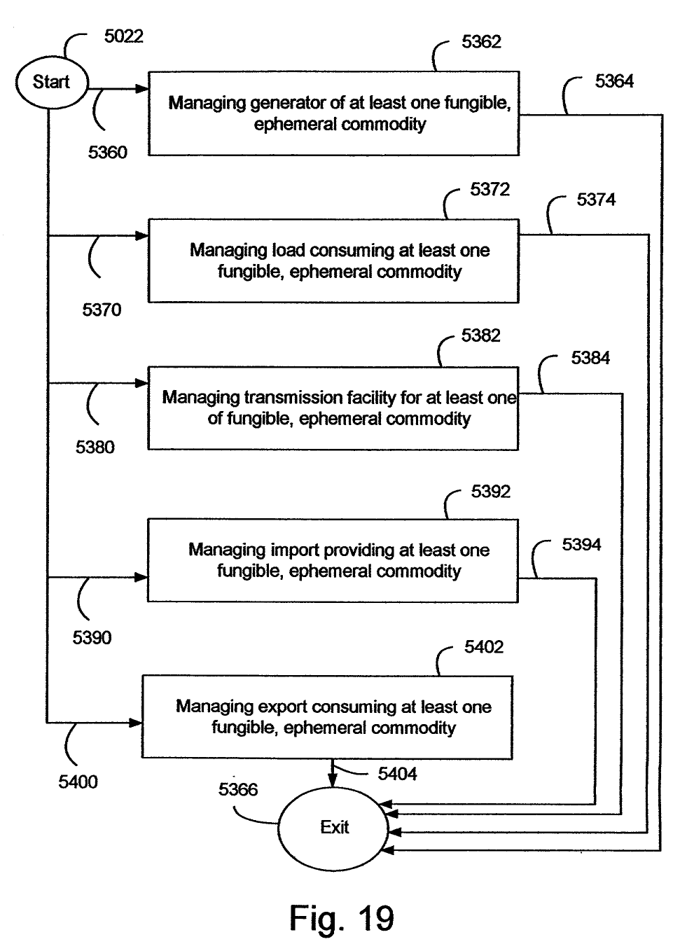

FIG. 19 depicts a detail flowchart of operation 5022 of FIG. 4 for managing the user resource.

Arrow 5360 directs the flow of execution from starting operation 5022 to operation 5362. Operation 5362 performs managing a generator of at least one of the fungible, ephemeral commodities. Arrow 5364 directs execution from operation 5362 to operation 5366. Operation 5366 terminates the operations of this flowchart.

Arrow 5370 directs the flow of execution from starting operation 5022 to operation 5372. Operation 5372 performs managing a load consuming at least one of the fungible, ephemeral commodities. Arrow 5374 directs execution from operation 5372 to operation 5366. Operation 5366 terminates the operations of this flowchart.

Arrow 5380 directs the flow of execution from starting operation 5022 to operation 5382. Operation 5382 performs managing a transmission facility for at least one of the fungible, ephemeral commodities. Arrow 5384 directs execution from operation 5382 to operation 5366. Operation 5366 terminates the operations of this flowchart.

Arrow 5390 directs the flow of execution from starting operation 5022 to operation 5392. Operation 5392 performs managing an import providing at least one of the fungible, ephemeral commodities. Arrow 5394 directs execution from operation 5392 to operation 5366. Operation 5366 terminates the operations of this flowchart.

Arrow 5400 directs the flow of execution from starting operation 5022 to operation 5402. Operation 5402 performs managing an export consuming at least one of the fungible, ephemeral commodities. Arrow 5404 directs execution from operation 5402 to operation 5366. Operation 5366 terminates the operations of this flowchart.

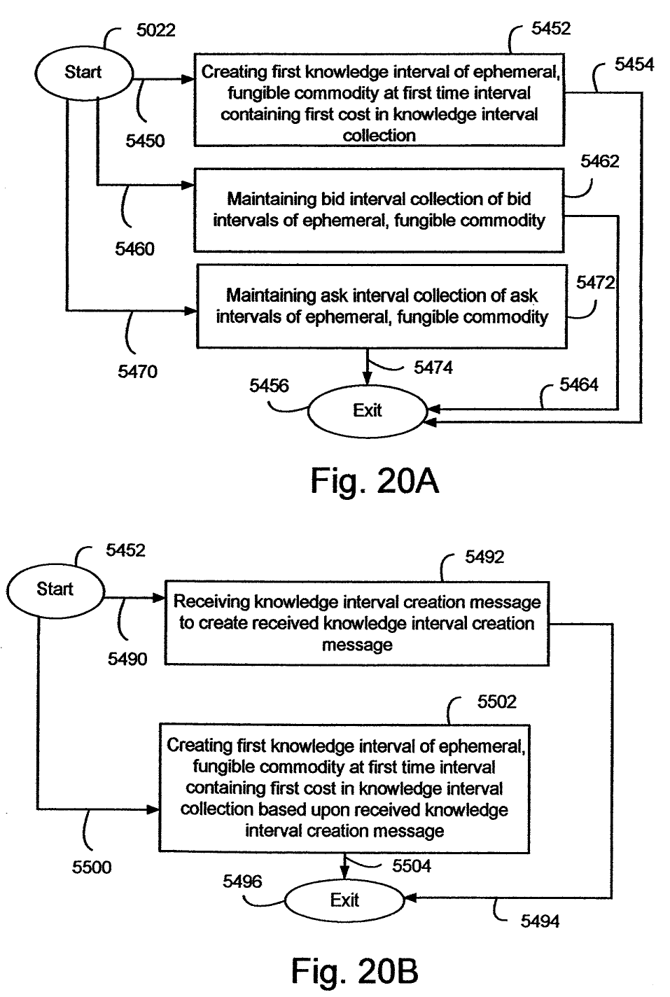

FIG. 20A depicts a detail flowchart of operation 5022 of FIG. 4 for managing the user resource.

Arrow 5450 directs the flow of execution from starting operation 5022 to operation 5452. Operation 5452 performs creating a first knowledge interval of the ephemeral, fungible commodity at a first time interval containing a first cost in the knowledge interval collection. Arrow 5454 directs execution from operation 5452 to operation 5456. Operation 5456 terminates the operations of this flowchart.

Certain embodiments of the invention include at least one of the two following operations.

Arrow 5460 directs the flow of execution from starting operation 5022 to operation 5462. Operation 5462 performs maintaining a bid interval collection of bid intervals of the ephemeral, fungible commodity, each comprised of a bid price, a bid amount, and a bid time interval. Arrow 5464 directs execution from operation 5462 to operation 5456. Operation 5456 terminates the operations of this flowchart.

Arrow 5470 directs the flow of execution from starting operation 5022 to operation 5472. Operation 5472 performs maintaining an ask interval collection of ask intervals of the ephemeral, fungible commodity, each comprised of a ask price, a ask amount, and a ask time interval. Arrow 5474 directs execution from operation 5472 to operation 5456. Operation 5456 terminates the operations of this flowchart.

Note that these bid intervals and ask intervals may be related or the same as the bids and asks initiated by the certified client. Such bids and asks may alternatively be integrated into a market trading portfolio.

FIG. 20B depicts a detail flowchart of operation 5452 of FIG. 20A for creating the first knowledge interval.

Arrow 5490 directs the flow of execution from starting operation 5452 to operation 5492. Operation 5492 performs receiving a knowledge interval creation message to create a received knowledge interval creation message. Arrow 5494 directs execution from operation 5492 to operation 5496. Operation 5496 terminates the operations of this flowchart.

Arrow 5500 directs the flow of execution from starting operation 5452 to operation 5502. Operation 5502 performs creating the first knowledge interval of the ephemeral, fungible commodity at the first time interval containing the first cost in the knowledge interval collection based upon the received knowledge interval creation message. Arrow 5504 directs execution from operation 5502 to operation 5496. Operation 5496 terminates the operations of this flowchart.

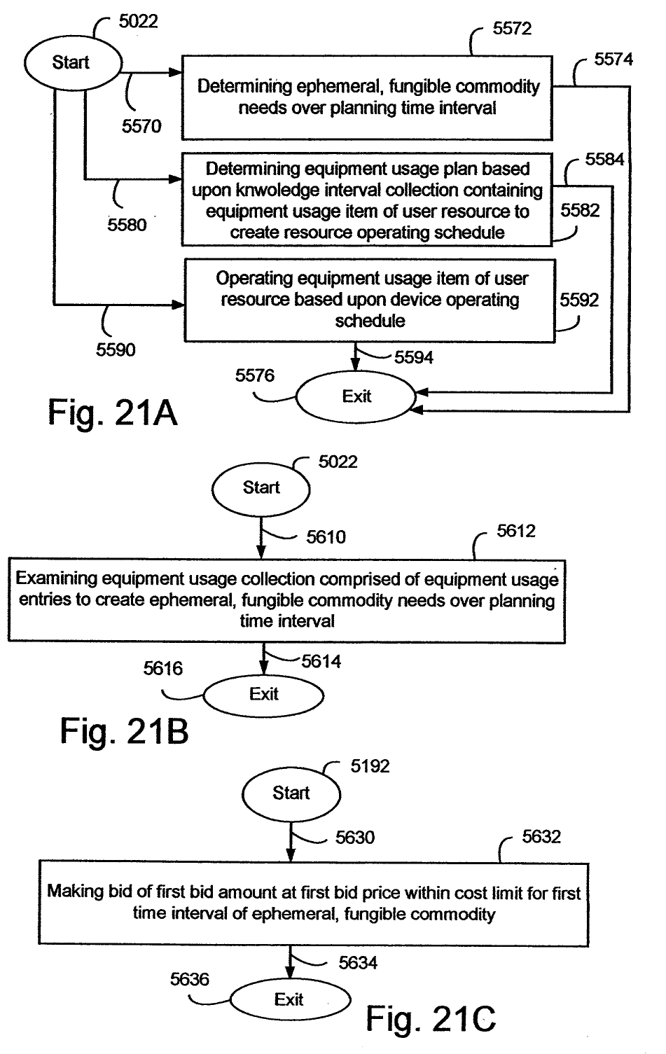

FIG. 21A depicts a detail flowchart of operation 5022 of FIG. 4 for managing the user resource.

Arrow 5570 directs the flow of execution from starting operation 5022 to operation 5572. Operation 5572 performs determining the ephemeral, fungible commodity needs over a planning time interval. Arrow 5574 directs execution from operation 5572 to operation 5576. Operation 5576 terminates the operations of this flowchart.

Arrow 5580 directs the flow of execution from starting operation 5022 to operation 5582. Operation 5582 performs determining an equipment usage plan based upon the knowledge interval collection containing an equipment usage item of the user resource to create a resource operating schedule. Arrow 5584 directs execution from operation 5582 to operation 5576. Operation 5576 terminates the operations of this flowchart.

The equipment usage item of the user resource is comprised of an activation time and an action belonging to an action collection comprising start-action, stop-action and throttle-action.

Arrow 5590 directs the flow of execution from starting operation 5022 to operation 5592. Operation 5592 performs operating the equipment usage item of the user resource based upon the device operating schedule. Arrow 5594 directs execution from operation 5592 to operation 5576. Operation 5576 terminates the operations of this flowchart.

FIG. 21B depicts a detail flowchart of operation 5022 of FIG. 4 for managing the user resource.

Arrow 5610 directs the flow of execution from starting operation 5022 to operation 5612. Operation 5612 performs examining an equipment usage collection comprised of equipment usage entries to create the ephemeral, fungible commodity needs over the planning time interval. Arrow 5614 directs execution from operation 5612 to operation 5616. Operation 5616 terminates the operations of this flowchart.

Each equipment usage entries contains a delivery time and a need schedule for the ephemeral, fungible commodity. The ephemeral, fungible commodity needs over the planning time interval comprise an amount.

The ephemeral, fungible commodity needs over the planning time interval further comprise a cost limit.

FIG. 21C depicts a detail flowchart of operation 5192 of FIG. 5A for the certified client initiating the bid.

Arrow 5630 directs the flow of execution from starting operation 5192 to operation 5632. Operation 5632 performs making the bid of a first bid amount at a first bid price within the cost limit for the first time interval of the ephemeral, fungible commodity. Arrow 5634 directs execution from operation 5632 to operation 5636. Operation 5636 terminates the operations of this flowchart.

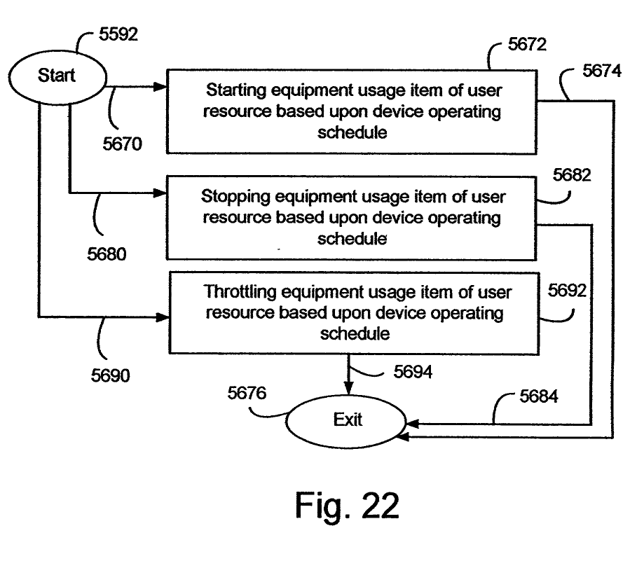

FIG. 22 depicts a detail flowchart of operation 5592 of FIG. 21A for operating the equipment usage item.

Arrow 5670 directs the flow of execution from starting operation 5592 to operation 5672. Operation 5672 performs starting the equipment usage item of the user resource based upon the device operating schedule. Arrow 5674 directs execution from operation 5672 to operation 5676. Operation 5676 terminates the operations of this flowchart.

Arrow 5680 directs the flow of execution from starting operation 5592 to operation 5682. Operation 5682 performs stopping the equipment usage item of the user resource based upon the device operating schedule. Arrow 5684 directs execution from operation 5682 to operation 5676. Operation 5676 terminates the operations of this flowchart.

Arrow 5690 directs the flow of execution from starting operation 5592 to operation 5692. Operation 5692 performs throttling the equipment usage item of the user resource based upon the device operating schedule. Arrow 5694 directs execution from operation 5692 to operation 5676. Operation 5676 terminates the operations of this flowchart.

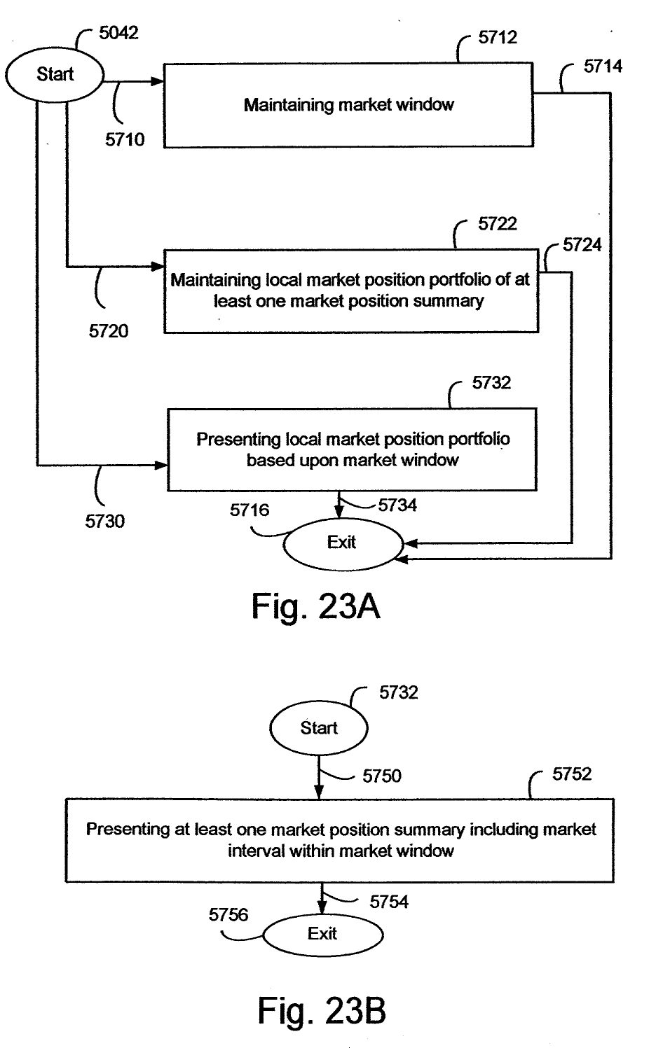

FIG. 23A depicts a detail flowchart of operation 5042 of FIG. 4 for managing the market position portfolio.

Arrow 5710 directs the flow of execution from starting operation 5042 to operation 5712. Operation 5712 performs maintaining a market window. Arrow 5714 directs execution from operation 5712 to operation 5716. Operation 5716 terminates the operations of this flowchart.

Arrow 5720 directs the flow of execution from starting operation 5042 to operation 5722. Operation 5722 performs maintaining a local market position portfolio comprised of at least one market position summary. Arrow 5724 directs execution from operation 5722 to operation 5716. Operation 5716 terminates the operations of this flowchart.

Each of the market position summaries includes a market interval of the fungible, ephemeral commodity within the market window.

Arrow 5730 directs the flow of execution from starting operation 5042 to operation 5732. Operation 5732 performs presenting the local market position portfolio based upon the market window. Arrow 5734 directs execution from operation 5732 to operation 5716. Operation 5716 terminates the operations of this flowchart.

FIG. 23B depicts a detail flowchart of operation 5732 of FIG. 23A for presenting the local market position portfolio.

Arrow 5750 directs the flow of execution from starting operation 5732 to operation 5752. Operation 5752 performs presenting at least one of the market position summaries including the market interval within the market window. Arrow 5754 directs execution from operation 5752 to operation 5756. Operation 5756 terminates the operations of this flowchart.

Note that at least one of the market position summaries of the local market position portfolio may include an amount-held, a current bid summary, a current ask summary, a current market price and a current order summary.

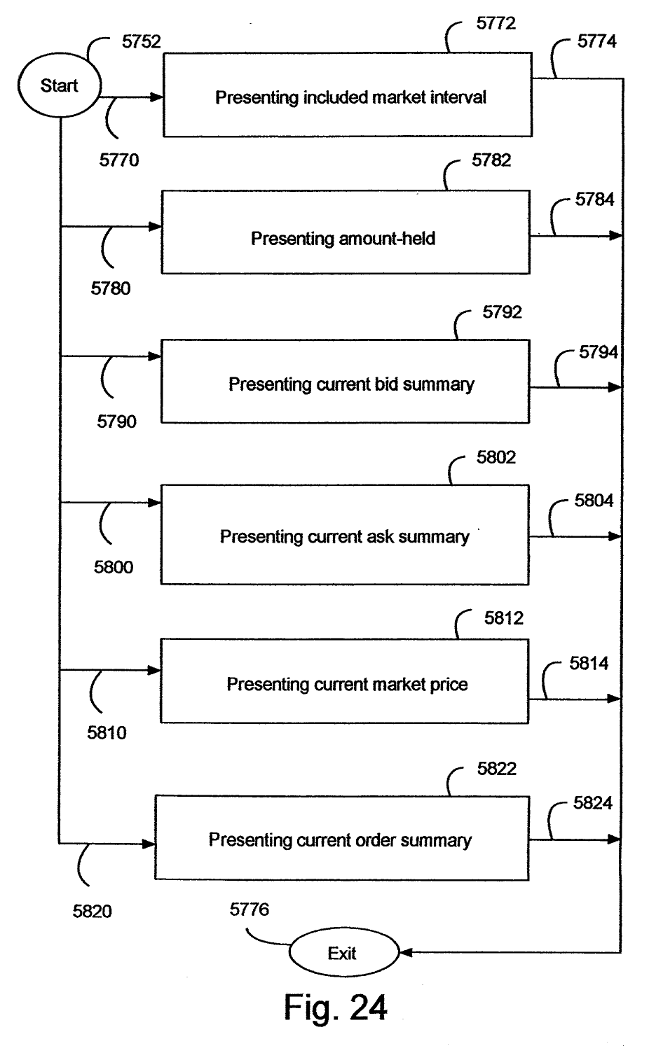

FIG. 24 depicts a detail flowchart of operation 5752 of FIG. 23B for presenting the market position summary.

Arrow 5770 directs the flow of execution from starting operation 5752 to operation 5772. Operation 5772 performs presenting the included market interval. Arrow 5774 directs execution from operation 5772 to operation 5776. Operation 5776 terminates the operations of this flowchart.

Arrow 5780 directs the flow of execution from starting operation 5752 to operation 5782. Operation 5782 performs presenting the amount-held. Arrow 5784 directs execution from operation 5782 to operation 5776. Operation 5776 terminates the operations of this flowchart.

Arrow 5790 directs the flow of execution from starting operation 5752 to operation 5792. Operation 5792 performs presenting the current bid summary. Arrow 5794 directs execution from operation 5792 to operation 5776. Operation 5776 terminates the operations of this flowchart.

Arrow 5800 directs the flow of execution from starting operation 5752 to operation 5802. Operation 5802 performs presenting the current ask summary. Arrow 5804 directs execution from operation 5802 to operation 5776. Operation 5776 terminates the operations of this flowchart.

Arrow 5810 directs the flow of execution from starting operation 5752 to operation 5812. Operation 5812 performs presenting the current market price. Arrow 5814 directs execution from operation 5812 to operation 5776. Operation 5776 terminates the operations of this flowchart.

Arrow 5820 directs the flow of execution from starting operation 5752 to operation 5822. Operation 5822 performs presenting the current order summary. Arrow 5824 directs execution from operation 5822 to operation 5776. Operation 5776 terminates the operations of this flowchart.

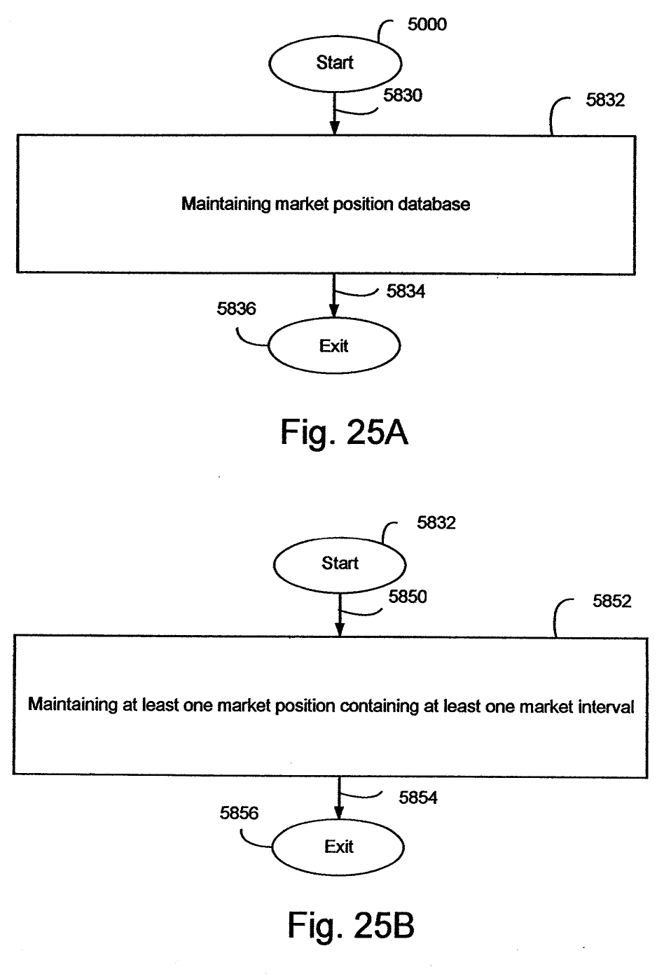

FIG. 25A depicts a detail flowchart of operation 5000 of FIG. 4 for the method of using the transaction system.

Arrow 5830 directs the flow of execution from starting operation 5000 to operation 5832. Operation 5832 performs maintaining a market position database. Arrow 5834 directs execution from operation 5832 to operation 5836. Operation 5836 terminates the operations of this flowchart.

FIG. 25B depicts a detail flowchart of operation 5832 of FIG. 25A for maintaining the market position database.

Arrow 5850 directs the flow of execution from starting operation 5832 to operation 5852. Operation 5852 performs maintaining at least one market position containing at least one of the market intervals. Arrow 5854 directs execution from operation 5852 to operation 5856. Operation 5856 terminates the operations of this flowchart.

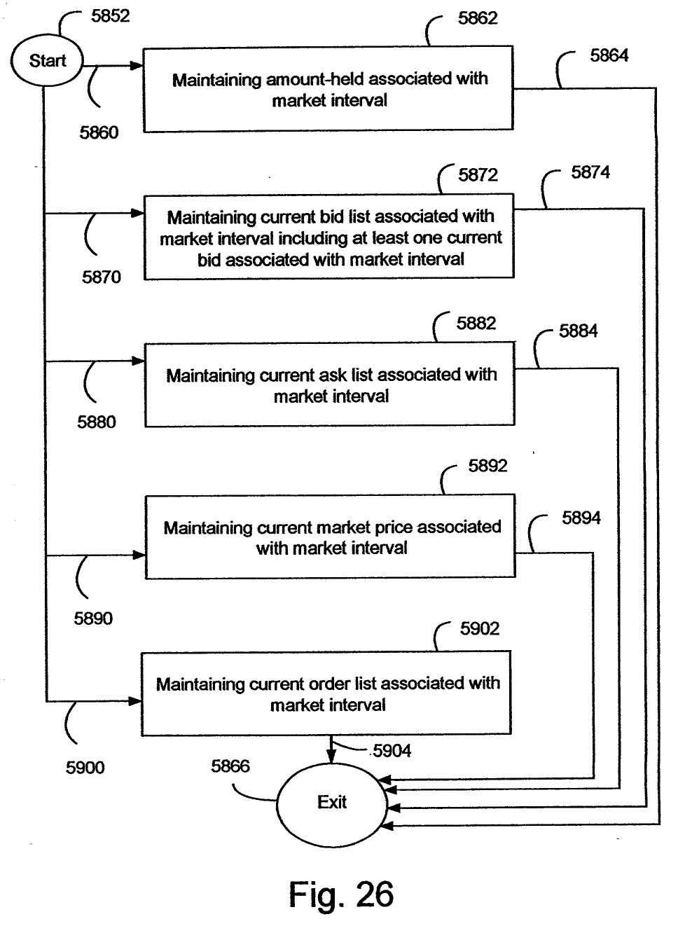

FIG. 26 depicts a detail flowchart of operation 5852 of FIG. 25B for maintaining the market position.

Arrow 5860 directs the flow of execution from starting operation 5852 to operation 5862. Operation 5862 performs maintaining an amount-held associated with the market interval. Arrow 5864 directs execution from operation 5862 to operation 5866. Operation 5866 terminates the operations of this flowchart.

Arrow 5870 directs the flow of execution from starting operation 5852 to operation 5872. Operation 5872 performs maintaining a current bid list associated with the market interval including at least one current bid associated with the market interval. Arrow 5874 directs execution from operation 5872 to operation 5866. Operation 5866 terminates the operations of this flowchart.

Arrow 5880 directs the flow of execution from starting operation 5852 to operation 5882. Operation 5882 performs maintaining a current ask list associated with the market interval including at least one ask associated with the market interval. Arrow 5884 directs execution from operation 5882 to operation 5866. Operation 5866 terminates the operations of this flowchart.

Arrow 5890 directs the flow of execution from starting operation 5852 to operation 5892. Operation 5892 performs maintaining a current market price associated with the market interval. Arrow 5894 directs execution from operation 5892 to operation 5866. Operation 5866 terminates the operations of this flowchart.

Arrow 5900 directs the flow of execution from starting operation 5852 to operation 5902. Operation 5902 performs maintaining a current order list associated with the market interval. Arrow 5904 directs execution from operation 5902 to operation 5866. Operation 5866 terminates the operations of this flowchart.

Certain embodiments of the invention support at least one of the operations of FIG. 26.

Note that at least one of the market intervals contains an AC power transfer product type as the fungible, ephemeral commodity and contains the location as a first of the nodes directed to a second of the nodes of the AC power network node collection.

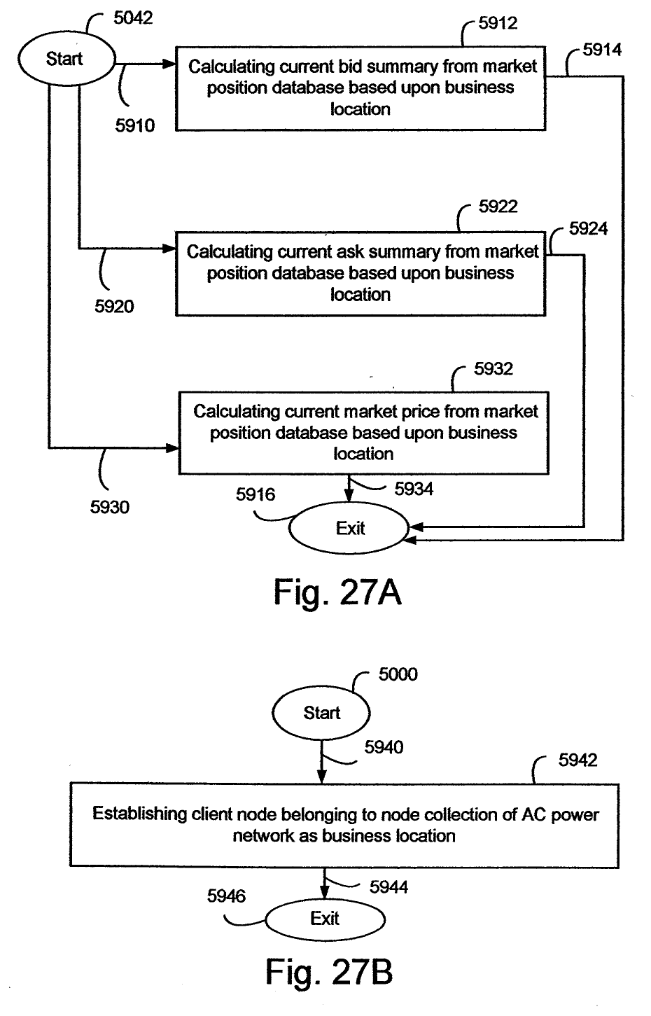

FIG. 27A depicts a detail flowchart of operation 5042 of FIG. 4 for maintaining the local market position portfolio.

Arrow 5910 directs the flow of execution from starting operation 5042 to operation 5912. Operation 5912 performs calculating the current bid summary from the market position database based upon the business location. Arrow 5914 directs execution from operation 5912 to operation 5916. Operation 5916 terminates the operations of this flowchart.

Arrow 5920 directs the flow of execution from starting operation 5042 to operation 5922. Operation 5922 performs calculating the current ask summary from the market position database based upon the business location. Arrow 5924 directs execution from operation 5922 to operation 5916. Operation 5916 terminates the operations of this flowchart.

Arrow 5930 directs the flow of execution from starting operation 5042 to operation 5932. Operation 5932 performs calculating the current market price from the market position database based upon the business location. Arrow 5934 directs execution from operation 5932 to operation 5916. Operation 5916 terminates the operations of this flowchart.

FIG. 27B depicts a detail flowchart of operation 5000 of FIGS. 2A-2E for the method of using the transaction system.

Arrow 5940 directs the flow of execution from starting operation 5000 to operation 5942. Operation 5942 performs establishing a client node belonging to the node collection of the AC power network as the business location. Arrow 5944 directs execution from operation 5942 to operation 5946. Operation 5946 terminates the operations of this flowchart.

Note that the operations of FIG. 27A may each be further based upon the flowgate collection.

The market interval may contain the AC power transfer product type as the fungible, ephemeral commodity and further, the market interval may contain an AC power transfer point-to-point product type as the fungible, ephemeral commodity.

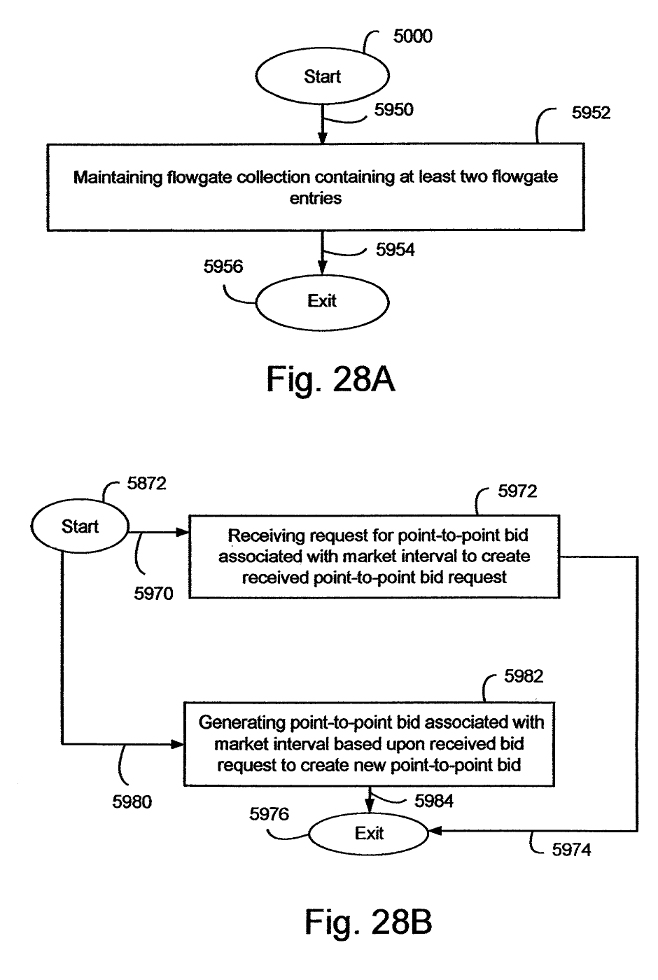

FIG. 28A depicts a detail flowchart of operation 5000 of FIGS. 2A-2E for the method of using the transaction system.

Arrow 5950 directs the flow of execution from starting operation 5000 to operation 5952. Operation 5952 performs maintaining a flowgate collection containing at least two flowgate entries. Arrow 5954 directs execution from operation 5952 to operation 5956. Operation 5956 terminates the operations of this flowchart.

Each flowgate entry contained in the flowgate collection may include a factor, a from-node of the node collection and a to-node of the node collection.

For each of the flowgate entries contained in the flowgate collection, at least one of the market intervals contains the AC power transfer product type as the fungible, ephemeral commodity and the location coinciding with the flowgate entry.

Note that as new transmission resources become available, the flowgate collection may be altered. Note also that if transmission resources become damaged, as for instance may result from a hurricane, the flowgate collection may also be altered.

FIG. 28B depicts a detail flowchart of operation 5872 of FIG. 26 for maintaining the current bid list.

Arrow 5970 directs the flow of execution from starting operation 5872 to operation 5972. Operation 5972 performs receiving a request for a point-to-point bid associated with the market interval to create a received point-to-point bid request. Arrow 5974 directs execution from operation 5972 to operation 5976. Operation 5976 terminates the operations of this flowchart.

Arrow 5980 directs the flow of execution from starting operation 5872 to operation 5982. Operation 5982 performs generating a point-to-point bid associated with the market interval based upon the received bid request to create a new point-to-point bid associated with the market interval. Arrow 5984 directs execution from operation 5982 to operation 5976. Operation 5976 terminates the operations of this flowchart.

Note that certified client market makers 1440 may actively use the operations of FIG. 28B.

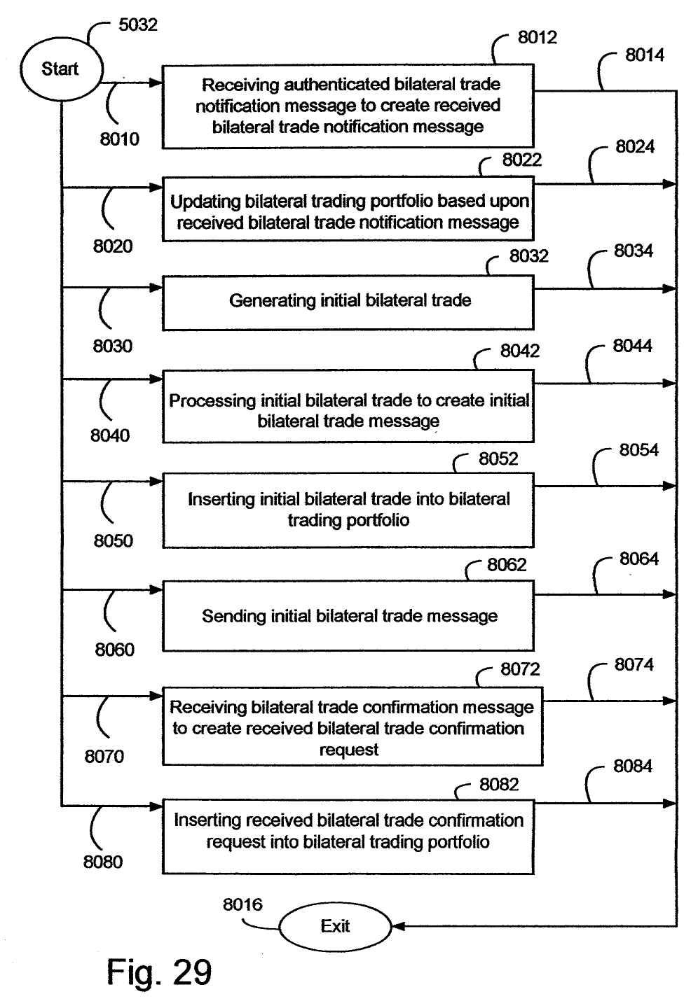

FIG. 29 depicts a detail flowchart of operation 5032 of FIG. 4 for managing the bilateral trading portfolio.

Arrow 8010 directs the flow of execution from starting operation 5032 to operation 8012. Operation 8012 performs receiving an authenticated bilateral trade notification message to create a received bilateral trade notification message. Arrow 8014 directs execution from operation 8012 to operation 8016. Operation 8016 terminates the operations of this flowchart.

Arrow 8020 directs the flow of execution from starting operation 5032 to operation 8022. Operation 8022 performs updating the bilateral trading portfolio based upon the received bilateral trade notification message. Arrow 8024 directs execution from operation 8022 to operation 8016. Operation 8016 terminates the operations of this flowchart.

Arrow 8030 directs the flow of execution from starting operation 5032 to operation 8032. Operation 8032 performs generating an initial bilateral trade. Arrow 8034 directs execution from operation 8032 to operation 8016. Operation 8016 terminates the operations of this flowchart.

Arrow 8040 directs the flow of execution from starting operation 5032 to operation 8042. Operation 8042 performs processing the initial bilateral trade to create an initial bilateral trade message. Arrow 8044 directs execution from operation 8042 to operation 8016. Operation 8016 terminates the operations of this flowchart.

Arrow 8050 directs the flow of execution from starting operation 5032 to operation 8052. Operation 8052 performs inserting the initial bilateral trade into the bilateral trading portfolio. Arrow 8054 directs execution from operation 8052 to operation 8016. Operation 8016 terminates the operations of this flowchart.

Arrow 8060 directs the flow of execution from starting operation 5032 to operation 8062. Operation 8062 performs sending the initial bilateral trade message. Arrow 8064 directs execution from operation 8062 to operation 8016. Operation 8016 terminates the operations of this flowchart.

Arrow 8070 directs the flow of execution from starting operation 5032 to operation 8072. Operation 8072 performs receiving a bilateral trade confirmation message to create a received bilateral trade confirmation request. Arrow 8074 directs execution from operation 8072 to operation 8016. Operation 8016 terminates the operations of this flowchart.

Arrow 8080 directs the flow of execution from starting operation 5032 to operation 8082. Operation 8082 performs inserting the received bilateral trade confirmation request into the bilateral trading portfolio. Arrow 8084 directs execution from operation 8082 to operation 8016. Operation 8016 terminates the operations of this flowchart.

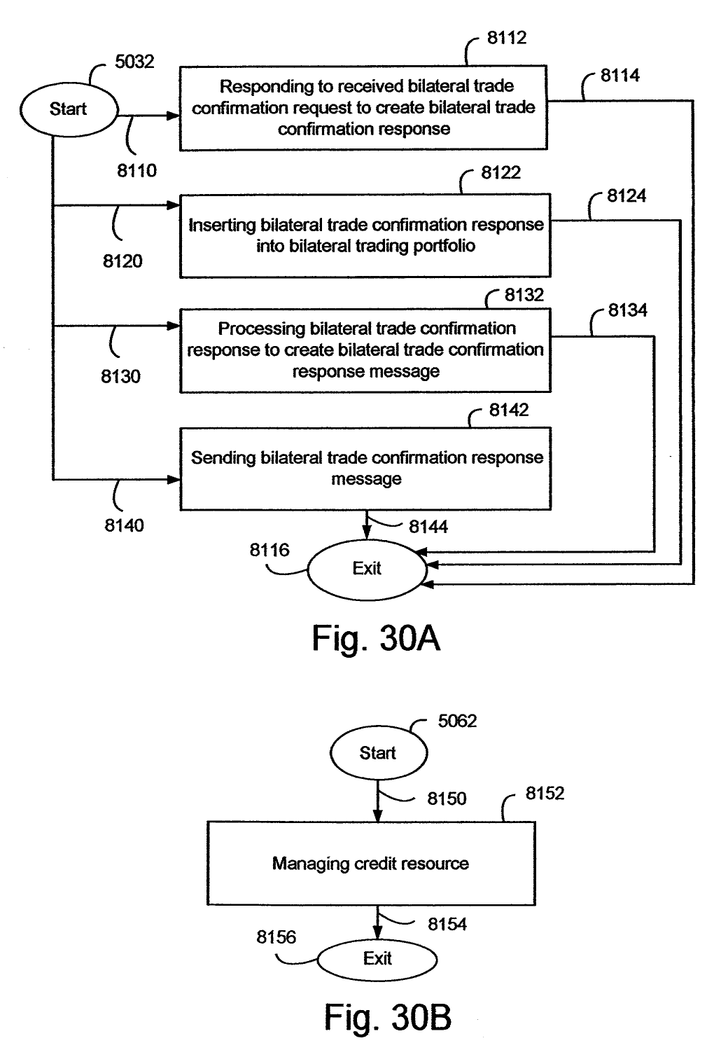

FIG. 30A depicts a detail flowchart of operation 5032 of FIG. 4 for managing the bilateral trading portfolio.

Arrow 8110 directs the flow of execution from starting operation 5032 to operation 8112. Operation 8112 performs responding to the received bilateral trade confirmation request to create a bilateral trade confirmation response. Arrow 8114 directs execution from operation 8112 to operation 8116. Operation 8116 terminates the operations of this flowchart.

Arrow 8120 directs the flow of execution from starting operation 5032 to operation 8122. Operation 8122 performs inserting the bilateral trade confirmation response into the bilateral trading portfolio. Arrow 8124 directs execution from operation 8122 to operation 8116. Operation 8116 terminates the operations of this flowchart.

Arrow 8130 directs the flow of execution from starting operation 5032 to operation 8132. Operation 8132 performs processing the bilateral trade confirmation response to create a bilateral trade confirmation response message. Arrow 8134 directs execution from operation 8132 to operation 8116. Operation 8116 terminates the operations of this flowchart.

Arrow 8140 directs the flow of execution from starting operation 5032 to operation 8142. Operation 8142 performs sending the bilateral trade confirmation response message. Arrow 8144 directs execution from operation 8142 to operation 8116. Operation 8116 terminates the operations of this flowchart.

FIG. 30B depicts a detail flowchart of operation 5062 of FIG. 4 for managing the credit resource collection, for each of the credit resources of the credit resource collection.

Arrow 8150 directs the flow of execution from starting operation 5062 to operation 8152. Operation 8152 performs managing the credit resource. Arrow 8154 directs execution from operation 8152 to operation 8156. Operation 8156 terminates the operations of this flowchart.

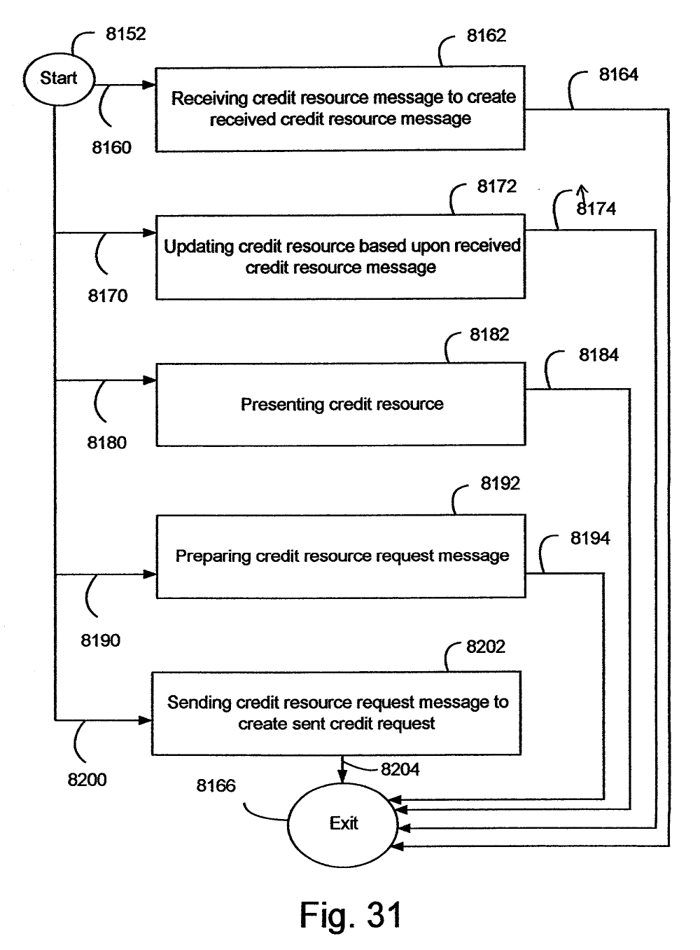

FIG. 31 depicts a detail flowchart of operation 8152 of FIG. 30B for managing the credit resource, for at least one of the credit resources of the credit resource collection.

Arrow 8160 directs the flow of execution from starting operation 8152 to operation 8162. Operation 8162 performs receiving a credit resource message to create a received credit resource message. Arrow 8164 directs execution from operation 8162 to operation 8166. Operation 8166 terminates the operations of this flowchart.

Arrow 8170 directs the flow of execution from starting operation 8152 to operation 8172. Operation 8172 performs updating the credit resource based upon the received credit resource message. Arrow 8174 directs execution from operation 8172 to operation 8166. Operation 8166 terminates the operations of this flowchart.

Arrow 8180 directs the flow of execution from starting operation 8152 to operation 8182. Operation 8182 performs presenting the credit resource. Arrow 8184 directs execution from operation 8182 to operation 8166. Operation 8166 terminates the operations of this flowchart.

Arrow 8190 directs the flow of execution from starting operation 8152 to operation 8192. Operation 8192 performs preparing a credit resource request message. Arrow 8194 directs execution from operation 8192 to operation 8166. Operation 8166 terminates the operations of this flowchart.

Arrow 8200 directs the flow of execution from starting operation 8152 to operation 8202. Operation 8202 performs sending the credit resource request message to create a sent credit request. Arrow 8204 directs execution from operation 8202 to operation 8166. Operation 8166 terminates the operations of this flowchart.

Note that one or more of the operations of FIG. 31 may act as refinements of one or more of the operations of FIG. 5B and/or act as a refinement of operation 5212 of FIG. 5A.

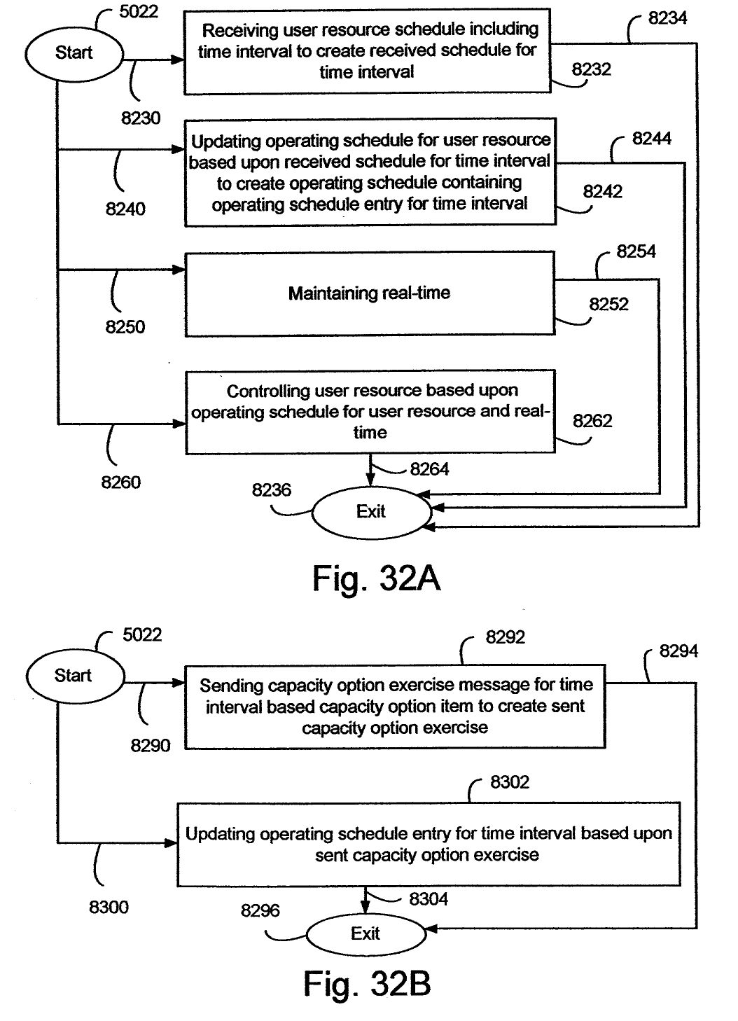

FIG. 32A depicts a detail flowchart of operation 5022 of FIG. 4 for managing the user resource.

Arrow 8230 directs the flow of execution from starting operation 5022 to operation 8232. Operation 8232 performs receiving a user resource schedule including a time interval to create a received schedule for the time interval. Arrow 8234 directs execution from operation 8232 to operation 8236. Operation 8236 terminates the operations of this flowchart.

Arrow 8240 directs the flow of execution from starting operation 5022 to operation 8242. Operation 8242 performs updating an operating schedule for the user resource based upon the received schedule for the time interval to create the operating schedule containing an operating schedule entry for the time interval. Arrow 8244 directs execution from operation 8242 to operation 8236. Operation 8236 terminates the operations of this flowchart.

Arrow 8250 directs the flow of execution from starting operation 5022 to operation 8252. Operation 8252 performs maintaining a real-time. Arrow 8254 directs execution from operation 8252 to operation 8236. Operation 8236 terminates the operations of this flowchart.

Arrow 8260 directs the flow of execution from starting operation 5022 to operation 8262. Operation 8262 performs controlling the user resource based upon the operating schedule for the user resource and based upon the real-time. Arrow 8264 directs execution from operation 8262 to operation 8236. Operation 8236 terminates the operations of this flowchart.

Note that a market trading system component and a scheduling system component within the transaction system may use the same real-time clocking scheme, or separate and distinct real-time clocking schemes. This will effect operating the equipment usage item 5592, maintaining the market window 5712, by way of example. The market window preferably closes long enough before the real-time it refers to, so that all commitments are scheduled, and those schedules received by the certified client reliably.

The operating schedule entry for the time interval contained in the operating schedule for the user resource may include a capacity option item.

FIG. 32B depicts a detail flowchart of operation 5022 of FIG. 4 for managing the user resource.

Arrow 8290 directs the flow of execution from starting operation 5022 to operation 8292. Operation 8292 performs sending a capacity option exercise message for the time interval based the capacity option item to create a sent capacity option exercise. Arrow 8294 directs execution from operation 8292 to operation 8296. Operation 8296 terminates the operations of this flowchart.

Arrow 8300 directs the flow of execution from starting operation 5022 to operation 8302. Operation 8302 performs updating the operating schedule entry for the time interval based upon the sent capacity option exercise. Arrow 8304 directs execution from operation 8302 to operation 8296. Operation 8296 terminates the operations of this flowchart.

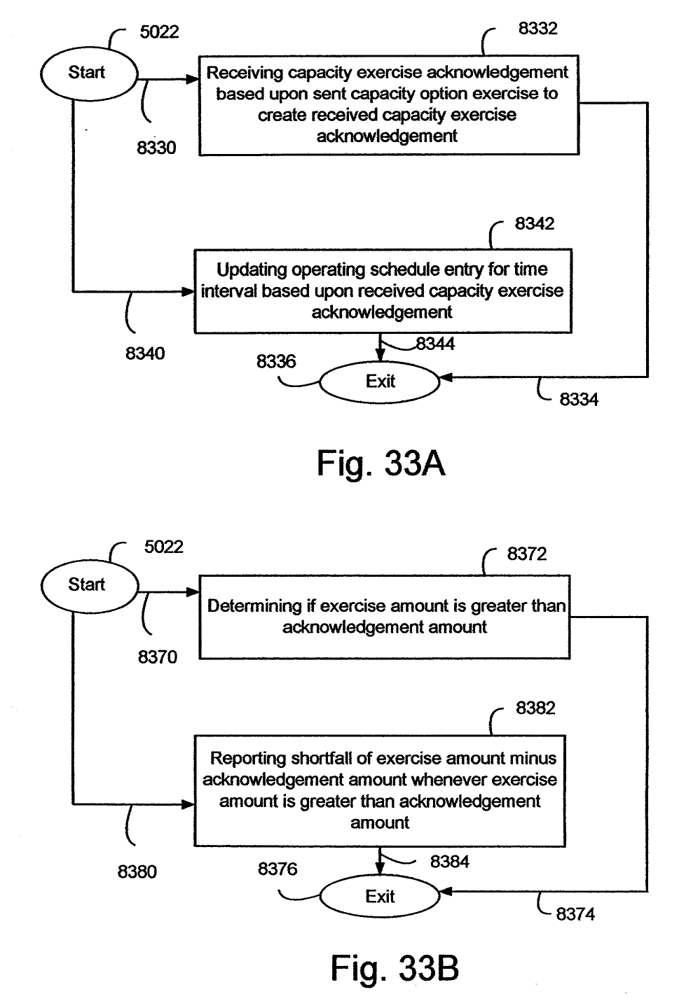

FIG. 33A depicts a detail flowchart of operation 5022 of FIG. 4 for managing the user resource.

Arrow 8330 directs the flow of execution from starting operation 5022 to operation 8332. Operation 8332 performs receiving a capacity exercise acknowledgment based upon the sent capacity option exercise to create a received capacity exercise acknowledgment. Arrow 8334 directs execution from operation 8332 to operation 8336. Operation 8336 terminates the operations of this flowchart.

Arrow 8340 directs the flow of execution from starting operation 5022 to operation 8342. Operation 8342 performs updating the operating schedule entry for the time interval based upon the received capacity exercise acknowledgment. Arrow 8344 directs execution from operation 8342 to operation 8336. Operation 8336 terminates the operations of this flowchart.

In certain embodiments of the invention, a sent capacity option exercise includes an exercise amount and the received capacity exercise acknowledgment includes an acknowledgment amount.

FIG. 33B depicts a detail flowchart of operation 5022 of FIG. 4 for managing the user resource.

Arrow 8370 directs the flow of execution from starting operation 5022 to operation 8372. Operation 8372 performs determining if the exercise amount is greater than the acknowledgment amount. Arrow 8374 directs execution from operation 8372 to operation 8376. Operation 8376 terminates the operations of this flowchart.

Arrow 8380 directs the flow of execution from starting operation 5022 to operation 8382. Operation 8382 performs reporting a shortfall of the exercise amount minus the acknowledgment amount whenever the exercise amount is greater than the acknowledgment amount. Arrow 8384 directs execution from operation 8382 to operation 8376. Operation 8376 terminates the operations of this flowchart.

Note that a market trade may be associated with at least one of said market intervals of said fungible, ephemeral commodity by said certified client with a member of the trade specification collection.

A trade specification collection may include a bid specification, an ask specification and a commitment specification. Each of these specifications may include an amount and price.

Additionally any of these specifications may refer to a capacity option which would include at least an exercise price.

A commitment specification may further include references to one or more other certified clients participating in the commitment.

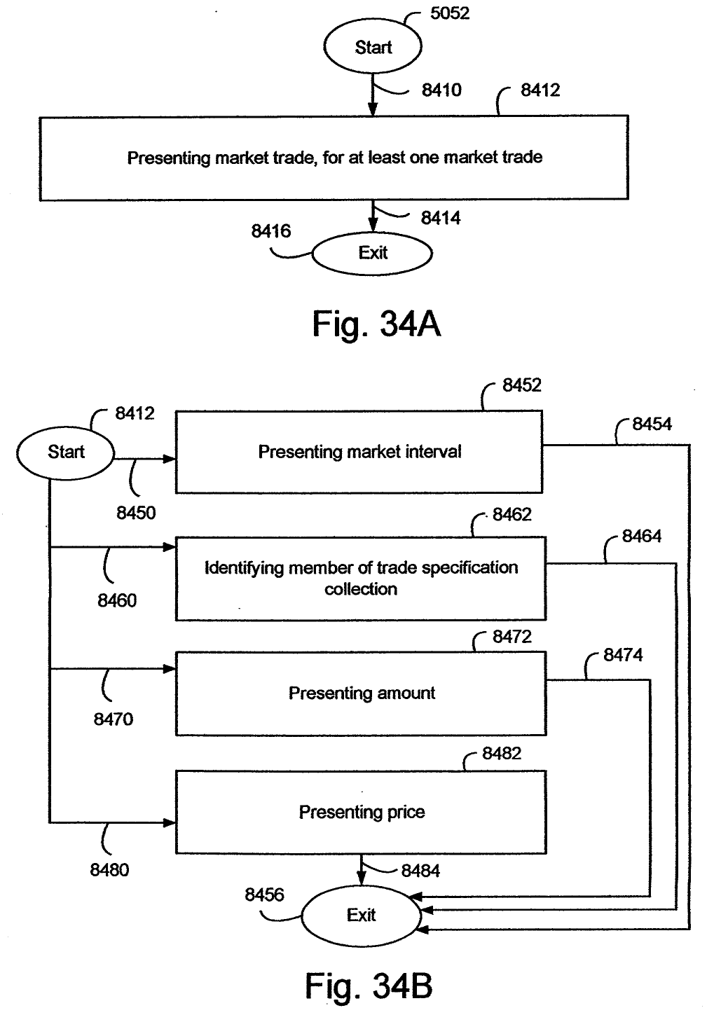

FIG. 34A depicts a detail flowchart of operation 5052 of FIG. 4 for managing said market trade collection.

Arrow 8410 directs the flow of execution from starting operation 5052 to operation 8412. Operation 8412 performs presenting said market trade, for at least one of said market trades. Arrow 8414 directs execution from operation 8412 to operation 8416. Operation 8416 terminates the operations of this flowchart.

FIG. 34B depicts a detail flowchart of operation 8412 of FIG. 34A for presenting said market trade, for at least one of said market trades.

Arrow 8450 directs the flow of execution from starting operation 8412 to operation 8452. Operation 8452 performs presenting said market interval. Arrow 8454 directs execution from operation 8452 to operation 8456. Operation 8456 terminates the operations of this flowchart.

Arrow 8460 directs the flow of execution from starting operation 8412 to operation 8462. Operation 8462 performs identifying said member of said trade specification collection. Arrow 8464 directs execution from operation 8462 to operation 8456. Operation 8456 terminates the operations of this flowchart.

Note that identifying the trade specification collection member may be achieved by at least any of the following: a visual token or icon located near the presentation of the trade; a columnar region in which all the market trades for that specification member are listed; and a color coding of a market trade based upon the specification collection membership.

Arrow 8470 directs the flow of execution from starting operation 8412 to operation 8472. Operation 8472 performs presenting said amount. Arrow 8474 directs execution from operation 8472 to operation 8456. Operation 8456 terminates the operations of this flowchart.

Arrow 8480 directs the flow of execution from starting operation 8412 to operation 8482. Operation 8482 performs presenting said price. Arrow 8484 directs execution from operation 8482 to operation 8456. Operation 8456 terminates the operations of this flowchart.

Note that as used herein, presentation of a market trade to a certified client, who is a software agent, may include the operations of FIG. 34B asserting facts to the software agent.

In many circumstances, the identification of other certified clients involved in at least the commitment trades can be expected, even though this may not always be the case.

Consider a collective trading situation of a group of small facility operators pooling their resources to trade in a general market such as the virtual trading floor. Such small operators may be unable to individually participate in the general market, due to minimum lot size constraints. In such situations, the individual certified client may not be informed of other trading certified clients, just of the open bids and asks as well as commitments within their collective group.

If flowgates are adopted by any RTO, and gaming were to become a widespread problem, a consensus would quickly develop that forward flowgate markets are not good policy. Market participants clearly want tradable transmission rights, and a way to lock-in energy and transmission costs in a continuously traded forward market.

The invention allows people to trade transmission rights and energy in the form of complete bundles. These complete bundles allow the purchase of delivered energy with a single click; customers no longer need to be aware of the underlying flowgate rights. The system permits the bundles to be large and complicated under the hood, in order to allow every flowgate right, and potential flowgate right, to be traded. LMP accomplishes this, but does so at a cost of forcing participants to trade transmission rights (known as FTRs) at a limited number of discrete times. The invention combines the flexibility of LMP with the benefits of true continuously traded forward markets.

Participants enter bids for the complete bundles through the user interface described throughout that they wish to buy and offers for the complete bundles that they wish to sell. An optimization system is provided that constantly searches for ways to disassemble the bundles that participants wish to sell into their component elements (flowgates and energy) and reassembles them into bundles that participants wish to buy. Any time a set of bundles that participants wish to sell can be reassembled into a set of bundles that other participants wish to buy, and the aggregate bids for the new bundles exceeds the aggregate offers for the old bundles, the optimization system contracts orders for the bundles and performs the disassembly and reassembly.

The optimization system performs some of the same functions that customers could perform manually using the invention's user interface. However, the optimization system automatically searches for all of the ways to recombine the components. It can also search for all the ways to set bid and offer prices on the components, while giving the customer his desired aggregate bid or offer price for the bundle. Therefore, the market can be more liquid, while relieving customers of the task of tracking their holdings of most individual components.

The optimization model itself is, in this implementation, a straightforward linear program (LP). Packages are available that can perform even huge LPs extremely quickly. So, there is no problem having many customers bidding and offering for lots of complex bundles. The LP can reside on a server, and reruns each time a new order is submitted, or every few seconds if orders were coming in more often than every few seconds. Since orders are contracting continuously, the invention provides a true forward market, with prices locked-in at the time of contracting.

Aside from speed, another nice feature of LPs is that they give a shadow price for each constraint. This feature could be used to calculate a price for each component (energy or flowgate) that is being traded “under the hood”. These component prices would always be available, even when the LP was run and nothing contracted. The component prices could be used to calculate bid or offer prices for any bundle a customer might consider buying. In particular, it could be used to generate the “all-in” prices currently displayed in the flowgate demo system energy market screens described throughout. These would be real bid and offer prices, which customers could actually hit or lift if they choose.

How liquid would this market be? As with any market, this depends upon the willingness of customers to post standing bids and offers. However, in this approach, these could be standing bids and offers for bundles (such as the flowgates needed for point-to-point transmission between two locations), rather than just individual flowgates or energy at one location. The system can be formulated in such a way that the components of the bundles being disassembled would not have to correspond exactly to the components of the bundles that are being reassembled. The quantity of each component obtained from disassembly just has to be greater than or equal to the quantity of the same component needed for reassembly. The LP can be designed so any bundle whose components are, in aggregate, more valuable reassembled into other bundles will be reassembled. If some of the components are not needed by the new bundles (that is, they currently have zero value), the owner of the old bundle would get to keep them and could post standing offers to sell them later.

Some of the benefits of the invention are as follows:

a) It should pass muster on the gaming issue; all flowgates and potential flowgates could be traded.

b) The RTO would not need to determine which flowgates are “commercially significant”, the market would make this determination by assigning zero value to the non-commercially significant ones.

c) The ability of the optimization system to search numerous possible ways of disassembling and reassembling customer bundles should lead to a more liquid market.

d) Most customers would not need to be concerned with individual flowgates; these would reside “under the hood”. The user interface could be simple, and similar to what is in the flowgate demo.

e) It provides a solution to the chicken-or-the-egg problem often encountered in trading transmission—by the time you get one component that you need to do a trade, some other component may no longer be available

f) There would be no need for FTRs or “registered trades” or other instruments for long-term hedging.

g) There would be no need for a distinct initial flowgate auction; customers and market-makers will simply file bids for the long-term deals they wish to do, or expect to facilitate for others, while the RTO will file offers for all flowgates expected to be available. The optimization runs the first time exactly as it will run later.

The invention provides a participant with a ex ante quote for any point-to-point transmission right at any time. The optimization system calculates this quote based on the standing bids and offers for other point-to-point transmission rights, or flowgates, currently posted in the system by other participants or market makers. A participant who found the quote attractive places an order at any time and is assured that the order will contract at the quoted price. Participants can therefore negotiate energy deals on any terms they wished with each other, using the transmission quotes provided by the optimization system to guide them to the best deal. The invention can also provide a joint market for energy and transmission—it provides quotes for energy at any location, as well as transmission between locations. The invention allows a true fully competitive energy market.

Mathematical Appendix

This section presents the optimization approach mathematically.

Let i be a bundle of energy and flowgate rights, requiring components 1,2, . . . , n in amounts fi1,fi2, . . . , fin to deliver a megawatt of energy. Typically, the components of i would consist of the transmission rights necessary to move energy from one point in the network to another, or energy at one point in the network plus the transmission rights needed to deliver it to some other point. In the former case, the fi1, fi2, . . . , fin would be the distribution factors for the point to point transaction, showing how much of each flowgate is needed to move one megawatt of energy. The bundle i could also represent individual flowgates or individual energy offers, which customers who wished to be market makers could offer. In this case, one of the fij's would be equal to one, and the others would be zero.

Let yi be the quantity of bundle i that the customer buys or sells. The yi's are positive if the customer is buying, and negative if the customer is selling. These are what we want to solve for. Associated with each bundle i is a bid or offer price pi, at which the customer is willing to buy or sell.

The goal of the system then becomes to maximize value to customers. Mathematically, we seek to maximize:

p1*y1+p2*y2+ . . . +pn*yn,

subject to the constraints:

yi>=0 for bundles i the customer wishes to buy; and

yi<=0 for bundles i the customer wishes to sell.

We also need to limit the yi's to the quantity the customer wishes to buy or sell, so:

yi<=qbi, where qbi is the maximum quantity that the customer wishes to buy; and

yi>=−qsi, where qsi is the maximum quantity that the customer wishes to sell.

To illustrate the crudest version of the system, assume all the yi's contain only component, and that this component has an fi1=1, so people are simply trading the one component. Then we can add one more constraint, which simply says

f11*y1+f21*y2+ . . . fn1*yn=0, or

y1+y2+ . . . +yn=0. (1)

This constraint simply says that the amount of bundle 1 bought (yi>0) must be equal the amount of bundle 1 sold (yi<0). Performing this maximization exactly as stated so far would simply tell the LP to sell y1 as long as the price any seller is bidding is greater than the price any buyer is offering.

However, we want to have bundles that consist of multiple products in varying proportions. In this case, we must replace constraint (1) with constraints of the form:

f1j*y1+f2j*y2+ . . . +fnj*y3<=0, (2)

for each component j (flowgate or energy at some location). The “less than or equal to” here allows for the possibility that there is a surplus of the flowgate once the bundles are broken up and reassembled.

A numerical example might make this easier. Suppose bundle 1 consists of the flowgates required to move one megawatt of energy from Grand Coulee to San Jose. The bundle includes 0.9 MW of COI flowgate, −0.2 MW of Path 15 flowgate, and 0.1 MW of AZ-CA flowgate. The customer who wishes to buy this bundle is bidding $10 per MW. In this case, p1=$10, f11=0.9 (the COI flowgate), f12=−0.2 (the Path 15 flowgate), and f13=0.1 (the AZ-CA flowgate). y1 are the megawatts of capacity from Grand Coulee to San Jose that the customer ends up buying. If the customer wishes to buy 50 MW, then qb1=50 MW.

Suppose that another bundle consists of the flowgates required to move energy from Grand Coulee to Los Angeles, which another customer wishes to sell. This bundle includes 0.8 MW of COI flowgate, 0.8 MW of Path 15 flowgate, and 0.2 MW of the AZ-CA flowgate. The customer who wishes to sell this bundle is asking $5 per MW. In this case, p2=$5, f21=0.8 (the COI flowgate), f22=0.8 (the Path 15 flowgate), f23=0.2 (the AZ-CA flowgate). y2 are the megawatts of capacity from Grand Coulee to San Jose that the customer ends of selling. If the customer wishes to sell 100 MW, then qs2=100 MW.

In this example, the complete formulation of the problem would be:

| | | |
|---|---|---|
| Maximize | $10 * y1 + $5 * y2 | (objective function) |
| Subject to: | Y1 >= 0 | (customer is buying bundle 1) |
| | Y2 <= 0 | (customer is selling bundle 2) |
| | Y1 <= 50 | (customer wishes to buy 50 MW of |
| | | bundle 1) |
| | Y2 >= −100 | (customer wishes to sell 100 MW |
| | | of bundle 2) |
| | .9 * y1 + .8 * y2 <= 0 | (COI released must exceed COI |
| | | reused) |
| | −.2 * y1 + .8 * y2 <= 0 | (Path 15 released must exceeded |
| | | Path 15 reused) |
| | .1 * y1 + .2* y2 <= 0 | (AZ-CA released must exceed AZ- |
| | | CA reused). |

This example is simple enough to work by hand. The resulting contract will be y1=50 MW (that is, 50 MW of bundle 1 bought) and y2=−56.25 MW (that is, 56.25 MW of bundle 2 sold). The COI flowgate is the binding constraint that will have value, with 45 MW changing hands. The Path 15 and AZ-CA constraints are not binding, implying that these flowgates have no value. In this example, the owner of bundle 2 gets to keep a leftover 45 MW of Path 15, since Path 15 is not needed for bundle 1 at all. The owner of bundle 2 also gets to keep 6.25 MW of AZ-CA, since the 50 MW of bundle 1 requires only 5 MW of the 11.25 MW of AZ-CA released by the 56.25 MW of bundle 2. The new owner of bundle 1 gets to keep 10 MW of counterflow rights on Path 15, which his/her bundle has created.

The following is an exemplary specification for the user interface, called Market Window 2002, as previously mentioned that allows users to perform trades:

1. The General Framework

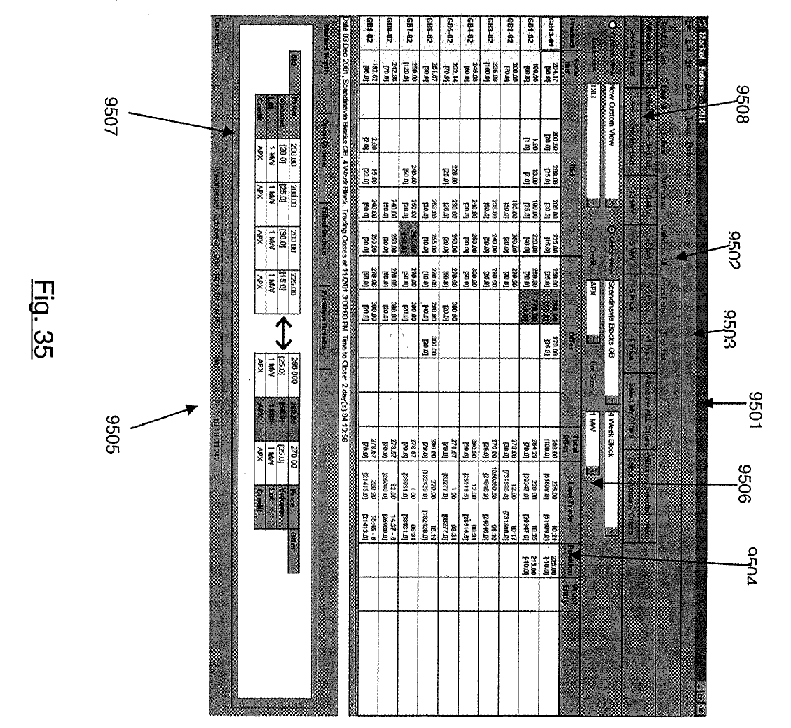

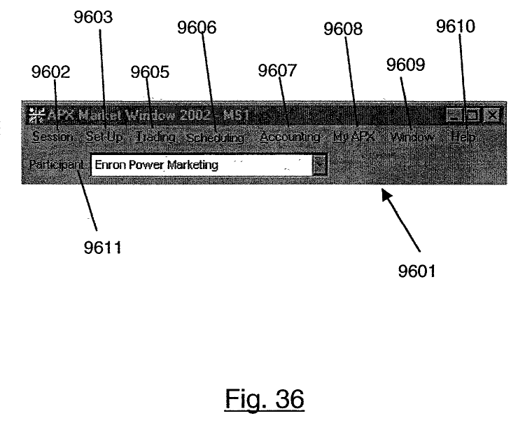

Referring to FIG. 35, Market Window 2002 uses a multi-window format 9501. Users control the windows that appear, as well as the overall configuration of the system through a main menu bar, which is always available. The screens that display data and allow the user to enter orders and other information appear in separate windows. The remainder of this Section 1 describes the main menu bar and the common features of each of the screens.

1.1 The Main Menu

The Main Menu bar 9502 appears in its own window. Although it may be shrunk to an icon, it is always on the user's screen.

1.11 The Title Bar

At the top of Main Menu bar 9502, and other Market Window 2002 windows, is a title bar 9503. Items on this Main Menu bar are, from left to right:

APX Market Window 2002 Logo

Product Name “APX Market Window 2002”—The Market Window 2002 logo and product name is configurable at compile time for other logos and names, in order to enable the Market Window 2002 to be used where APX is providing Application Service Provider (ASP) services.

Product Type—Shown on the Market Screen Only Download logo, product name, and click throughs are login ID sensitive and loaded at runtime. Depending upon the login id, the resale relationship is clear and the interface is branded to reflect this. Changing the relationship is then a server-side change, and does not require another release process. Registration would identify the “skin” to be used—from the server based on the login ID.

Account ID—The user's login ID. This allows the user to have multiple copies of the Market Window 2002 open on their desktop without confusion as to which windows go with which login Ids.

MS Windows Window Buttons

Minimize Button—shrinks Market Window 2002 to a MS Windows taskbar button.

Full/Reduce Button—expands a “reduced” Market Window 2002 to full-screen or reduces a “full” Market Window 2002 to its previous size.

Exit Button—signals the Market Engine to terminate the session, disconnects from TCP/IP and closes the Market Window 2002.

1.2 Menu Bar

With respect to FIG. 36, the menu bar 9601 provides eight options, which are discussed in the sections below.

1.2.1 Session Menu 9602

The session menu 9602 drops down a menu containing the following options:.

Logoff/Login—If the user is logged in, this option says “Logoff” and when clicked, initiates the logoff process described in Section 1.12. If the user is not logged in, this button says “Login” and when clicked initiates the login process described in Section 1.7.

Protocol—Allows the user to specify whether to communicate with the server using HTTPS or Native APX protocols. HTTPS is the preferred protocol, being an industry standard. Native APX may be necessary in some environments where HTTPS is not supported.

Exit—signals Market Engine to terminate the session, disconnects from the TCP/IP network, and closes the Market Window 2002. Clicking the ‘X’ button on the title bar is equivalent to clicking Exit.

1.2.2 Set-Up Menu 9603

Provides access to five Set-Up screens, which are described in detail in Section 6. These are screens provide information on the status of the user's account and, in some cases, allow the user to update this account information. The user may have one of each of these screens open at the same time.

1.2.3 Trading Menu 9605

Provides access to the screens commonly used for trading. The Market screen is described in Section 2, the Order Summary screen is described in Section 4, and the Reports are described in Section 5. Only reports applicable to trading are available on the Trading Menu; these are identified in Section 5. The user may have multiple Market screens and multiple Reports open at the same time, but only one Order Summary screen at a time is allowed.

1.2.4 Scheduling Menu 9606

Provides access to the screens commonly used for scheduling. The Schedule Manager screen is described in Section 3, the Order Summary screen is described in Section 4, and the Reports are described in Section 5. Only reports applicable to scheduling are available through the Scheduling Menu; these are identified in Section 5. The user may have multiple Schedule Manager screens and multiple Reports open at the same time, but only one Order Summary screen at a time is allowed. Note that the Order Summary screen may be invoked from either the Trading Menu or the Scheduling Menu, since it is applicable to both functions.

1.2.5 Accounting 9607

Clicking this option invokes a browser, which takes the user to the APX Settlements web site.

1.2.6 My APX 9608

Clicking this option invokes a browser, which takes the user to their My APX page on the APX web site. The My APX page may be configured by the user to display a variety of current market data.

1.2.7 Window Menu 9609

This menu displays a list of the currently open windows. Windows are identified on the menu by the name of the screen. For the Market screen, Schedule Manager screen, and Order Summary screen, the name of the custom view displayed on each window, if any, is also shown. The user may click on a window to bring it to the foreground.

1.2.8 Help 9610

All help features (except about) are maintained as web pages and are specific to the language setting of the user's OS.

Set the on-line help URL specifically for each login through the registration process. This allows customizing on line help to market, resale/partner, and language.

Online Help—Links to an indexed, online user's guide.

Tutorials—links to an online tutorial guide.

About—opens a popup window listing the name of program, version, and any necessary legal notices.

1.2.9 Participant Drop-Down Menu 9611

For APX employee users with “APX Broker” login privileges, a drop-down menu for selecting the participant appears under the Main Menu. The user will see all Market Window 2002 screens as if logged in as the selected participant, and be able to enter orders on behalf of that participant. When the APX Broker places an order on behalf of a participant, the system will record the broker's login as the login that placed the order, just as if it were a login of that participant.

The system remembers the participant selected the last time the user logged-in in the Options file on the user's machine. The next time the user logs in, the Market Window 2002 is set to the same participant. The first time a new user with APX Broker login privileges logs in, the participant may be selected arbitrarily.

The user can configure the pull-down list of participants to limit the participants included, and specify their order, using the Participant Accounts Setup Screen, as described in Section 6.3.5. Each participant can also be assigned a color, which will appear as a background color behind the participant name when that participant is selected. The colors do not need to appear on the drop-down menu itself.

Participants with APX Broker privileges are always viewing the Market Window 2002 from the perspective of a participant. In addition to actual participants, users with APX Broker login privileges may select “Specify Later” as a participant. See Section 2.10.

This feature is extended to users with “APX Operator” login privileges. APX Operators can see all Market Window 2002 screens as if logged in as the selected participant.

1.3 Market Window Screen Menus 9502

Each individual Market Window 2002 screen also contains its own drop-down menu. The choices made through this menu define how the screen is behave. Some of the choices apply only to the selected screen, while others apply to all screens.

The options on the Market Window Screen Menus vary by screen. In this section we discuss only the options that appear on two or more screens. Options that apply only to a single screen are discussed in the Section specifying that screen.

1.3.1 The File Menu

The file menu generally contains two options—Print and Exit.

1.3.1.1 Print

Clicking this option opens the “Print” popup window containing the options below. Pressing Control-P is another way to access this option.

Name—drops down a list of printer choices.

Properties—opens a popup window for setting printer properties, including portrait or landscape page orientation and number of copies. The pop-up window is specific to the selected printer, and is provided by a third-party data grid tool.

Print to file—saves the report to a text file.

Print range—enabling “All” prints the entire screen as it is; enabling “Selection” prints the selected area only. The user may highlight any data area of the grid by clicking and dragging; going beyond the edge of the screen causes it to scroll.

Copies/Collate—works in the usual MS Windows way.

OK—Prints the selected are and closes the Print pop-up window

Cancel—Closes the Print pop-up window without printing.

1.3.1.2 Exit

Clicking this option closes the current window, but does not close any other Windows, such as the Main Menu window. It is equivalent to pressing the ‘X’ in the upper right corner of the screen.

1.3.2 Edit Menu

These functions depend on the user being able to select a rectangular-shaped group of cells in the grid by left-clicking on one corner of the rectangle and dragging to the opposite corner of the rectangle. ‘Cut’, ‘Paste’, and ‘Fill Down’ are available only when the selected group of cells consists entirely of data-entry cells. These options may be grayed-out where one or more of the selected cells is read-only. These options should not be available on screens that do not have data entry cells.

Cut—removes the highlighted data from the grid and stores it in the paste buffer. Pressing Control-X also invokes this option.

Copy—copies the highlighted data in the grid and stores it to the paste buffer. Pressing Control-C also invokes this option.

Paste—pastes any data in the paste buffer to the grid. Note: the cut, copy, and paste functionality should be similar to MS Excel. Users should be able to cut, copy, and paste any highlighted rectangle within the grid. Pressing Control-V also invokes this option.

Fill Down—copies the contents of the top cell in the highlighted section of a column to the rest of the cells in the highlighted section of the column. Pressing Control-F also invokes this option.

Select All—highlights (selects) all the cells in the grid. Pressing Control-A invokes this option.

1.3.3 View Menu

When present, this menu allows the users to invoke screen-specific pop-up menus that display more details on the cells currently highlighted in the grid such as the bid/offer details or previous trades.

1.3.4 Actions Menu

When present, this menu allows the users to take basic actions. These actions may refer to the currently selected cells in the grid. The following options appear on two or more screens.

1.3.4.1 Submit and Submit All

Used to submit (communicate the order to the Market Engine) orders that have been entered in the grid and not yet submitted. ‘Submit’ submits only the orders that have been highlighted by the user, while ‘Submit All’ submits all orders that have been entered by the user. Otherwise, the function of ‘Submit’ and ‘Submit All’ is identical. These options are available in the Market (see Section 2.5.2.1) and Schedule Manager (see Section 3.X.X) screens. Pressing Control-S is equivalent to selecting submit.

1.3.4.2 Resubmit Last

Resubmits the last batch of market orders withdrawn (see Section 4.5.2). This button is available in the Market and Order Summary screens.

1.3.4.3 Withdraw

Withdraws any highlighted market orders from the participant's account.

This button is available only in the Market screen (see below), although a variant “Withdraw/Recall” is available in the Order Summary Screen (see below). Pressing Control-W is equivalent to choosing this option (or the “Withdraw/Recall” option in the Order Summary Screen). Withdrawn orders may be resubmitted using the “Resubmit Last” or “Resubmit” (see Section 4.5.1) bottom buttons.

1.3.4.4 Withdraw All

Withdraws all open market orders once the user has confirmed through the Withdraw All popup window shown below. Whether all open market orders refers to all orders submitted by the current user login or all orders submitted by a participant account is determined by a Global Preferences setting (see Section 1.3.6). This button is available on all screens except the Schedule Manager. Withdrawn orders may be resubmitted using the “Resubmit Last” or “Resubmit” (see Section 4.5.1) bottom buttons.

Clicking the “Withdraw All” bottom button causes the Withdraw All popup window to appear. It contains the following elements:

a. Markets Segments Checklist—checklist displaying all market segments for which the user is registered. The user may select individual markets segments by clicking the appropriate check boxes.

b. Check All Button—Checks all markets. All markets should be checked by default.

Uncheck All Button—Unchecks all markets.

Withdraw—Withdraws orders in the checked APX Markets and closes the Withdraw All pop-up window. If orders were withdrawn, a pop-up message box appears reading “X open market orders from the selected market(s) have been withdrawn.” If the user has any outstanding bilateral orders, the message continues: “Any bilateral orders you wish to withdraw must be withdrawn using the Recall option in the Schedule Manager screen.” Here X is the number of orders withdrawn. The user may click “OK” to close the pop-up message box.

If no orders were withdrawn, the popup message box reads: “No open market orders to withdraw in selected markets”. The user may click “OK” to close the pop-up message box.

In the event that the user clicks the Withdraw button without checking any markets, a pop-up warning message box appears reading “You have not checked any markets. The user may click “OK” to close the pop-up message box and return to the Withdraw All pop-up window.

Cancel—Closes the Withdraw All Popup Window without taking any action. It is equivalent to clicking the ‘X’ in the upper right corner of the Withdraw All popup window.

1.3.5 Tools Menu

When present, this menu allows the users to invoke screen-specific pop-up menus that allow the user to enter data or perform other useful operations, such as order entry and modify orders. This data entry may refer specifically to the cells currently highlighted in the grid.

An Option that always appears on the Tools menu is “Messages”. This option opens the Messages pop-up window (see Section 7).

1.3.6 Preferences

This menu generally includes two options. The first, “Screen Preferences” brings up a set of menus which allows the user to configure the layout of the current screen. The Screen Preferences are specific to each screen.

The second, “Global Preferences”, allows the user to specify several characteristics that define how the Market Window should behave. Global Preferences is available from all screens.

a. Warnings Tab—enables the user to set which situations are to be warned of and which to ignore. All three boxes should be checked by default. See Section 1.7 for an explanation of the first class of warnings. See Section 2.5.2.1 for an explanation of the last two classes of warnings.

ReviewOrdersTab—The user can elect whether to see the “Review/Submit” pop-up window before submitting any order (see Section 2.5.2.1) or withdrawing any order (see Section 2.5.2.3). Both boxes should be checked by default. Users may also elect whether to see the Market Selection pop-up window (see Section 1.3.4.4) before withdrawing all orders. Only users with the “One Click Hit/Take” Registration flag set are allowed to uncheck these boxes. The boxes should be grayed-out for users without these privileges (see Section 1.6).

The user can also instruct the system to print deal confirmation tickets automatically for each APX market and bilateral transaction (see Section 4.5.8). A pull-down menu of available printers allows the user the select the printer on which to print the deal confirmation tickets.

Withdrawing OrdersTab—The tab contains two pairs of radio buttons dealing with withdrawing orders.

If the user is disconnected, the Market Window 2002 automatically attempts to reconnect. If these attempts fail, the first pair of radio buttons allows the user to specify whether or not all orders should be withdrawn. The “Withdraw all orders . . . ” radio button specifies that all open orders should be withdrawn after a user-specified number of minutes. The “User will call . . . ” radio button specifies that orders should not be automatically withdrawn if the connection to the Market Engine fails—the user must call APX Market Operations to have them withdrawn.

A second set of radio buttons allows the user to specify the scope of the “Withdraw All” functionality that is invoked when the user presses the “Withdraw All” button (see Section 1.3.4.4) or when the user is disconnected (see above), and that the user may invoke when logging out (see Section 1.7). Withdrawing only orders for this login is the default. The scope of the “Withdraw All” functionality can be set for a participant account through registration, This allows the radio buttons to be enabled through Registration. If the buttons are not enabled through Registration, then they will appear grayed-out and “Withdraw All” will withdraw only the users own orders.

Sorting Tab—This tab allows the user to configure the sort order of the market segments on pull-down menus, the Screen Options pop-up window, and the “Markets” Set-Up screen. The user“preferences are stored in the Options file for each login on the users computer. The default Options file that is installed with the Market Window will contain a default sort order. As always, this file will be copied to become the Options file for each login the first time the user uses a new login (see Section 1.12).

If the user is registered for market segments that do not appear in the sort ordering in the Options file, these market segments should be listed in alphabetical order after the market segments that are in the Options file. If the user is not registered for market segments that do appear in the sort ordering in the Options file, the missing market segments should not appear in either the drop down menus or the this Sorting Tab. They should be automatically removed from the Options file when the user OK's their Global Preferences.

On each of these tabs, the user may click the “OK” button to save the indicated selections and exit the pop-up window. Alternatively, the user may click the “Cancel” button to close the pop-up window without making any changes to global preferences. Clicking the “Cancel” button is equivalent to clicking the “X” in the upper right corner.

1.3.7 Help

Links user to help information on the current screen. Pressing Control-H or F1 is equivalent to pressing the Help bottom button.

1.4 Status Bar 9505

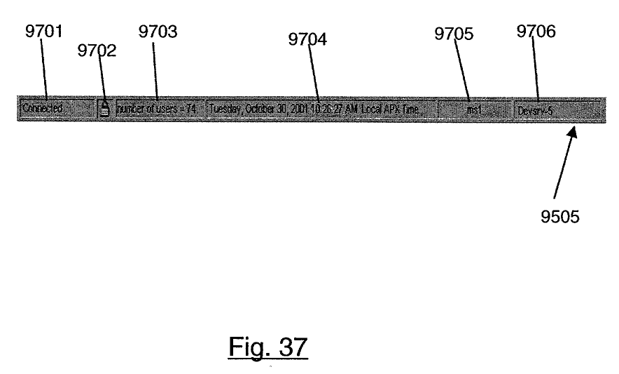

Referring to FIGS. 35 and 37, at the bottom of each screen is a Status Bar 9505, showing information about the current session. Information shown on the Status Bar is as follows.

a. Connected/Disconnected 9701—TCP/IP connection status.

b. Secure Server Icon 9702—Appears when Market Window 2002 is in “secure” mode. Should have tool tip that says “Secure APX Protocol” when Market Window 2002 is in secure mode.

c. Number of Users 9703—Indicates number of users logged onto this server. It is possible to turn off this functionality through Registration.

d. Local APX Time 9704—APX Market date and time converted to local time.

e. Login ID 9705—User's login ID

f. Server Name 9706—The name of the server to which the user is connected.

1.5 Language/Date Configurability

All labels (menus, buttons, column headings, etc.) and pop-up messages are in a database manager, allowing them to be configured to various languages through a database setting. The labels described in this document are used in the “English (United States)” version. The software senses the language setting of the user“computer operating system and sets itself to the appropriate language.

All dates (except the interval labels) aree shown in the ‘long’ or ‘short’ date formats selected through the user's operating system. The date on the status bar is shown in the ‘long’ date format; all other dates should be shown in the ‘short’ date format. The dates in the interval labels are set through configuration of the market segment.

All times, except for the interval labels, are displayed in the format selected through the user's operation system.

1.6 Logging In

When the user clicks on the Market Window 2002 icon, a login screen like the one shown above will appear, allowing the user to enter login, password, and market engine name. The login name and market engine (but not password) used in the last session on this machine should appear by default. The Market Engine line should provide a pull-down menu of previously used Market Engines on this computer, or allow the user to type in the Market Engine directly.

If the user login fails, the Main Menu window should appear with only the “Session”, “My APX”, and “Help” options not greyed out. Using the Session drop down menu, the user can switch between HTTPS and Native APX protocol.

There are two ‘login types’ that are relevant to Market Window 2002 users. Although there are currently some additional login types available in Registration, these are used only by Settlements, the Scheduler, or other functions that do not involve the Market Window 2002. The three login types are listed below:

Trader—Gives access to all Market Window 2002 functionality intended for participant use. All functions described in this specification are available to traders except for those specifically noted as being available only to APX Broker or APX Operator logins.

APX Broker—Gives access to additional functionality designed to allow APX Brokers to view the Market Window 2002 as any participant would see it, and enter orders on behalf of participants. For security reasons, we may want to allow APX Broker logins only from behind the APX firewall.

This incorporates the functionality of the current Operator Window, including the ability to view the current sessions, purge sessions, and send messages to participants. There is also a screen for listing participants with imbalances.

In addition to these three types of logins, the Trader login allows additional flags, which restrict or grant additional privileges. These flags are as follows:

Change Party Selection—Allows the login to change the list of approved counterparties for the participant account (see Section 6.3.2).

Retail Login—Calculates the “Allowance to Buy” and “Allowance to Sell” for the account based on hourly Customer Baseline Load (CBL) files uploaded through a special market window. This flag affects the Market Engine only.

One Click Hit/Take—Allows the login to turn-off the confirmation pop-up windows before submitting or withdrawing/recalling an order (see Section 1.3.6).

Allow Submit Nets—The flag is apparently supposed to enable the “Submit Nets” switch in the Asset Manager screen of Market Window 2000. However, it appears that this capability is always enabled. The corresponding capability in the Market Window 2002 (see Section 3.4.2) is also always enabled, so this flag may be removed.

View Facility Locations—This flag enables a capability in Market Window 2000 to display the location of the facility through which an order was placed in the order depth display. There is no corresponding capability in the initial version of the Market Window 2002. There is, however, no harm in keeping this flag in case we decide to add such a capability in the future. There are currently no participants using this feature.

Disable Market Screen—If this flag is set, the login will not be able to view the Market Screen or enter orders into the any market. This flag does not prevent the login from entering schedules (bilaterals or asset transfers) through the Schedule Manager screen.

Disable Scheduler Screen—If this flag is set, the login will not be able to view the Schedule Manager screen or enter schedules (bilaterals or asset transfers). This flag does not prevent the login from entering orders into a market (APX or external).

Disable Settlements—If this flag is set, the login will not be able to view the participant-specific Settlement pages on the APX website.

Once the user has logged in, the Market Window 2002 restores all the windows that were open at the last logout, with all settings, custom views, and window sizing and locations set as they were. This information is stored in the Options file for the login on the users computer.

1.7 Logging Out

When a user with open APX Market orders in the system logs out, a pop-up warning box will appear reading “You have some open orders. Would you like to withdraw them now?”. The user may click the “Yes” or “No” buttons to close the pop-up warning box. If the user clicks “Yes”, the “Withdraw All” process, as described in Section 1.3.4.4, is invoked. After the user completes the “Withdraw All” process, the user will be logged out. If the user clicks “No”, the user will be logged out directly.

What APX Market orders will prompt the “You have some open orders . . . ” warning depends upon the setting of the second set of “Withdrawing Orders” radio buttons described in Section 1.3.6. If the user has selected “Withdraw All withdraws all APX Market orders for this participant account”, then the warning appears if there are any open APX Market orders in the system for the participant account. If the user has selected “Withdraw All withdraws only APX Market orders for this login”, the the warning appears only if there are open APX Market orders submitted by the current login.

1.8 Self-Upgrading

The Market Window 2002 has a self-upgrading feature. That is, each time the user logs in, the system checks whether any upgrades to the Market Window 2002 software are available from APX beyond the software version that the user currently has. If upgrades are available, they are automatically downloaded and installed before starting up the Market Window 2002. In order to allow the downloading to proceed quickly, only components being upgraded are downloaded.

1.9 Encryption

Communication between the Market Window 2002 and the Market Engine supports the “RSA” Industry Encryption Standard.

1.10 Product Codes

Both Scandinavia and the UK use standardized codes for combinations of market segments, strips, and intervals. This API generates and displays these product codes as needed. They are referred to in numerous places throughout this document.

Product codes are always in the format:

XX[NN]-[Date],

where Date may be YY, DDMMYY, MMDDYY, DDMM, or MMDD.

Here XX is corresponds to a set of alphanumeric characters identifying the market segment and strip combination, while NN represents a sequential counter. If the date format used is YY, the counter is reset to 1 each year on the anniversary of the alignment date. If any other date format is used, the counter is reset to 1 each day at the alignment hour. For example, the fifth weekly interval of 2001 might be designated W05-01 (YY date format). The fifth half-hour block of Feb. 15, 2002 might be designated as HH05-150202 (DDMMYY date format). For ‘interval beginning’ products, the counter is reset for the first interval beginning on or after the alignment hour. For ‘interval ending’ products, the counter is reset for the first interval ending after (but not on) the alignment hour. There may be as many as nine alphanumeric characters in the XX part of the code (upper or lower case), and as many as three numbers in the NN part of the product code, but always at least two (use a leading zero if necessary).

The date is always reset to a new date when the counter is reset. In most cases, the alignment hour will be set to midnight in the time zone of the market, and the new date should correspond to the date that begins at that midnight hour. If the alignment date for the market segment is not midnight in the time zone of the market, then the date to be applied to all intervals beginning on or after (or ending after, for interval ending products) the alignment hour but prior to midnight in the time zone of the market is the following day. For example, if four hour blocks are aligned to 18:00 hours in the time zone of the market, then the four hour block covering 18:00-22:00 in the time zone of the market on Feb. 15, 2002 might be coded 4B1-160202 (DDMMYY date format, but note the 16). The four hour block covering 22:00 on Feb. 15, 2002 to 2:00 on Feb. 16, 2002 might be coded 4B2-160202. The four hour block covering 2:00-6:00 on Feb. 16, 2002 might be coded 4B3-160202, and so on, up to the four hour block covering 14:00 to 18:00 on Feb. 16, 2002. Note that the numbering for the example would be exactly the same regardless of whether the four hour block product is ‘interval beginning’ or ‘interval ending’. Since the four hour block covering 18:00-22:00 on Feb. 16, 2002 starts on or after (or ends after, if it is an interval ending product) the alignment hour of 18:00 but before midnight, it would use the following day's date, and might be coded 4B1-170202.

On time change days (when we switch on or off daylight time), the same rules as usual apply. For strips with a period greater than one hour, the system will lengthen or shorten one of the intervals by one hour, and there is no change to the period numbering. For strips with a period of an hour or less, rge system will add or delete intervals, as appropropriate, and these intervals should be numbered sequentially as usual. For example, half-hour periods would be numbered 1-46 in March and 1-50 in October. In leap years, February 29 should be handled like any other day.

There are some additional special rules that apply to Product Codes:

1. If the Periodid of the product is one year or more, then no counter NN is included in the code. For example, an annual product for 2002 might be designated as YR-02.

2. If the Periodid of the product is one day or more, and we are NOT using the YY date format, then no counter NN is included in the code. For example, a daily product for Feb. 15, 2002 might be designated as D-150202.

3. An option is available to use sequence numbers alternately ending with lower case ‘a’ and ‘b’. For example, two hour blocks might be numbered 2B1a-150202, 2B1b-150202, 2B2a-150202, 2B2b-150202, etc.

The APX Configuration system allows users to configure product codes through the section of the ‘Market Segments’ page where data on specific strips are entered. The above extracts from this page shows how this works. The “4HB” is entered in a space reserved for the alphanumeric characters of the product code. Note that these characters refer to a combination of market segment and strip, not just to the strip. There is no need to check that the letters assigned to a market segment-strip combination are unique to that market segment-strip combination.

Below the alphanumeric characters is a pull-down menu where the user can select the date format. The five options available are YY, DDMMYY, MMDDYY, DDMM, and MMDD. A final checkbox allows the user to indicate if a-b numbering is to be used.

1.11 Credit Methods

There are two credit methods potentially available in APX Markets:

Self-Managed Credit (“Self”)—Participants manage credit risk themselves by selecting the counterparties with whom they will deal and also handle settlements with those counterparties on their own.

APX Managed Credit—(“APX”)—APX Manages credit risk for participants by requiring cash deposits or letters of credit. APX also handles the settlements.

As a general rule, buy and sell orders should not match unless both orders specify the same credit method. In the Market screens, orders that do not have the same credit method as the one currently selected by the user should appear with a gray background in the order depth display.

1.12 The Options File

Certain settings entered by the user, such as various Custom Views, Global Options, Screen Options, and the setup of the windows when the user logs out are stored in an “Options” file on the user's computer, so they will be available when the user logs on again. The Options file is specific to a login and a machine, so if a machine is used by several logins, settings can be stored separately for each login.

There is a Default Options file that is installed by the Market Window 2002 installation package. A copy of this Default Options file becomes the initial Options file the first time a user logs in to the system with a new login ID on a particular machine.

The “Options” file information is stored on the server by login, so it is accessible regardless of the machine the user logs in on.

2.0 The Market Screen 9501

This section details the required functionality for the Market screen 9501. There are two versions of this screen, one intended for use by APX/M3 participants, the other intended for use by APX/M3 brokers and other APX customer service personnel. The Broker Version is basically the same as the Participant Version, but includes some additional functionality needed by brokers and APX customer service personnel. The additional Broker Version features are described in Section 2.10.

To access the Market Screen, the user clicks “Trading” on the Market Window 2002 Main Menu, then “Market” on the resulting drop-down menu. A listing of product types (“Energy”, “Financials”, etc.) will appear, from which the user selects the desired product type. All information on a Market Screen pertains only to the selected product type. The user may open multiple product screens simultaneously for the same or different product types.

The user opens the Market screen and designates the desired Tradebook (or “Trading Asset”) by selecting it from a drop-down menu. The Market Screen can be used in two modes. In the “Quick View” mode, the user can display all available intervals for one selected market and strip. In the “Custom View” mode, the user can select combinations of markets and strips, as well as specify the number of intervals to display for each combination. The layout of the Market Screen is shown above.

2.1 The Selection Bar 9506

The Selection Bar, which appears above the data grid 9504, allows the user to select the items to be displayed, using a series of pull-down menus and one set of radio buttons.

a. The “Custom View” Radio Button—If the user clicks on the “Custom View” radio button, he or she may select a custom view to apply to the data to be displayed.

b. The Custom View—If the user selects the “Custom View” radio button, the user may select the custom view to apply using this pull-down menu. One of the custom views always on the list is called “New Custom View”. If the user selects “New Custom View”, the Screen Preferences pop-up window should appear (see Section 2.5.4.1) allowing the user to define a new custom view. The list of custom views is saved locally on the user's machine by login account (in the “Options” file), and is specific to the selected trading asset. The system remembers the last custom view the user displayed for the selected trading asset, and displays this custom view when the user clicks the “Custom View” radio button. Custom views appear on the list in alphabetical order, except for “New Custom View” which always appear at the end of the list.

c. The “Quick View” Radio Button—If the user clicks on the “Quick View” radio button, he or she will be allowed to display all available intervals for one selected market and one strip. The system remembers the selected market and strip, as well as the Screen Preferences settings, from the last time the user was in “Quick View” mode.

d. The Market—If the Quick View radio button has been selected, the user may select the market segment to be displayed with this pull-down menu. This pull-down menu is grayed-out if the user has not selected the Quick View radio button. Market segments are listed in the order specified in the “Sorting” tab of the Global Preferences menu (see Section 1.3.6).

e. The Strip—If the Quick View radio button has been selected, the user may select the strip to be displayed with this pull-down menu. This pull-down menu should be grayed-out if the user has not selected the Quick View radio button.

f. The Trading Asset (also known as the Tradebook)—The user selects the trading asset against which he/she wishes to trade using the drop down menu at the left (see Section 3.2 for an explanation of the “trading asset” concept). When the user changes the trading asset selection, the markets and strips shown in the data grid below should not change. Any markets and strips shown in the data grid for which the selected trading asset is not registered to trade should have a ‘xxx’ appear in their data entry columns.

The first time the user opens the Market Screen after installation of the Market Window 2001, the Selection Bar is set to Quick View mode, with a trading asset for which the user is registered to trade selected arbitrarily. A market and strip in which the selected trading asset is registered to trade is selected arbitrarily.

2.2 The Market Data Grid

The data grid 9504 displays information on the markets, strips, and intervals selected by the user. If the user has selected the “Custom View” radio button on the Selection Bar, the data grid will display any combination of markets, strips, and intervals sorted in the sequence specified by the user. The markets, strips, and intervals to be displayed, and their sort sequence, are selected using the Screen Preferences option (see Section 2.5.4.1).

If there are more rows and columns than can fit on the screen, the screen can scroll vertically or horizontally. The Product, Interval, and Market/Strip, if displayed, remains on the screen unless the width of the screen is resized too small to show even them alone. In this case, columns to the right may be removed as necessary. The user may add or delete columns to or from the data grid, including the Market, Strip, Interval, and Product columns, using the Screen Preferences option (see Section 2.5.4.1).

Each time the user opens a new “View” (whether selecting a new market and strip for a Quick View or a new Custom View”) the screen should appear with the first row containing an interval open for trading (including intervals in accumulate or suspend mode) appearing at the top of the screen. This rule applies even though there may be additional rows for closed intervals above this row. This rule economizes on use of screen real estate by not wasting space on rows that are not open for trading.

Each “row” of the data grid actually includes two stacked numbers. Prices are always displayed at the top, while volumes are displayed in brackets at the bottom in each cell. In the event that the column does not have both a price and a volume component (as with Capacity to Buy and Capacity to Sell), then only one of the two numbers are displayed.

All data for continuously traded markets are shown in regular font. Data for markets or intervals that are in “accumulate” mode, as in auction markets, are shown in Italics. Data for intervals that are already closed or suspended are shown against the same background used for titles and borders.

Except for the “Minimum Filled” and “Maximum Filled” columns, all data shown in the data grid, including the participant positions, refer only to the specific market segment, strip, and interval for that row. This change eliminates a source of confusion about the meaning of the positions shown in Market Window 2000 when there are several strips spanning the same point in time. The calculation of the “Buy Allowance” and “Sell Allowance” will still have to take into account what the user has transacted in other markets and strips.

The bid and offer depth is shown in each row in the groups of columns headed “Bid” and “Offer”. Bids are listed from right to left in order of price attractiveness (highest to lowest price). Offers are listed from left to right in order of price attractiveness (lowest to highest price).

Bids and offers entered by the user's login ID are shown in bold type against a green background. Bids and offers entered by other login ID's from the same account are shown in regular type against a green background. Bids and offers entered by other accounts are shown in regular type against the standard background. When the user points to a bid or offer from his/her own account with the mouse, a tool-tip shows the name associated with the login ID that entered the order (that is, the name of the person who placed the order, not the account name). Bids and offers with which the user cannot contract (due to counterparty selections, if using Self-Managed credit) appear with the same background color used for titles and borders. Virtual bids and offers should appear with underscored characters.

Users can “select” orders (for purposes of viewing the order details, hitting or lifting, modifying, withdrawing, or using the Market Tool as described in Section 9.4.4) by clicking on each cell while holding down the “control” key. The first bid or offer may be selected simply by clicking on it. All the orders in a particular row entered by the user's login may be selected by double-clicking the cell in the “Product” column. Selected cells should have a bold border around them.

When the bid or offer depth on a row changes for any reason (such as an order contracted or withdrawn), the bid and offer columns blink briefly to provide a clear visual signal. The blinking does not affect any data the user has typed into the Entry column for that row.

The width of each individual column in the data grid (including the width of individual bid and offer columns) are adjustable by clicking and dragging on the line between columns, in standard MS-Windows fashion. The number of bid and offer columns displayed is adjustable using the Screen Preferences menu (see Section 2.5.4.1).

Intervals currently being delivered have the grid line under them bolder than usual.

In Quick View mode, all intervals open for trading (including intervals in accumulate mode and suspend mode) for the selected market and strip are displayed plus the number of recently closed intervals specified by the user using the Screen Preferences menu. In Custom View mode, the user can select the number of open for trading and recently closed intervals to display through the Screen Preferences menu.

The system is delivered with a Default Options file which defines a set of initial custom views and screen preferences. These Default Options files can be different for different markets, thereby allowing us to customize the initial layout of the grid for each market.

Immediately under the data grid is a row showing the interval, market, and strip currently selected in the data grid. Also shown for continuously traded markets is the closing time and date information for the interval. For continuously traded markets, the message reads “Trading Closes at”. The closing times and dates are shown in the time format and ‘short date’ format selected by the user through his/her operating system. Also shown for continuously traded markets is a “Time to Close” in HH:MM:SS format. For markets set to “Accumulate” mode”, the message reads “Accumulating for auction.” with no date or time. For markets set to “Suspend” mode, the message reads “Order entry suspended.” For intervals that are already closed, the message reads “Market closed”.

2.3 Column Functionality (Market Screen)

Name in quotes at the left is the column heading. Description to the right is the tool tip when the user highlights the column heading. For many columns, there are two tool tips, one for the top number and one for the bottom number. The notes in square brackets or parenthesis are not included in the tool tip. Columns marked with a # appear in the default configuration of the Market Window 2001 in the order shown. Note that for the Position, Minimum Filled, and Maximum Filled columns, the user can choose to designate sells with an ‘s’ or a ‘−’ before the quantity and designate buys with ‘b’ or nothing before the quantity using the Screen Preferences—General tab (see Section 2.5.4.1).

The Market Screen shall have the following columns:

1. #“Product”—The Product Code for this Market and Interval [See Section 1.14 for a description of Product Codes. This column is also used to display half-hour and four-hour numbered blocks in the UK Market.]

2. “Interval”—[Top] “Beginning” or “Ending” Time Indicator. [Bottom] Date and Time of the Interval.

3. “Market/Strip”—[Top] The Market Segment [Bottom] The Strip

4. #“Total Bid”—[Top Number] Weighted Average Price of All Bids; [Bottom Number] Total Qty of All Bids

5. #“Bid”—[Top Number] Price of Bid; [Bottom Number] Qty of Bid [“Bid” is actually not one column, but several, as described in Section 2.2 above. ‘All-or-Nothing’ orders should be have an * before the quantity.]

6. #“Offer”—[Top Number] Price of Offer; [Bottom Number] Qty of Offer [“Offer” is actually not one column, but several, as described in Section 2.2 above. ‘All-or-Nothing’ orders should be have an * before the quantity.]

7. #“Total Offer”—[Top Number] Weighted Average Price of All Offers; [Bottom Number] Total Qty of All Offers

8. #“Last Trade”[1]—[Top Number] Price of the Last Trade—Green Type if Up-tick, Red Type if Down-tick, Black Type if Unchanged; [Bottom Number] Qty of the Last Trade [The “Last Trade” heading actually spans two columns, hence the designations “Last Trade”[1] and “Last Trade”[2].]

9. #“Last Trade”[2]—[Top Number] Time of the Last Trade; ‘−1’ Indicates Previous Day; [Bottom Number] Today's Cumulative Traded Qty for All Participants [Time is shown in HH:MM format; if the time is from n days previous, time is shown as HH:MM-n]

10. #“Pos”—[Top Number] Average Price of My Position (=(Sum Over All Purchases (Price*Quantity)−Sum Over All Sales(Price*Quantity))/Qty of My Position; leave blank if Qty of My Position is zero) [Bottom Number] Qty of My Position.

11. “Buys” [Top Number] Average Price of My Buys [Bottom Number] Qty of My Buys.

12. “Sells” [Top Number] Average Price of My Sells [Bottom Number] Qty of My Sells.

13. “Minimum Filled”—Displays Minimum MWs of Filled Trades for This Trade book in this Interval over all markets. [See Section 2.3.1 below for definition of Concurrent Minimum Function.]

14. “Maximum Filled—Displays the Maximum MWs of Filled Trades for This Trade book in This Interval over all markets. [See Section 2.3.2 below for definition of Concurrent Maximum Function.]

15. #“Entry”—Enter Bid Price on Top, Bid Quantity Below; For Offers, Enter Negative Quantity Below; a ‘*’ Before an Order Indicates an ‘All or None’ Order. [Note, user may also enter an ‘s’ before or after the quantity for an offer (rather than a negative sign) and a ‘b’ before or after a bid. User may also enter an asterisk either before or after the quantity to indicate an “All or Nothing” order.]

16. “Expire Time”—The Bid(s) or Offer(s) Will be Automatically Withdrawn at the Date and Time Selected. [This column is blank by default. When the user double-clicks on the column, the current date and time plus 24 hours appear, followed by a down arrow. When the user clicks on the down arrow, a pop-up calendar appears allowing the user to change the date. The user may change the time by typing in a new time.]

17. “Capacity to Buy”—[Bottom Number Only] Total Starting Capacity of This Trading Asset to Buy in This Market

18. “Capacity to Sell”—[Bottom Number Only] Total Starting Capacity of This Trading Asset to Sell in This Market

19. “Allowance to Buy”—[Bottom Number Only] Remaining Capacity of This Trading Asset to Buy in This Market

20. “Allowance to Sell”—[Bottom Number Only] Remaining Capacity of This Trading Asset to Sell in This Market.

2.3.1 Definition of Concurrent Minimum Function

This function is used to calculate the “Minimum Filled” column. To take the concurrent minimum for an interval, iterate over all subintervals of the interval and calculate the sum over all markets for each subinterval for the selected trade book. If any of the sums are zero, or if not all of the sums are the same sign, then the concurrent minimum is zero. Assuming all the sums are the same sign, pick the smallest in absolute value. Iterate over all markets regardless of whether or not the user has chosen to display that market.

2.3.2 Definition of Concurrent Maximum Function

This function is used to calculate the “Maximum Filled” column. To take the concurrent maximum for an interval, iterate over all subintervals of the interval and calculate the sum over all markets for each subinterval for the selected trade book. Pick the largest in absolute value.

2.4 Screen Tab Functionality 9507

The bottom portion of the screen contains several displays that may be selected with tabs. The information on each display is specific to the interval selected in the upper part of the screen.

For the Market Depth, and Open Orders tabs, the same rules of formatting apply as in the main data grid, including:

Data for continuously traded markets are shown in regular font. Data for markets or intervals that are in “accumulate” or “suspend” mode (for auctions) are shown in Italics.

Orders placed by the user's own participant account are shown against a green background

Orders placed by the user's own login are shown in bold.

“Virtual” orders are shown in Italics.

a. Orders with which the participant cannot contract due to credit selections are shown against the same color background as is used in the titles and borders.

a. “Market Depth”—This is a more complete version of the bids and offers display that appears for each interval in the upper grid. The best bid and offer should be shown at the center, with less attractive bids arranged by price to the left, and less attractive offers arranged by price to the right. The tab scrolls horizontally if there are too many bids and offers to display on the tab. In this case, the display is initially centered, so as to display the most attractive bids and offers. “Market Depth” should show the Lot Size and Credit for each order.

| Order | | | | Open | Limit |
|---|---|---|---|---|---|
| ID | Market | Strip | Interval | Quantity | Price |
| 1932 | APX No. | Hourly | Jun. 7, 2000 13:00 | 100 b | 50.00 |
| | Cal Energy | | | | |

b. “Open Orders”—Shows all of the login's open orders for all markets in the selected intervals, as shown above. Note the plural here—the user may select multiple market segments.

| Order | | | | Filled | Average |
|---|---|---|---|---|---|
| ID | Market | Strip | Interval | Quantity | Price |
| 1933 | APX No. | Hourly | Jun. 7, 2000 13:00 | 100 S | 43.00 |
| | Cal Energy | | | | |

c. c. “Filled Orders”—Shows all orders filled since midnight (local time for the user) for all markets in the selected intervals, as shown above. Note the plural here—the user may select multiple market segments.

| | My Bids | My Offers | My MWs | My MWs |
|---|---|---|---|---|
| | Open | Open | Bought | Sold |
| Interval Minimum | XXX | XXX | XXX | XXX |
| Interval Maximum | XXX | XXX | XXX | XXX |
| Interval Average | XXX | XXX | XXX | XXX |

e. “Position Details”—shows the user the difference in their concurrent minimum position and their concurrent maximum position for the selected interval and trade book. See Section 2.3.1 and 2.3.2 for definitions of the concurrent minimum and maximum functions.

2.5 Screen Menu and Toolbar 9502

At the top of the Market screen is a pull-down menu and a toolbar. All of the buttons on the toolbar are also accessible through the pull-down menu. Options on the pull-down menu that are common to several screens have already been discussed in Section 1.3. Options that are unique to the Market screen are discussed here.

2.5.1 The View Menu

The View menu contains two options that allow the user to view data on the selected intervals.

2.5.1.1 Bid/Offer Details

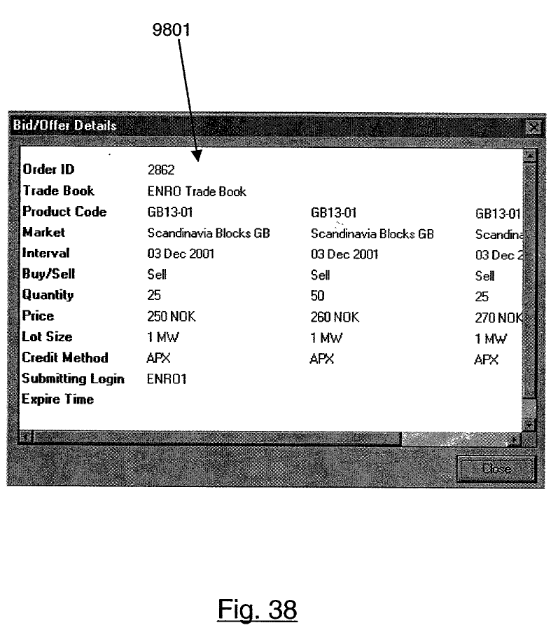

With respect to FIG. 38, clicking this option causes a window 9801 to pop-up giving details on the selected bids and offers. Order ID, Trade Book, Submitting Login, and “Expire Date” are shown only if the selected bid or offer is from the participant's own account or if the user is using the Broker version of the Market Screen (see Section 2.10 below). If more than one bid or offer has been selected, the orders should be listed in columns in arbitrary order. If there are too many columns to fit in the window, then the columns scroll horizontally, with the row names held fixed. This option can also be invoked using the shortcut Control-D or from the right-click menu.

2.5.1.2 Previous Trades

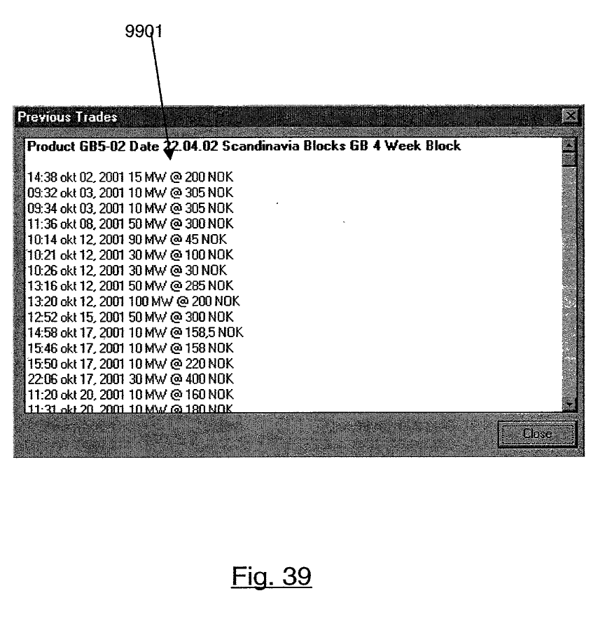

Referring to FIG. 39, the Previous Trades window 9901 allows the user to see the previous prices and quantities traded by all participants for the market, strip, and interval to which the grid cursor is currently pointing. Previous Trades can also be invoked by double-clicking on the Last Trade column or from the right-click menu.

The Previous Trades Window displays each of the last trades for the given product up to a maximum of 12 previous trades. The list of trades may be limited to the time horizon for the Market Engine database—generally the last six days. The time and date of the trade is displayed, with the most recent trades shown at the top (contrary to the example shown above). The user clicks the “Close” button to close the pop-up window, which is equivalent to clicking the ‘X’ in the upper right corner.

At the top of the Previous Trades window is a heading that gives the product code (if available), the interval beginning or ending time, the market, and the strip.

The Previous Trades pop-up window can also show previous trades by all participants, not just previous trades for the current participant.

2.5.2 The Actions Menu

The Actions Menu contains five basic trading functions.

2.5.2.1 Submit and Submit All

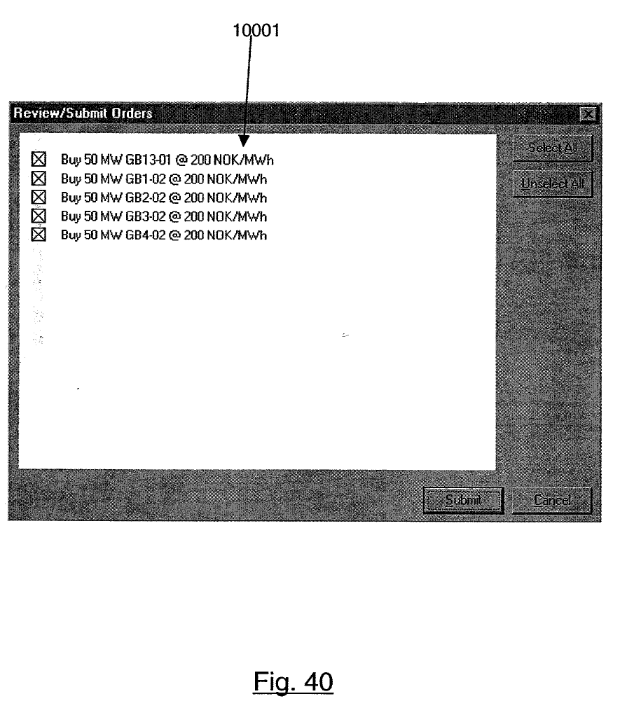

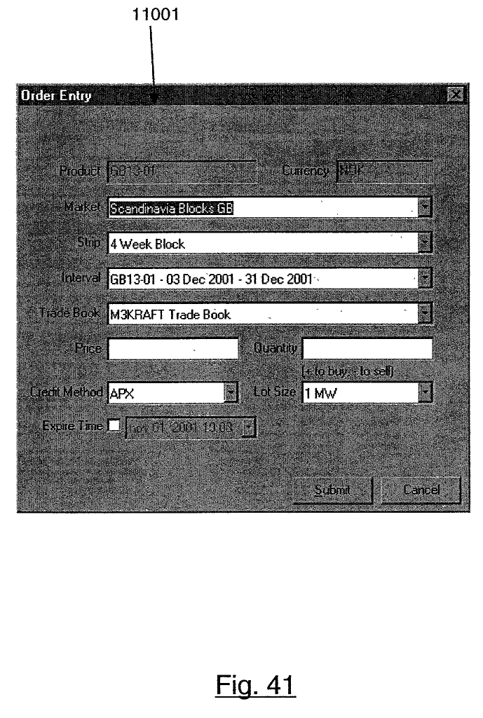

With respect to FIG. 40, assuming the user has chosen to show a confirmation pop-up window before submitting an order (see Section 1.3.6), selecting the “Submit” or “Submit All” option causes the Review/Submit Orders pop-up window 10001 to appear. “Submit” and “Submit All” are identical except that “Submit” submits only orders in the rows currently highlighted by the user, while “Submit All” submits all orders the user has entered in the Order Entry column. Pressing Control-S is equivalent to selecting the Submit All option. “Submit” and “Submit All” are also options on the Toolbar. If the user has not chosen to show a confirmation pop-up window, the orders will be submitted immediately when the user presses “Submit”, “Submit All”, or Control-S.

All orders that the user has entered in the Order Entry column should appear in the Submit Orders pop-up window. If the user has clicked the “Submit” button, only the highlighted orders should be checked; if the user has clicked the “Submit All” button or Control-S, all orders should be checked. Orders will be listed in the format

[{Buy|Sell}]XMWs[Product Code]@Y[Currency Symbol].

In the event that the product does not have a product code, orders will be listed in the format (all on one line):

[{Buy|Sell}]XMWs@Y[Currency Symbol]

[Name of Strip][Name of Market] for [Interval].

In the event that the user has not entered any orders, an error message should appear saying “Error: No orders to submit.” The user may then click an “OK” button to close the error message box.

Select All Button—Clicking this button causes all orders listed to become checked.

Unselect All Button—Clicking this button causes all orders listed to become unchecked.

Submit Button—Submits the checked orders and closes the Submit Orders pop-up window. Pressing Control-S is equivalent to pressing the “Submit” button.

Cancel Button—Closes the pop-up window without taking an action; it is equivalent to clicking the “X” in the upper right corner.

Once the user has clicked the “Submit” button on the Review/Submit Orders pop-up window (or the “Submit” or “Submit All” options on the Actions menu, if the user has not chosen to show a confirmation pop-up window before submitting an order), there are two warning messages that may appear. Both warnings may be disabled using the Global Preferences described in Section 1.3.6

The first warning appears if the user is entering an order for a market segment that does not have the same location as the trading asset (trade book). This warning should only appear if the user is using a trading asset that is also a scheduled asset (see Section 3.X), not a true trading asset. In this case, a pop-up warning message should appear saying “The market you have chosen, [name of market segment], is not native to the trading asset [name of trading asset]. You may incur congestion charges. Do you wish to continue?”.

The second warning appears if the user is entering an order with a limit price that is lower than the default hit price or above the default take price. In this case, a pop-up warning message should appear reading “The price you have entered for [name of market segment] is exceptionally [high|low]. Do you wish to continue?” The word “high” or “low” is displayed as appropriate in this message.

In both cases, if the user is submitting orders into more than one market segment to which the warning is applicable, then the system should pick the name of the market segment to display arbitrarily from the market segments to which the warning is applicable.

In the case of either warning, the user may select from buttons on the pop-up window marked “Yes” or “No”. If the user clicks “Yes”, the warning pop-up box will close and order submission will continue as usual. If the user clicks “No”, the warning pop-up box will close, and a new pop-up warning appears reading “Order submission aborted”, with a single button marked “OK”. Clicking the “OK” button closes the pop-up warning box and returns the user to the Market Screen.

2.5.2.2 Resubmit Last

The “Resubmit Last” option is described in Section 4.5.2. Resubmit last is also a button the Toolbar.

2.5.2.3 Withdraw

Assuming the user has chosen to show a confirmation pop-up window before withdrawing an order (see Section 1.3.6), selecting the “Withdraw” option causes the Withdraw Orders pop-up window 10001 to appear. If the user has selected one or more open orders from his/her own account (using any of the methods described in Section 2.2 above), then the pop-up window lists these orders and they are checked. Orders are listed in the same format as in the Submit Orders pop-up window described above. It is not necessary to show trading asset, lot size, or credit type on the “Withdraw Orders” pop-up window. Pressing Control-W is equivalent to selecting the Withdraw option. Withdraw is also a button on the Toolbar and an option on the right-click menu. If the user has not chosen to show a confirmation pop-up window, the selected orders will be withdrawn immediately.

If no orders submitted by the user's account have been selected when the Withdraw button is clicked, an error message pop-up reads “Error: You must first select one or more orders submitted by your account before performing this function.” The error message pop-up window includes a button labeled “OK”. Clicking “OK” closes the error message pop-up window, and is equivalent to clicking the ‘X’ in the upper right corner.

If the user has selected cells that are not orders submitted by his/her own account, an error message pop-up reads “Error: One or more of the selected cells is not an order submitted by your account. Selected cells must include only orders from your account.” Again, the error message pop-up window includes a button labeled “OK”. Clicking “OK” closes the error message pop-up window, and is equivalent to clicking the ‘X’ in the upper right corner.

a) “Select All” button. Clicking this button causes all orders to be checked (the default).

b) “Unselect All” button—Clicking this button causes all orders not be checked.

c) “Withdraw” button—Clicking this button causes the checked orders to be withdrawn and the Withdraw Orders pop-up window to close. Pressing Control-W is equivalent to pressing the “Withdraw” button.

d) “Cancel” button—Clicking this button closes the “Withdraw Orders” pop-up window with no action taken. It is equivalent to clicking the “X” in the upper right corner of the pop-up window.

2.5.2.4 Withdraw All

The “Withdraw All” option is described in Section 1.3.4.4. “Withdraw All” is also a button on the Toolbar.

2.5.3 The Tools Menu

The Tools Menu provides access to five tools that make trading easier.

2.5.3.1 Hit Bid/Lift Offer

Hit Bid/Lift Offer is equivalent to submitting matching bid(s) or offer(s) to the currently highlighted offer(s) or bid(s). Assuming the user has elected to show a confirmation pop-up window before submitting an order (see Section 1.3.6), clicking on this option will cause the “Submit Orders” pop-up window to appear, as described in Section 2.5.2.1, showing the matching bid(s) or offer(s) for the selected offer(s) and bid(s). If the user has elected not to show a confirmation pop-up window before submitting an order, clicking this option will cause the matching order(s) to be submitted immediately. Control-N is a shortcut to this function. This function will match only orders placed by accounts other than the user's own. If the user has selected one or more orders placed by his/her own account, an error message will be generated reading “Error: One or more of the selected orders were placed by your own account. These orders cannot be hit or lifted.” The error message pop-up window should include a button labeled “OK”. Clicking “OK” closes the error message pop-up window, and is equivalent to clicking the ‘X’ in the upper right corner.

2.5.3.2 Order Entry

Referring to FIG. 41, the Order Entry Window 11001 offers the user an alternative approach to entering an order. The user may enter the order quantity (preceded by + or ‘b’ or nothing for buy, − or ‘s’ for sell; the ‘b’ or ‘s’ may also be written after the quantity) and price in the appropriate space. Order Entry is also a button on the Toolbar.

The Order Entry pop-up window will default to the market, strip, and interval to which the grid cursor is currently pointing. The user may select a different market, strip, or interval using the pull-down menus. The Product code and Currency for the selected Market, Strip, and Interval will appear automatically (and is view-only). The Product Code also appears before the date and time of the interval on the Interval pull-down menu. The Trade Book, Credit Method, and Lot Size will default to the values currently selected in the Market Window. The Trade Book, Credit Method, and Lot Size may be changed using the pull-down menus. The default value for Expire Time is none. To enter an Expire Time, the user should check the box next to “Expire Time”, which will activate the pull-down menu to the right, setting it to the current time plus 24 hours. To change the Expire Time, the user should click the down arrow on the pull-down menu, which causes a pop-up calendar to appear. The user selects the appropriate expire date on the calendar. The user may change the expire hour and minutes by typing in a new time in HH:MM format.

When the user has completed entering the information, he/she may click “Submit” to submit the order. If the user has elected to show a confirmation pop-up window before submitting an order (See Section 1.3.6), the Submit Orders Window will appear (see Section 2.5.2.1). If not, the order will be submitted directly. Clicking the “Cancel” button closes the window without submitting any order; it is identical to clicking the ‘X’ in the upper right corner.

2.5.3.3 Task List

The Task List option offers the user a way to enter several orders sequentially and submit them all at the same time. Task List is also a button on the Toolbar, or it may be invoked by clicking Control-L.

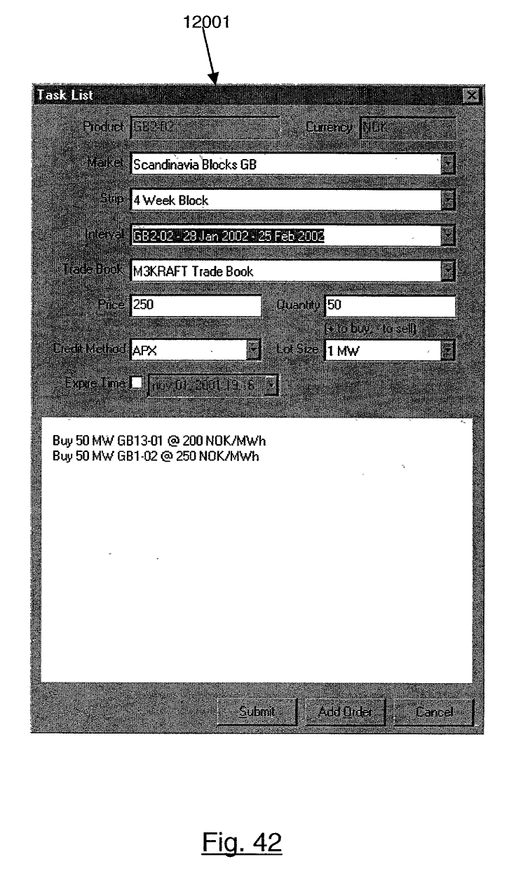

With respect to FIG. 42, the pop-up window 12001 that appears has a top section identical to the Order Entry window described in the previous section. At the bottom, there is an additional button labeled “Add Order”. The user enters the first order exactly as with the Order Entry window, then clicks “Add Order” (or Control-O), which causes the order to be added to the list in the bottom part of the screen. The user may repeat the process for as many orders as desired.

Clicking the “Submit” button (or Control-S) submits the orders and closes the Task List pop-up window. The bottom part of the Task List pop-up window is identical to the Submit Orders pop-up window used to confirm orders (see Section 9.5.1). Therefore, when the user clicks the “Submit” button, no additional confirmation is necessary, and the orders are submitted immediately.

2.5.3.4 Modify Orders

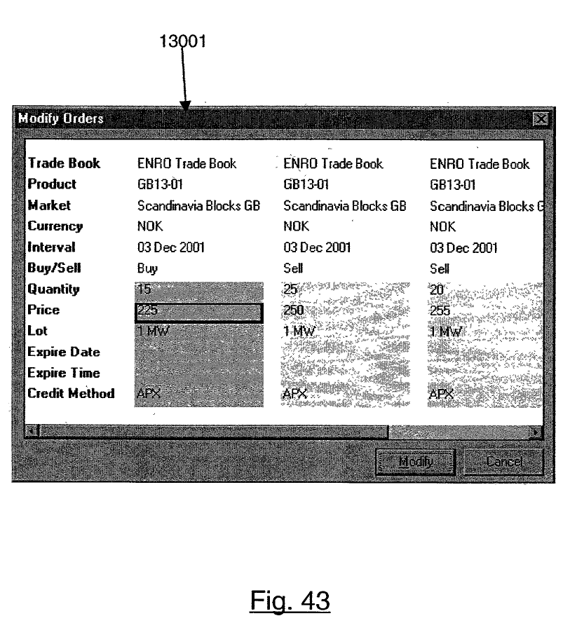

Referring to FIG. 43, this option is available only if the selected bids or offers are from the participant's own account. If the user has selected bids or offers from his/her own account, then clicking this option will cause the pop-up window 13001 to appear, showing the details of the currently highlighted bids or offers. If the user has highlighted multiple bids or offers, they will appear on this screen in columns from left to right. If there are too many bids and offers to fit in the window, the window should scroll horizontally, with the row names held fixed. Modify Orders may also be invoked from the right-click menu, or by pressing Control-M.

The user may change items in the highlighted area and click the “Modify” button to modify the order and close the pop-up window. The highlighted area is shown in blue for bids and yellow for offers. The user may enter data and move to the next data entry field down by pressing the tab key. Modifying an order is equivalent to withdrawing the original order and submitting a new order. Clicking the “Cancel” button closes the pop-up window without modifying the order. Clicking the “Cancel” button is equivalent to clicking the “X” in the upper right corner of the pop-up window.

If the user has selected cells that are not open orders from his/her own account, an error message should pop-up reading “Error: One or more of the selected cells is not an order from your account. Selected cells must include only orders from your account before performing this function.” The error message pop-up window should include a button labeled “OK”. Clicking “OK” closes the error message pop-up window, and is equivalent to clicking the ‘X’ in the upper right corner.

2.5.3.5 Messages

Selecting the Messages option invokes the Messages pop-up window, discussed in Section 7.

2.5.4 The Preferences Menu

The Preferences menu invokes two pop-up menus that allow the user to configure the behavior of the program

2.5.4.1 Screen Preferences

The “Screen Preferences” menu allows the user to vary the format of the Market screen. Additionally, if the user has selected a Custom View (see Section 2.1), the Screen Preferences option may be used to select the markets, strips, and number of intervals to be displayed. Selecting the “Screen Preferences” option causes the “Screen Preferences” pop-up window to appear. This menu may also be invoked from the right-click menu when the user is not highlighting only bids and offers.

The pop-up window has five tabs, labeled “General”, “Rows”, “Columns”, “Sort”, and “Market Tool”.

The General tab allows the user to specify three options:

Rows to Display, which offers three radio buttons which allow the user to filter the rows to be displayed

Whether to display the Screen Tabs described in Section 2.4.

How to designate of buys and sells, which offers a choice between using + and − signs or ‘b’ and ‘s’ (as in the Position, Minimum Filled, and Maximum Filled columns)

The contents of the Rows tab differs depending upon whether the user is in Quick View or Custom View mode. If the user is in Quick View Mode, the Rows tab allows the user to specify the number of recently closed intervals to display. These are the intervals immediately prior to the first currently open interval.

If the user is in Custom View Mode, the Rows tab allows the user to select the number of open and recently closed intervals to display for each available market and strip combination. The tab lists every market and strip combination for which the user is registered to trade. Market and strip combinations are listed in the format:

[Product Code]−[Market Segment]−[Strip].

In the event that no Product Code has been defined, the Product Code is omitted. Market-strip combinations are ordered by the market segment ordering specified in the “Sorting” tab of the Global Preferences menu (see Section 1.3.6), then by increasing length of strip. In the event that there are too many market/strip combinations to fit on the display window, the window scrolls up and down. In the event that any of the lines become too long to fit on the display window, the window scrolls left and right.

To the left of each market/strip combination is are two entry spaces where the user may enter integers, indicating the number of open and closed intervals of that market/strip combination he/she wishes to display. The user types in the number directly. All numbers must be one or two digits. The user may set the number to zero if he/she does not wish to see any intervals. The default value for open intervals should be one and the default value for closed intervals should be zero for each market/strip combination. ‘Open’ intervals here actually refers to intervals in open, accumulate, or suspend mode. If the number entered for open intervals is larger than the number of intervals in open, accumulate, or suspend mode, all intervals in open, accumulate, or suspend mode should be displayed. If the number entered for closed intervals is larger than the number available in the Market Engine database, all closed intervals should be displayed.

If one or more new market-strip combinations are added in registration for a user, they have no effect on any of the user's saved custom views. However, they appear on the Screen Preferences “Rows” tab for those saved custom views with an initial value of zero.

The “Columns” tab allows the user to select the columns to be displayed from a list of the available columns. The columns tab also allows the user to select the ordering of the columns. The ‘Bid’ and ‘Offer’ columns are actually a set of columns, displaying individual bids and offers. Therefore, the user separately sets the number of bid and offer columns to display in the lower portion of this tab. At least 20 bids and 20 offers may be displayed, if desired (more would be better). The user may enter these numbers directly, or use the up and down arrows to increase or decrease the previous numbers. The default should be five. The default columns are given in Section 2.3.

The “Sort” tab allows the user to select the sort sequence for the rows of the Market Window. Users may sort by any combination of Interval, Market, or Strip. These are the only three options that appear on the pull-down menus of the “Sort” tab. The default sort should be by market, then by strip, then by interval.

Sorting by strip is by period of the strip, not alphanumerically. So, for example, if the user chooses an increasing sort by strip, “Hourly” should come before “Daily”. Intervals are sorted by their start times.

Start times or end times for intervals should be compared in Greenwich Mean Time, implying that market segments in different time zones will be grouped together based on the Greenwich Mean Time of the interval.

The Market Tool tab contains a checkbox where the user can indicate whether the Market Tool should be displayed on the Market Screen (see Section 2.6). Four other boxes allow the user to specify the MW and Price Increments to be shown on the Market Tool. The increments may be any positive number with up to three digits and a decimal point. The increments do NOT have to be in any particular order (increasing or decreasing). The order they are shown in this tab should correspond to the order they appear on the Market Tool.

For all five tabs, the buttons that appear at the bottom of the screen when the user is in Custom View mode are as follows:

a) “Save Custom View As”—Clicking this button will save a new custom view under the name entered by the user in the space at the left and close the Screen Preferences pop-up window. The Custom View pull down menu should show the new custom view as the selected custom view. If the user attempts to save a custom view for which no markets/strips combinations have non-zero interval numbers on the Rows tab, an error message will pop-up saying “Error: No market/strip combinations have been selected”. The user may click a button labeled “OK” to return to the Screen Preferences pop-up window. If the user attempts to save a custom view without entering a name for the custom view, an error message will pop-up saying “Error: No name entered for custom view.” The user may click a button labeled “OK” to return to the Screen Preferences pop-up window. If the user enters a name that already exists, a warning message will pop-up saying “Warning: Custom view with this name already exists. Continue?” The user may click buttons labeled “Yes” or “No”. If the user clicks “Yes”, the system will continue as usual, overwriting the existing custom view. The user may click “No” to return to the Screen Preferences pop-up window.

b) “Update”—Clicking this option overwrites the previous settings for the current Custom View with the selected settings and closes the Screen Preferences pop-up window. There is no warning before saving.

c) “Delete Custom View”—Clicking this view will cause a warning message to pop up reading “Warning: Custom View XXX Will Be Deleted.”, where XXX is the name of the currently selected custom view. The user may select from buttons labeled “OK” or “Cancel”. If the user clicks “OK”, the currently selected custom view will be deleted, the warning message box and the Screen Preferences pop-up window will close, the Selection Bar will switch to the “Quick View” radio button, and the market and strip selected when the user was last in “Quick View” mode will be displayed. If the user clicks “Cancel, the warning message box will close and the user will be returned to the Screen Preferences pop-up window.

d) “Cancel” button—Clicking this button closes the Screen Preferences pop-up window with no action taken. It is equivalent to clicking the “X” in the upper right corner of the pop-up window.

If the user is in Quick View mode, the only buttons available are “OK” (to save the new settings and exit the Screen Preferences menu), and “Cancel’. Screen Options for both Custom View and Quick View mode are saved in the Options file, and will be used in future sessions for this login on this machine.

2.5.4.2 “Global Preferences”

The “Global Preferences” option is described in Section 1.3.6

2.6 The Market Tool

The Market Tool 9508 allows participants, especially market makers, to quickly adjust the prices and quantities of their bids and offers. The Market Tool appears above the data grid on the Market screen and is attached to it. The Market Tool will be displayed when the user has selected the appropriate setting on the Screen Preferences Market Tool tab (see Section 2.5.4.1).

The Market Tool affects only bids and offers from the user's own account that have been selected by the user. As described in Section 2.2, users can “select” orders by clicking on each cell while holding down the “control” key. The first bid or offer may be selected simply by clicking on it. All the orders in a particular row entered by the user's login may be selected by double-clicking the cell in the “Product” column. Selected cells will have a bold border around them. Users can also select all bids entered by their own login ID by clicking the “Select My Bids” button on the Market Tool, or select all bids entered by any login ID for their participant account by clicking the “Select Company Bids” button on the Market Tool. Similarly, users can select all offers entered by their own login ID or by any login ID for their participant account by clicking the “Select My Offers” or “Select Company Offers” buttons on the Market Tool.

If no orders submitted by the user's account have been selected when a button that requires a selection is clicked, an error message should pop-up reading “Error: You must first select one or more orders submitted by your account before performing this function.” The error message pop-up window includes a button labeled “OK”. Clicking “OK” closes the error message pop-up window, and is equivalent to clicking the ‘X’ in the upper right corner.

If the user has selected cells that are not orders from his/her own account, an error message should pop-up reading “Error: One or more of the selected cells is not an order submitted by your account. Selected cells must include only orders submitted by your account.” Again, the error message pop-up window includes a button labeled “OK”. Clicking “OK” closes the error message pop-up window, and is equivalent to clicking the ‘X’ in the upper right corner.

The “+X MW” and “−X MW” buttons on the Market Tool increase or decrease, respectively, the quantity of all the selected bids or offers by X MWs. The “+Y Price” and “−Y Price” buttons on the Market Tool increase or decrease, respectively, the price of all the selected bids or offers by Y. If the user has selected a “−Y Price” button that would have the effect of reducing the price of one or more of the selected orders to zero or below, an appropriate error message should pop-up. The error message reads “Error: One or more of the selected orders would have a price reduced to zero or below.” As usual, the error message pop-up window includes a button labeled “OK”. Clicking “OK” closes the error message pop-up window, and is equivalent to clicking the ‘X’ in the upper right corner

The user can select the two values of X and Y to appear on the Market Tool using the Screen Preferences Market Tool tab, as described in Section 2.5.4.1. The user can also use the “Withdraw All Bids”, “Withdraw Selected Bids”, “Withdraw All Offers” and “Withdraw Selected Offers” buttons to perform the indicated functions.

If the user has elected to show a confirmation pop-up window before submitting an order (see Section 1.3.6), a pop-up window appears with an appropriate confirmation message:

“Are you sure you want to increase the selected orders by X MW?”

“Are you sure you want to decrease the selected orders by X MW?”

“Are you sure you want to increase the price of the selected orders by Y?”

“Are you sure you want to decrease the price of the selected orders by Y?”

where X and Y are the MW and price change, respectively. The user may respond “Yes” to confirm or “Cancel” to cancel the change.

If the user has elected to show a confirmation pop-up window before withdrawing an order (see Section 1.3.6), the pop-up “Withdraw” confirmation window described in Section 2.5.2.3 should appear. The Withdraw confirmation window lists each of the orders to be withdrawn, and allows the user to uncheck any orders he/she may not actually wish to withdraw.

2.7 “Credit Method” Pull-Down Menu

The “Credit Method” pull-down menu allows the user to choose the credit method. Scandinavian markets will introduce at least two new credit methods: Norwegian Energy Clearing (NEC) and Approved Counterparty Credit (ACC). ACC is like our existing Self-Managed Credit, except that APX will be handling invoicing and payments; the participants will bear the risk of any defaults. Initially, however, the credit methods in Scandinavia will be selected automatically—ACC if both counterparties approve credit with each other (Section 6.3.2), NEC otherwise. This will appear to Scandinavian participants as “APX” credit. This display will, therefore, work just as in Market Window 2000. “APX” should be the default credit method.

If the user attempts to submit an order that includes market segments for which the selected credit method is not available, an error message pop-up reads “Error: XXX credit is not available for market YYY”, where XXX is the currently selected credit method and YYY is the name of the market segment. In this case, the entire set of orders should be rejected. If the error message applies to more than one of the orders which the user is attempting to submit, the error message should only be displayed once, with the market segment YYY selected arbitrarily from among the market segments for the inappropriate orders. The user may click a button labeled “OK” to close the error message pop-up window and return to the Market screen.

2.8 Lot Size” Pull-Down Menu

The “Lot Size” pull-down menu allows the user to select a lot size as the default for new orders submitted. One lot size may be “AON” for All-or-None. If the user attempts to submit an order that includes market segments for which the selected lot size is not available, an error message pop-up reads “Error: XXX lot size is not available for market YYY”, where XXX is the currently selected lot size and YYY is the name of the market segment. In this case, the entire set of orders should be rejected. If the error message applies to more than one of the orders which the user is attempting to submit, the error message should only be displayed once, with the market segment YYY selected arbitrarily from among the market segments for the inappropriate orders. The user may click a button labeled “OK” to close the error message pop-up window and return to the Market screen.

2.9 Right-Click and Double-Click Functionality

There are two right click menus, depending upon whether the user is highlighting only bids or offers, or whether the user is highlighting other cells, perhaps in addition to bids and offers.

2.9.1 Right-Click and Double-Click Functionality When The User Is Highlighting Not Only Bids and Offers

When the user is highlighting a group of cells that are not entirely bids and offers, the menu above appears when the user right-clicks. The first eight options on this menu are just different ways to get at functionality described elsewhere in this document.

a) “Submit” is the same as selecting the “Submit” option, described in Section 2.5.2.1.

b) “Cut”, “Copy”, “Paste”, and “Fill Down”, and Select are the same as accessing these functions from the “Edit” option on the Menu Bar, described in Section 1.3.2.

c) “Screen Preferences” is the same as selecting the “Screen Preferences” option, described in Section 2.5.4.1.

The next two options are available only if the user is highlighting a single cell or group of cells in a single row, and only if the user is in a custom view. They have the effect of increasing or decreasing the interval count for the product shown on the currently selected row. The change to the interval count is not saved.

The final option, “Hide Borders”, allows the user to hide the pull-down menus at the top of the screen and the closing time information at the bottom of the screen, thus saving on screen real estate. When the screen is in “Hide Borders” mode, this option becomes “Show Borders”.

Double-clicking on a Last Trade column causes the Previous Trades pop-up window to appear (see Section 2.5.1.2). Double-clicking on a cell in the “Product” column selects all the orders submitted by the user's login in that row. Double-clicking on a cell in the Total Bid or Total Offer column hits or lifts all bids or offers in that row.

2.9.2 Right-Click and Double-Click Functionality When the User Is Highlighting Only Bids or Offers.

When the user has highlighted only a single bid or offer, or selected a group of bids and offers, the right-click menu shown above appears. Each of the items on this menu have been described previously: Bid/Offer Details in Section 2.5.1.1, Hit Selected Bids/Lift Selected Offers in Section 2.5.3.1, Modify Selected Bids/Offers in Section 2.5.3.4, Withdraw Selected Bids or Offers in Section 2.5.2.3, and Hide Borders in Section 2.9.1.

Double-clicking on a bid or offer is equivalent to clicking “Hit Selected Bids/Lift Selected Offers. Double-clicking does not work when multiple bids and offers are selected, since double-clicking will undo the selection.

2.10 Broker Version of Market Screen

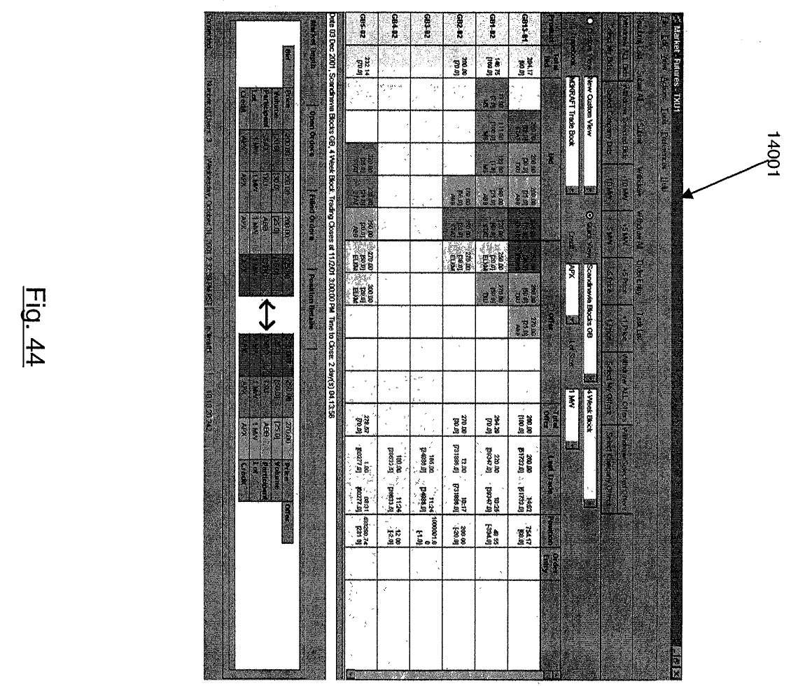

Referring to FIG. 44, a special version of the Market Screen 14001 is available for use by APX/M3 brokers and other APX Customer Service personnel. The ability to view this screen should be available only to those with “APX Broker” login privileges. See Section 1.6 for a discussion of login privileges.

The Broker Version of the Market Screen differs from the Participant Version in two respects.

2.10.1 Participant Account Information

The Broker Version of the Market Screen provides full information on the participant account placing each bid or offer. A third line may added to each row showing a code of up to four characters, identifying the participant account placing each bid or offer. The codes are taken from the “Participant Key” for the account entered through the registration system.

This third line is optional, and may be turned on or off using the “Screen Preferences” button. For the Broker Version of the Market screen, the “General” tab of the Screen Preferences pop-up window is modified as shown above. If the user checks “Display Participant Account Codes with Bids and Offers”, the third line will be displayed. Note that the setting of this option is specific to each Custom View or the Quick View.

In addition to the availability of the codes for participant accounts, a tooltip gives the full name associated with the login ID placing the bid or offer (that is, the name of the person who placed the order, not the account name) when the bid or offer is highlighted with the mouse.

The Broker Version of the Market Screen also allows users to identify the participant account placing the order by color. Using the Setup Screen (see Section 6.3.5), users can assign a color to each participant account. Bids or offers placed by the participant account will then be colored with this assigned color. If no color has been assigned to a participant account, the bid or offer will appear with the usual background. Orders placed by the broker should appear in bold type.

An additional option, “Participant Information” appears on the right-click menu when the broker highlights a single bid or offer (this option is grayed-out or not shown when the broker selects a group of bids or offers). Control-I is a shortcut to this function. Other options on this menu are discussed in Section 2.9.2

Clicking this option causes the Participant Information pop-up window shown above to appear. The “Order Contact” is the name of the person who placed the order, as shown in the Registration information for the login placing the order. The system matches the login to the contact information in our database in order to obtain the remaining contact information. Except for the use of the word “Participant” instead of “Counterparty”, this Participant Information pop-up window is the same as the Counterparty Information pop-up window discussed in Section 4.4(b).

2.10.2 Entering Orders on Behalf of Participants

The Broker Version of the Market Screen allows APX Brokers to enter orders on behalf of participants. As discussed in Section 1.2.9, the Main Menu for the Broker Version includes a pull down menu labeled “Participant”. Using this pull-down menu, the broker can select the participant on whose behalf he/she wishes to place orders. Once the broker has selected the participant, the broker can place orders in any of the usual ways just as if he/she were logged in as that participant.

The Participant selection is not saved as part of a custom view or quick view definition. When the broker changes views, either between custom views, or between custom views and quick view, the participant selection should not change. This allows the broker to easily look at alternate views of the screen while carrying on a conversation with a single participant.

The broker can configure the pull-down list of participants to limit the participants included, and specify their order, using the Setup Screen, as described in Section 6.3.4. One of the options on the pull-down list is labeled “Specify Later”. If the broker selects this option, the broker will be responsible for specifying the participant later using the Order Summary Screen, as described in Section 4.5.13. The Market Screen should treat “Specify Later” just like any other participant. It may be assigned a color. The broker may hit or lift standing orders, or enter new orders, on behalf of participant “Specify Later”.

Orders with which the selected participant cannot contract due to counterparty selection should appear with the background color used for titles and borders, as they would on the participant's own screen. The “Specify Later” participant should be able to contract with all orders. It is the broker's responsibility to be aware of any restrictions that apply to a participant's ability to contract when that participant is to be specified later (this should not be an issue in Scandinavia, where all orders should be able to contract).

When the broker enters an order using the Order Entry pop-up window or the Task List (see Sections 2.5.3.2 and 2.5.3.3), an additional field appears on the pop-up window for selecting the participant, as shown above. The participant may be selected from the same drop-down menu that was used to select the participant at the top of the Market Screen. This menu also includes a “Specify Later” option. The default value for the participant field shown on the Order Entry pop-up window is the same as the participant selected at the top of the Market Screen. In the event that the broker selects a participant through the Order Entry pop-up window that differs from the participant selected at the top of the Market Screen, the participant selected through the Order Entry pop-up window is the determining one.

In the Broker Version of the Order Entry pop-up window there are two additional buttons, labeled “Save” and “Contact”. “Save” allows the broker to save the values shown on the pop-up window as default values for that participant. The next time the broker opens the Order Entry pop-up window (either independently or using the Task List) and selects that same participant (or finds it selected by default), the saved values will appear automatically. “Contact” causes the “Participant Contact” pop-up window shown in Section 9.7.1 to appear for the currently selected participant.

3 The APX Market Window Schedule Manager Screen

With respect to FIG. 35, the Schedule Manager Screen 15001 is a Market Window interface for customers of the APX QSE/SC as well as the customers of other QSE/SCs using APX systems under ASP contracts. This section refers to these customers as “APX participants”. For example, Aquila is an APX participant, but APX is not the QSE. BP is also an APX participant, but here APX is the QSE.

The Schedule Manager provides APX participants with the capability to view his/her energy positions, record bilaterals with other market participants, and create schedules. This screen combines the asset transfer functionality of the Market Window 2000 Asset Manager Screen with the bilateral functionality of the Market Window 2000 Bilateral Screen.

QSE/SC's for which APX is the operator, either directly or as ASP, will be referred to as “APX-operated QSE/SC's”. QSE/SC's not operated by APX will be referred to as “foreign QSE/SC's”. Market participants who use foreign QSE/SC's will be referred to as “foreign participants”. APX-operated QSE/SC's that are not the same as an APX participant's own QSE/SC will be referred to as “remote QSE/SC's”. The APX participants using these remote QSE/SC's will be referred to as “remote participants”. The APX participants using the same QSE/SC will be referred to as “local participants”.

3.1 Improved Handling of Transfers with Remote and Foreign Participants

Three sets of enhancements are needed in the APX Market software to improve the handling of transfers with Local and Foreign participants: handling of all bilateral trades as true bilateral trades (as opposed to current workarounds), gross, in addition to net, recording of trades, and improved scheduling of APX Market transactions with self-managed credit. The first two of these are discussed in this section. Improved scheduling of APX Market transactions with self-managed credit will be discussed in the next section, since it requires an understanding of the revised Scheduling Process.

3.1.1 Handling of All Bilateral Trades as Bilateral Trades

The Market Window 2002 has the ability to handle all bilateral trades as true bilateral trades, regardless of whether or not the counterparty is local, remote, or foreign.

3.1.1.1. Functionality

In order to record a bilateral with a counterparty using another SC/QSE (local or foreign), APX registers a facility of the type SC Transfer for the specific combination of APX User, counterparty SC/QSE, and direction applicable to the bilateral. Then the APX User can record an asset transfer to that SC Transfer asset.

To improve the process for foreign participants, they are registered just as APX participants. As far as the Market Engine is concerned, the only way these participants differ from an APX participant is that bilaterals with the foreign participants get confirmed automatically. Of course, should these foreign participants choose to use APX systems to confirm their transactions with APX participants, it will be possible to register Login IDs for them. The “auto-confirmation” capability will be turned off for that foreign participant, and they can then access the Market Window 2002 to enter and confirm bilateral transactions with APX participants.

3.1.1.2 The Confirmation Robot

This piece of software automatically confirms the bilaterals that are offered to any participant set up for automatic confirmation. As part of the confirmation process, the Confirmation Robot must assign the bilateral to a facility for that participant. The facility to which bilaterals are to be assigned is selected through the Registration process. Separate facilities may be designated for buys and sells. The delivery location will be inferred from the market in which the sale is done. For example, a sale to a foreign participant in a Northern California market implies that the foreign participant will take delivery in Northern California, and be responsible for transmission from there to their actual load.

SC/QSEs are currently registered for each asset (facility) in the database. In order to provide a facility for the confirmation of the foreign counterparty, we will register ‘Buy’ and ‘Sell’ ‘Transfer’ (formerly SC Transfer) assets and assign the appropriate SC/QSE to the asset. In the unusual case of a counterparty who uses multiple SC/QSEs, they are registered as multiple counterparties.

For External counter-parties who do wish to manually confirm their bilaterals with APX participants, the ‘robot confirmation’ capability is deactivated. These participants will need to log into the Schedule Manager and confirm their bilaterals just like an APX participant, and ‘schedule’ the bilaterals to their Transfer asset.

Remote participants are, of course, already registered in the system, and should be willing to confirm their bilaterals with other APX participants, whether remote or local. APX participants are able to do bilaterals with each other the same way, regardless of whether they are local or remote to each other.

The Scheduler must recognize that a bilateral with a remote or foreign participant should be considered delivered to or received from the SC/QSE of that participant's facility at the location of the market in which the transaction was done.

3.1.2 Gross vs. Net Transaction Recording

The recording of transactions on a ‘gross’ basis, rather than a ‘net’ basis is supported. Presently, the Market Engine sums the participant's filled position into a single net value, with the sign indicating whether the overall position is long (+) or short (−). The CAISO, however, requires that SC transfers be reported on a ‘gross’ basis. Also, certain counter-parties in ERCOT insist on scheduling ‘gross.’ That is, total summed buys must be reported separately from total summed sells.

3.1.2.1 Functionality

The Market Engine and Market Window will make available “corrective” transaction types. One will be used to reduce the buy position, one to reduce the sell position.

The Market Engine tracks long and short positions with each bilateral counterparty separately. API instructions will deliver these separate long and short positions to the Market Window 2002. API instructions will report long and short transactions separately to the Market Engine. Purchases are reported as purchases (an increase in the long position). Corrections to reduce a previous sale aree entered by the participant as a negative sale (a decrease in the short position).

The API instructions return net positions (long-short) to the client, and always save all new transactions to the long position (buys as positive, sells as negative).

3.1.3 Special Scheduling Data Entry

There is a need to allow participants to enter additional generator scheduling information that is not required by APX, but is required by some grid operators. This includes such time varying information as ramp rates and minimum run-times. If these data are time-variant, their data entry are allowed through the Schedule Manager, using additional columns.

In order to make only the columns required by the grid operator available for each generator, the columns required by each generator are selectable through Registration.

Static data are handled through the Registration system. These static data may be made accessible to customers via web-based self-registration screens, and do not require special Scheduling Window functionality. These special requirements will arise in the context of any particular ISO or Grid Operator.

3.2 The Scheduling Process

The APX software allows participants to do all of their trading in the Market screen against one or more “Trade Books”. Using the Schedule Manager, the participants can later assign the power to physical sources and sinks.

3.2.1 Functionality

The Registration system allows assets to be classified as “Trading” assets, “Scheduled” assets, or both. These asset “types” will be implemented using the Facility Type Flags described in the registration section of the APX Platform Requirements.

“Trading” assets are the only ones available in the Market Screen. Trading assets will not appear in the Schedule Manager. Instead, the summed position of all Trading asset transactions done under APX managed credit is displayed as the APX Credit Position columns in order to inform participants of the amount of power that must be scheduled. Trading asset transactions done using self-managed credit are integrated into the counter-party specific Buys and Sells columns. Since all assets must have a location in our Registration system, a Trading asset may need to be assigned a location. However, this location has no meaning, since no power will ever physically move to the Trading asset's location. Therefore, the warning message that is generated when ordering from a non-native market (see Section 1.8.6) is always suppressed for orders placed against a Trading asset.

“Scheduled” assets appear only in the Schedule Manager screen, not the Market screen. These are the assets for which we will file schedules as an SC/QSE. Generally speaking, Generation, Load, Import, Export, and Transfers will be Scheduled assets, while all other types of assets will be Trading assets. Schedule positions at the Scheduled assets can be changed through the Schedule Manager by either performing asset transfers or bilaterals.

Participants who wish to trade directly against a Scheduled asset may have their Scheduled asset registered as both a Scheduled asset and a Trading asset. It will then appear on the Market screen, as well as in the Schedule Manager screen. In the Schedule Manager screen, two positions will be shown for the asset—a trading position (buys and sells) which cannot be changed through the Schedule Manager and a schedule position (source and sink) which can be changed through the Schedule Manager. When the participant does a trade through the Market Screen, the trade should be reflected in both the trading position and the schedule position. For example, if the participant does a buy against a Load, this should appear in the Schedule Manager as both a buy position and a sink position. This design allows participants who are willing to do all their trading against Scheduled assets to avoid having to do any scheduling.

A key concept of the Schedule Manager screen is that the participant's imbalance and their net position are the same. When the participant's schedule is balanced, their net position (trading buys−trading sells+scheduled source−scheduled sink) is equal to zero. With appropriate sign changes, the imbalance can be obtained simply by summing the trade position and schedule position columns of the Schedule Manager.

It is possible to submit unbalanced orders through the Schedule Manager screen and maintain non-zero imbalances up to the scheduling deadline. In fact, trades against a Trade-only asset into a scheduled market will initially contribute imbalances. The participant is responsible for resolving these imbalances prior to that market's scheduling deadline by balancing the imbalances with Scheduled assets or bilateral counterparties.

Participants do not have to be balanced in each specific market or location, but they do have to be balanced in aggregate for each product in each Control Area. For example, a participant with 10 MW of excess supply in the NP15 Energy scheduling space and a 10 MW shortage in the SP15 Energy scheduling space would be balanced.

Note that all assets in the Market Engine have the capability to record ‘gross’ and ‘net’ transactions. The methodology for recording transactions is built into the Market Engine, and can be assigned to an asset as specified in registration.

3.2.1.1 Scheduling of APX Market Transactions Using Self-Managed Credit

The solution described in is easily extended to APX Market transactions using self-managed credit. Consider first an APX Market transaction using self-managed credit between two participants for whom APX is the SC/QSE. In this case, if a participant did the trade at a schedulable asset (facility), the system automatically files a schedule to source or sink the transaction at that asset. If the participant did the trade at a non-schedulable asset, the participant is required to do an asset transfer to a schedulable asset.

Now consider an APX Market transaction using self-managed credit between two participants, one of whom uses APX as an SC/QSE, while the other does not. For the participant for whom APX is the SC/QSE, the process would work just as described in the last paragraph. As discussed above, the participant for whom APX is not the SC/QSE is also registered in the system. That participant has a single Transfer asset to which any APX Market transactions are automatically assigned. This is completely analogous to the way bilaterals with a participant for whom APX is not the SC/QSE will be automatically assigned to that participant's Transfer asset. This automatic assignment of transactions to a Transfer asset allows the Scheduler to file a schedule showing the SC Transfer. Of course, the participant for whom APX is not the SC/QSE will need to schedule an SC Transfer with APX through his/her own SC/QSE.

Finally, consider a transaction between two participants for whom APX is not the SC/QSE. APX cannot file schedules for the transaction. The participants must arrange their own schedules through their own SC/QSEs.

3.2.1.2 Scheduling Spaces

In many cases, there may be multiple markets segments for the same product in the same location, as when there was a CaIPX and APX Market in both Northern and Southern California. For various reasons, we may also choose to have various APX Market segments and bilateral market segments for the same product in the same location.

When the participant goes to schedule power at one of these multiple market segment locations, it makes no difference what market segment the power was sold or procured in. For this reason, the Schedule Manager screen allows users to select a “scheduling space” rather than a market. A scheduling space is simply a combination of product (such as “Energy”) and a location. Products are currently defined in the system, and are selected using the Market Menu on the left side of the screen. Locations are also defined in the system, and one is assigned to each market segment. In the Schedule Manager screen, the user selects the location(s) to be displayed directly, using a pull-down menu.

Internally, the market positions and other values displayed for each scheduling space are simply the sum of the values of all the markets for the selected product at the selected location. For each scheduling space, there is a “default market segment” to which any transactions entered through the Schedule Manager screen are assigned. The default market segment also determines the opening and closing time for the scheduling space, as well as the strips that are available. The default market segment must be a bilateral market, not a market traded in the Market screen. The reason for this rule is that we do not want transactions in the Schedule Manager to mess up a participant's trade positions.

A bilateral market segment is used as the default market segment wherever possible. The bilateral market segment can have a later closing time than the market segments traded in the Market screen. Thus, trading in the Market screen can close while scheduling continues through the Schedule Manager screen. This staggering of closing times gives participants a chance to complete their scheduling after the close of trading.

Note that the location of an asset should not be confused with the location of the scheduling space where transactions against that asset may be done. For example, a participant can do an asset transfer in a Northern California scheduling space from a generator located in Southern California. This asset transfer means that the participant is preventing an imbalance in Northern California by sourcing power in Southern California. There is nothing wrong with this as long as the participant has made any necessary transmission arrangements and is willing to pay any resulting congestion charges.

A counterparty is not registered with a specific location. However, by specifying the market or scheduling space where a bilateral with a counterparty is to be done, the participants are specifying that delivery will be made at the location of that market or scheduling space.

The Schedule Manager screen for a given scheduling space should, therefore, be able to display all the assets available to the login. It should also be able to display all counterparties registered to trade. The data shown will represent transactions for that asset or counterparty in that scheduling space, regardless of the physical location of the asset or counterparty.

3.2.2 Closing Time Procedures

Two features to the closing time procedures resolve customer service problems. The first is that APX Operators are allowed to override the configured opening and closing times for any market for selected intervals and specify a new closing time, as well as close or suspend markets that should be open, or reopen market interval(s) that have already closed. These enhancements allow the APX Operators to close markets temporarily while schedule submission was actually in progress, thereby reducing the risk that a participant might do a last minute transaction that would mess-up an otherwise balanced schedule. Similarly, the operators can hold markets open beyond their normal closing time to deal with unusual emergencies, thereby mitigating the damaging and costly consequences these emergencies could have. This functionality is constructed in a manner allowing APX Operations to continue all scheduling transactions while customers are prevented from doing so. This may require tying the market suspend/close/clear/etc. functions to the login type, giving some login types continued functions while shutting out others. It may also be tied to participant type, such that Reporting Agents Operations Desks (especially under ASP) have access to some functions at some times that other customers do not.

The second is that ‘APX Broker’ logins are able to enter transactions into the Schedule Manager screen after the market has been suspended or closed for as long as the needed data remains available in the database. All open transactions (bids, offers, inbox, and outbox) are rejected when the market closes. However, these privileges allow APX Operators to enter asset transfers or robot-confirmed outbox transactions when the market is closed. New transactions that are left standing in the system (bids, offers, or non-robot confirmed outbox transactions) could not be entered after market closing, but could be entered into a suspended market. These privileges are in APX Operator login.

Operators can authorize specific participant logins to enter transactions into the Schedule Manager screen for specific market segments and intervals after the market has been suspended or closed, as described in the previous paragraph. This enhancement gives the Operators one more tools for handling unusual emergencies.

The Market Segment Opening and Closing Times actually only define the birth and death of the Market Segment objects in the system memory. The functionality of the Market Segments of Suspend, Accumulate, Clear, and other methods are disassociated from the object life cycle, and can be triggered solely by external events (SetMEState). These events are then scheduled as part of each QSE/SC TaskManager tool and associated manual overrides.

Functionality at the intersection of Market Segments and Login IDs are controlled by privilege flags. For example, a Login ID privilege flag may be called “Ability to transact during MEState=Holding,” or “Ability to transact during MEState=Closed.” Each privilege flag is a key to a lock in the ME that allows the Login IDs with those keys to have that certain functionality.

3.2.3 California Operational Enhancements

The California market has two rounds of scheduling—“Preferred” to “Revised Preferred” and “Revised Preferred” to “Final”—in the day-ahead market, as well as a “Preferred” to “Final” round for the hour-ahead market.

In addition to the features described in earlier sections, the Scheduler program calculates the amount of any cuts and loads them into special market segments. With this, the APX California markets operate on a more streamlined basis.

In Design Option 1, there is a market segment for each round at each hub—APX Day-Ahead Preferred, APX Day-Ahead Revised Preferred, and APX Hour-Ahead, as well as a Bilateral Market. This configuration with a separate market segment for each round allows the display of a true closing time for each market interval using existing technology (driven by the configured Market Segment Open/Close times). In Design Option 2, there is one market segment that is closed before each deadline, then reopened. The system needs to be able to read the Task Manager for the QSE/SC responsible for that Market Segment (see ASP project), and drive count-down timers based on those variables. These variables may be updated and changed via the new Ops Console, so the logic driving these displays need to synch with these variables.

Except when suspended by the Operators, the Bilateral Market remains open until the hour-ahead scheduling deadline, thus allowing participants to enter schedules on a continuous basis. Participants with unbalanced schedules could be made aware of the scheduling deadlines through warning messages sent by the APX Operators.

The APX Day-Ahead Preferred Market would probably close a short time before the day-ahead preferred scheduling deadline, in order to give participants a chance to enter their schedules. Similarly, the APX Day-Ahead Revised Preferred and the APX Hour-Ahead markets would also close a short time before their respective scheduling deadlines.

With this setup, participants could do transactions in the APX Day-Ahead Preferred Market until shortly before the scheduling deadline, and then complete their scheduling process in the Schedule Manager before the Day-Ahead Preferred deadline. At the deadline, the APX Operators would resolve any imbalances using the enhanced Query Window (see Section 3.1.3) and use the Scheduler to submit the Day-Ahead Preferred schedules to the CAISO. The Operators could, if they wished, suspend trading in the bilateral markets, thereby suspending schedule changes through the Schedule Manager, during this process (see Section 3.2.2).

When CAISO adjusted day-ahead schedules become available, the Scheduler can upload them and calculate the cuts. Under Design Option 1, the cuts will then be loaded into a special “California Day-Ahead Round 1 Cuts” market segment as offers (for generators and exports) and bids (for loads and exports). The cuts are not loaded as actual transactions, since in Round 1, they are not actual schedule changes, but merely suggested schedule changes. The California Day-Ahead Round 1 Cuts market segment is not an actual market segment. It is just a clever way to display cuts in the Market Window. Participants are not allowed to enter orders or trade in this market segment.

The Market Engine allows the Schedule Manager screen to display the intervals and assets or counterparties with proposed cuts in a special color, so participants can easily identify them. The Configuration system allows a color to be assigned to a market segment. Any time that market segment has an order or a position, the corresponding figure in the Schedule Manager screen appears in the selected color. Colors may be assigned to more than one market segment, so there is a priority scheme to specify which color to display when two or more segments assign a color to the same cell in the Schedule Manager.

Once the cuts from the adjusted day-ahead markets had been uploaded to the California Day-Ahead Round 1 Cuts Energy Market, the APX Operator sends out a message to participants (see Section 7). The Operator also opens the Revised Preferred Energy Market for trading (see Section 3.2.2), and reopens the Bilateral Market, so as to again allow transactions through the Schedule Manager. Participants can easily see the transactions affected by the suggested cuts in the Schedule Manager screen, since they are in a different color. Participants can determine the magnitude of the cuts by looking at the Market screen for the California Day-Ahead Round 1 Cuts Energy Market. Participants who wished to adjust their schedules in response to the suggested cuts could do market transactions in the Revised Preferred Energy Market, or do asset transfers and bilaterals in the Schedule Manager screen.

When the participants have completed their changes, the APX Operators resolve any imbalances and then use the Scheduler to submit the Revised Preferred Schedules to the CAISO. When they become available, the Scheduler will upload the CAISO final day-ahead schedules and again calculate the cuts. Cuts will be loaded into a special “California Day-Ahead Round 2 Cuts” Energy Market, which is similar to the California Day-Ahead Round 1 Cuts Energy market discussed earlier. However, this time, since the cuts are real, they would be loaded as transactions—purchases for generators and imports, sales for loads and exports. The APX Operators will send out a message notifying the participants that these results are available for viewing. Participants see their final day-ahead schedules in the Schedule Manager screen, with the figures affected by the day-ahead cuts identified in a distinctive color different from the color used in Round 1. Participants can determine the magnitude of the cuts by looking at the Market screen for the California Day-Ahead Round 2 Cuts Energy Market.

The California Hour-Ahead Energy market segments would then open for trading. Trading in each hour would close shortly before the scheduling deadline. At the hour-ahead deadline, the Bilateral market segments close, thus closing scheduling activity for that interval in the Schedule Manager screen. The APX Operators resolve any imbalances, if necessary, and use the Scheduler to submit the Hour-Ahead Preferred schedules to the CAISO. When they become available, the Scheduler uploads the CAISO Final Hour-Ahead schedules and calculates any cuts. The cuts will then be loaded into a special “California Hour-Ahead Cuts” Energy Market” as transactions. Participants can view their final hour-ahead schedules through the Schedule Manager screen, with figures affected by hour-ahead cuts appearing in another distinctive color. Participants can determine the magnitude of the cuts by looking at the Market screen for the California Hour-Ahead Cuts Energy Market.

This approach to organizing the APX California Markets consistently allows participants to see their positions, including any cuts, through the Schedule Manager screen, and allows clear and enforceable deadlines, thus reducing the chances of confusion and error on the part of our participants. It also reduces the need for APX Operators to call participants about cuts, reducing labor and eliminating another potential source of error for APX. The system can automatically send e-mail messages, phone notifications, or pages to participants who had cuts in each round.

3.3 The Selection Bar

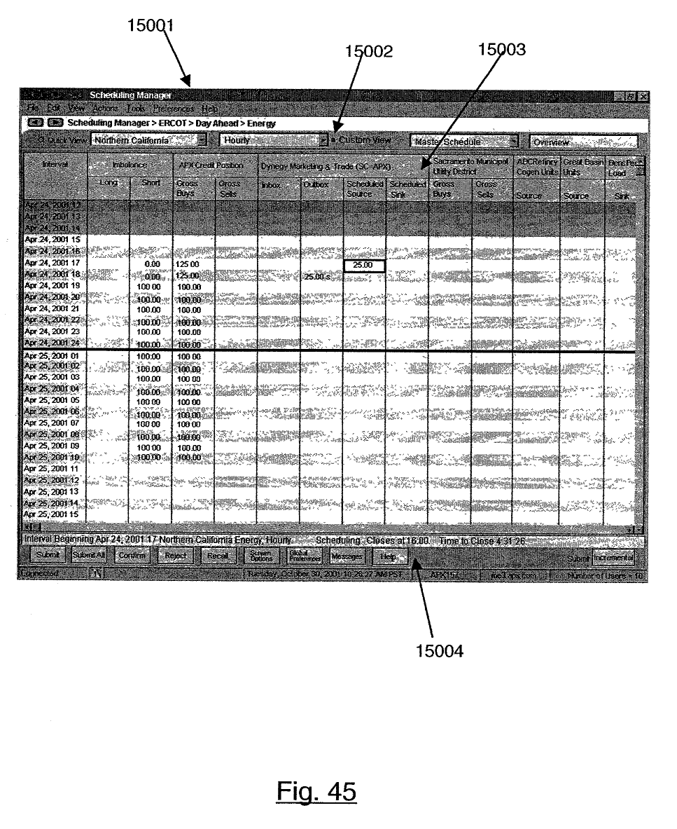

Referring to FIG. 45, the Selection Bar 15002, which appears above the data grid 15003, allows the user to select the items to be displayed using a series of pull-down menus, a switch, and one set of radio buttons. We discuss them here from left to right. If the bar is too long to fit on the actual screen, it is acceptable to show only the drop down menus applicable to the selected radio button.

a. The “Quick View” Radio Button—If the user clicks on the “Quick View” radio button, he or she will be allowed to display all available intervals for one selected market and one strip. The system remembers the selected market, and strip, as well as the screen options settings, from the last time the user was in “Quick View” mode.

b. The Location—If the Quick View radio button has been selected, the user may select the scheduling space (location) to be displayed with this pull-down menu. This pull-down menu is grayed-out if the user has not selected the Quick View radio button.

c. The Strip—If the Quick View radio button has been selected, the user may select the strip to be displayed with this pull-down menu. This pull-down menu is grayed-out if the user has not selected the Quick View radio button.

d. The “Custom View” Radio Button—If the user clicks on the “Custom View” radio button, he or she may select a custom view to apply to the data to be displayed.

e. The Custom View—If the user selects the “Custom View” radio button, the user may select the custom view to apply using this pull-down menu. One of the custom views always on the list should be called “New Custom View”. If the user selects “New Custom View”, the Screen Options pop-up window should appear (see Section 3.7.5) allowing the user to define a new custom view. The list of custom views is saved locally on the user's machine by login account (in the “Options” file). The system remembers the last custom view the user displayed, and display this custom view when the user clicks the “Custom View” radio button. Custom views appear on the list in alphabetical order, except for “New Custom View” which always appears at the end of the list. Custom views are created through the “Screen Options” bottom button (see Section 3.7.5).

f. Screen Version—Regardless of which radio button the user selects, the user must also select whether to display the “Overview” version of the screen, or the “Detailed” version of the screen. These are discussed in Section 3.4.1 and 3.4.2 below. Although the switch object for changing screen versions looks much like a pull-down menu, the user can change screen versions simply by pointing at the switch and clicking. There are also right-click options for changing screen versions (see Section 3.8). When the user switches screen versions, the cursor goes to the leftmost data entry column for the same asset or counterparty, if there is a data entry column shown. If no data entry column is shown, the cursor goes to the leftmost column for the same asset or counterparty.

The first time the user opens the Schedule Manager after installation of the Market Window 2002, the Selection Bar should be set to Quick View mode, with a location and strip in which the login is registered to trade selected arbitrarily. The Overview version of the screen should be selected.

3.4 The Data Grid

The data grid 15003 displays information on the intervals, location, and strip selected by the user. The colored stripes covering alternating rows can be removed and replaced with light grid lines between the rows.

If the user has selected the “Custom View” radio button on the Selection Bar, the data grid will display a single strip for any set of locations (scheduling spaces). Data is always displayed sorted first by increasing date/time, then alphabetically by location. The market segments and strip to be displayed are selected using the Screen Options bottom button (see Section 3.7.5).

Each time the user opens a new “View” (whether selecting a new location and strip for a Quick View or switching to a new Custom View or switching between Quick View and Custom View, or switching from another screen to the Schedule Manager screen) the screen appears with the first row containing an open interval one row down from the top of the screen. This rule applies even though there may be additional rows for closed intervals above the first row containing an open interval. Displaying the first open interval one row down from the top, rather than at the top, provides an immediate visual signal to the user that this is the first open interval. There are no changes to the current rules governing the number of closed intervals to display per location before and after the open intervals. In Quick View mode, rows representing the current date/time can be highlighted in green.

All data for continuously traded scheduling spaces are shown in regular font. Data for scheduling spaces and intervals that are in “accumulate” or “suspend” mode, as well as intervals that are closed, should be shown in Italics. Except for the “Source Remaining” and “Sink Remaining” columns for schedulable assets, all data shown in the data grid refers only to the specific location for that row. Data at the shortest strip level (hourly for California) reflects transactions in all strips. Data for longer strips reflects only activity in those strips. The user may elect to display “Overall” lines in the Schedule Manager screen, which sum the participants position, as well as imbalances, over all markets displayed.

3.4.1 The Overview Version of the Screen

The “Overview” version of the screen 15003 displays the participant's imbalances plus selected columns for selected assets and counterparties. The “Overview” version of the screen is designed to give the user a comprehensive overview of his/her position in the market.

Users choose the columns, assets, and counterparties to display using the Screen Options bottom button (see Section 3.7.5). Although numerous columns are available, most users may set up the “Overview” screen to display only a few columns, then drill down to the ‘Detailed” screen when additional columns are needed. The cursor serves as a pointer to indicate which asset or counterparty to display when the user switches to the Detailed version of the screen.

The system remembers the asset or counterparty selected the last time the user accessed the Schedule Manager screen (as indicated by where the cursor was pointing in the “Overall” version, or which asset or counterparty was displayed in the “Detailed” version). Each time the user opens a new “View” while displaying the Overall Version of the Schedule Manager screen, the Schedule Manager attempts to set the cursor in the new “View” to the same asset or counterparty selected in the previous view. If that asset or counterparty is not available in the new view, the cursor points to the columns for the leftmost asset or counterparty. The screen will always open with the columns for the selected counterparty or asset in the center of the screen.

3.4.2 The Detailed Version of the Screen

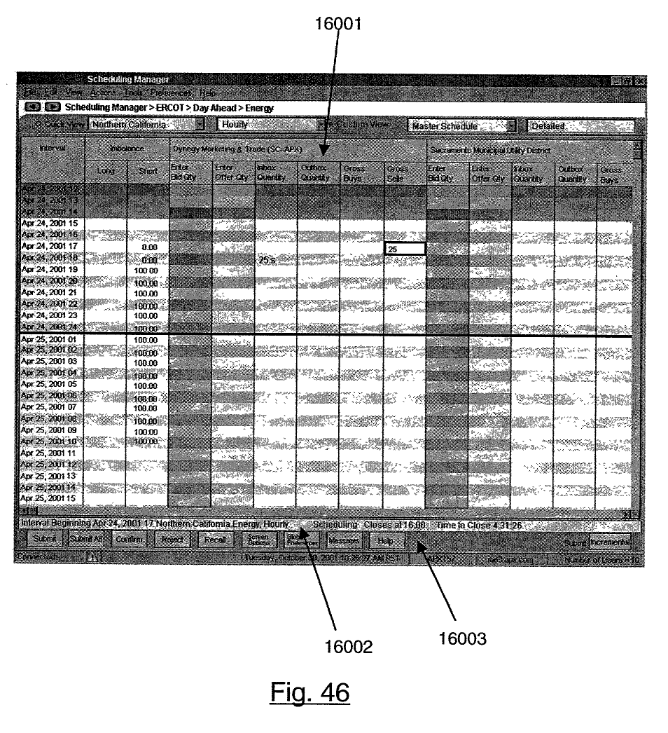

With respect to FIG. 46, the Detailed Version of the screen 16001 displays multiple columns for a single selected asset or a single selected counterparty. The columns to be displayed are selected using the Screen Options button (see Section 3.7.5). The Detailed version of the screen is unavailable until the participant's assets have been converted to new-style assets (see Section 3.2).

Each time the user opens a new “View” while displaying the Detailed Version of the Schedule Manager screen, Schedule Manager attempts to display the new “View” for the same asset or counterparty selected in the previous view. If that asset or counterparty is not available in the new view, the screen version should automatically switch to the Overview screen version, with the cursor pointing to the columns for the leftmost asset or counterparty.

3.5 Column Functionality (Schedule Manager Screen)

Notes in square brackets indicate how this column is to be aggregated in the “Overall” line; if no information is given in square brackets, then this column is blank in the “Overall” line. Name in quotes at the left are the column heading. Description to the right is the tool tip when the user highlights the column; the notes in square brackets or parenthesis should not be included in the tool tip. Columns marked with a # should appear in the initial default configuration.

3.5.1 Column Functionality (Schedule Manager Screen—Overall Version) Columns Always Available:

1. #“Interval”—Date and Time of the Interval [should span the “Overall” line].

2. #“Location”—Name of Location. (Shown by default only if multiple locations are displayed on the same screen.) [should say “Overall”].

3. Time Zone—The Time Zone of the Location.

4. #“Imbalance Long”—Difference Between My Filled Buys/Sources and Sells/Sinks in This Interval and Location. (The imbalance should be the imbalance for this interval only. If there has been no activity in this interval, then the value should be left blank. If there has been activity, then the value is zero unless Buys/Sources exceed Sells/Sinks.) [sum]

5. #“Imbalance Short”—Difference Between My Filled Sells/Sinks and Buys/Sources in this Interval and Location. (The imbalance is the imbalance for this interval only. If there has been no activity in this interval, then the value should be left blank. If there has been activity, then the value is zero unless Sells/Sinks exceed Buys/Sources.) [sum]

Columns Available for Each Selected Counterparty

6. #“Enter Bid Qty”—Column for Entering Bid Quantity for This Counterparty, Location, and Interval. (This column is shown in blue. Shown by default only if the user's assets have not been converted to new-style assets. It is acceptable to enter a negative number as an indication that this bid, if filled, reduces the quantity bought, as opposed to an offer, which would increase the quantity sold)

7. “Enter Bid Price”—Column for Entering Bid Price for This Counterparty, Location, and Interval. (This column is shown in blue.)

8. #“Enter Offer Qty”—Column for Entering Offer Quantity for This Counterparty, Location, and Interval. (This column is shown in yellow. Shown by default only if the user's assets have not been converted to new-style assets. It is acceptable to enter a negative number as an indication that this offer, if filled, reduces the quantity sold, as opposed to an offer, which would increase the quantity bought.)

9. “Enter Offer Price”—Column for Entering Offer Price for This Counterparty, Location, and Interval. (This column is shown in yellow.)

10. #“Inbox”—Displays Net MWs of Proposed Trades for This Location and Interval That Have Been Submitted By This Counterparty to Me That I Have Not Yet Confirmed. A ‘b Indicates I Am Buying, an ‘s’ Indicates I Am Selling. (This column is not shown for counterparties who are set for robot confirmation. Display of the column is suppressed if all values in the column are zero. Note that this column is actually the difference of two quantities that internally need to be tracked separately: offers submitted by this counterparty to me minus bids submitted by this counterparty to me. A positive sign on this difference translates to a ‘b’, while a negative sign translates to an ‘s’.)

11. “Inbox Price”—Displays Average Price of Proposed Trades for This Location and Interval That Have Been Submitted By This Counterparty to Me That I Have Not Yet Confirmed. (This column is not shown for counterparties who are set to confirm automatically. Display of the column is suppressed if all values in the column are zero. In the unusual case where the user has bids and offers open simultaneously from the same counterparty, leave this field blank.)

12. #“Outbox”—Displays Net MWs of Proposed Trades for This Location and Interval That I Have Submitted to This Counterparty That the Counterparty Has Not Yet Confirmed. A ‘b Indicates I am Buying, an ‘s’ Indicates I Am Selling. (This column is not shown for counterparties who are set to confirm automatically. Display of the column is suppressed if all values in the column are zero. Note that this column is actually the difference of two quantities that internally need to be tracked separately: bids submitted by me to this counterparty minus offers submitted by me to this counterparty. A positive sign on this difference translates to a ‘b’, while a negative sign translates to an ‘s’.)

13. “Outbox Price”—Displays Average Price of Proposed Trades for This Location and Interval That I Have Submitted to This Counterparty That the Counterparty Has Not Yet Confirmed. (This column is not shown for counterparties who are set to confirm automatically. Display of the column is suppressed if all values in the column are zero. In the unusual case where the user has bids and offers open simultaneously for the same counterparty, leave this field blank.)

14. #“Scheduled Source”—My Bids Filled for This Counterparty, Location, and Interval [sum].

15. #“Scheduled Sink”—My Offers Filled for This Counterparty, Location, and Interval [sum].

16. “Net Source”—Scheduled Source—Scheduled Sink [sum]

17. “Net Sink”—Scheduled Sink—Scheduled Source [sum]

Columns Available for Each Selected Asset

18. #“Enter Sink Qty”—Column for Entering Sink Quantity for This Asset, Location, and Interval. (This column is shown in blue. Shown by default only if the user's assets have not been converted to new-style assets. Available only for scheduled assets and old-style assets. It is acceptable to enter a negative number as an indication that this order reduces the Sink Filled, as opposed to “Enter Source Qty”, which increases the Source Filled).

19. #“Enter Source Qty”—Column for Entering Source Quantity for This Asset, Location, and Interval. (This column is shown in yellow. Shown by default only if the user's assets have not been converted to new-style assets. Available only for scheduled assets and old-style assets. It is acceptable to enter a negative number as an indication that this order reduces the Source Filled, as opposed to “Enter Sink Qty”, which increases the Sink Filled.)

20. #“Gross Sink”—MWs Sinking at This Asset for This Location, and Interval (Available only for scheduled assets and old-style assets.) [sum].

21. #“Gross Source”—MWs Sourced at This Asset for This Location, and Interval (Available only for scheduled assets and old-style assets.) [sum].

22. “Net Sink”—Gross Sink—Gross Source (Available only for scheduled assets.) [sum]

23. “Net Source”—Gross Source—Gross Sink (Available only for scheduled assets.) [sum]

24. “Source Capacity”—Total Source Capacity of This Asset. (Available only for scheduled assets and old-style assets.)

25. “Sink Capacity”—Total Sink Capacity of This Asset. (Available only for scheduled assets and old-style assets.)

26. “Source Remaining”—Remaining Uncommitted Source Capacity of This Asset. (Available only for scheduled assets and old-style assets. Concurrent minimum. See Section 2.3.c for definition of Concurrent Minimum function.)

27. “Sink Remaining”—Remaining Uncommitted Sink Capacity of This Asset. (Available only for scheduled assets and old-style assets. Concurrent minimum. See Section 2.3.c for definition of Concurrent Minimum function.)

Columns Available for APX Market Position

28. #“Gross Buys”—My Bids Filled for This Asset, Location, and Interval [sum].

29. #“Gross Sells”—My Offers Filled for This Asset, Location, and Interval [sum].

30. “Net Buys”—Gross Buys—Gross Sells [sum]

31. “Net Sells”—Gross Sells—Gross Buys [sum]

3.5.2 Column Functionality (Schedule Manager Screen—Detailed Version)

A # indicates the default selection.

Columns Always Available:

1. #“Interval”—Date and Time of the Interval [should span the “Overall” line].

2. #“Location”—Name of Location. Shown only if multiple locations are displayed on the same screen. [should say “Overall”].

3. Time Zone—The Time Zone of the Location.

4. #“Imbalance Long”—Difference Between My Filled Buys/Sources and Sells/Sinks in This Interval and Location. (The imbalance is the imbalance for this interval only. If there has been no activity in this interval, then the value is left blank. If there has been activity, then the value is zero unless Buys/Sources exceed Sells/Sinks.) [sum]

5. #“Imbalance Short”—Difference Between My Filled Sells/Sinks and Buys/Sources in this Interval and Location. (The imbalance is the imbalance for this interval only. If there has been no activity in this interval, then the value is left blank. If there has been activity, then the value is zero unless Sells/Sinks exceed Buys/Sources.) [sum]

Columns Available for Each Selected Counterparty

6. #“Enter Bid Qty”—Column for Entering Bid Quantity for This Counterparty, Location, and Interval. (This column is shown in blue. It is acceptable to enter a negative number as an indication that this bid, if filled, reduces the quantity bought, as opposed to an offer, which would increase the quantity sold)

7. “Enter Bid Price”—Column for Entering Bid Price for This Counterparty, Location, and Interval. (This column is shown in blue.)

8. #“Enter Offer Qty”—Column for Entering Offer Quantity for This Counterparty, Location, and Interval. (This column is shown in yellow. It is acceptable to enter a negative number as an indication that this offer, if filled, reduces the quantity sold, as opposed to an offer, which would increase the quantity bought.)

9. “Enter Offer Price”—Column for Entering Offer Price for This Counterparty, Location, and Interval. (This column is shown in yellow.)

10. #“Inbox”—Displays Net MWs of Proposed Trades for This Location and Interval That Have Been Submitted By This Counterparty to Me That I Have Not Yet Confirmed. A ‘b Indicates I Am Buying, an ‘s’ Indicates I Am Selling. (This column is not shown for counterparties who are set for robot confirmation. Display of the column is suppressed if all values in the column are zero.)

11. “Inbox Price”—Displays Average Price of Proposed Trades for This Location and Interval That Have Been Submitted By This Counterparty to Me That I Have Not Yet Confirmed. (This column is not shown for counterparties who are set to confirm automatically. Display of the column is suppressed if all values in the column are zero. In the unusual case where the user has bids and offers open simultaneously from the same counterparty, leave this field blank.)

12. #“Outbox”—Displays Net MWs of Proposed Trades for This Location and Interval That I Have Submitted to This Counterparty That the Counterparty Has Not Yet Confirmed. A ‘b Indicates I am Buying, an ‘s’ Indicates I Am Selling. (This column is not shown for counterparties who are set to confirm automatically. Display of the column is suppressed if all values in the column are zero.)

13. “Outbox Price”—Displays Average Price of Proposed Trades for This Location and Interval That I Have Submitted to This Counterparty That the Counterparty Has Not Yet Confirmed. (This column is not shown for counterparties who are set to confirm automatically. Display of the column is suppressed if all values in the column are zero. In the unusual case where the user has bids and offers open simultaneously for the same counterparty, leave this field blank.)

14. #“Scheduled Source”—My Bids Filled for This Counterparty, Location, and Interval [sum].

15. #“Scheduled Sink”—My Offers Filled for This Counterparty, Location, and Interval [sum].

16. “Net Source”—Scheduled Source—Scheduled Sink [sum]

17. “Net Sink”—Scheduled Sink—Scheduled Source [sum]

Columns Available for Each Selected Asset

18. #“Enter Sink Qty”—Column for Entering Sink Quantity for This Asset, Location, and Interval. (This column is shown in blue. Available only for scheduled assets and old-style assets. It is acceptable to enter a negative number as an indication that this order reduces the Sink Filled, as opposed to “Enter Source Qty”, which increases the Source Filled).

19. #“Enter Source Qty”—Column for Entering Source Quantity for This Asset, Location, and Interval. (This column is shown in yellow. Available only for scheduled assets and old-style assets. It is acceptable to enter a negative number as an indication that this order reduces the Source Filled, as opposed to “Enter Sink Qty”, which increases the Sink Filled.)

20. #“Gross Sink”—MWs Sinking at This Asset for This Location, and Interval (Available only for scheduled assets and old-style assets.) [sum].

21. #“Gross Source”—MWs Sourced at This Asset for This Location, and Interval (Available only for scheduled assets and old-style assets.) [sum].

26. “Net Sink”—Gross Sink—Gross Source (Available only for scheduled assets.) [sum]

27. “Net Source”—Gross Source—Gross Sink (Available only for scheduled assets.) [sum]

22. “Source Capacity”—Total Source Capacity of This Asset. (Available only for scheduled assets and old-style assets. Formerly, this was labeled “Capacity to Sell”.)

23. “Sink Capacity”—Total Sink Capacity of This Asset. (Available only for scheduled assets and old-style assets. Formerly, this was labeled “Capacity to Buy”.)

24. “Source Remaining”—Remaining Uncommitted Source Capacity of This Asset. (Available only for scheduled assets and old-style assets. Formerly, this was labeled “Allowance to Sell”. Concurrent minimum. See Section 2.3.c for definition of Concurrent Minimum function.)

25. “Sink Remaining”—Remaining Uncommitted Sink Capacity of This Asset. (Available only for scheduled assets and old-style assets. Formerly, this was labeled “Allowance to Buy”. Concurrent minimum. See Section 2.3.c for definition of Concurrent Minimum function.)

Columns Available for APX Market Position

26. #“Gross Buys”—My Bids Filled for This Asset, Location, and Interval [sum].

27. #“Gross Sells”—My Offers Filled for This Asset, Location, and Interval [sum].

28. “Net Buys”—Gross Buys—Gross Sells [sum]

29. “Net Sells”—Gross Sells—Gross Buys [sum]

3.6 Screen Tabs Functionality (Schedule Manager Screen)

There are no requirements at this time for Screen Tabs 16002 on the Schedule Manager Screen.

Under the data grid in the Schedule Manager screen, one row shows the interval, location, and strip selected. Data shown is for the default market assigned to the selected scheduling space (see Section 3.2.1). The interval description reads “Interval Beginning . . . ” or “Interval Ending . . . ”, depending upon the registration flags for the market. Also shown for continuously traded default markets is the closing time and date for the interval currently highlighted by the cursor. For continuously traded markets, the message reads “Trading Closes at . . . ”. The closing times is shown in 24-hour format and the closing date is shown in the “short date” format selected by the user through his/her operating system. For default markets set to “Accumulate” mode”, the message reads “Accumulating for Auction” with no date or time. For default markets set to “Suspend” mode, the message would read “Order entry suspended.” For default markets that are already closed, the message reads “Market Closed”. Also shown for all default markets that are still open is a “Time to Close” in HH:MM:SS format.

3.7 Bottom Button Functionality (Schedule Manager Screen)

This section describes the function of the buttons and the switch 16003 that appear at the bottom of the Schedule Manager Screen. All buttons are available in both versions of the Schedule Manager screen. There are nine buttons and one switch.

3.7.1 “Submit” and “Submit All” Buttons

The Submit and Submit All buttons on the Schedule Manager screen allow the user to submit bilateral or asset transfer orders. Orders may be submitted through either version of the Schedule Manager screen provided that order entry columns are included among the columns displayed.

Pressing either the Submit or Submit All button cause a pop-up window to appear listing all orders that are currently entered on the screen. The difference between the buttons is that Submit causes only orders in cells that the user has highlighted to be checked, while Submit All checks all the orders. The user may also check or uncheck individual orders as desired.

Bilateral orders will be listed in the format:

[{Buy|Sell}]XMWs@$Y for [interval][name of strip][location][{from|to}][counterparty name]

Asset transfer orders will be listed in the format

[{Buy|Sell}]XMWs for [interval][name of strip][location][{from|to}][name of asset]

“Energy w/Trans” products may be handled in the Submit Orders pop-up window of the Schedule Manager screen in the same way as other products (without any special transmission features). The Submit Orders pop-up window in the Schedule Manager screen offers the same special transmission features for Energy w/Tr products as in the Submit Orders pop-up window of the Market Screen.

Users may submit one or more orders at a time with the “Submit Orders” pop-up window. Once the participant's assets have been converted to new-style assets, there is no requirement that balance be maintained. If an order causes an imbalance, the imbalance will be shown in the Imbalance columns for the user to rectify later. Participants whose assets have not been converted to new-style assets are required to submit two or more orders at a time that can maintain a zero imbalance (see Section 3.2).

a. “Select All” button. Clicking this button causes all orders to be checked (the default).

b. “Unselect All” button—Clicking this button causes all orders not be checked.

c. “Submit” button—Clicking this button causes the checked orders to be submitted and the Submit Orders pop-up window to close.

d. “Cancel” button—Clicking this button closes the “Submit Orders” pop-up window with no action taken. It is equivalent to clicking the “X” in the upper right corner of the pop-up window.

e. “Help” button—Clicking this button invokes a link to help information on submitting orders.

3.7.2 The “Confirm” Button

The “Confirm” button allows the user to confirm bilaterals proposed by other counterparties, which appear in the user's inbox. Pressing the “Confirm” button causes the “Confirm Orders” pop-up window shown above to appear. All orders currently in the user's inbox will be shown. However, only orders in cells that the user has highlighted will appear checked.

The megawatts for the bilaterals confirmed may be sourced or sunk to a specific asset or temporarily assigned to imbalance (the default) by clicking the appropriate radio button. If the user selects to sink or source the bilaterals to a specific asset, the pull-down menu allows the user to select the asset.

To support grid operators, the system allows users to partially confirm inbox orders. To support this functionality, ‘lot size’ settings are added to the Schedule Manager screen, similar to the Market screen.

a. “Select All” button. Clicking this button causes all orders to be checked.

b. “Unselect All” button—Clicking this button causes all orders not be checked.

c. “Confirm” button—Clicking this button causes the checked orders to be confirmed and the Confirm Orders pop-up window to close.

d. “Cancel” button—Clicking this button closes the “Confirm Orders” pop-up window with no action taken. It is equivalent to clicking the “X” in the upper right corner of the pop-up window.

e. “Help” button—Clicking this button invokes a link to help information on confirming orders.

3.7.3 “Reject” Button

The “Reject” button allows the user to reject bilaterals proposed by other counterparties. Pressing the “Reject” button causes the “Reject Orders” pop-up window shown above to appear. All orders currently in the user's inbox will be shown. However, only orders in cells that the user has highlighted will appear checked.

a. “Select All” button. Clicking this button causes all orders to be checked.

b. “Unselect All” button—Clicking this button causes all orders not be checked.

b. “Reject” button—Clicking this button causes the checked orders to be rejected and the Reject Orders pop-up window to close.

c. “Cancel” button—Clicking this button closes the “Reject Orders” pop-up window with no action taken. It is equivalent to clicking the “X” in the upper right corner of the pop-up window.

d. “Help” button—Clicking this button invokes a link to help information on rejecting orders.

3.7.4 “Recall” Button

The “Recall” button allows the user to withdraw bilaterals proposed to other counterparties. Pressing the “Recall” button causes the “Recall Schedules” pop-up window shown above to appear. All orders currently in the user's outbox will be shown. However, only orders in cells that the user has highlighted will appear checked.

a. “Select All” button. Clicking this button causes all orders to be checked.

e. “Unselect All” button—Clicking this button causes all orders not be checked.

f. “Recall” button—Clicking this button causes the checked orders to be withdrawn and the Withdraw Orders pop-up window to close.

g. “Cancel” button—Clicking this button closes the “Recall Schedules” pop-up window with no action taken. It is equivalent to clicking the “X” in the upper right corner of the pop-up window.

h. “Help” button—Clicking this button invokes a link to help information on withdrawing orders.

3.7.5 “Screen Options” Button

The “Screen Options” bottom button allows the user to vary the format and default settings of the Schedule Manager Screen. Pressing the “Screen Options” bottom button causes a pop-up window to appear. The pop-up window has six tabs, the first labeled “General”, the second labeled “Assets”, the third labeled “Counterparties”, the fourth labeled “Asset Columns”, the fifth labeled “Counterparty Columns”, and the sixth labeled “Markets & Strip”.

Any orders the user has typed in, but not yet submitted, are preserved when the user clicks the Screen Options button. When the user is finished resetting Screen Options, the orders that have been entered are preserved (except, of course, when the user has removed the asset or counterparty for which the order was entered from the screen).

The items shown on the “General” tab are as follows:

a) Time Frame—This allows the user to set the range of time intervals displayed on the Schedule Manager screen. There are two options.

1) The default, “All open intervals”, displays the open intervals specified through the configuration process for the default market. Six intervals are actually displayed before and after the open intervals, as in the current Trade Manager Window.

2) “Specify number of intervals per strip after selected date/time” allows the user to specify a particular date and time and number of intervals. The specified number of intervals after that date and time will be displayed on the Schedule Manager screen for each combination of location and strip. For this option, a blank is provided where the user can enter the specified number of time intervals and the specified date and time. The default value for the date and time is the current date and time. If the user clicks the down arrow next to the date and time, a pop-up calendar appear for selecting the date. The check box labeled “auto-increment date bounds” will cause the selected date/time to move with time like a clock. If the “auto-increment date bounds” box is not checked, the selected date and time will remain unchanged.

b) Summary Rows—This check box allows the user to select whether to display an “Overall” summary row.

1) “Overall”—If the user checks the “Overall” checkbox, a row will be displayed for each interval summarizing the data for all the displayed markets combined. The algorithm for the summary of each column is described in Section 3.5 above.

The “Assets tab allows the user to select the assets to be displayed on the Schedule Manager screen (both versions), and the order in which these assets should be displayed. Assets available appear in alphabetical order.

The Counterparties tab allows the user to select the counterparties to be displayed on the Schedule Manager screen (both versions), and the order in which these counterparties will be displayed. Counterparties are always displayed on the screen to the left of the assets. The counterparties available appear in alphabetical order.

The Assets Columns tab allows the user to specify the columns to be displayed on both versions of the Schedule Manager screen for each asset. In the top portion of the window, the user selects the columns that appear in the Overall version of the screen, while in the bottom portion of the window, the user selects the columns that appear in the Detailed version of the screen.

The Counterparty Columns tab allows the user to specify the columns to be displayed on both versions of the Schedule Manager screen for each counterparty. The Assets Columns and Counterparty Columns tabs are identical except for the columns available. The columns available are listed in Section 3.5.

The Locations & Strip tab allows the user to select the strip and the locations to display on both versions of the Schedule Manager screen. The locations available for selection depend upon the strip—the locations available should be all those for which the participant is registered to trade and which trade the selected strip.

For all six tabs, the buttons that appear at the bottom of the screen are as follows:

a. “Save Custom View As”—Clicking this button saves the currently selected screen options on all tabs under the name the user has typed in the space to the left and closes the Screen Options window. The user will return to Schedule Manager screen with the new custom view selected on the Selection Bar. Typing in the name of a custom view that already exists causes a pop-up warning to appear reading “Warning: The custom view name you have entered already exists. Do you wish to overwrite?” The user may click a button on the pop-up window labeled “Yes” to save the changes, close the pop-up window, and close the Screen Options window as usual. The user may click a button on the pop-up window labeled “No” to close the pop-up window without saving the changes and return to the Screen Options window.

b. “Delete Custom View”—This button is available only when the Screen Options button in invoked while the Custom View radio button is selected on the Schedule Manager Screen. Clicking the button causes a pop-up warning to appear reading: “Warning: Are you sure you want to delete the current custom view?” The user may click a button on the pop-up window labeled “Yes” to delete the custom view, close the pop-up window, close the Screen Options window, and return to the Schedule Manager screen with “Quick View” for an arbitrary location and strip selected on the Selection Bar.

c. “Update”—Clicking this button applies the selected changes to the current custom view or quick view and closes the Screen Options pop-up window.

d. “Cancel” button—Clicking this button closes the Screen Options pop-up window with no action taken. It is equivalent to clicking the “X” in the upper right corner of the pop-up window.

e. “Help” button—Clicking this button invokes a link to help information on Screen Options.

3.7.9 “Incremental vs. Absolute” Switch

Clicking this switch changes the interpretation of the numbers entered by the user. With the switch set to “Incremental”, the new bilateral bid or offer quantity is interpreted as being in addition to any previous bids and offers. With the switch set to “Absolute”, the bilateral bid or offer quantity is interpreted as replacing all previous bid or offer quantities, both unconfirmed and confirmed.

Internally, the “Absolute” bids are implemented by submitting a new bid equal to

Absolute Bid Quantity Entered:

− Confirmed Buys by the Participant from the Counterparty

+ Confirmed Sells by the Participant to the Counterparty

− Unconfirmed Bids Submitted by the Participant to the Counterparty

+ Unconfirmed Offers Submitted by the Participant to the Counterparty

− Unconfirmed Offers Submitted by the Counterparty to the Participant

+ Unconfirmed Bids Submitted by the Counterparty to the Participant.

“Absolute” offers are implemented by submitting a new offer equal to

Absolute Offer Quantity Entered:

− Confirmed Sells by the Participant to the Counterparty

+ Confirmed Buys by the Participant from the Counterparty

− Unconfirmed Offers Submitted by the Participant to the Counterparty

+ Unconfirmed Bids Submitted by the Participant to the Counterparty

− Unconfirmed Buys Submitted by the Counterparty to the Participant

+ Unconfirmed Offers Submitted by the Counterparty to the Participant.

Note that it is possible for this new bid or offer to turn out negative. If the bid turns out to be negative, it is submitted as a negative bid, not an offer. Similarly, if the offer turns out to be negative, it is submitted as a negative offer, not a bid.

The concept here is that, when everything is contracted, the absolute bid quantity will become the ‘net’ contracted buys by the participant from the counterparty. Similarly, the absolute offer quantity will become the ‘net’ contracted sells by the participant to the counterparty.

“Incremental” should be the default setting for this switch, which appears whenever the Schedule Manager screen is opened. The switch should set itself back to incremental after each order is entered.

3.8 Right-Click Functionality

Right-clicking in the grid area of the Schedule Manager screen, Overall Version, results in the pop-up menu shown above. All of the options on this menu except “Left” and “Right” are just different ways to get at functionality described elsewhere in this document.

a. “Down (Detailed)” is the same as clicking the switch to move to the Detailed Version of the Schedule manager screen, described in Section 3.4.2.

b. “Left” moves the cursor to the same column for the asset or counterparty to the left. This option is grayed-out if there is no asset or counterparty to the left.

c. “Right” moves the cursor to the same column for the asset or counterparty to the right. This option is grayed-out if there is no asset or counterparty to the right.

d. “Submit” is the same as clicking the “Submit” bottom button, described in Section 3.7.1.

e. “Confirm” is the same as clicking the “Confirm” bottom button, described in Section 3.7.2.

f. “Reject” is the same as clicking the “Reject” bottom button, described in Section 3.7.3.

g. “Withdraw” is the same as clicking the “Withdraw” bottom button, described in Section 3.7.4.

h. “Cut”, “Copy”, “Paste”, and “Fill Down” are the same as accessing these same functions from the “Edit” option on the Menu Bar, described in Section 1.2.2.

i. “Screen Options” is the same as clicking the “Screen Options” bottom button, described in Section 3.7.5.

Right clicking in the grid area of the Schedule Manager screen, Detailed Version, results in the pop-up menu shown above, which is very similar to the pop-up menu for the Overall Version of the screen. The key difference is that the “Down (Detailed)” option is replaced with an “Up (Overall)” option, which moves the user to the overall version of the screen. It is, however, still equivalent to clicking the switch to change screen versions (see Section 3.3.f).

3.9 Potential Enhancements in Future Versions

a) Integrate with tagging. Create a tag and display it with the “Submit” button. Counterparty could also see tag when they accept.

b) More customization for term deals. Check boxes for custom terms with a free form field for any terms that are not covered in check boxes, for example:

Changing start and stop times to change ramp (flexible ramp)

Buy back (buy back at discount at LMP and specify the discount)

Comment field

Custom strips

c) Explore ways to turn Market Window 2002 into full-scale deal capture system.

d) Allow a vertical split screen within the Schedule Manager Screen, permitting the user to hold one asset or counterparty on the Screen while scrolling through other assets and counterparties. This feature could work in a manner similar to the split-screen feature of MS Excel.

4.0 The APX Order Summary Screen

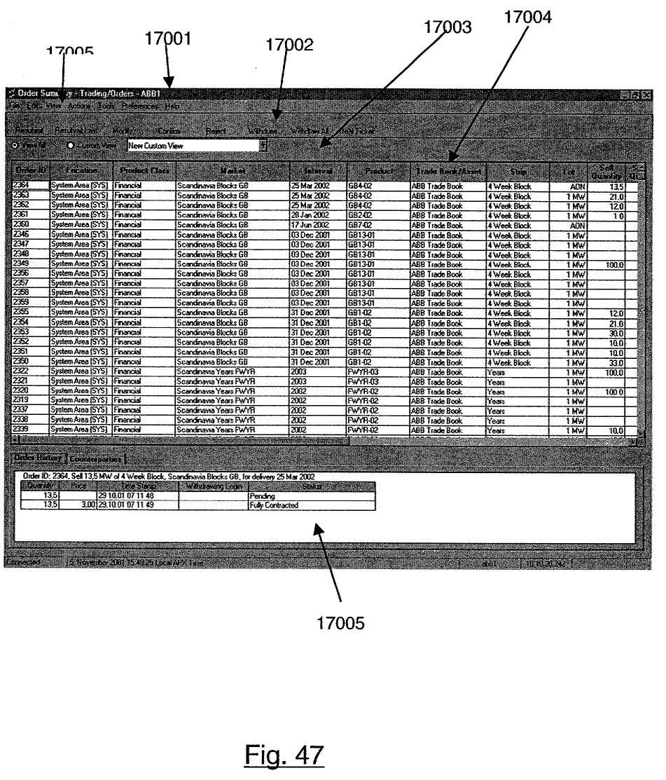

Referring to FIG. 47, the APX Market Window 2002 Order Summary Screen 17001 allows the user to view the details of their orders, both past and still open. All market, bilateral, and asset transfer orders are listed. The layout of the Order Summary screen is shown above.

4.1 The Selection Bar

The Selection Bar 17003, which appears above the data grid 17004, allows the user to select the items to be displayed, using a pull-down menu and one set of radio buttons. From left to right:

a. The “View All” Radio Button—If the user clicks on the “View All” radio button, all orders available will be displayed (all orders that are in the Market Engine database, generally going back a few days). The system remembers the Screen Preferences selected by the user (using the “Screen Preferences” pop-up window described in Section 4.5.3.1) from the last time the user was in “View All” mode.

b. The Custom View—If the user selects the “Custom View” radio button, the user may select the custom view to apply using this pull-down menu. Custom views are customized versions of the screen. One of the custom views always on the list is called “New Custom View”. If the user selects “New Custom View”, the Screen Options pop-up window appears (see Section 4.5.3.1) allowing the user to define a new custom view. The list of custom views is saved locally on the user's machine. The system remembers the last custom view the user displayed, and select it when the user clicks “Saved Custom View”. Custom views appear on the list in alphabetical order, except for “New Custom View” which appears at the end of the list.

4.2The Data Grid

The data grid 17004 displays information on the orders selected by the user. Column widths are adjustable by clicking or dragging on the tops of the lines between columns.

4.3 Column Functionality (Order Summary)

Name in quotes at the left are the column heading. Description to the right is the tool tip when the user highlights the column; the notes in parenthesis should not be included in the tool tip. Columns marked with a # appear in the default configuration.

The Order Summary Screen has the following columns:

1. #“Order ID”—Unique Number Identifying the Order

2. #“Location”—The Hub Location for the Order

3. #“Product Class”—The Product Class of the Order [such as “Energy”, “Tickets”, “Spinning”, etc.]

4. #“Market—The Market Segment for Market Orders, Otherwise Blank

5. #“Interval”—Name of the Interval (usually Date and Time)

6. #“Product”—The Product Code for this Market and Interval [See Section 1.10 for a description of Product Codes].

7. #“Trade Book/Asset”—The Trade Book or Asset for Which the Order Was Placed (will be blank for bilaterals)

8. #“Strip”—The Strip

9. “Lot”—The Lot Size for the Order

10. #“Sell Quantity”—The Order Quantity of the Market or Bilateral Sell Order in Megawatts

11. #“Source Quantity”—The Quantity of the Asset Transfer Source Order in Megawatts

12. #“Buy Quantity”—The Order Quantity of the Market or Bilateral Buy Order in Megawatts

13. #“Sink Quantity”—The Order Quantity of the Asset Transfer Sink Order in Megawatts

14. #“Limit Price”—For Bids, the Highest Price the Buyer is Willing to Pay; for Offers, the Lowest Price the Seller is Willing to Accept (Should Say “Market” for market orders, not blank, but may be blank for asset transfers and bilaterals without a price.)

15. #“Status”—F=Filled O=Open/Outbox, I=Inbox, W=Withdrawn, R=Rejected; Multiple Letters May Be Used If Portions of the Order Have Different Statuses, Such as FO If the Order Is Partly Filled and Partly Open

16. Last Status Change Time—Date and Time of Last Change to the Status of This Order

17. Order Type—B=Bilateral, M=Market, T=Asset Transfer

18. #“Submit Time”—Date and Time the Order Was Submitted

19. #“Submitting Login”—Login ID of Person Who Placed the Order

20. #“Expire Time”—Date and Time When the Order Expires

21. #“Filled”—The Quantity That Has Been Filled So Far in Megawatts (Should NOT Say ‘b’ or ‘s’ to Indicate Buy or Sell)

22. #“Average Price”—The Weighted Average Price for the Portion of the Order That Has Been Filled So Far

23. “Bilateral Party”—For Bilaterals Only, This Column Shows the Counterparty Name

24. #“Credit Method”—The Credit Method Specified (APX or Self)

4.4 Screen Tabs Functionality

The bottom portion of the screen 17005 contains two displays that may be selected with tabs. The information on each display is specific to the order selected in the upper grid. Above the grid for each of these tabs is a row showing the order ID, whether the order is to buy, sell, source, or sink, the quantity of the order, the strip, the market segment (for market orders) or product/location for bilateral and asset transfer orders, and the delivery interval.

a. “Order History”—Shows one row for each separately filled block of the order, plus any remaining unfilled portion. The columns are as follows.

1. The Quantity of This Portion of the Order (Should Not Say ‘b’ or ‘s’ to Indicate Buy or Sell)

2. Portion Price”—The Price at Which This Portion of the Order Was Filled

3. Time Stamp”—The Date and Time This Portion of the Order Was Filled, Withdrawn, or Rejected (leave blank if order is still open)

4. Withdrawing Login—Login ID of the user who withdrew this portion of the order; blank if this portion of the order was not withdrawn

5. #“Status”—Text Description of Status of Order (from Messages)

b. “Counterparties”—Shows one row for each combination of separately filled quantity and counterparty. The only time a separately filled quantity of an order may have more than one counterparty is when the order has been matched with several orders for different sub-intervals (for example, a daily order has been matched with hourly orders). This information should, of course, only be disclosed in market segments where the “Disclose Parties” flag has been set in configuration. The columns are as follows:

1. “Counterparty”—Counterparty Name. Right-Click for Contact Information.

2. “Quantity”—The Quantity of This Portion of the Order (Should Not Say ‘b’ or ‘s’ to Indicate Buy or Sell)

3. “Price”—The Price at Which This Portion of the Order Was Filled

4. “Begin Time”—The Starting Date and Time for this Portion of the Order

5. “End Time”—The Ending Date and Time for this Portion of the Order

6. “Phone Number”—The Counterparty's Telephone Number

A tool tip when the user points to anywhere on the Counterparties tab says “Double-click for counterparty information”. When the user double-clicks, the counterparty information pop-up window appears for the selected row. The “Order Contact” is the name of the person who placed the order, as shown in the registration information for the login placing the order. Ideally, the phone numbers and e-mail address match this order contact. The SC/QSE for the participant can be determined from the trade book/asset where the trade was done. Except for the use of the word “Counterparty” instead of “Participant”, the Counterparty Information pop-up window is the same as the Participant Information pop-up window discussed in Section 2.10.1.

Clicking on the e-mail address causes a web form for creating a new e-mail message to pop-up addressed to this counterparty.

4.5 Screen Menu and Toolbar

At the top of the screen is a pull-down menu and toolbar 17005. All of the buttons on the toolbar are also accessible through the pull-down menu. Options on the pull-down menu that are common to several screens have already been discussed in Section 1.3. Options that are unique to the Order Summary screen are discussed here. The File, Edit, Tools, and Help menus contain only Options discussed in Section 1.3.

4.5.1 The View Menu

The only option that appears on the View Menu in the Order Summary screen is “Deal Ticket.

4.5.1.1 Deal Ticket

The “Deal Ticket” option allows the user to view, and if desired print, a “deal confirmation ticket” for the highlighted order. “Deal Ticket” is also a button on the Order Summary screen toolbar, and a right-click option. Deal confirmation tickets may be printed out only for filled orders (market or bilateral). If the highlighted order does not have a status of “Filled”, then an error message box should appear reading “Error: Highlighted order has not been filled.” The user may close the message box by clicking a button labeled “OK”. If the user highlights more than one order, then the system should attempt to generate a deal ticket only for the first highlighted order.

Pressing the Print Button causes the dialog box described in Section 1.3.1.1 to appear. The user may specify that deal tickets should be printed automatically for each trade.

The tickets come in several variants. The simplest case is when an entire order has been matched with a single counterparty. If the order has been matched with different counterparties in different subintervals, then the different counterparties are listed next to “Purchaser” or “Seller” as appropriate, along with the beginning and ending time of the each subinterval, as shown in the second of the figures above. If the order has been matched in several separately filled blocks of megawatts, then a separate ticket is produced for each block. Should one or more of these blocks be matched with different counterparties in different subintervals, then the different counterparties are listed next to “Purchaser” or “Seller”. In all cases, the ‘Market’ field should be left blank for bilateral orders.

The system automatically e-mails copies of the confirmation tickets for each trade to a pre-specified address (such as the participant's back office). Tickets can be e-mailed in comma delimited or XML format, as well as text.

4.5.2 The Actions Menu

The Actions menu contains seven basic trading functions. For users logging in with “APX Broker” privileges who have selected participant “Specify Later” on the participant drop-down menu, an additional option appears on the Actions menu labeled “Assign Party”. This option is used to assign a participant to a deal that the broker has already done, as discussed in Section 4.5.4.

4.5.2.1 Resubmit

The Resubmit option allows the user to resubmit market or bilateral orders that have previously been withdrawn. Resubmit is also an option on the toolbar and an option on the right-click menu. Selecting this option causes a pop-up window to appear. All withdrawn orders in the rows highlighted by the user in intervals for which trading is still open should appear and should be checked. If none of the highlighted orders have a status of “Withdrawn” and is in an interval for which trading is still open, then an error message box should appear reading “Error: No withdrawn orders for which trading is still open have been highlighted.” The user may close the message box by clicking a button labeled “OK”.

Market orders will be listed in the format:

[{Buy|Sell}]XMWs[Product Code]@Y [Currency Symbol].

In the event that the product does not have a product code, orders will be listed in the format:

[{Buy|Sell}]XMWs @Y[Currency Symbol]

[Name of Strip][Name of Market] for [Interval].

Bilateral orders will be listed in the format

[{Buy|Sell}]XMWs[Product Code]@Y[Currency Symbol]

[name of location][{from|to}][counterparty name].

In the event that the product does not have a product code, bilateral orders will be listed in the format:

{Buy|Sell}XMWs@$Y for [interval]

[name of strip][name of product]/[name of location]

[{from|to}][counterparty name].

a. “Select All” button. Clicking this button causes all orders to be checked (the default).

b. “Unselect All” button—Clicking this button causes all orders not be checked.

c. “Resubmit” button—Clicking this button causes the checked orders to be submitted and the Resubmit pop-up window to close. The user is allowed to modify the price on a Resubmit.

d. “Cancel” button—Clicking this button closes the Resubmit pop-up window with no action taken. It is equivalent to clicking the “X” in the upper right corner of the pop-up window.

4.5.2.2 Resubmit Last

The Resubmit Last option allows the user to resubmit the last set of APX Market or bilateral orders to have been withdrawn. Resubmit Last is also an option on the toolbar. Selecting this option causes the Resubmit pop-up window discussed in the previous section to appear. The only difference is that the orders listed in the pop-up window will be the last set of orders to have been withdrawn. All the orders should have been withdrawn in the same Withdraw All or Withdraw action. If there are no orders with a status of “Withdrawn” still in the system, then an error message box appears reading “Error: There are no withdrawn orders.” If there are orders with a status of withdrawn, but there are none in the last lot withdrawn that are in intervals for which trading is still open, then an error message box appears reading “Error: None of the last orders withdrawn are in intervals for which trading is still open.” The user may close either message box by clicking a button labeled “OK”.

The system does not permit the same set of orders to be resubmitted twice. A flag of some type is stored in the Options file to prevent a user from resubmitting orders that have been resubmitted in a previous session. This flag does not provide absolute protection against resubmitting orders that have been resubmitted in a previous session. For this reason, the system compares the withdraw time stamp on the orders to the start time of the current session. If the orders were withdrawn in a previous session, the system generates a warning message that reads “Warning: The orders you are about to resubmit were withdrawn in a previous session. Therefore, it is also possible that they were already resubmitted in a previous session. Do you wish to continue?” The user may choose from buttons labeled “OK”, which continues the Resubmit Last process, or “Cancel”, which cancels the Resubmit last process.

4.5.2.3 Modify

The Modify option allows the user to modify market or bilateral orders with a status of “Open/Outbox”. This option is described in Section 2.5.3.4. Modify can also be invoked from the toolbar, the right-click menu, or by pressing Cntl-M. If none of the highlighted orders has a status of “Open/Outbox”, then an error message appears reading “Error: No Open/Outbox orders have been highlighted.” The user may close the message box by clicking “OK”.

For market orders, the user may modify the quantity, price, lot size, expire date, expire time, or credit method. For bilateral orders, users may modify only the quantity and price.

4.5.2.4 Confirm

The Confirm option allows the user to confirm bilaterals proposed by other counterparties. The Confirm option may also be accessed from the toolbar, a right-click menu, or by pressing Ctrl-Y. Selecting the Confirm option causes a pop-up window to appear. All orders with a status of “Inbox” in the rows highlighted by the user appear and are checked. Orders are listed in the same format used in the Resubmit pop-up box shown in Section 4.5.2.1 above. If none of the highlighted orders have a status of “Inbox”, then an error message box appears reading “Error: No inbox orders have been highlighted.” The user may close the message box by clicking a button labeled “OK”.

a. “Select All” button. Clicking this button causes all orders to be checked (the default).

b. “Unselect All” button—Clicking this button causes all orders not be checked.

c. “Confirm” button—Clicking this button causes the checked orders to be confirmed and the Confirm Orders pop-up window to close.

d. “Cancel” button—Clicking this button closes the “Confirm Orders” pop-up window with no action taken. It is equivalent to clicking the “X” in the upper right corner of the pop-up window.

4.5.2.5 Reject

The Reject option allows the user to reject bilaterals proposed by other counterparties. The Reject option may also be accessed from the toolbar or a right-click menu. Selecting the Reject option causes a pop-up window to appear. All orders with a status of “Inbox” in the rows highlighted by the user appear and are checked. Orders are listed in the same format used in the Resubmit pop-up box shown in Section 4.5.2.1 above. If none of the selected orders have a status of “Inbox”, then an error message box appears reading “Error: No inbox orders have been selected.” The user may close the message box by clicking a button labeled “OK”.

a. “Select All” button. Clicking this button causes all orders to be checked (the default).

b. “Unselect All” button—Clicking this button causes all orders not be checked.

c. “Reject” button—Clicking this button causes the checked orders to be rejected and the Confirm Orders pop-up window to close.

d. “Cancel” button—Clicking this button closes the “Reject Orders” pop-up window with no action taken. It is equivalent to clicking the “X” in the upper right corner of the pop-up window.

4.5.2.6 Withdraw/Recall

The “Withdraw” option allows the user to withdraw market orders or recall bilateral orders submitted by any login in the user's account. The Withdraw option may also be accessed from the toolbar, a right-click menu, or by pressing Ctrl-W. Selecting the Withdraw option causes a pop-up window to appear. All APX Market orders and bilateral orders with a status of “open/outbox” in the rows of the Order Summary screen that the user is currently highlighting appear and are checked. Orders are listed in the same format used in the Resubmit pop-up box shown in Section 4.5.2.1 above. If none of the selected orders have a status of “Open/Outbox”, then an error message box appears reading “Error: No open/outbox orders have been highlighted.” The user may close the message box by clicking a button labeled “OK”.

a. “Select All” button. Clicking this button causes all orders to be checked (the default).

b. “Unselect All” button—Clicking this button causes all orders not be checked.

c. “Withdraw” button—Clicking this button causes the checked orders to be withdrawn and the Withdraw Orders pop-up window to close.

d. “Cancel” button—Clicking this button closes the “Withdraw Orders” pop-up window with no action taken. It is equivalent to clicking the “X” in the upper right corner of the pop-up window.

4.5.2.7 Withdraw All

The function of the “Withdraw All” option is described in Section 1.3.4.4. The Withdraw All option withdraws only open market orders, not bilateral orders.

4.5.3 The Preferences Menu

The Preferences menu invokes two pop-up menus that allow the user to configure the behavior of the program.

4.5.3.1 Screen Preferences

The Screen Preferences option allows the user to vary the format of the Order Summary screen, and define filters for the data. Selecting the Screen Preferences option causes a pop-up window to appear. Screen Preferences is also accessible from the right-click menu. The pop-up window has four tabs—“Columns”, “Sort”, “Market Filter”, and “Other Filters”.

The Columns tab allows the user to specify the columns to be displayed. The columns to choose from are listed in Section 4.3.

The “Sort” tab allows the user to select the sort sequence for the rows of the Order Summary screen. The user may choose to sort on up to three columns, selected using the pull-down menus. All currently selected columns are available on the pull-down menus. The default sort should be by Order ID.

The Market Filter tab is available only if the user has clicked the “Custom View” radio button on the Selection Bar. The tab shows a list of all market segments registered to this participant login (even if the login does not have Trader privileges—see Section 1.11). The ordering of the market segments is as specified in the Global Preferences “Sorting” tab (see Section 1.3.6). The user may select the market segment by checking or unchecking. Any number of market segments may be selected. Clicking the “Select all” button will cause all market segments to become checked. Clicking the “Unselect all” button will cause all market segments to become unchecked. If there are more market segments than can fit on the display, the display area will scroll. The default selection is to check all market segments.

If the user selects a market segment using this tab, the filter also picks up all bilaterals and asset transfers in the product/location combinations represented by these markets. For example, if the user checks the “APX So. CA Energy (Hourly/Daily)” market segment, the filter should also pick up all bilaterals and asset transfers for product energy with location in Southern California.

If there are significant numbers of participants who schedule, but are not registered to trade, additional filters are added by location and product for bilaterals and asset transfers.

The “Other Filters” tab is available only if the user has clicked the “Custom View” radio button on the Selection Bar. The items on this screen are:

a. Status—These checkboxes allow the user to select the status of the orders to be displayed.

b. Trade Book/Asset—Using this pull-down menu, the user can select either “All” to display orders for all trade books and assets, or a specific trade book or asset. The pull-down menu includes the user's trade books and all assets.

c. Strip—Using this pull-down menu, the user can select either “All” to display orders for all strips, or a specific strip. The pull-down menu includes all strips for which the user is registered to trade.

d. Interval—Using the pull-down menu, as shown above, the user can select a variety of interval ranges for which to display orders. To the right are “from” and “to” date fields, where the user may enter dates required by the selection on the pull-down menu. “Between” requires a “from” and “to” date. “On or after” requires a “from” date. “On or before” requires a “to” date. A pop-up calendar for selecting the date is available by clicking the calendar icon next to the date entry field.

e. Submitting Login ID—Using the radio buttons, the user may choose whether to display orders submitted only by him/herself, or to display orders for all logins under the user's account.

f. Counterparty—Using the pull-down menu, as shown above, the user can select a class of counterparty arrangements to display. If the user selects “bilateral counterparty”, the user must also select the bilateral counterparty from another pull-down menu to the right. The list of potential counterparties includes all APX participants registered to engage in bilateral transactions.

For all four tabs, the buttons that appear at the bottom of the screen are as follows:

a. “Save Custom View As”—Clicking this button will save a new custom view under the name entered by the user in the space at the left and close the Screen Options pop-up window. The Selection Bar switches to the “Custom View” radio button, if not already selected, and show the new custom view as the selected custom view. If the user attempts to save a custom view for which no markets have been selected, an error message will pop-up saying “Error: No markets have been selected”. If the user attempts to save a custom view without entering a name for the custom view, an error message will pop-up saying “Error: No name entered for custom view.” In either case, the user may click a button labeled “OK” to return to the Screen Options pop-up window.

b. “Delete Custom View”—Clicking this view will cause a warning message to pop up reading “Warning: Custom View XXX Will Be Deleted.”, where XXX is the name of the currently selected custom view. The user may select from buttons labeled “OK” or “Cancel”. If the user clicks “OK”, the currently selected custom view will be deleted, the warning message and the Screen Options pop-up window will close, and the Selection Bar will switch to the “View All” radio button. If the user clicks “Cancel, the warning message will close and the user will be returned to the Screen Options pop-up window.

c. “Update”—Clicking this option overwrites the previous settings for this view (whether a Custom View or View All) with the currently selected settings and closes the Screen Options pop-up window. There is no warning before saving. This option is not available if the “Custom View” radio button is clicked and the pull-down menu on the Selection Bar shows “New Custom View”.

d. “Cancel” button—Clicking this button closes the Screen Options pop-up window with no action taken. It is equivalent to clicking the “X” in the upper right corner of the pop-up window.

Screen Options for both Custom Views and View All mode are saved in the Options file, and will be used in future sessions for this login on this machine.

4.5.3.2 Global Preferences

The Global Preferences” option is described in Section 1.3.6.

4.5.4 Assign Party

As explained in Section 2.10.2, the Broker Version of the APX Financial Market screen allows APX brokers to do transactions on behalf of a participant called “Specify Later”. The “Assign Party” option on the Tools drop-down menu allows APX Brokers to assign a participant to these trades after the deal has been done.

Recall that for users with “APX Broker” login privileges, the Market Window 2002 Main Menu contains a drop-down menu to select the participant (see Section 1.2.9). The user will see the Order Summary screen as if he/she were logged in to the selected participant account; in other words, the user will see the Order Summary as that participant sees it. The participant selection is NOT saved with the screen options that go with “View All” or any custom view.

One of the participants that may be selected is called “Specify Later”. When the user selects this “participant”, the user will see all orders that have been placed on behalf of participant “Specify Later” by any login for the APX broker account. Before filled orders on behalf of participant “Specify Later” can be settled, a true participant must be assigned to each order. Allowing the broker to assign a participant to these filled orders is the function of the “Assign Party” option. The “Assign Party” option should appear on the Tools menu only for users with “APX Broker” login privileges, and only if the user has selected participant “Specify Later” on the participant drop-down menu.

If the user highlights one or more filled orders and selects the “Assign Parties” option, the pop-up window shown above will appear. The user may select the participant to whom the orders really belong and may click “OK” to assign the orders to that participant. The user may configure the pull-down menu of participants using the Setup Screen, as described in Section 6.X.X. The user may click Cancel to close the Assign Parties pop-up window and return to the Order Summary Screen.

If the user is highlighting an order that has not been filled, or a set of orders that includes one or more orders that have not been filled, and selects the “Assign Parties” option, an error message pop-up window appears. The message should read “Error: Not all the highlighted orders have been filled.” The user may click “OK” to close the error message pop-up window and return to the Order Summary screen.

The user may only assign a party to filled orders initially assigned to participant “Specify Later”. It is not possible to reassign orders from one participant to another, or to assign orders back to “Specify Later”. If the broker makes a mistake in assigning a participant to an order, the error must be corrected in the settlement process. Brokers are, however, not limited to assigning parties to orders they entered; any broker can assign a party to an order entered by any other broker.

4.6 Right-Click and Double-Click Functionality

Right-clicking in the grid area of the Order Summary screen results in the pop-up menu shown above. All of the options on this menu are just different ways to get at functionality described elsewhere in this document. There is no right click functionality on the screen tabs.

a. “Copy”, “Select All”, and “Print” are the same as selecting these options on the Edit pull down menu, as described in Section 1.3.2.

b. “Resubmit” is the same as selecting the “Resubmit” option, as described in Section 4.5.2.1.

c. “Modify” is the same as selecting the “Modify” option, as described in Section 4.5.2.3

d. Confirm is the same as selecting the “Confirm” option, as described in Section 4.5.2.4.

e. “Reject” is the same as selecting the “Reject” option, as described in Section 4.5.2.5.

f. “Withdraw” is the same as selecting the “Withdraw” option, as described in Section 4.5.2.6.

g. “Screen Preferences” is the same as selecting the Screen Preferences option, as described in Section 4.5.3.1

h. “Deal Ticket” is the same as selecting the “Ticket” option, as described in Section 4.5.1.1.

i. “Hide Borders”/“Show Borders” is the same as selecting this option on the right-click menu of the Market Screen, as described in Section 2.9.1.

Double clicking on the main grid area is the same as selecting the “Resubmit” option. Double-clicking on the “Counterparties” tab displays the Counterparty Information for the selected counterparty (see Section 4.4b). There is no double-click functionality on the “Order History” tab.

5.0 Reports

The Reports screen for Market Window 2002 enables the user to create customized reports showing data on the market and on the user's own transactions. All report data may be copied and pasted into an Excel spreadsheet for charting and analysis.

5.1 Reports Menu

The Reports Menu is available on both the “Trading” and “Scheduling” pull-down menu of the Market Window 2002 Main Menu. The options on the “Trading” and “Scheduling” reports menus include only those reports relevant to trading and scheduling, respectively. A total of six reports are available:

a. Market Data by Delivery Time

b. Market Data by Trade Time (“Trading” menu only)

c. Detailed Checkout Report (“Scheduling” menu only)

d. Summary Checkout Report (“Scheduling” menu only)

e. Transactions by Delivery Time

f. Transactions by Trade Time (“Trading” menu only)

All of these reports are generated within Market Window 2002. In addition, a Broker Summary Report for Scandinavia should be available to APX Brokers through the Clearing System.

5.2 Selection Bar

The selection bar allows the user to choose whether to create a new report or view an existing saved report (‘Test 1’ in this example). The pull down menu includes all saved reports of the type selected on the Reports Menu. The report definitions are saved on the user's own machine. If the user selects “New Report”, the Screen Preferences menu, as described in Section 5.4.2.1, will appear for defining the report. “New Report” is the default selection the first time each report type is selected. Subsequently, the default selection becomes the report last viewed.

5.3 Report Contents

Each of the reports discussed here may be customized by the user using the Screen Preferences menu, as described in Section 5.4.2.1.

5.3.1 Market Data by Delivery Time

In the Market Data by Delivery Time report, each data column should have a three-row heading. The first row of each data column heading gives the name of the market segment. The second row of each data column heading gives the name of the strip. The third row of each data column heading gives the name of the data attribute. The report may be scrolled up and down or left and right, as necessary. Up to seven data columns may be selected.

The intervals shown at the left correspond to the selected data column with the shortest intervals. For example, if the user elects to display both daily and hourly data in the same report, the intervals shown at the left would be hourly. In the daily columns, the daily data would simply be repeated for each hour of the day. In the event that two columns are tied for shortest interval (such as hour beginning and hour ending), the leftmost of the two columns define the intervals used. The date and time formats for these intervals correspond to the short date and time format selected on through the user's operating system.

For columns that use intervals that do not match those displayed at the left, the proper value to be displayed is the value corresponding to the midpoint of the interval shown at the left. For example, if the user creates a report showing monthly values in one column and weekly values in the other column, the intervals appearing at the left would be weekly, since weekly is the shortest of the intervals. To determine the monthly values corresponding to each of these weeks, the report should determine the appropriate monthly value at the middle of each week. So if a week begins on September 30 and ends on October 6, then the October value should be displayed in the monthly column corresponding to the week beginning September 30, since the midpoint of the week (October 3) lies in October. Here are two more examples to make this clearer.

Example 1: Suppose the user elects to display both daily and weekly strips in the report. The intervals shown will be daily, since daily is shorter than weekly. The values shown for the weekly strips will be the weekly values that apply at the middle of each day. In this example, assuming weeks begin on Sunday, the user would see something like:

| | APX No. | |
|---|---|---|
| | California Energy | APX No. California Energy |
| | Daily On-Peak | Weekly |
| Interval | Average Price | Average Price |
| Thurs. Sep. 6, 2001 | 36. | 41. |
| Fri. Sep. 7, 2001 | 39. | 41. |
| Sat. Sep. 8, 2001 | 28. | 41. |
| Sun. Sep. 9, 2001 | 25. | 38. |
| Mon. Sep. 10, 2001 | 38. | 38. |
| Tues. Sep. 11, 2001 | 35. | 38. |
| Wed. Sep. 12, 2001 | 37. | 38. |
| Thurs. Sep. 13, 2001 | 36. | 38. |
| Fri. Sep. 14, 2001 | 38. | 38. |
| Sat. Sep. 15, 2001 | 30. | 38. |
| Sun. Sep. 16, 2001 | 29. | 40. |
| Mon. Sep. 17, 2001 | 38. | 40. |

Example 2 (Trickier): Suppose the user elects to display both hourly (hour-ending) and daily on-peak (where ‘on-peak’ is 7 am to 8 pm). In this example, the user would see something like:

| | APX No. California Energy | APX No. California Energy |
|---|---|---|
| | Daily On-Peak | Hourly |
| | Average Price | Average Price |
| 9/6/01 HE 1 | — | 25. |
| 9/6/01 HE 2 | — | 24. |
| 9/6/01 HE 3 | — | 23. |
| 9/6/01 HE 4 | — | 25. |
| 9/6/01 HE 5 | — | 26. |
| 9/6/01 HE 6 | — | 28. |
| 9/6/01 HE 7 | —* | 30. |
| 9/6/01 HE 8 | 32. | 33. |
| 9/6/01 HE 9 | 32. | 34. |
| 9/6/01 HE 10 | 32. | 35. |
| . | . | . |
| . | . | . |
| . | . | . |
| 9/6/01 HE 19 | 32. | 34. |
| 9/6/01 HE 20 | 32. | 35. |
| 9/6/01 HE 21 | —* | 33. |

(*note:
HE 7 has midpoint at 6:30, so there is no corresponding on-peak price. Similarly, HE 21 has midpoint at 20:30, so there is no corresponding on-peak price)

Each data column shows data converted to the time zone selected by the user through the Screen Preferences menu (see Section 5.4.2.1.1). The report is limited in length to 100 intervals. If the user specifies beginning and ending date/times that would require listing more than 100 intervals, the user receives a warning: “Warning: More than 100 intervals in the specified time period; intervals beyond the 100th interval will not be shown.”

5.3.2 Market Data by Trade Time

| | APX No. | |
|---|---|---|
| | California Energy | APX No. California Energy |
| | Hourly | Hourly |
| Trade Time | Delivery Apr. 2, 2001 8 | Delivery Apr. 2, 2001 8 |
| Hour Beginning | Lowest Price | Highest Price |
| Apr. 1, 2001 1 | 150. | 200 |
| Apr. 1, 2001 2 | 200. | 200 |
| Apr. 1, 2001 3 | 175. | 250 |
| . | . | . |
| . | . | . |
| . | . | . |

The Market Data by Trade Time report shows data for a series of trading hours. This report should have the hours in the range selected by the user listed in the first column. Note that the trade times shown in the left column are always hours; this is not affected by the choice of strips for which data is to be displayed. In future versions of this report, it may be useful to allow the user to display trading intervals other than hours.

Up to seven data columns may be specified. Each column should have a four-row heading. The first row of each data column gives the name of the market. The second row of each data column gives the name of the strip. The third row of each data column gives the delivery interval preceded by the word “Delivery”. The fourth row gives the name of the data attribute.

Times for the delivery intervals are converted to the time zone selected by the user through the Screen Preferences menu (see Section 5.4.2.1.1). However, the trade times shown in the first column correspond to local time for the user—that is, GMT as broadcast by the server, adjusted to the user's time zone.

5.3.3 The Detailed Checkout Report

The Detailed Checkout Report described in this section, and the Summary Checkout Report described in the next section, are designed to help users understand their commitments and verify that their physical resources match their market commitments. Currently these reports are applicable only for California and Texas, since only in California and Texas does APX physically schedule. The reports will probably need to be somewhat custom-coded for each of these “control areas”, so as to properly reflect the locations within the control areas.

The Checkout report has a separate section for each delivery interval during the day selected by the user. The intervals should be at the lowest level at which the user has done any transactions for delivery on this day. For example, if the user has done only daily or longer transactions for delivery on the selected day, then the only intervals that need to be shown are daily intervals. However, if the user has done even a single hourly transaction for delivery on the selected day, then the intervals shown should be hourly.

Under each time interval is a section for each asset at which the user has done asset transfers or APX Market transactions that span the interval. (“Spanning the interval” means transactions or asset transfers that would include the interval. For example, a daily transaction would span each of the hourly intervals in that day.) The ‘Trade Book’ is NOT one of these assets, although there is a separate section for the APX Market discussed below. For example, there is only one asset, “Hyatt Generation”. Under each asset are listed the specific APX markets and strips for which the user has done asset transfers or APX Market transactions. Since asset transfers are done by Scheduling Space, not by market segment (see Section 3.2.1), asset transfers will be listed under the default market segment. Assume in this example that ‘APX No. California Energy’ is the default market segment for Northern California scheduling space asset transfers and ‘APX So. California Energy’ is the default market segment for Southern California scheduling space asset transfers. In the example, we are examining an hourly interval (Apr. 1, 2001 1), but the user has done hourly, daily off-peak, and monthly transactions that span this interval, and thus represent a commitment of this asset for this interval.

The report contains two columns for each delivery location (scheduling space) in which the user has done trades or asset transfers in the given time interval, plus two “Total” columns. For example, there are two locations where the user may have done transactions—No. California and So. California—giving a total of four columns. The numbers in the “Source” column for an asset will be the sum of asset transfers sourced at this asset and APX Market sales for this asset (that is, sales where the participant sold directly from the asset, not from the Trade Book). The numbers in the “Sink” column for an asset will be the sum of all asset transfers for which this asset is a sink and all APX Market purchases for this asset. Bilateral sales and purchases are not associated with an asset, and thus do not directly affect these numbers. Physical commitments for bilateral sales and purchases must be assigned through an asset transfer.

In this example, the user has done several asset transfers sourced at the Hyatt Generation asset. The user has also done a buyback in the APX No. California hourly market at the Hyatt Generation asset, for example, a 100 would show in the “Sink” column.

Source and sink totals in each delivery location are given for each asset. The difference between the source and sink totals for the asset represents the physical commitment of this asset to the given market. For example, Hyatt Generation is physically committed to produce 400−100=300 MW for Northern California delivery. If the sink total exceeded the source total, then the asset would be physically committed as a load. If the two are equal, then the asset is booked-out.

After the sections on each asset are similar sections on each bilateral counterparty with whom the user has done transactions. Here the “Source” column is relabeled “Buy” and the “Sink” column is relabeled “Sell”. These sections list all of the user's buys and sells with each bilateral counterparty that span the interval. If the user has done APX Market transactions using self-managed credit, these transactions will also show up as bilaterals with the counterparty with whom they were matched in the APX Market. Consistent with our philosophy of handling all bilateral trades as bilateral trades, there is no distinction in this report between counterparties for whom APX is the SC/QSE and counterparties who use other SC/QSEs.

After the sections on each asset and bilateral counterparty is a similar section on the APX Market, if the user has done transactions in the APX Market using APX-managed credit. Here the “Source” column is again relabeled “Buy” and the “Sink” column is again relabeled “Sell”. This section should list all the user's buys and sells in the APX Market that span the interval and used APX-managed credit. If the user is properly balanced, each transaction in the APX Market is represented twice in this report—once in the APX Market section and once as an offsetting amount in the section for the relevant asset, a bilateral counterparty, or the APX Market. For example, the user sells 100 MW in the APX No. California off-peak daily market, which shows up once as a sell in the APX Market section, and once as a source from Hyatt Generation. Similarly, all bilateral transactions should show up twice in this report—once in the section for the bilateral counterparty and once as an offsetting amount in the section for the relevant asset, another bilateral counterparty, or the APX Market.

Purchases and sales in the APX Market using APX-managed credit show up in the “APX Market” section of the Detailed Checkout report, while purchases and sales in the APX Market using self-managed credit show up in the bilateral counterparties section, regardless of whether the purchases and sales were made against the Trade Book or a specific asset. If purchases and sales were made against the Trade Book, the user must do asset transfers to identify the source or sink asset for the transactions before the Detailed Checkout Report will balance. If purchases and sales were made against a specific asset, then the source or sink asset has been identified as part of the trade and the Checkout Report will balance immediately.

When the participant's schedule is properly balanced, the final totals for the ‘source’ (or ‘buys’) column will equal the totals for the ‘sink’ (or ‘sells’ column) in each interval in each location. The power flowing in equals the power flowing out. Some examples may help to clarify how this report works.

| | No. California | |
|---|---|---|
| Asset: Hyatt Generation | Source | Sink |
| APX No. California Energy | | |
| Hourly | 100 | 0 |
| APX Market | Buys | Sells |
| APX No. California Energy | | |
| Hourly | 0 | 100 |

Example 1: The user sells 100 MW against his/her Trade Book into the hourly APX No. California Energy Market using APX-managed credit. Initially, this transaction would show up only as a Sell in Northern California under “APX Market; APX No. California Energy Market; Hourly”. The user will, therefore, be unbalanced. Later, the user does an asset transfer, assigning 100 MW of Source in Northern California to Hyatt Generation. This asset transfer would show up as a Source in Northern California under “Hyatt Generation; APX No. California Energy Market; Hourly” (since we assume APX No. California Energy is the default market for Northern California). The user is now balanced, since the 100 MW of Source equals the 100 MW of Sell.

| | So. California | |
|---|---|---|
| Asset: Hyatt Generation | Source | Sink |
| APX So. California Energy | | |
| Hourly | 100 | 0 |
| Bilateral: Enron | Buys | Sells |
| APX So. California Energy | | |
| Hourly | 0 | 100 |

Example 2: The user sells 100 MW against his/her Trade Book into the hourly APX So. California Energy Market using self-managed credit. The participant is matched with Enron as a buyer. Initially, this transaction would show up only as a Sell in Southern California under “Bilateral; Enron; APX So. California Energy Market; Hourly”. The user will, therefore, be unbalanced. Later, the user does an asset transfer, assigning 100 MW of Source in Southern California to Hyatt Generation. This asset transfer would show up as a Source in Southern California under “Hyatt Generation; APX So. California Energy Market; Hourly” (since we assume APX So. California Energy is the default market for Southern California). The user is now balanced, since the 100 MW of Source equals the 100 MW of Sell. Note, however, that since the Hyatt Generation facility is physically located in Northern California, the user is responsible for any congestion costs required to deliver power from this facility to Enron in Southern California.

| | No. California | |
|---|---|---|
| Asset: Hyatt Generation | Source | Sink |
| APX No. California Energy | | |
| Hourly | 100 | 0 |
| APX Market | Buys | Sells |
| APX No. California Energy | | |
| Hourly | 0 | 100 |

Example 3: The user sells 100 MW against the Hyatt Generation facility into the hourly APX No. California Energy Market using APX-managed credit. This transaction shows up as a Sell in Northern California under “APX Market; APX No. California Energy Market; Hourly” and a Source in Northern California from “Hyatt Generation; APX No. California Energy Market; Hourly”. Since the sale is matched with a source, the user is balanced with no further action required by the user.

| | So. California | |
|---|---|---|
| | Buys | Sells |
| Bilateral: SDG&E | | |
| APX So. California Energy | | |
| Hourly | 0 | 100 |
| APX Market | | |
| APX So. California Energy | | |
| Hourly | 100 | 0 |

Example 4: The user sells 100 MW in a bilateral transaction to SDG&E in Southern California. Initially, this transaction shows up as only as a Sell in Southern California under “Bilateral; SDG&E; APX So. California Energy Market; Hourly”. The user will, therefore, be unbalanced. The user then does a 100 MW purchase in the APX So. California Energy Market using APX-managed credit. This transaction shows up as a Buy in Southern California under “APX Market; APX So. California Energy Market; Hourly”. Since the purchase and sale are matched, the user is balanced.

5.3.4 Summary Checkout Report

The Summary Checkout Report gives interval totals of each column by market and strip over all assets, the APX Market, and the bilateral counterparties. Here the columns are labeled “Available” and “Required”. If the user is in balance, the “Available” and “Required” totals should match for each location. If the user is not in balance, this report tells the user which market and strip is causing the problem. The user can then consult the Detailed Checkout Report for more details.

Referring back to the Detailed Checkout Report for this example, in the Northern California market, the user is a source for 400 MW and has purchased an additional 100 MW in the APX Market using APX-managed credit, for a grand total of 500 MW available. The user has sold 300 MW in the APX Market using APX-managed credit, sold 100 MW through bilaterals, and is a sink for 100 MW, for a grand total of 500 MW required. (Of course, this user does not actually sink 100 MW—the 100 MW goes against the 400 MW sourced for a net total generation of 300 MW.) This explains why everything checks out in the Summary Checkout Report.

5.3.5 APX Market and Bilateral Transactions by Delivery Interval

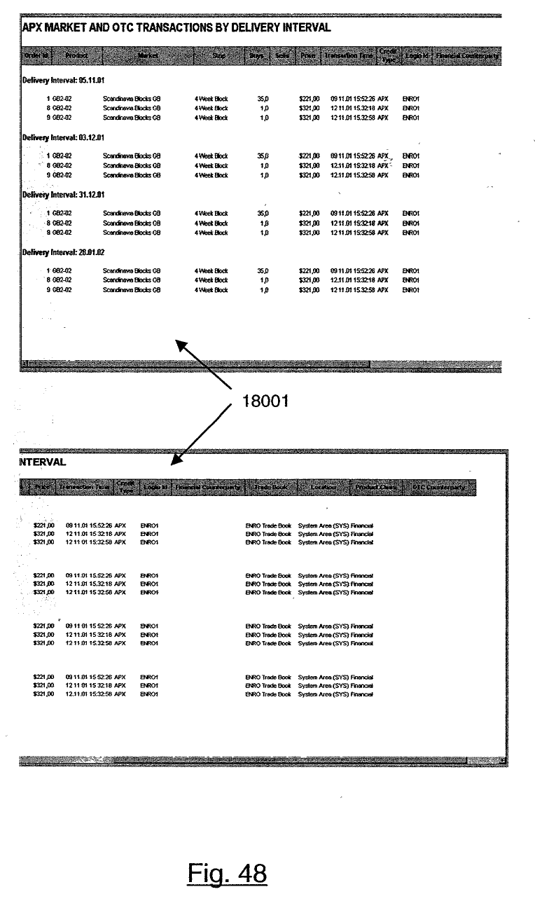

With respect to FIG. 48, the APX Market and Bilateral Transactions by Delivery Interval report 18001 is designed to give the user a listing of all their APX Market and Bilateral transactions that span a particular delivery interval. (Note that the two figures above show the left and right sides of the same report.) The delivery intervals shown should be at the lowest level at which the user did any APX Market transactions on the specified date. Within each delivery interval, transactions should be sorted by Order ID, then by transaction time. Only APX Market and Bilateral transactions are shown, not asset transfers.

In this report, each separately contracted portion of an order is considered a separate transaction. If the order was split into several contracts by quantity (for example 50 MW with counterparty A and 50 MW with counterparty B), then each portion should be listed separately in each interval spanned by the order. If the order was split into several contracts by time (for example, the user's daily on-peak order was matched with 16 hourly orders), then only the contract portions spanning the specific interval are listed under that interval.

As usual, the delivery time should be converted to the time zone selected by the user through the Screen Preferences menu (see Section 5.4.2.1.1). However, transaction times are in the user's local time.

The report is limited to 100 transactions in length. If the user specifies a time period containing more than 100 transactions, only the first 100 transactions will be shown. Before the report is generated, the user will receive a warning: “Warning: More than 100 transactions in the specified time period; transactions beyond the 100th transaction will not be shown.”

The report is also limited to 100 time intervals. If the user specifies a time period containing more than 100 time intervals, only the first 100 time intervals will be shown. Before the report is generated, the user will receive a warning: “Warning: More than 100 intervals in the specified time period; intervals beyond the 100th interval will not be shown.”

5.3.6 APX Market and Bilateral Transactions by Trade Time

The APX Market and Bilateral Transactions by Trade Date report is designed to give the user a chronological listing of all transactions according to the time the order contracted. The report is sorted by transaction time, then by delivery interval. As with the APX Market and Bilateral Transactions by Delivery Interval report, each separately contracted portion of an order is considered a separate transaction. Only APX Market and Bilateral transactions are shown, not asset transfers.

As usual, the delivery times shown are converted to the time zone selected by the user through the Screen Preferences menu (see Section 5.4.2.1.1). However, transaction times are in the user's local time.

The report is limited to 100 transactions in length. If the user specifies a time period containing more than 100 transactions, only the first 100 transactions will be shown. Before the report is generated, the user will receive a warning: “Warning: More than 100 transactions in the specified time period; transactions beyond the 100th transaction will not be shown”

5.3.7 Broker Summary Report

The Broker Summary Report is available only to APX employees through the Clearing System. It is designed to help APX brokers understand market trends and evaluate their own performance. The report lists all transactions, whether or not they were assisted by an APX broker.

An “O” indicates that the customer who was the Originator of the order. An “A” indicates the Aggressor who matched the order. A “Trader/Broker” column shows the name of the person who placed the order, as shown in the registration information for the login. For “Own” orders, this would be the name of the customer trader; for “APX Broker” orders, this would be the name of the APX broker. A date is shown in the “Short Date” format selected through the user's operating system. The time is shown in HH:MM:SS 24-hour format.

The user is able to sort the report by any column by clicking on the column heading.

5.3.8 Imbalance Report

A report is available to APX Operators at all times showing information on customers who are imbalanced. This report probably belongs in the Query Window currently used to APX Operators to diagnose imbalances. The report includes the customer name, location, and size of imbalance (+for long, −for short) for each combination of customer and location where there is an imbalance. Operators are able to filter by control area and location.

5.4 Screen Menu and Toolbar

At the top of the screen is a pull-down menu and toolbar. Options on the pull-down menu that are common to several screens have already been discussed in Section 1.3. Options that are unique to the Reports screens are discussed here. The File, Edit, Tools, and Help menus contain only options discussed in Section 1.3.

5.4.1 The Actions Menu

The only option on the Actions Menu is “Withdraw All”.

5.4.1.1 Withdraw All

The “Withdraw All” option is described in Section 1.3.4.4. It is also the only button on the toolbar.

5.4.2 The Preferences Menu

The Preferences Menu invokes two pop-up menus that allow the user to configure the behavior of the program

5.4.2.1 Screen Preferences

The Screen Preferences option invokes a pop-up window that allows the user to configure a new report, or reconfigure the currently selected report. The pop-up window may have multiple tabs, depending upon the report. Only the Market Data by Delivery Time and the Market Data by Trade Time have more than one tab.

5.4.2.1.1 The General Tab

The initial tab is basically the same for all reports except the Detailed and Summary checkout reports, and is labeled “General”. Items on the General tab are as follows:

a) “Starting Delivery Date/Time” for the report. For the Market Data by Trade Time Report and the APX Market and Bilateral Transactions by Trade Time Report, this will be the “Starting Trade Date/Time” for the report. This field allows the user to enter the earliest date and time for which data is to be shown on the report. If the user clicks the down arrow next to the date and time blank, a pop-up calendar appears for selecting the date. The user types in the time. This date/time should default to yesterday at 0:00. In the event that the user chooses a Starting Delivery Date/Time that does not fall on an interval boundary (or for the Market Data by Trade Time Report, a Starting Transaction Date/Time that does not fall on an even hour), the first interval shown in the report (or the first hour) should be the first interval (or first hour) beginning after the selected Starting Trade Date/Time. The Transactions by Trade Time Report can have any Starting Time, regardless of whether it falls on an even hour. The date and time formats for this item should correspond to the short date and time format selected on through the user's operating system.

b) “Ending Delivery Date/Time” for the report. For the Market Data by Trade Time Report, and the APX Market and Bilateral Transactions by Trade Time Report, this will be the “Ending Trade Date/Time” for the report. This field allows the user to enter the latest date and time for which data is to be shown on the report. This date should default to yesterday at 23:59. In the event that the user chooses a Ending Delivery Date/Time that does not fall on an interval boundary (or a Ending Transaction Date/Time that does not fall on an even hour), the last interval shown in the report (or the last hour) should be the last interval (or last hour) ending before the selected Ending Trade Date/Time. The Transactions by Trade Time Report can have any Ending Time, regardless of whether it falls on an even hour. The date and time formats for this item should correspond to the short date and time format selected on through the user's operating system.

c) Time Zone for Delivery Date/Times. This pull-down menu will allow the user to select a time zone. The Starting Delivery Date/Time, Ending Delivery Date/Time, and all delivery intervals and delivery times shown in the report are converted to this time zone. The Starting Trade Date/Time, Ending Trade Date/Time and all trade times shown in the report are shown in the user's local time zone, as specified in through the user's operating system, and do not use this setting.

d) The check box labeled “auto-increment date bounds” will cause both selected dates/times to move with time like a clock. If the “auto-increment date bounds” box is not checked, the selected dates and times will remain unchanged. This box should be checked by default.

e) “Save Report As” button and entry field. If the user enters a report name in the indicated field and presses the “Save Report As” button, a new report definition will be created, and a pop-up message box appears reading “Report Definition XXX Has Been Saved”, where XXX is the new report name. When the user clicks a button labeled “OK”, both the message box and the Screen Preferences pop-up window will close. The new report name should then be shown on the Selection Bar. If the user enters a name that already exists, a warning box will appear reading “Warning: Report Definition for XXX Already Exists. Do You Want to Overwrite It?”. The user can then click a button labeled “Yes” to save the report definition as usual and close both the warning pop-up message box and the Screen Preferences pop-up window. Alternatively, the user can click a button labeled “No” to close the warning pop-up box and return to the Screen Preferences pop-up window.

f) “Update Report” button—Clicking this button saves the selected changes and closes the Screen Preferences pop-up window.

g) “Delete Report” button. This button should be greyed-out unless the user has selected a saved report on the Selection Bar. If the user presses this button, a warning pop-up box will appear reading “Warning: Report Definition for XXX Will Be Deleted. Are You Sure You Want to Continue?”, where XXX is the name of the current report as shown on the Selection Bar. The user can then click a button labeled “Yes” to delete the report definition. Clicking the “Yes” button will close the warning pop-up message box and cause a new pop-up message box to appear reading “Report XXX Has Been Deleted”. When the user clicks a button labeled “OK”, both this message box and the Screen Preferences pop-up window will disappear. The name of the deleted report should disappear from the Selection Bar, and another saved report (if any) should be arbitrarily selected. If no saved reports are available, “New Report” should be selected, and the Screen Preferences window should again pop-up. Alternatively, the user can click a button labeled “No” on the warning window to close the warning pop-up box and return to the Screen Preferences pop-up window.

h) “Cancel” button—Clicking this button closes the Screen Preferences pop-up window with no action taken. It is equivalent to clicking the “X” in the upper right corner of the pop-up window.

The “General” tab for the Detailed Checkout Report and the Summary Checkout Report is similar to the “General” tab for the other reports. The user must, however, select a Control Area (currently California or Texas) and a single date (with no hours). All delivery dates and times shown in the Detailed Checkout Report and Summary Checkout report are shown in the time zone of the control area.

5.4.2.1.2 Screen Preferences for Market Report by Delivery Time

For the Market Report by Delivery Time, the second through eighth tabs are labeled “Column 1”, “Column 2”, . . . , “Column 7”, and are identical. For each one, the user selects a market, a strip, and an attribute from a pull-down menu. The attribute pull-down menu should include the following options: best bid, best ask, weighted-average price, bid quantity, ask quantity, and traded quantity. Best bid, best ask, bid quantity, and ask quantity are, of course, only available for future delivery dates, and will show up in the report as blanks for any historical delivery dates. The remaining attributes (weighted-average price and traded quantity) are available for all dates.

5.4.2.1.3 Screen Preferences for Market Report by Trade Time

For the Market Report by Trade Time, the second through eighth tabs are also labeled “Column 1”, “Column 2”, “Column 7”, and are identical. For each one, the user selects a market, a strip, an attribute, and an interval from a pull-down menu. The intervals on the pull-down menu will, of course, depend upon the strip that has been selected. This is similar to the interval pull-down menu on the Market Window 2000 Market screen. The intervals available should include all currently open intervals plus the most recent 24 hours of closed intervals. [Version 3 Enhancement—Add archival data on additional closed intervals as well.] The attribute pull-down menu should include the following options: quantity-weighted mean price, traded quantity, highest price, lowest price, and closing price.

5.4.2.2 Global Preferences

The “Global Preferences” button is described in Section 1.3.6.

5.4.2.2 Messages

The “Messages” button is described in Section 7.0.

5.4.2.3 Help

The “Help” button invokes a link to help information on the Report Screens.

5.5 Right-Click Functionality (Reports Windows)

Right-clicking any area of the Reports screen results in the pop-up menu shown above. The options on this menu are just different ways to get at functionality described elsewhere in this document.

a. “Copy” and “Select All” are the same as accessing these functions from the “Edit” menu, described in Section 1.3.2. There is no “cut” or “paste” functionality on the Reports screens, since there are no data entry fields.

b. Print is the same as accessing this function from the “File” menu, discussed in Section 1.3.

c. “Withdraw All” is the same as accessing this function from the “Actions” menu, discussed in Section 1.3.3.

d. “Screen Preferences” and “Global Preferences” are the same as accessing these options on the “Preferences” menu, as discussed in Section 1.3.6.

e. “Messages” is the same as accessing these options on the “Tools” menu, as discussed in Section 1.3.5.

6.0 The Set-Up Screens

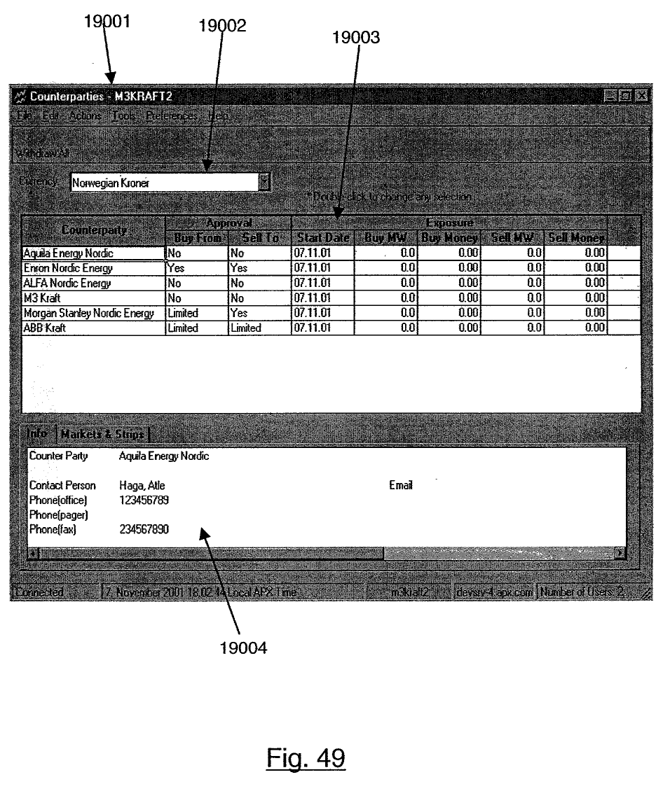

Referring to FIG. 49, the Set-Up screens 19001 allow users to view and in some cases, modify, information about their account. The Set-Up screens provide participants with access to five types of functionality: Credit Information, Counterparties, Markets, Assets/Trade Book, and Change Password. Users ‘Broker’ login privileges (see Section 1.11) will have access to one additional type of functionality—Participant Accounts.

6.1 Window Menu

The Window Menu will be designed with a one-level approach providing the following options:

a. Credit Information

b. Counterparties

c. Markets

d. Assets/Trade Books

e. Change Password

f. Participant Accounts

The ‘Participant Accounts’ option appears only for users with ‘Broker’ login privileges. The “Change Password” option simply invokes a link to a website, where the user can change his/her password.

6.2 Selection Bar

The selection bar 19002 on the Counterparties and Credit Information screens should allow the user to select the currency in which they would like to see all monetary amounts displayed. A currency is configured for each market segment, as well as an exchange rate for each currency. Each monetary amount is multiplied by the appropriate exchange rate before aggregating.

6.3 Column Functionality

The columns displayed 19003 depend on which of the screens the user has selected. Name in quotes at the left are the column heading. Description to the right is the tool tip when the user highlights the column; the notes in square brackets or parenthesis are not included in the tool tip. Columns marked with a # should appear in the default configuration. Where neighboring columns share a common beginning word (“Exposure”,“Approval”), this word may be put in the top line spanning all columns that begin with that word.

6.3.1 Credit Information

Display only. Pressing the F4 key anywhere in the program immediately opens this screen. All monetary information are displayed in the selected currency, and exposure figures include bilateral transactions.

#“Credit Limit”—The Participant Credit Limit

#“Exposure Open”—Current Credit Exposure for All Open Orders.

#“Exposure Filled”—The Current Credit Exposure for All Filled Orders.

#“Available Funds”—Credit Limit Less Exposure Open.

6.3.2 Counterparties

Users with ‘Change Party Selection’ privileges (see Section 1.6) can change the “Approval to Buy” and “Approval to Sell” for each counterparty. Participants can change their selection by double clicking anywhere on the row for the participant, which causes the pop-up window discussed in Section 6.3.2.1 to appear. Existing limits on how frequently a user can change the counterparty approvals should remain in place.

The counterparties listed include, for Trader logins (see Section 1.6), all parties registered to trade in market segments where the “Disclose Counterparties” flag has been set. For Broker logins, the counterparties listed include all registered participants. All money exposure figures are in the selected currency.

#“Counterparty Name”—The Name of the Counterparty.

#“Approval to Buy”—Can You Buy From This Counterparty? Double-click to Change Approval.

#“Approval to Sell”—Can You Sell To This Counterparty? Double-click to Change Approval.

#“Exposure Start Date”—Date From Which Exposure Is Calculated. Double-click to Change. [Default to Today.]

#“Exposure Buy MW”—Megawatt Exposure Due to Open and Filled Buys From This Counterparty. Includes exposure due to bilaterals. One decimal place.

#‘Exposure Buy Money”—Exposure in Indicated Currency Due to Open and Filled Buys From This Counterparty. Includes exposure due to bilaterals, where a price has been specified for the bilateral. Two decimal places.

#“Exposure Sell MW”—Megawatt Exposure Due to Open and Filled Sells From This Counterparty. Includes exposure due to bilaterals. One decimal place.

#‘Exposure Buy Money”—Exposure in Indicated Currency Due to Open and Filled Sells From This Counterparty. Includes exposure due to bilaterals, where a price has been specified for the bilateral. Two decimal places.

Any changes to the approved counterparties apply to existing open orders as well as newly placed orders. Whenever the user changes a counterparty selection, pop-up a list of the currently open orders, and allow the user to select which orders this change is to apply to.

The system allows the user to set trigger levels by counterparty. When exposure to a counterparty reaches a trigger level, a warning message will pop-up.

6.3.2.1 Counterparty Selection

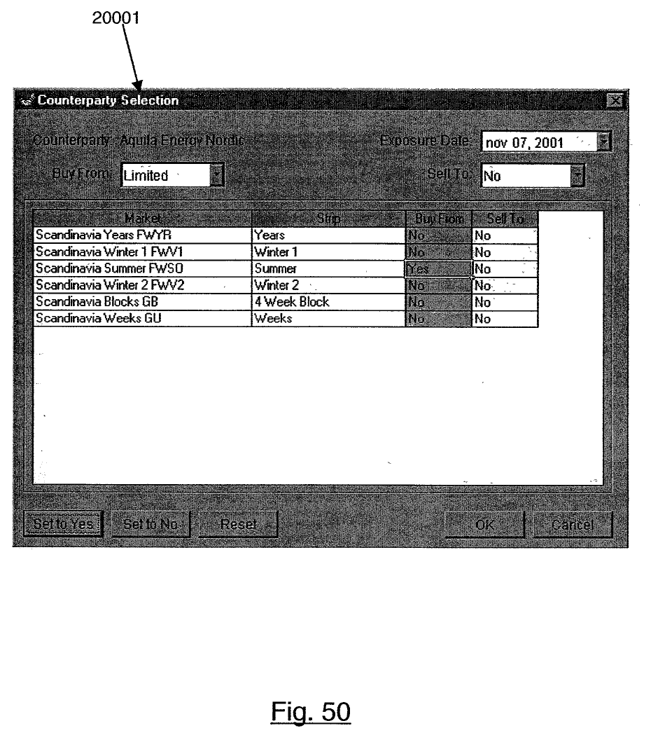

With respect to FIG. 50, when the user double-clicks anywhere on the row for a counterparty, the pop-up window 20001 appears, allowing the user to change the selections for that counterparty. This pop-up window may also be accessed from the right-click menu.

At the top of the are three pull-down menus. The “Buy From” and “Sell To” pull-down menus include the choices “Yes”, “No”, and “Limited”. Selecting “Limited means that trading with that counterparty should be limited to certain market segment and strip combinations, as specified in the lower part of the window. The “Exposure Date” drop-down menu actually drops down a calendar, allowing the user to select the date from which exposure should be calculated.

If the user has selected “Limited” for “Buy From” or “Sell To”, the columns labeled “Buy From” and “Sell To” in the lower part of the screen will change from yellow to blue. The user may highlight cells in blue columns and then click the “Set to Yes” or “Set to No” buttons at the bottom of the window to change the settings. The “Reset” button at the bottom of the screen changes all setting back to their original values when the window was opened.

The user may click “OK” to save the new settings and exit the Counterparty Selection pop-up window, or click “Cancel” to close the Counterparty Selection pop-up window without saving the changes. “Cancel” is equivalent to clicking the ‘X’ in the upper right corner of the window.

6.3.3 Markets

Display only.

#“Market”—The Name of the Market.

#“Product Type”—The Name of the Product Type Traded in This Market.

#“Location”—The Location of the Market.

#“Time Zone”—The Time Zone for the Market.

#“Currency”—The Currency for the Market.

#“Default Hit Price”—Sell Price Below Which a Warning Will Be Given.

#“Default Take Price”—Buy Price Above Which a Warning Will Be Given.

#“Minimum Order”—Minimum Order Size in MWs for This Market.

6.3.4 Assets/Trade Book

Display only.

#“Name”—Name of the Asset/Trade Book

#“Location”—Location of the Asset/Trade Book

#“Type”—Description of Asset/Trade Book

#“Allow Trading”—Can You Trade at This Asset/Trade Book?

#“Buy Capacity”—How Many MWs Can I Buy at This Asset/Trade Book?

#“Sell Capacity”—How Many MWs Can I Sell at This Asset/Trade Book?

Set buy and sell limits for each asset or trade book by login.

6.3.5 Participant Accounts

The Participant Accounts screen allows the user to assign a color to each participant. This list of participants shown, and their order, is specified through the Screen Preferences “Rows” tab as discussed in Section 6.5.2.1. The user can assign a color to each participant by double clicking on the color cell next to each participant to bring up the Edit Colors pop-up window discussed in Section 6.3.5.1 below. These colors will become the background color for the participant's bids and offers in the Broker Version of the Market Screen (see Section 2.10.1).

#“Participant Key”—Short Name of the Participant Account

#“Participant Account”—Name of Participant Account

#“Color”—Color Assigned to this Participant Account. This column displays a small box for each participant showing the color assigned to the participant.

6.3.5.1 Selecting the Participant Account Color

When the user clicks on a color box for a participant account, a pop-up window like the one shown above allows the user to select the color to assign to that participant. The user can select one of the standard colors shown, or may choose their own “Custom Color” by clicking on the “Define Custom Colors” button.

The Define Custom Colors button allows the user to specify a custom color from the full range of available colors. The color selections should be stored in the “Options” file on the user's computer. The default color should be the default background color selected through the user's operating system.

6.4 Screen Tab Functionality

Screen tab functionality is available only for the Counterparties screen. In this case, there are two screen tabs available—“Contact Information” and “Markets and Strips”.

6.4.1 Contact Information

The Contact Information tab displays contact information for the counterparty highlighted in the grid area. Contact information includes the name of the counterparty, the contact person name, the office phone, 24-hour phone and fax numbers, and e-mail address. A participant who wishes to send an e-mail message to the counterparty should be able to click on the e-mail address to pop-up a web e-mail form addressed to the counterparty.

A flag in registration should allow APX to suppress display of this information for a login. This capability is needed for the UK market, where regulators could view APX as fostering collusion if we were to make it easy for participants to contact each other.

6.4.2 Markets and Strips

The Markets and Strips tab displays information on each market and strip for the counterparty highlighted in the grid area. Using this Markets and Strips tab, the user can see his/her exposure to the counterparty by market and strip. All monetary information should be displayed in the selected currency. Also shown are the current counterparty selection settings for each market and strip.

The columns shown are as follows. Following the name of each column is a description that appears as a tool-tip. Notes in square parenthesis should not appear in the tool tip.

Market—The Name of the Market.

Strip—Name of the Strip

to Buy—Can You Buy This Market and Strip from This Counterparty?

to Sell—Can You Sell This Market and Strip from This Counterparty?

Start Date—Date From Which Exposure Is Calculated.

Buy MW—Megawatt Exposure Due to Open and Filled Buys for This Market and Strip from This Counterparty [Should include exposure due to bilaterals. One decimal place.]

“Buy Money”—Exposure in Indicated Currency Due to Open and Filled Buys for This Market and Strip From This Counterparty. [Should include exposure due to bilaterals, where a price has been specified for the bilateral. Two decimal places.]

“Sell MW”—Megawatt Exposure Due to Open and Filled Sells for This Market and Strip From This Counterparty [Should include exposure due to bilaterals. One decimal place.]

#‘Buy Money”—Exposure in Indicated Currency Due to Open and Filled Sells for This Market and Strip From This Counterparty. [Should include exposure due to bilaterals, where a price has been specified for the bilateral. Two decimal places.]

6.5 Screen Menu and Toolbar

At the top of the screen is a pull-down menu and toolbar. Options on the pull-down menu that are common to several screens have already been discussed in Section 1.3. Options that are unique to the Set-Up screens are discussed here. The File, Edit, Tools, and Help menus contain only options discussed in Section 1.3.

6.5.1 The Actions Menu

The only option on the Actions Menu is “Withdraw All”.

6.5.1.1 Withdraw All

The “Withdraw All” option is described in Section 1.3.4.4. It is also the only button on the toolbar.

6.5.2 The Preferences Menu

The Preferences Menu invokes two pop-up menus that allow the user to configure the behavior of the program

6.5.2.1 Screen Preferences

The “Screen Preferences menu allows the user to vary the format of each of the Set-Up Screens except for the Credit Information and Participant Accounts screens, which are so simple they have nothing to vary. Selecting the “Screen Preferences option causes the pop-up window shown above to appear. It may also be accessed from the right-click menu. The pop-up window has two tabs, the first labeled “Columns” and the second labeled “Sort”. There is an additional “Rows” tab for the Participant Accounts Set-Up Screen.

The “Columns” tab allows the user to select the columns to be displayed from a list of the available columns. The columns tab also allows the user to select the ordering of the columns.

The “Sort” tab allows the user to select the sort sequence for the rows of any of the Set-Up screens. Users may sort by any combination of three columns. The pull-down menus display a list of columns.

In the case of the Participant Accounts Set-Up Screen, there is an additional tab for selecting the participant accounts to be displayed, and the order in which they should be displayed. The participant accounts selected for this Set-Up screen, and their order, also determine the participant accounts selected, and their order, in the participant selection drop-down lists that appear for users with “Broker” privileges (see Section 1.2.9 and Section 2.10.2).

For all tabs, the buttons that appear at the bottom of the screen are as follows:

a. “OK”—Clicking this button applies the selected changes and closes the Screen Options pop-up window.

b. “Cancel” button—Clicking this button closes the Screen Options pop-up window with no action taken. It is equivalent to clicking the “X” in the upper right corner of the pop-up window.

6.5.2.2 “Global Preferences” Bottom Button

The “Global Preferences” button is described in Section 1.3.6

6.6 Right-Click Functionality

Right-clicking any area of the Set-Up screen results in the pop-up menu shown above. The options on this menu are just different ways to get at functionality described elsewhere in this document.

a. “Counterparty Selection” is only available in the Counterparties Set-Up screen. It is the same as double clicking on a counterparty to bring up the Counterparty Selection screen discussed in Section 6.3.2.1.

b. “Copy” and “Select All” are the same as accessing these functions from the “Edit” menu, described in Section 1.3.2. There is no “cut” or “paste” functionality on the Set-Up screen, since there are no data entry fields other than ‘approval to buy’ and ‘approval to sell’.

c. Print is the same as accessing this function from the “File” menu, discussed in Section 1.3.

d. “Withdraw All” is the same as accessing this function from the “Actions” menu, discussed in Section 1.3.3.

e. “Screen Preferences” and “Global Preferences” are the same as accessing these options on the “Preferences” menu, as discussed in Section 1.3.6.

f. “Messages” is the same as accessing these options on the “Tools” menu, as discussed in Section 1.3.5.

The only Set-Up screen that has double-click functionality is Counterparties, where double-click invokes the “Counterparty Selection screen discussed in Section 6.3.2.1.

7.0 The Messaging System

The Messaging System is primarily designed to provide APX participants with feedback on the response of the APX system to their requests, as well as warnings and alerts regarding the current state of the market. In addition, the Messaging System provides a basic two-way e-mail interface between APX operators and users.

7.1 The Messages Window

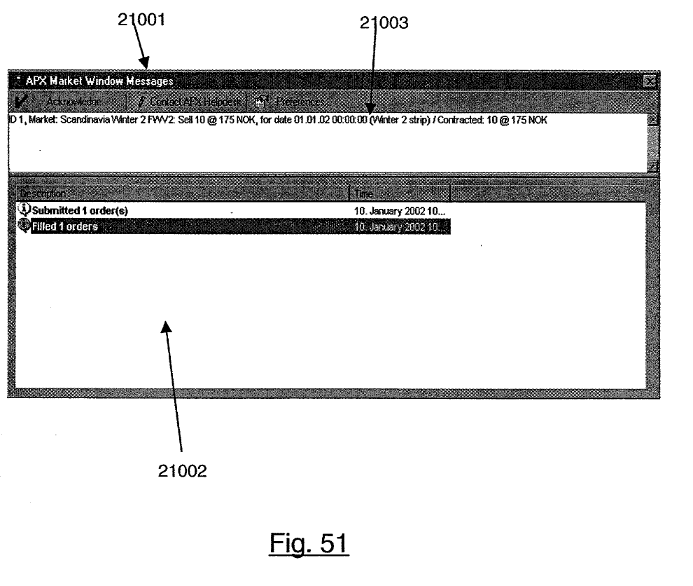

Referring to FIG. 51, the Messages Window 21001 will pop-up on top of the user's screen whenever the user selects “Messages” on the “Tools” pull-down menu, or whenever an event occurs that has been selected by the user to trigger the pop-up (see Section 7.2 below). The bottom half of the screen 21002 lists the messages that have been received, showing one row for each message. This row gives an icon for the type of message, a title for the message, and the date and time the message was received.

New messages are added to the bottom of the list as they are received. All messages since the this user logged-in, as well as Market Notices received since the user login last logged-out, are shown up to a maximum of at least 100. Once the maximum number of messages has been reached, one old message is deleted for each new message received, with the oldest message being deleted first. If the number of messages exceeds the space available on the screen, the list will scroll. All messages are deleted when the user logs off normally.

The top half of the screen 21003 shows the text of the message highlighted by the user in the bottom half of the screen. If the message is longer than the space available on the screen, the message will scroll.

Message titles initially appear in the bottom half of the screen in bold. Each time the user clicks the “Acknowledge” button at the top of the box, all bolded titles change to un-bolded.

Most messages do NOT accumulate while the user is not logged on to the system. There is, however, a class of operator broadcast messages called “Market Notices” that do accumulate while the user is not logged on, and that will appear in the Messages Box when the user logs in the next time after the message was sent. These Market Notices are intended to be used to announce significant changes in the market (new participants, changes in trading rules, etc.). The Market Notices are not lost if the user is disconnected from the system accidentally. Market Notices older than three days may be deleted if a user login has not logged in to receive them. Like all messages, the Market Notices for a particular login should be deleted when the user logs off normally.

In addition to the Market Notices, operators should also be able to send messages that do not accumulate. These Operator Messages are intended for more routine communications (such as “The market closed at . . . ”). Operators can send either class of messages only to participant logins authorized to trade in a particular control area.

When the user clicks the “Contact APX Helpdesk” button at the top of the Messages box, a web page pop-up allows the user to send an e-mail message to the APX Help desk. The system also allows live chat capability with Operators.

The user may expand the Messages pop-up box to full-screen, reduce it to the default size, shrink it into the taskbar, or close it completely using the standard Windows icons in the upper right corner. If the Messages pop-up box is displayed in its default size, the user may resize it by clicking and dragging on any of the edges. When the Messages Box pops-up, it appears in whatever size and in whatever location on the screen it had when it was last viewed in its default size. The system remembers this formatting information by login from one session to the next using the “Options” file stored on the user's computer.

7.2 Message Preferences

Pressing the “Preferences” button on the Messages Box causes a Message Preferences pop-up box to appear. This Message Preferences pop-up box has two tabs. Using the “Notification” tab, the user can select how he/she should be notified of each type of event. “Post Message” simply causes the system to post a notification message in the Messages box when the event occurs. “Popup” causes the Messages box to pop-up when the event occurs. “Beep” causes the user's computer to beep when the event occurs. “Post Message” must be checked before “Popup” and “Beep” can be checked.

There are two additional types of events that are not user configurable. First, a simple login event posts a message in the Messages Box, but does not pop-up or beep. However, if there are accumulated messages, the Messages Box should pop-up when the user first logs in. Second, a disconnection from the server posts a message in the Messages Box, causes the Messages Box to pop-up, and causes the computer to beep.

A second tab, called “Sounds”, allows the user to specify specific sounds for the ‘beeps’ that are generated when the user has specified that an event should cause a beep. Sounds are associated with events by assigning a .wav file to the event. The user can select the event to which he/she wishes to assign a sound in the top half of the box. In the bottom half of the box, the user specifies the .wav file. By pressing the “Browse’ button, the user can browse the .wav files available on the computer. Once the user has selected a .wav file, the user can hear a preview of what it sounds like by pressing the “Preview” button.

Clicking OK saves the preferences changes and closes the Message Preferences box. Clicking “Cancel” closes the Message Preferences box without saving any changes. “Cancel is equivalent to clicking the “X” icon in the upper right corner.

7.3 Messages Box Text

Examples of the title and text of each type of message are shown below:

New APX Market Order:

Submitted 1 Order(s)

Market FE System Firm; Sell 10 @ 50 USD for date Apr. 1, 2001 (Daily Off-Peak 1-7:24 strip); Order ID 7800080; Trade Book Buy/Sell_AIRLIQUIDE-1458011

APX Market Order Filled:

Filled 1 Order(s)

Market FE System Firm; Buy 10 @ 50 USD, for date Apr. 1, 2001 (Daily Off-Peak 1-7:24 strip); Order ID 7800081; Trade Book Buy/Sell AIRLIQUIDE-1458011; Counterparty

FirstEnergy Corp. Wholesale Energy (Pryor, Glenn@440-717-6821): SC/QSE APX/ Contracted 5 @ 45 USD

APX Market Order Rejected:

If order cannot be submitted:

Error Submitting 1 Order(s)

Market FE System Firm; Sell 100 @ 50 USD, for date Apr. 1, 2001 (Daily Off-Peak 1-7:24 strip)-->Reached trade book position limit

or (if order is later rejected by the system):

System Has Rejected 1 Order(s)

Market FE System Firm; Sell 100 @ 50 USD for date Apr. 1, 2001 (Daily Off-Peak 1-7:24 strip); Order ID 7800073; Trade Book Buy/Sell AIRLIQUIDE-1458011-->Trading is closed for this strip

APX Market Order Withdrawn:

Withdrew 1 Order(s)

Market FE System Firm; Sell 100 @ 50 USD, for date Apr. 3, 2001 (Daily Off-Peak 1-7:24 strip); Order ID 7800082, Trade Book Buy/Sell AIRLIQUIDE-1458011

New Schedule Submitted:

If schedule is a bilateral:

Submitted 1 Bilateral Schedule(s)

Scheduling Space No. CA Energy (Hourly/Daily); My Sell 100 @ 50 USD, for hour ending Mar. 30, 2001 22 (Hourly strip); Order ID 14; Counterparty Enron Energy Services (Hickey, Tom@408-517-2151)

If schedule is an asset schedule:

Submitted 1 Asset Schedule(s)

Scheduling Space FE System Firm; Source 100 for date Apr. 3, 2001 (Daily-Off Peak 1-7 strip); Order ID 4603; Asset: Orion Riverside 3

New Schedule Received

Received 1 Bilateral Schedule(s)

Scheduling Space: No. CA Energy (Hourly/Daily);My Sell 100@50 USD for hour ending Mar. 30, 2001 22 (Hourly strip); Order ID: 3010304; Counterparty: Enron Energy Services (Hickey, Tom@408-517-2151)

New Schedule Confirmed:

Confirmed 1 Bilateral Schedule(s)

Scheduling Space: FE System Firm; My Buy 10 @ 50 USD for date Apr. 1, 2001 (Daily Off-Peak 1-7:24 strip); Order ID 7800081; Counterparty: FirstEnergy Corp., Wholesale Energy (Pryor, Glenn@440-717-6821)

New Schedule Rejected:

If bilateral schedule cannot be submitted:

Error Submitting 1 Bilateral Schedule(s)

Scheduling Space: No. CA Energy (Hourly/Daily);Sell 100 @ 50 USD for date Apr. 3, 2001 (Daily Off-Peak 1-7:24 strip); Counterparty Enron Energy Services-->Insufficient credit

or (if asset schedule cannot be submitted):

Rejected 1 Asset Schedule(s)

Scheduling Space FE System Firm; Source 100 for date Apr. 3, 2001 (Daily-Off Peak 1-7 strip); Asset: Orion Riverside 3-->Exceeds Asset Source Capacity

or (if bilateral schedule is later rejected by the system):

System Has Rejected 1 Bilateral Schedule(s)

Scheduling Space FE System Firm; Sell 100 @ 50 USD for date Apr. 3, 2001 (Daily Off-Peak 1-7:24 strip); Order ID 7800081; Counterparty: Enron Energy Services-->Trading is closed for this strip

or (if counterparty rejects schedule):

Counterparty Has Rejected 1 Bilateral Schedule(s)

Scheduling Space FE System Firm; Sell 100 @ 50 USD for date Apr. 3, 2001 (Daily Off-Peak 1-7:24 strip); Order ID 7800081; Counterparty: Enron Energy Services

Schedule Withdrawn:

Withdrew 1 Bilateral Schedule(s)

Scheduling Space FE System Firm; Sell 100 @ 50 USD, for date Apr. 3, 2001 (Daily Off-Peak 1-7:24 strip); Order ID 7800082; Counterparty: Enron Energy Services

Operator Message Received:

Received Operator Message

Day-Ahead Schedules Are Now Available [Note: Operators should be able to include URLs in their messages, which users can click on to obtain further information.]

Market Notice Received

Received Market Notice

ABC Systems will be a new California market participant as of May 14, 2001; please add ABC Systems to your approved counterparty list if you wish to be able to trade with them under self-managed credit.

Helpdesk Message Requested:

Helpdesk Message Requested

You popped-up the form to send a message to the helpdesk.

This system cannot tell if you actually sent the message.

Available Funds <25%:

Available Funds<25%

Your available funds are <25% of their original value.

Login:

Login

Connected to Servers: 10.10.20.144

Connection to Server Lost:

Lost Connection

Timeout sending data to the server

Error −8487(0xFFFEDECF)

Note that all dates are given in the ‘long date’ format as set through the user's computer operating system. All messages are language configurable, as described in Section 1.5. Orders where different blocks have different dispositions (such as 100 MW filled with one counterparty, 100 MW filled with a different counterparty, and 100 MW rejected when trading closes) generate a separate message for each block.

7.4 Login Message

Each time the user logs in to the Market Window, if any APX market orders or bilateral schedules have changed status since the last login, he/she is greeted by a pop-up window such to the one shown above. This login message should inform the user if any of the following events have occurred since the last login:

any APX market orders have been filled (“X of your APX market orders have been filled since your last logoff at . . . ”)

any APX Market orders have been rejected (“X of your APX market orders have been rejected since your last logoff at . . . ”)

any bilateral schedules have been received (“X bilateral schedules have been received from other participants since your last logoff at . . . ”)

any bilateral schedules submitted by the participant have been confirmed (“X bilateral schedules submitted by you to other participants have been confirmed . . . ”)

any bilateral schedules submitted by the participant have been rejected. (“X bilateral schedules submitted by you to other participants have been rejected . . . ”)

The user may click the “OK” button to close this pop-up window. The Market Window determines the number of changed orders or schedules from data in the user's Order Summary screen. The system stores the time/date of the user's last logoff (or lost connection) in the “Options” file on the user's computer. By comparing this last logoff time/date with data shown in the user's Order Summary screen, the system determines these values.

7.5 Sending Operator Messages

APX employees with ‘APX Customer Service’ or ‘APX Broker’ privileges may send messages to the Messages Window of other APX Market Window 2002 users. To send a message, the user clicks on the “Send Operator Message” button on his/her own Messages Window. The “Send Operator Message” button replaces the “Contact APX Helpdesk” button for users with ‘APX Customer Service’ or ‘APX Broker’ privileges. (APX Employees who need to contact the APX Helpdesk may use internal APX e-mail.)

Pressing the “Send Operator Message” button causes an APX Operator Message box to appear. The user may choose between sending a normal APX Operator Message (which will be delivered only to participants currently on-line) and a Market Notice (which will go to all users, and will accumulate for users not currently on-line). The user may type the text of the message in the lower portion of the box, and click the “Send” button to send it, or the “Discard Button” to discard the message and close the APX Operator Message Box.

If the APX Employee clicks the selection icon next to “To:” a “Select Login Identities” box will pop-up allowing the user to select a specific Login ID from the list of Login IDs currently on-line (messages may not be sent to specific Login IDs unless the Login ID is currently on-line). The listing includes the Login ID of the user and the company name associated with that Login ID.

The listing also includes a distribution list for each “Control Area” operated by APX, beginning with the word “All” followed by the name of the Control Area (for example “All California” or “All U.K.”). The system can figure out if a login is registered in a particular control area, since it knows what market segments a login is registered to trade, and knows what control area each market segment is in. For normal messages, these distribution lists will send the message to all Login IDs registered to trade in the indicated control area that are currently on-line. For Market Notices, these distribution lists will send messages to all Login ID's registered to trade in the indicated control area, whether or not they are currently on-line. There is a similar distribution list for “All Participants”

The user may, if he/she prefers, type the Login ID or the distribution list name directly into the “To:” line of the APX Operator Message box. If the user attempts to send a message without filling in the “To:” line, an error message box appears reading “Error: Missing Address”. The user may click an “OK” button to close the error message box and return to the APX Operator Message box. Similar error messages reading “Error: Invalid Address” or “Error: Recipient Login ID is not on-line” should appear if the address entered is not valid or the recipient Login ID is not on line, respectively.

8.0 Transmission Features

The Market Window 2000 demonstrates the proposed APX Flowgate Market. These capabilities have been described above, but are also summarized here.

1) It is possible to configure markets of type “Energy (w/FGR)”. “FGR” stands for “Flowgate Right”. These markets will include the following features:

a) The Market screen includes two additional columns showing the “Transmission Cost to Buy” (deliver it to the currently selected facility from the currently selected market) and the “Transmission Cost to Sell” (deliver it from the currently selected facility to the currently selected market).

b) The “Interval Depth” tab of the Market Screen shows an “All-In” price for each bid and offer, which includes the “Transmission Cost to Buy” for bids, and be net of the “Transmission Cost to Sell” for offers. The bids and offers are sorted in order of price attractiveness by this “All-In” price.

c) When the user submits a bid or offer, the “Submit Orders” pop-up window proposes buying any FGRs needed to deliver to energy to the buyer, and selling any FGRs resulting from counterflows created through delivering the energy to the buyer. The user may select whether or not to submit these FGR orders.

d) A “Transmission Assumptions” pop-up window is available (as a button on the “Submit Orders” pop-up window and as a right-click option in the screen tabs area) showing the details of the “All-In” price calculation.

2) It is possible to configure markets of type “FGR (w/Energy)”. These markets will include the following feature

a) The Market screen includes two additional columns showing the “Required” and “Shortage” quantities. The “Required” quantity is the total amount of the FGR required to deliver the Energy (w/FGR) that the user has already contracted to buy. The “Shortage” quantity is equal to the “Required” quantity minus the “Contracted” quantity.

The Market Window 2000 itself includes a database table for storing the Transmission Distribution Factors (TDFs) needed to calculate the FGR requirements associated with an Energy (w/FGR) trade. The table has a column for each FGR market, and a row for each location. The table shows the MWs of the FGR required to deliver 1 MW of energy from a reference location to the location associated with the row. Entries in the TDF table may be negative if delivering a MW of energy from the reference location to the location associated with the row creates a counterflow across the flowgate. The FGR requirements to deliver one megawatt of energy from any location to any other location may be calculated by subtracting the TDF from the origin location to the reference location from the TDF from the reference location to the destination location.

Each market and facility is registered to a designated location. Transmission requirements to sell an order into a particular market may therefore be calculated by multiplying the size of the order by the MWs of each FGR required to deliver 1 MW of energy from the selling facility location to the market location. The “Transmission Price to Sell” is, of course, just these FGR requirements multiplied by their respective prices and summed over all FGRs. Similarly, transmission requirements to buy an order from a particular market may be calculated by multiplying the size of the order by the MWs of each FGR required to deliver 1 MW of energy from the market location to the buying facility location. The “Transmission Price to Buy” is these FGR requirements multiplied by their respective prices and summed over all FGRs.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A process for the bundling and trading of energy and transmission rights between participants, comprising the steps of:
accepting participant offers to sell complete bundles of energy and transmission rights;
allowing participants to enter bids to buy complete bundles of energy and transmission rights;
continuously searching for ways to disassemble said sale bundles into component elements of energy and transmission rights and reassemble said component elements into said bid bundles; and
wherein if aggregate bids for a complete bundle exceeds aggregate offers of component elements of said sale bundles, then said continuously searching step contracts orders for bid bundles and sale bundles and performs disassembly of sale bundles and reassembles appropriate component elements into bid bundles.

2. The process of claim 1, further comprising the step of:
generating a price quote for a point-to-point transmission right for a participant on demand.

3. The process of claim 2, wherein said generating step calculates said price quote based on the standing bids and offers for point-to-point transmission rights currently posted by other participants.

4. The process of claim 2, wherein a participant that is interested in said price quote can place an order at any time and be assured that said order is contracted at said price quote.

5. The process of claim 1, wherein if said component elements have a higher aggregate value after being reassembled into other bid bundles then said component elements are reassembled to reach the higher aggregate value.

6. The process of claim 1, wherein if any component elements are not needed by any bid bundles then they are returned to the owner of the component elements.

7. The process of claim 1, further comprising the step of:
generating a price quote for energy at a particular location for a participant on demand.

8. The process of claim 7, wherein a participant that is interested in said price quote can place an order at any time and be assured that said order is contracted at said price quote.

9. A process for the bundling and trading of energy and transmission rights between participants, comprising the steps of:
providing a server based trading system;
requiring participants to log onto said server;
accepting participant offers to sell complete bundles of energy and transmission rights;
allowing participants to enter bids to buy complete bundles of energy and transmission rights;
providing trading display means on said server for displaying to a participant particular bids and offers;
providing optimization means on said server for continuously searching for ways to disassemble said sale bundles into component elements of energy and transmission rights and reassemble said component elements into said bid bundles; and
wherein if aggregate bids for a complete bundle exceeds aggregate offers of component elements of said sale bundles, then said optimization means contracts orders for bid bundles and sale bundles and performs disassembly of sale bundles and reassembles appropriate component elements into bid bundles.

10. The process of claim 9, further comprising the step of:
providing a participant with a price quote for any point-to-point transmission right at any time.

11. The process of claim 10, wherein said providing step calculates said price quote based on the standing bids and offers for point-to-point transmission rights currently posted by other participants.

12. The process of claim 10, wherein a participant that is interested in said price quote can place an order at any time and be assured that said order is contracted at said price quote.

13. The process of claim 9, wherein if said component elements have a higher aggregate value after being reassembled into other bid bundles then said component elements are reassembled to reach the higher aggregate value.

14. The process of claim 9, wherein if any component elements are not needed by any bid bundles then they are returned to the owner of the component elements.

15. The process of claim 9, further comprising the step of:
generating a price quote for energy at a particular location for a participant on demand.

16. The process of claim 15, wherein a participant that is interested in said price quote can place an order at any time and be assured that said order is contracted at said price quote.

17. An apparatus for the bundling and trading of energy and transmission rights between participants, comprising:
a module for accepting participant offers to sell complete bundles of energy and transmission rights;
a module for allowing participants to enter bids to buy complete bundles of energy and transmission rights;
a module for continuously searching for ways to disassemble said sale bundles into component elements of energy and transmission rights and reassemble said component elements into said bid bundles; and
wherein if aggregate bids for a complete bundle exceeds aggregate offers of component elements of said sale bundles, then said continuously searching module contracts orders for bid bundles and sale bundles and performs disassembly of sale bundles and reassembles appropriate component elements into bid bundles.

18. The apparatus of claim 17, further comprising:
a module for generating a price quote for a point-to-point transmission right for a participant on demand.

19. The apparatus of claim 18, wherein said generating module calculates said price quote based on the standing bids and offers for point-to-point transmission rights currently posted by other participants.

20. The apparatus of claim 18, wherein a participant that is interested in said price quote can place an order at any time and be assured that said order is contracted at said price quote.

21. The apparatus of claim 17, wherein if said component elements have a higher aggregate value after being reassembled into other bid bundles then said component elements are reassembled to reach the higher aggregate value.

22. The apparatus of claim 17, wherein if any component elements are not needed by any bid bundles then they are returned to the owner of the component elements.

23. The apparatus of claim 17, further comprising:
a module for generating a price quote for energy at a particular location for a participant on demand.

24. The apparatus of claim 23, wherein a participant that is interested in said price quote can place an order at any time and be assured that said order is contracted at said price quote.

25. An apparatus for the bundling and trading of energy and transmission rights between participants, comprising:
a server based trading system;
a module for requiring participants to log onto said server;
a module for accepting participant offers to sell complete bundles of energy and transmission rights;
a module for allowing participants to enter bids to buy complete bundles of energy and transmission rights;
trading display means on said server for displaying to a participant particular bids and offers;
optimization means on said server for continuously searching for ways to disassemble said sale bundles into component elements of energy and transmission rights and reassemble said component elements into said bid bundles; and
wherein if aggregate bids for a complete bundle exceeds aggregate offers of component elements of said sale bundles, then said optimization means contracts orders for bid bundles and sale bundles and performs disassembly of sale bundles and reassembles appropriate component elements into bid bundles.

26. The apparatus of claim 25, further comprising:
a module for providing a participant with a price quote for any point-to-point transmission right at any time.

27. The apparatus of claim 26, wherein said providing module calculates said price quote based on the standing bids and offers for point-to-point transmission rights currently posted by other participants.

28. The apparatus of claim 26, wherein a participant that is interested in said price quote can place an order at any time and be assured that said order is contracted at said price quote.

29. The apparatus of claim 25, wherein if said component elements have a higher aggregate value after being reassembled into other bid bundles then said component elements are reassembled to reach the higher aggregate value.

30. The apparatus of claim 25, wherein if some component elements are not needed by any bid bundles then they are returned to the owner of the component elements.

31. The apparatus of claim 25, further comprising:
a module for generating a price quote for energy at a particular location for a participant on demand.

32. The apparatus of claim 31, wherein a participant that is interested in said price quote can place an order at any time and be assured that said order is contracted at said price quote.
